(19) United States
(12) Patent Application Publication
(10) Pub. No.: US 2007/0031514 A1
(43) Pub. Date: Feb. 8, 2007

(54) Use of isoindolinone derivatives as insecticides

(76) Inventors: Katsuaki Wada, Tochigi (JP); Takuya Gomibuchi, Ibaraki (JP); Yasushi Yoneta, Saitama (JP); Yuichi Otsu, Tochigi (JP); Katsuhiko Shibuya, Tochigi (JP); Hanako Okuya, Ibaraki (JP)

Correspondence Address: BAYER CROPSCIENCE LP;Patent Department, 100 BAYER ROAD, PITTSBURGH, PA, 15205-9741, US

(21) Appl. No.: 10/558,459

(22) PCT Filed: May 25, 2004
(86) PCT No.: PCT/EP04/05600

§ 371 Date: Nov. 28, 2005

(30) Foreign Application Priority Data
Jun. 6, 2003 (JP) 2003-162176

(51) Int. Cl. A01N 59/00

(52) U.S. Cl. 424/724

(57) ABSTRACT

This invention relates to the use of isoindolinone derivatives of formula (I) 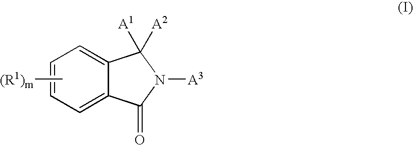
wherein A¹, A², A³, R¹ and m have the meanings given in the disclosure, and to novel isoindolinone derivatives and processes for preparing them.

The present invention relates to the use of isoindolinone derivatives as insecticidal agent, to novel isoindolinone derivatives and to processes for their preparation.

It has been known that certain isoindolinone derivatives have various physiological activities [cf.: JP-A 144570/1978, DE-A 28 31 770, J. Med. Chem. 40, 2858-2865 (1997), Bioorg. Med. Chem. 5, 2095-2102 (1997); Biomedicine & Pharmacotherapy 50, 290-296 (1996), Anti-Cancer Drugs 5, 207-212 (1994), Pharm. Res. 4, 21-27 (1987)].

Further, in the field of organic chemistry, various isoindolinone derivatives have been synthesized and studied [cf.: for example, J. Het. Chem. 34, 1371-1374 (1997), Bull. Chem. Soc. Jpn. 59, 2950-2952 (1986), Latvijas PSR Zinatnu Akademijas Vestis, Kimijas Serija, 2, 234-237 (1983), J. Org. Chem. 40, 2667-2674 (1975), J. Org. Chem. 39, 3924-3928 (1974), Khimiya Geterotsildicheskikh Soedinenii, 4, 640-644 (1969), Aust. J. Chem. 21, 1375-1378 (1968), Bull. Soc. Chim. Belg. 91, 763-790 (1982), J. Chem. Soc. Perkin Trans. I, 2149-2154 (1988), J. Het. Chem. 22, 449-451 (1984), Acta Chimica Hungarica 125, 831-838 (1988), Pol. J. Chem. 62, 115-125 (1988), Heterocyclic Commun. 3, 175-181 (1997), Bull. Soc. Chim. Belg. 92, 965-993 (1983), Ind. J. Chem. 20B, 1039-1042, (1981), Ind. J. Chem. 20B, 751-754 (1981), Ind. J. Chem. 15B, 61-63 (1977), Chem. Ber. 100, 1073-1081 (1967)].

It has now been found that a group of isoindolinone derivatives of the following formula (I) have insecticidal activities; 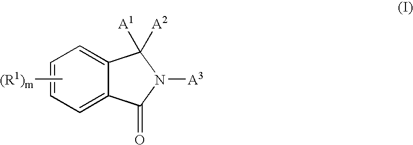
wherein
a) A¹ represents hydrogen, and
   A² represents one of the following groups 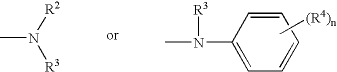
      or
b) A¹ and A² together form one of the following groups 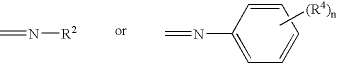
   and
A³ represents —R² or the group 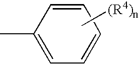
R¹ represents halogen, alkyl, alkoxy, alkylthio, alkylsulfonyl, alkylsulfonyloxy, haloalkyl, haloalkoxy or nitro,
m represents 0, 1, 2, 3 or 4, where R¹ may be identical or different, in case that m represents an integer of 2 or more,
R² represents alkyl which is optionally substituted by alkylthio, alkylsulfinyl or alkylsulfonyl,
R³ represents hydrogen or alkyl,
R⁴ represents halogen, alkyl, haloalkyl which is optionally substituted by hydroxy; haloalkoxy or phenyl which is optionally substituted by haloalkyl,
n represents 0, 1, 2, 3 or 4, where R⁴ may be identical or different, in case that n represents an integer of 2 or more.

The isoindolinone derivatives of the following formula (IA), included in the aforementioned formula (I), according to the present invention, are novel compounds that are not described in the existing publications.

The formula 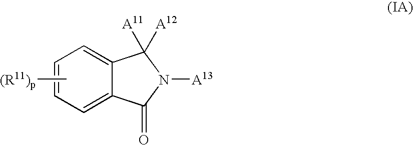
wherein
a) A¹¹ represents hydrogen, and
   A¹² represents one of the following groups 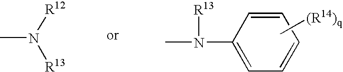
      or
b) A¹¹ and A¹² together form one of the following groups 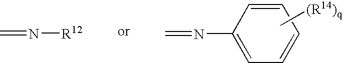
   and
A¹³ represents —R¹² or the group 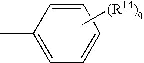
R¹¹ represents halogen, alkyl, alkoxy, alkylthio, alkylsulfonyl, alkylsulfonyloxy, haloalkyl, haloalkoxy or nitro,
p represents 0, 1, 2, 3 or 4, where R¹¹ may be identical or different, in case that p represents an integer of 2 or more,
R¹² represents alkyl which is optionally substituted by alkylthio, alkylsulfinyl or alkylsulfonyl,
R¹³ represents hydrogen or alkyl,
R¹⁴ represents halogen, alkyl, haloalkyl which is optionally substituted by hydroxy; haloalkoxy or phenyl which is optionally substituted by haloalkyl,
q represents 0, 1, 2, 3 or 4, where R¹⁴ may be identical or different, in case that q represents an integer of 2 or more,
with the exception of the following cases (E-1)-(E-11);
(E-1) the case in which
   A¹¹ represents hydrogen,
   A¹² represents anilino,
   A¹³ represents tert-butyl, and
   p represents 0,
(E-2) the case in which
   A¹¹ represents hydrogen,
   A¹² represents 2-fluoro-4-methylanilino or 3-trifluoromethylanilino,
   A¹³ represents n-butyl or 3-methylbutyl,
(E-3) the case in which
   A¹¹ represents hydrogen,
   A¹² represents the group —NH—R¹²,
   A¹³ represents —R¹²,
   R¹² in the above-mentioned groups represents at the same time ethyl, iso-propyl, n-butyl, 1-methyl-n-hexyl or n-dodecyl, and
   p represents 0,
(E-4) the case in which
   A¹¹ represents hydrogen,
   A¹² represents tert-butylamino or diethylamino,
   A¹³ represents methyl, and
   p represents 0,
(E-5) the case in which
   A¹¹ represents hydrogen atom,
   A¹² represents anilino or 2-methylanilino,
   A¹³ represents phenyl, and
   p represents 0,
(E-6) the case in which
   A¹¹ and A¹² together form methylimino or ethylimino,
   A¹³ represents 2,6-di(isopropyl)phenyl, and
   p represents 0,
(E-7) the case in which
   A¹¹ and A¹² together form the group ═N-alkyl,
   A¹³ represents 2,6-diethylphenyl, and
   p represents 0 or p represents 1 and R¹¹ represents lower alkyl,
(E-8) the case in which
   A¹¹ and A¹² together form phenylimino,
   A¹³ represents methyl or n-propyl, and
   p represents 0,
(E-9) the case in which
   A¹¹ and A¹² together represent group ═N—R¹²,
   A¹³ represents —R¹²,
   R¹² in the above-mentioned groups represents at the same time C₁₋₅-alkyl, and
   p represents 0,
(E-10) the case in which
   A¹¹ and A¹² together form 4-methylanilino,
   A¹³ represents anilino or 4-methylanilino, and
   p represents 0,
(E-11) the case in which
   A¹¹ and A¹² together form the group 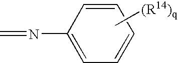
   A¹³ represents the group 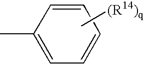
   R¹⁴ in the above-mentioned groups each independently represents methyl or chloro,
   q represents 0 or 1, and
   p represents 1 and R¹¹ represents chloro or bromo.

The compounds of the formula (IA) can be obtained by a process in which
(A) in case that
   A¹¹ represents hydrogen atom,
   A¹² represents one of the following groups 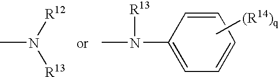
   R¹², R¹³, R¹⁴ and q have the same definition as aforementioned:
   compounds of the formula (IB) 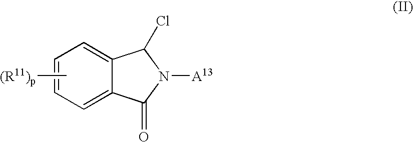
   wherein
   A¹³ represents —R¹² or the group 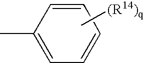
   R¹¹, R¹², R¹⁴, p and q have the same definition as aforementioned,
   are reacted with compounds of the formula (E)
      H-A^{12a} (III)
   wherein
   A^{12a} represents one of the following groups 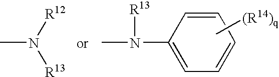
   R¹², R¹³, R¹⁴ and q have the same definition as aforementioned,
   in the presence of inert solvents, and optionally in the presence of an acid binder,
      or
(B) in case that
   R¹¹ represents halogen, alkyl, alkoxy, alkylsulfonyl, alkylsulfonyloxy, haloalkyl, halo-alkoxy or nitro and
   R¹² represents alkyl that is substituted by alkylsulfinyl or alkylsulfonyl: compounds of the formula (IAb) 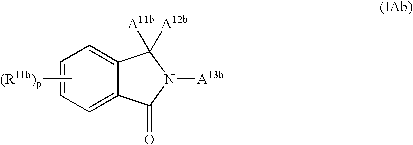
   wherein
   a) A^{11b} represents hydrogen atom, and
      A^{12b} represents one of the following groups 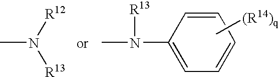
   or
   b) A^{11b} and A^{12b} together form one of the following groups 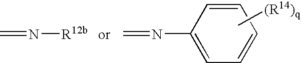
   and
   A^{13b} represents —R^{12b} or the group 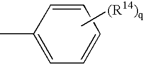
   R^{11b} represents halogen, alkyl, alkoxy, alkylsulfonyl, alkylsulfonyloxy, haloalkyl, halo-alkoxy or nitro,
   R^{12b} represents alkyl that is substituted by alkylthio, and
   R¹³, R¹⁴, p and q have the same definition as aforementioned,
   are reacted with a peroxy acid in the presence of inert solvents,
      or
(C) in case that
   A¹¹ and A¹² together form one of the following groups 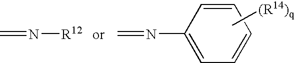
   A¹³ represents —R¹² or the group 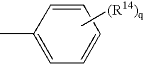
   R¹², R¹³, R¹⁴ and q have the same definition as aforementioned:
   compounds of the formula (IAc) 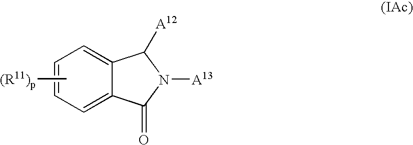
   wherein
   A¹² represents one of the following groups 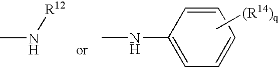
   A¹³ represents —R¹² or the group 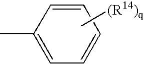
   R¹¹, R¹², R¹⁴, p and q have the same definition as aforementioned,
   are reacted with a cyanide, in the presence of inert solvents,
      or
(D) in case that
   A¹¹ and A¹² together form one of the following groups 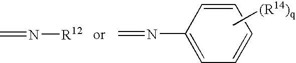
   A¹³ represents —R¹² or the group 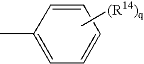
   R¹¹ represents halogen, alkyl, alkoxy, alkylsulfonyl, alkylsulfonyloxy, haloalkyl, halo-alkoxy or nitro, and
   R¹² represents alkyl that is substituted with alkylsulfonyl:
   compounds of the formula (IAd) 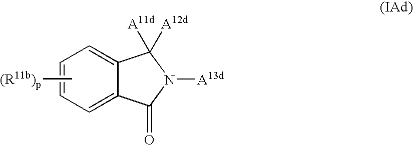
   wherein
   a) A^{11d} represents hydrogen, and
      A represents one of the following groups 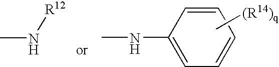
   or
   b) A^{11d} and A^{12d} together form one of the following groups 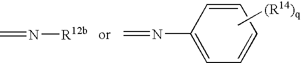
   and
   A^{13d} represents —R^{12b} or group 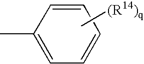
   R^{11b}, R¹², R^{12b}, R¹⁴, p and q have the same definition as aforementioned,
   are reacted with an oxidizing agent, in the presence of inert solvents.

The compounds of the formula (I), according to the present invention show strong insecticidal action.

In the present specification:

“Halogen” and halogen part in “haloalkyl” and “haloalkoxy” represent fluoro, chloro, bromo or iodo. “Alkyl” and alkyl part in “alkoxy”, “alkylthio”, “alkylsulfinyl”, “alkylsulfonyl” and “alkylsulfonyl-oxy” can be straight chain or branched chain and there can be mentioned, for example, methyl, ethyl, n- or iso-propyl, n-, iso-, sec- or tert-butyl, n-, iso-, neo- or tert-pentyl, 2-methylbutyl, n-, iso- or sec-hexyl, etc.

“Haloalkyl” represents straight chain or branched chain alkyl, in which at least one hydrogen is substituted by halogen and there can be mentioned as examples C₁₋₆-alkyl substituted with, for example, 1-9 fluoro and/or chloro, and as their specific examples there can be mentioned difluoromethyl, trifluoromethyl, 2-fluoroethyl, 2-chloroethyl, 2,2,2-trifluoroethyl, 1,1,2,2-tetrafluoroethyl, 1,1,2,2,2-pentafluoroethyl, 2-chloro-1,1,2-trifluoroethyl, 3-fluoropropyl, 3-chloropropyl, 1-methyl-2,2,2-tri-fluoroethyl, 2,2,3,3,3-pentafluoropropyl, 1,2,2,3,3,3-hexafluoropropyl, perfluoroisopropyl, perfluoro-butyl, 2,2,3,3,4,4,5,5,5-nonafluoropentyl, 3,3,4,4,5,5,6,6,6-nonafluorohexyl, etc.

Haloalkyl part of “haloalkyl which optionally substituted by hydroxy” can be of the same definition as the aforementioned “haloalkyl” and as specific examples of “haloalkyl which optionally substituted by hydroxy” there can be mentioned, in addition to the aforementioned specific example of halo-alkyl, 2,2,2-trifluoro-1-hydroxy-1-trifluoromethyl-ethyl etc.

Halogen-substituted alkyl part in “haloalkoxy” can be of the same definition as the aforementioned “haloalkyl” and as specific examples of “haloalkoxy” there can be mentioned, for example, difluoromethoxy, trifluoromethoxy, 2-fluoroethoxy, 2-chloroethoxy, 2-bromoethoxy, 2,2,2-trifluoroethoxy, etc.

In the compounds of the aforementioned formula (IA), preferably,
a) A¹¹ represents hydrogen, and
   A¹² represents one of the following groups 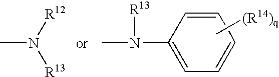
      or
b) A¹¹ and A¹² together form one of the following groups 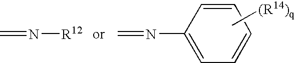
   and
A¹³ represents —R¹² or the group 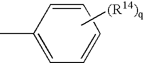
R¹¹ represents fluoro, chloro, bromo, iodo, C₁₋₄-alkyl, C₁₋₄-alkoxy, C₁₋₄-alkylthio, C₁₋₄-alkylsulfonyl, C₁₋₄-alkylsulfonyloxy, C₁₋₄-haloalkyl, C₁₋₄-haloalkoxy or nitro,
p represents 0, 1, 2, 3 or 4, where R¹¹ may be identical or different, in case that p represents an integer of 2 or more,
R¹² represents C₁₋₆-alkyl which is optionally substituted by C₁₋₄-alkylthio, C₁₋₄-alkylsulfinyl or C₁₋₄-alkylsulfonyl,
R¹³ represents hydrogen or C₁₋₆-alkyl,
R¹⁴ represents fluoro, chloro, C₁₋₄-alkyl, C₁₋₄-haloalkyl which is optionally substituted by hydroxy; C₁₋₄-haloalkoxy or phenyl which is optionally substituted by C₁₋₄-haloalkyl,
q represents 0, 1, 2, 3 or 4, where R¹⁴ may be identical or different, in case that q represents an integer of 2 or more,

with the exception of the following cases (E-1)-(E-11);
(E-1) the case in which
   A¹¹ represents hydrogen,
   A¹² represents anilino,
   A¹³ represents tert-butyl, and
   p represents 0,
(E-2) the case in which
   A¹¹ represents hydrogen,
   A¹² represents 2-fluoro-4-methylanilino or 3-trifluoromethylanilino,
   A¹³ represents n-butyl or 3-methylbutyl,
(E-3) the case in which
   A¹¹ represents hydrogen,
   A¹² represents the group —NH—R¹²,
   A¹³ represents —R¹²,
   R¹² in the above-mentioned groups represents at the same time ethyl, iso-propyl or n-butyl, and
   p represents 0,
(E-4) the case in which
   A¹¹ represents hydrogen,
   A¹² represents tert-butylamino or diethylamino,
   A¹³ represents methyl, and
   p represents 0,
(E-5) the case in which
   A¹¹ represents hydrogen,
   A¹² represents anilino or 2-methylanilino,
   A¹³ represents phenyl, and
   p represents 0,
(E-6) the case in which
   A¹¹ and A¹² together form methylimino or ethylimino,
   A¹³ represents 2,6-di(isopropyl)phenyl, and
   p represents 0,
(E-7) the case in which
   A¹¹ and A¹² together represent group ═N—C₁₋₆-alkyl,
   A¹³ represents 2,6-diethylphenyl, and
   p represents 0 or p represents 1 and R¹¹ represents C₁₋₄-alkyl,
(E-8) the case in which
   A¹¹ and A¹² together form phenylimino,
   A¹³ represents methyl or n-propyl, and
   p represents 0,
(E-9) the case in which
   A¹¹ and A¹² together represent group ═N—R¹²,
   A¹³ represents —R¹²,
   R¹² in the above-mentioned groups represents at the same time C₁₋₅-alkyl, and
   p represents 0,
E-10) the case in which
   A¹¹ and A¹² together form 4-methylanilino,
   A¹³ represents anilino or 4-methylanilino, and
   p represents 0,
(E-11) the case in which
   A¹¹ and A¹² together form the group 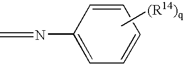
   A¹³ represents the group 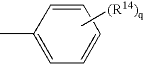
   R¹⁴ in the above-mentioned groups each independently represents methyl or chloro,
   q represents 0 or 1, and
   p represents 1 and R¹¹ represents chloro or bromo.

In the compounds of the aforementioned formula (IA), particularly preferably,
a) A¹¹ represents hydrogen, and
   A¹² represents one of the following groups 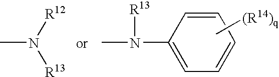
      or

b) A¹¹ and A¹² together form one of the following groups 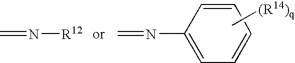
and
A¹³ represents —R¹² or the group 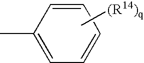
R¹¹ represents fluoro, chloro, bromo, iodo, methyl, methoxy, methylthio, methylsulfonyl, methylsulfonyloxy, trifluoromethyl, trifluoromethoxy or nitro,
p represents 0, 1 or 2, where R¹¹ may be identical or different, in case that p represents 2,
R¹² represents iso-propyl, 1-methyl-2-(methylthio)ethyl, 1,1-dimethyl-2-(methylthio)ethyl, 1-methyl-2-(methylsulfinyl)ethyl, 1,1-dimethyl-2-(methylsulfinyl)ethyl, 1-methyl-2-(methylsulfonyl)ethyl, 1,1-dimethyl-2-methylsulfonyl)ethyl,
R¹³ represents hydrogen or methyl,
R¹⁴ represents fluoro, chloro, methyl, trifluoromethyl, perfluoroisopropyl or trifluoromethoxy,
q represents 0, 1, 2 or 3, where R¹⁴ may be identical or different, in case that q represents an integer of 2 or more,
with the exception of the following cases (E-3), (E-5), and (E-9)-(E-11);
(E-3) the case in which
   A¹¹ represents hydrogen,
   A¹² represents the group —NH—R¹²,
   A¹³ represents —R¹²,
   R¹² in the above-mentioned groups represents at the same time iso-propyl, and
   p represents 0,
(E-5) the case in which
   A¹¹ represents hydrogen,
   A¹² represents anilino or 2-methylanilino,
   A¹³ represents phenyl, and
   p represents 0,
(E-9) the case in which
   A¹¹ and A¹² together represent group ═N—R¹²,
   A¹³ represents —R¹²,
   R¹² in the above-mentioned groups represents at the same time iso-propyl, and
   p represents 0,
(E-10) the case in which
   A¹¹ and A¹² together form 4-methylanilino,
   A¹³ represents anilino or 4-methylanilino, and
   p represents 0,
(E-11) the case in which
   A¹¹ and A¹² together form the group 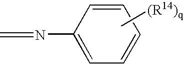
   A¹³ represents the group 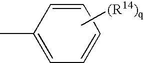
   R¹⁴ in the above-mentioned groups each independently represents methyl or chloro,
   q represents 0 or 1, and
   represents 1 and R¹¹ represents chloro or bromo.

The aforementioned preparation process (A) can be illustrated by the following reaction scheme in case that, for example, 3,4dichloro-2-[2-methyl-4-(1,2,2,2-tetrafluoro-1-trifluoromethyl-ethyl)phenyl]-2,3-dihydroisoindol-1-one and 1,1-dimethyl-2-methylthioethylamine are used as the starting materials.

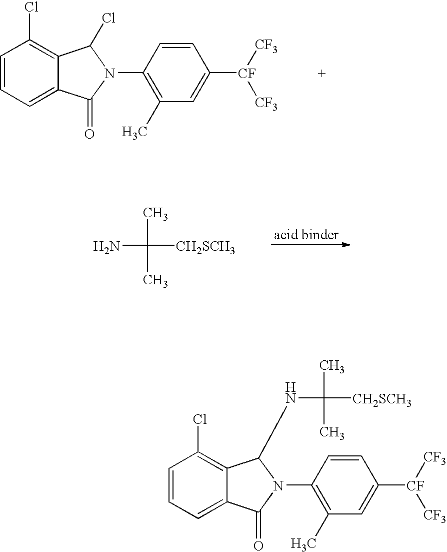

The aforementioned preparation process (B) can be illustrated by the following reaction scheme in case that, for example, 4-chloro-3-(1,1-dimethyl-2-methylthioethylamino)-2-[2-methyl-4-(1,2,2,2-tetrafluoro-1-trifluoromethylethyl)-phenyl]-2,3-dihydroisoindol-1-one and 3-chloroperbenzoic acid are used as the starting materials.

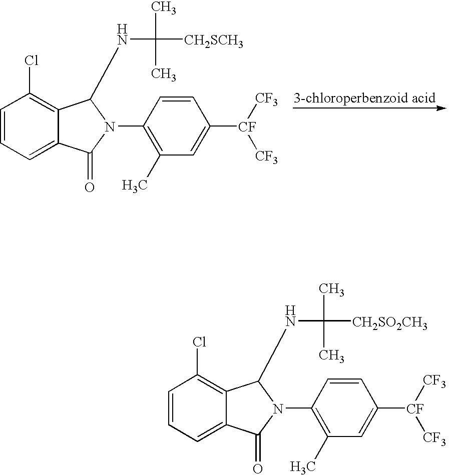

The aforementioned preparation process (C) can be illustrated by the following reaction scheme in case that, for example, 4-chloro-3-isopropylamino-2-[2-methyl-4-(1,2,2,2-tetrafluoro-1-trifluoromethylethyl)phenyl]-2,3-dihydroisoindol-1-one and potassium cyanide are used as the starting materials.

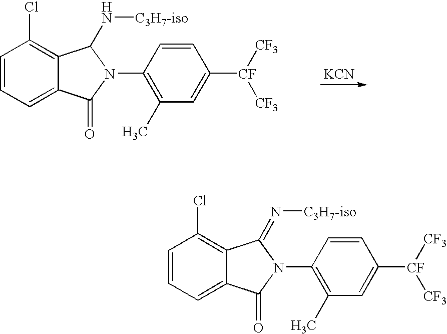

The aforementioned preparation process (D) can be illustrated by the following reaction scheme in case that, for example, 4-chloro-3-(1,1-dimethyl-2-methylthioethylamino)-2-[2-methyl-4-(1,2,2-tetrafluoro-1-trifluoromethylethyl)-phenyl]-2,3-dihydroisoindol-1-one and potassium permanganate are used as the starting materials.

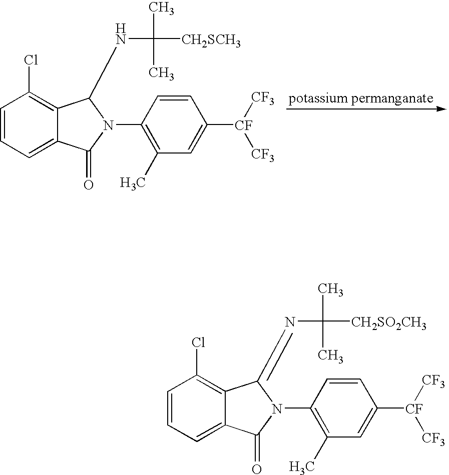

The compounds of the formula (II), used as starting materials in the above-mentioned preparation process (A), a part of which are novel compounds not described in the existing literature, can be easily prepared, for example, according to the process described in the literature such as Tetrahedron, 54, 1497-1506 (1998), U.S. Pat. No. 4,164,406, etc., for example, by reacting a compound represented by the formula 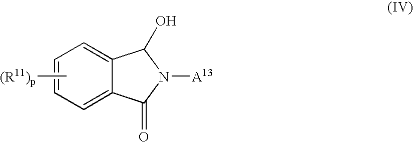
wherein
A¹³ represents —R¹² or the group 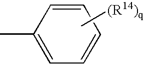
R¹¹, R¹², R¹⁴, p and q have the same definition as aforementioned,
with a halogenating agent for example, thionyl chloride, phosphoryl chloride, etc.

The compounds of the formula (III), used in the aforementioned preparation process (A), partly including compounds available on the market, are well known compounds in the field of organic chemistry and can be easily prepared according to the process described in, for example, J. Org. Chem. 29, 1 (1964), Angew. Chem. Int. Ed. Engl. 24, 871 (1985), JP-A 302233/1999, DE-A 20 45 905, WO 01/23350, J. Amer. Chem. Soc. 60, 2023-2025 (1938), etc.

The compounds of the aforementioned formula (IV), a part of which are novel compounds not described in the existing literature, can be easily prepared, for example, according to the process described in the literature such as Tetrahedron, 56, 4837-4844 (2000) etc., for example, by reacting a compound represented by the formula 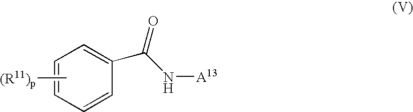
wherein
A¹³ represents —R¹² or the group 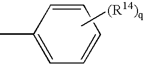
R¹¹, R¹², R¹⁴, p and q have the same definition as aforementioned,
with an organolithium compound, for example, sec-butyl lithium etc. and N,N-dimethylformamide.

The compounds of the above-mentioned formula (V), a part of which are novel compounds not described in the existing literature, can be easily prepared, for example, according to the preparation process of acid amide that is well known in the field of organic chemistry by reacting a per se known compound represented by the formula 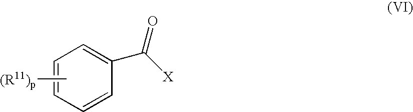
wherein
X represents hydroxy or chloro, and
R¹¹ and p have the same definition as aforementioned,
with a compound represented by the formula
   A¹³-NH₂ (VII)
   wherein
A¹³ represents —R¹² or the group 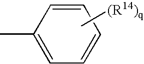
R¹², R¹⁴ and q have the same definition as aforementioned,
in the presence of a base, for example, triethylamine.
The compounds of the above-mentioned formula (VII) are the same kinds of amines included in the compounds of the aforementioned formula (III).

As specific examples of the compounds of the formula (II), used as starting materials in the aforementioned preparation process (A), there can be mentioned as follows:

3,7-chloro-2-isopropyl-2,3-dihydro-isoindol-1-one,

3,7-dichloro-2-(1-methyl-2-methylthioethyl)-2,3-dihydroisoindol-1-one,

3,7-dichloro-2-(1,1-dimethyl-2-methylthioethyl)-2,3-dihydroisoindol-1-one,

3,4-dichloro-2-[2-methyl-4-(1,2,2,2-tetrafluoro-1-trifluoromethylethyl)phenyl]-2,3-dihydroisoindol-1-one, etc.

As specific examples of the compounds of the formula (III), used as starting materials in the aforementioned preparation process (A), there can be mentioned as follows:

1,1-dimethyl-2-methylthioethylamine,

1-methyl-2-methylthioethylamine,

isopropylamine,

2-methyl-4-(1,2,2,2-tetrafluoro-1-trifluoromethylethyl)phenylamine,

methyl-[2-methyl-4-(1,2,2,2-tetrafluoro-1-trifluoromethylethyl)phenyl]amine,

ethyl-[2-methyl-4-(1,2,2,2-tetrafluoro-1-trifluoromethylethyl)phenyl]amine,

2,3,4-trichlorophenylamine,

2-methyl-4-trifluoromethoxyphenylamine, etc.

As specific examples of the compounds of the formula (IV), used as starting materials in the preparation of the compounds of the aforementioned formula (II), there can be mentioned as follows:

7-chloro-3-hydroxy-2-isopropyl-2,3-dihydroisoindol-1-one,

7-chloro-3-hydroxy-2-(1-methyl-2-methylthioethyl)-2,3-dihydroisoindol-1-one,

7-chloro-2-(1,1-dimethyl-2-methylthioethyl)-3-hydroxy-2,3-dihydroisoindol-1-one,

4-chloro)-3-hydroxy-2-[2-methyl-4-(1,2,2,2-tetrafluoro-1-trifluoromethylethyl)-phenyl]-2,3-dihydroisoindol-1-one,

3-hydroxy-4-iodo-2-[2-methyl-4-(1,2,2,2-tetrafluoro-1-trifluoromethylethyl)-phenyl]-2,3-dihydroisoindol-1-one, etc.

3-hydroxy-7-iodo-2-[2-methyl-4(1,2,2,2-tetrafluoro-1-trifluoromethylethyl)-phenyl]-2,3-dihydroisoindol-1-one, etc.

As specific examples of the compounds of the formula (V), used as starting materials in the preparation of the compounds of the aforementioned formula (M), there can be mentioned as follows:

2-chloro-N-isoproylbenzamide,

3-chloro-N-isoproylbenzamide,

2-chloro-N-(1-methyl-2-methylthioethyl)benzamide,

3-chloro-N-(1-methyl-2-methylthioethyl)benzamide,

3-chloro-N-(1,1-dimethyl-2-methylthioethyl)benzamide,

2-chloro-N-[2-methyl-4-(1,2,2,2-tetrafluoro-1trifluoromethylethyl)phenyl]benzamide,

3-chloro-N-[2-methyl-4-(1,2,2,2-tetrafluoro-1trifluoromethylethyl)phenyl]benzamide etc.

As specific examples of the compounds of the formula (VI), used as starting materials in the preparation of the compounds of the aforementioned formula (V), there can be mentioned as follows:

2-chlorobenzoic acid,

3-chlorobenzoic acid,

2-chlorobenzoyl chloride,

3-chlorobenzoyl chloride, etc.

Further, the compounds of the above-mentioned formula (IV), can also be easily prepared, for example, according to the process described in the literature such as Tetrahedron, 54, 1497-1506 (1998) etc., by reacting a compound represented by the formula 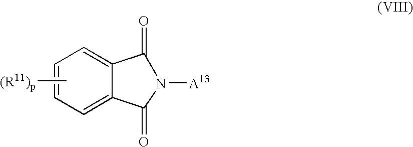
wherein
A¹³ represents —R¹² or the group 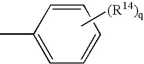
R¹¹, R¹², R¹⁴, p and q have the same definition as aforementioned,
with a metal hydride, for example, sodium borohydride etc.

The compounds of the above-mentioned formula (VIII) are well known compounds in the field of organic chemistry and can be easily prepared by the process described in the literature, for example, JP-A 246161/1986 etc.

As specific examples of the compounds of the formula (VIII), used as starting materials in the preparation of the compounds of the aforementioned formula (IV), there can be mentioned as follows:

4-chloro-2-[2-methyl-4-(1,2,2,2-tetrafluoro-1-trifluoromethylethyl)phenyl]-isoindol-1,3-dione,

4-iodo-2-[2-methyl-4-(1,2,2,2-tetrafluoro-1-trifluoromethylethyl)phenyl]isoindol-1,3-dione, etc.

Furthermore, the compounds of the above-mentioned formula (II), in case that A¹³ represents group 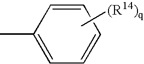
can be easily prepared, for example, according to the process described in the literature such as U.S. Pat. No. 4,164,406 etc., by reacting a compound represented by the formula 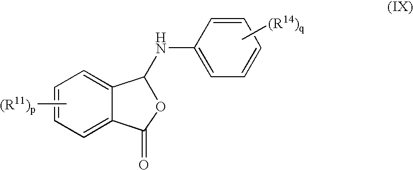
wherein
R¹¹, R¹⁴, p and q have the same definition as aforementioned,
with a chlorinating agent, for example, thionyl chloride etc.

The compounds of the above-mentioned formula (IX), a part of which are novel compounds not described in the existing literature, can be easily prepared, for example, according to the process described in the literature such as U.S. Pat. No. 4,164,406 etc., by reacting a compound represented by the formula 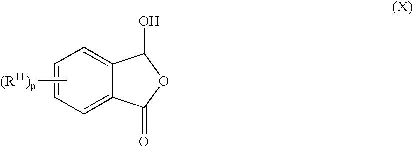
wherein R¹¹ and p have the same definition as aforementioned,
with a compound represented by the formula 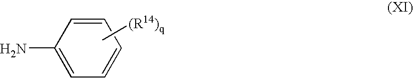
   wherein R²⁴ and q have the same definition as aforementioned.

The compounds of the above-mentioned formula (IX), a part of which are novel compounds not described in the existing literature, can be easily prepared, for example, according to the process described in the literature such as J. Org. Chem. 59, 4042-4044 (1994), J. Og. Chem 52, 713-719 (1987), Chem. Rev. 90, 879-933 (1990), etc., by reacting a per se known compound represented by the formula 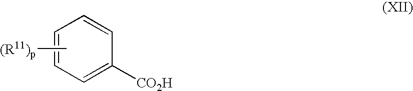
wherein R¹¹ and p have the same definition as aforementioned,
with N,N-dimethylformamide in the presence of sec-butyl lithium.

The compounds of the aforementioned formula (XI) are the compounds included in the aforementioned formula (III).

Further, the compounds of the aforementioned formula (X) can be easily prepared, for example, according to the process described in the literature such as J. Org. Chem. 59, 4042-4044 (1994), J. Org. Chem. 52, 713-719 (1987), Chem. Rev. 90, 879-933 (1990), etc., by reacting a per se known compound represented by the formula 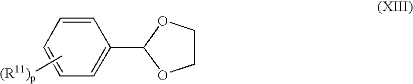
wherein R¹¹ and p have the same definition as aforementioned,
with N,N-dimethylformamide in the presence of sec-butyl lithium.

Furthermore, the compounds of the aforementioned formula (X) can be easily prepared, for example, according to the process described in the literature such as J. Org. Chem. 59, 4042-4044 (1994), J. Org. Chem. 52, 713-719 (1987), Chem. Rev. 90, 879-933 (1990), etc., by reacting a per se known compound represented by the formula 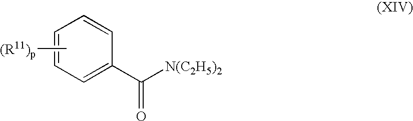
wherein R¹¹ and p have the same definition as aforementioned,
with N,N-dimethylformamide in the presence of sec-butyl lithium.

Furthermore, the compounds of the aforementioned formula (X) can be easily prepared by deprotecting a compound represented by the formula 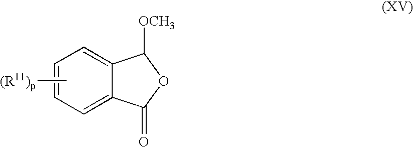
wherein R¹¹ and p have the same definition as aforementioned,
under acid condition, for example, under the acid condition with hydrochloric acid.

The compounds of the above-mentioned formula (XV), a part of which are novel compounds not described in the existing literature, can be easily prepared, for example, according to the process described in the literature such as J. Amer. Chem. Soc. 1767-1769 (1949), by reacting a per se known compound represented by the formula 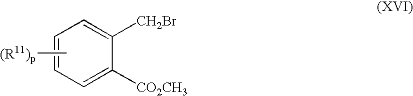
wherein R¹¹ and p have the same definition as aforementioned,
with 2-nitropropane in the presence of sodium methoxide.

As specific examples of the compounds of the formula (IX), used as starting materials in the preparation of the compounds of the aforementioned formula (II), there can be mentioned as follows:

4-chloro-3-[2-methyl-4-(1,2,2,2-tetrafluoro-1-trifluoromethylethyl)phenylamino]-3H-isobenzofuran-1-one,

7-chloro-3-[2-methyl-4-(1,2,2,2-tetrafluoro-1-trifluoromethylethyl)phenylamino]-3H-isobenzofuran-1-one,

4-iodo-3-[2-methyl-4-(1,2,2,2-tetrafluoro-1-trifluoromethylethyl)phenylamino]-3H-isobenzofuran-1-one,

3-[2-methyl-4-(1,2,2,2-tetrafluoro-1-trifluoromethylethyl)phenylamino]-4-nitro-3H-isobenzofuran-1-one, etc.

As specific examples of the compounds of the formula (X), used as starting materials in the preparation of the compounds of the aforementioned formula (IX), there can be mentioned as follows:

4-chloro-3-hydroxy-3H-isobenzofuran-1-one,

7-chloro-3-hydroxy-3H-isobenzofuran-1-one,

3-hydroxy-4-iodo-3H-isobenzofuran-1-one,

3-hydroxy-4-nitro-3H-isobenzofuran-1-one, etc.

The compounds of the formula (XI), used as starting materials in the preparation of the compounds of the aforementioned formula (IX) are the compounds included in the aforementioned formula (III) and as their specific examples there can be mentioned as follows:

2-methyl-4-(1,2,2,2-tetrafluoro-1-trifluoromethylethyl)phenylamine,

2,3,4-trichlorophenylamine,

2-methyl-4-trifluoromethylphenylamine, etc.

As specific examples of the compounds of the formula (XII), used as starting materials in the preparation of the compounds of the aforementioned formula (X), there can be mentioned as follows:

2-chlorobenzoic acid,

3-chlorobenzoic acid,

2-fluorobenzoic acid,

3-fluorobenzoic acid,

2-trifluoromethylbenzoic acid,

3-trifluoromethylbenzoic acid,

2-trifluoromethoxybenzoic acid,

3-trifluoromethoxybenzoic acid, etc.

As specific examples of the compounds of the formula (XIII), used as starting materials in the preparation of the compounds of the aforementioned formula (X), there can be mentioned as follows:

2-(3-chloro-phenyl)-[1,3]dioxane etc.

As specific examples of the compounds of the formula (XIV), used as starting materials in the preparation of the compounds of the aforementioned formula (X), there can be mentioned as follows:

2-chloro-N,N-diethylbenzamide etc.

As specific examples of the compounds of the formula (XV), used as starting materials in the preparation of the compounds of the aforementioned formula (X), there can be mentioned as follows:

3-methoxy-4-nitro-3H-isobenzofuran-1-one,

4-iodo-3-methoxy-3H-isobenzofuran-1-one, etc.

The compounds of the formula (IAb), used in the aforementioned preparation process (B) are the compounds included in the aforementioned formula (IA) and as their specific examples there can be mentioned as follows:

7-chloro-2-(1-methyl-2-methylthioethyl)-3-[2-methyl-4-(1,2,2,2-tetrafluoro-1-trifluoromethyl)-phenylamino]-2,3-dihydroisoindol-1-one,

7-chloro-2-(1,1-dimethyl-2-methylthioethyl)-3-[2-methyl-4-(1,2,2,2-tetrafluoro-1-trifluoromethyl-ethyl)phenylamino]-2,3-dihydroisoindol-1-one,

4-chloro-3-1-methyl-2-methylthioethylamino)-2-[2-methyl-4-(1,2,2,2-tetrafluoro-1-trifluoromethyl-ethyl)phenyl]-2,3-dihydroisoindol-1-one,

4-chloro-3-(1,1-dimethyl-2-methylthioethylamino)-2-[2-methyl-4-(1,2,2,2-tetrafluoro-1-trifluormethylethyl)phenyl]-2,3-dihydroisoindol-1-one,

3-(1,1-dimethyl-2-methylthioethylamino)-4-iodo-2-[2-methyl-4-(1,2,2,2-tetrafluoro-1-trifluoromethylethyl)phenyl]-2,3-dihydroisoindol-1-one,

3-(1,1-dimethyl-2-methylthioethylamino)-7-iodo-2-[2-methyl-4-(1,2,2,2-tetrafluoro-1-trifluoromethylethyl)phenyl]-2,3-dihydroisoindol-1-one, etc.

The compounds of the formula (IAc), used in the aforementioned preparation process (C) are the compounds included in the aforementioned formula (IA) and as their specific examples there can be mentioned as follows:

7-chloro-2-isopropyl-3-[2-methyl-4-(1,2,2,2-tetrafluoro-1-trifluoromethylethyl)phenylamino]-2,3-dihydroisoindol-1-one,

7-chloro-2-(1-methyl-2-methylthioethyl)-3-[2-methyl-4-(1,2,2,2-tetrafluoro-1-trifluoromethylethyl)-phenylamino]-2,3-dihydroisoindol-1-one,

7-chloro-2-(1,1-dimethyl-2-methylthioethyl)-3-[2-methyl-4-(1,2,2,2-tetrafluoro-1-trifluoromethyl-ethyl)phenylamino]-2,3-dihydroisoindol-1-one,

4-chloro-3-isopropylamino-2-[2-methyl-4-(1,2,2,2-tetrafluoro-1-trifluoromethylethyl)phenyl]-2,3-dihydroisoindol-1-one,

4-chloro-3-(1-methyl-2-methylthioethylamino)-2-[2-methyl-4-(1,2,2,2-tetrafluoro-1-trifluoromethyl-ethyl)phenyl]-2,3-dihydroisoindol-1-one,

4-chloro-3-(1,1-dimethyl-2-methylthioethylamino)-2-[2-methyl-4-(1,2,2,2-tetrafluoro-1-trifluoromethylethyl)phenyl]-2,3-dihydroisoindol-1-one,

3-(1,1-dimethyl-2-methylthioethylamino)-4-iodo-2-[2-methyl-4-(1,2,2,2-tetrafluoro-1-trifluoromethylethyl)phenyl]-2,3-dihydroisoindol-1-one,

3-(1,1-dimethyl-2-methylthioethylamino)-7-iodo-2-[2-methyl-4-(1,2,2,2-tetrafluoro-1-trifluoromethylethyl)phenyl]-2,3-dihydroisoindol-1-one, etc.

The compounds of the formula (IAd), used in the aforementioned preparation process (D) are the compounds included in the aforementioned formula (IA) and as their specific examples there can be mentioned as follows:

7-chloro-2-isopropyl-3-[2-methyl-4-(1,2,2,2-tetrafluoro-1-trifluoromethylethyl)phenylamino]-2,3-dihydroisoindol-1-one,

7-chloro-2-(1-methyl-2-methylthioethyl)-3-[2-methyl-4-(1,2,2,2-tetrafluoro-1-trifluoromethylethyl)-phenylamino]-2,3-dihydroisoindol-1-one,

7-chloro-2-(1,1-dimethyl-2-methylthioetyl)-3-[2-methyl-4-(1,2,2,2-tetrafluoro-1-trifluoromethyl-ethyl)phenylamino]-2,3-dihydroisoindol-1-one,

⁴-chloro-3-isopropylamino-2-[2-methyl-4-(1,2,2,2-tetrafluoro-1-trifluoromethylethyl)phenyl]-2,3-dihydroisoindol-1-one,

4-chloro-3-(1-methyl-2-methylthioethylamino)-2-[2-methyl-4-(1,2,2,2-tetrafluoro-1-trifluoromethyl-ethyl)phenyl]-2,3-dihydroisoindol-1-one,

4-chloro-3-(1,1-dimethyl-2-methylthioethylamino)-2-[2-methyl-4-(1,2,2,2-tetrafluoro-1-trifluoromethylethyl)phenyl]-2,3-dihydroisoindol-1-one,

3-(1,1-dimethyl-2-methylthioethylamino)-4-iodo-2-[2-methyl-4-(1,2,2,2-tetrafluoro-1-trifluoromethylethyl)phenyl]-2,3-dihydroisoindol-1-one,

3-(1,1-dimethyl-2-methylthioethylamino)-7-iodo-2-[2-methyl-4-(1,2,2,2-tetrafluoro-1-trifluoromethylethyl)phenyl)-2,3-dihydroisoindol-1-one, etc.

The reaction of the above-mentioned preparation process (A) can be conducted in an adequate diluent. As examples of the diluent used in that case there can be mentioned aliphatic, alicyclic and aromatic hydrocarbons (may be optionally chlorinated), for example, pentane, hexane, cyclohexane, petroleum ether, ligroine, benzene, toluene, xylene, dichloromethane, chloroform, carbon tetrachloride, 1,2-dichloroethane, chlorobenzene, dichlorobenzene, etc.; ethers, for example, ethyl ether, methyl ethyl ether, isopropyl ether, butyl ether, dioxane, dimethoxyethane (DME), tetrahydrofuran (THE), diethylene glycol dimethyl ether (DGM), etc.; ketones, for example, acetone, methyl ethyl ketone (MEK), methyl isopropyl ketone, methyl isobutyl ketone (MIBK), etc.; nitriles, for example, acetonitrile, propionitrile, acrylonitrile, etc.; esters, for example, ethyl acetate, amyl acetate, etc.; acid amides, for example, dimethylformamide (DMF), dimethylacetamide (DMA), N-methylpyrrolidone, 1,3-dimethyl-2-imidazolidinone, hexamethyl phosphoric triamide (HMPA), etc.; sulfones, sulfoxides, for example, dimethyl sulfoxide (DMSO), sulfolane, etc.; bases, for example, pyridine etc.

The preparation process (A) can be conducted in the presence of an acid binder and as usable acid binder there can be mentioned, as inorganic base, hydrides, hydroxides, carbonates, bicarbonates, etc. of alkali metals and alkaline earth metals, for example, sodium hydride, lithium hydride, sodium hydrogen carbonate, potassium hydrogen carbonate, sodium carbonate, potassium carbonate, lithium hydroxide, sodium hydroxide, potassium hydroxide, calcium hydroxide, etc.; inorganic alkali metal amides, for example, lithium amide, sodium amide, potassium amide, etc.; as organic base, alcoholates, tertiary amines, dialkylaminoanilines and pyridines, for example, triethylamine, 1,1,4,4-tetramethylethylenediamine (TMEDA), N,N-dimethylaniline, N,N-diethylaniline, pyridine, 4-dimethylaminopyridine (DMAP), 1,4diazabicyclo[2.2.2]octane (DABCO) and 1,8-diazabicyclo[5.4.0]-undec-7-ene (DBU), etc.; organolithium compounds, for example, methyl lithium, n-butyl lithium, sec-butyl lithium, tert-butyl lithium, phenyl lithium, dimethyl copper lithium, lithium diisopropyl amide, lithium cyclohexyl isopropyl amide, lithium dicyclohexyl amide, n-butyl lithium.DABCO, n-butyl lithium.DBU, n-butyl lithiumTMEDA, etc.

The preparation process (A) can be conducted in a substantially wide range of temperature. Generally it is preferably conducted at the temperatures in a range of about 10-about 80° C., particularly at room temperature. Although said reaction is conducted desirably under normal pressure, it can be operated also under elevated pressure or under reduced pressure.

In conducting the preparation process (A), the objective compound can be obtained, for example, by reacting 1-2 mole amount of a compound of the formula (III) to 1 mole of a compound of the formula (II) in a diluent, for example, THF, in the presence of triethylamine.

In conducting the preparation process (A), a compound of the formula (I) can be obtained starting from a compound of the formula (V) and continuously conducting reactions without isolating a compound of the formula (II), and a compound of the formula (IA) can also be obtained starting from a compound of the formula (IX) and continuously conducting reactions without isolating a compound of the formula (II).

The reaction of the above-mentioned preparation process (B) can be conducted in an adequate diluent. As examples of the diluent used in that case there can be mentioned water; aliphatic, alicyclic and aromatic hydrocarbons (may be optionally chlorinated), for example, pentane, hexane, cyclohexane, petroleum ether, ligroine, benzene, toluene, xylene, dichloromethane, chloroform, carbon tetrachloride, 1,2-dichloroethane, chlorobenzene, dichlorobenzene, etc.; ethers, for example, ethyl ether, methyl ethyl ether, isopropyl ether, butyl ether, dioxane, dimethoxyethane (DME), tetrahydrofuran (THF), diethylene glycol dimethyl ether (DGM), etc.; ketones, for example, acetone, methyl ethyl ketone (MEK), methyl isopropyl ketone, methyl isobutyl ketone (MIBK), etc.; nitrites, for example, acetonitrile, propionitrile, acrylonitrile, etc.; alcohols, for example, methanol, ethanol, isopropanol, butanol, ethylene glycol, etc.; esters, for example, ethyl acetate, amyl acetate, etc.; acid amides, for example, dimethylformamide (DMF), dimethylacetamide (DMA), N-methylpyrrolidone, 1,3-dimethyl-2-imidazolidinone, hexamethyl phosphoric triamide (HMPA), etc.; sulfones, sulfoxides, for example, dimethyl sulfoxide (DMSO), sulfolane, etc.; bases, for example, pyridine etc.; organic acids, for example, formic acid, acetic acid, etc.

The preparation process (3) can be conducted in a substantially wide range of temperature. Generally it is preferably conducted at the temperatures in a range of about 0-about 100° C., particularly about 10-about 50° C. Although said reaction is conducted desirably under normal pressure, it can be operated also under elevated pressure or under reduced pressure.

In conducting the preparation process (B), a compound of the formula (IA) can be obtained, for example, by reacting 1-2.5 mole amount of a peroxy acid, for example, 3-chloroperbenzoic acid, to 1 mole of a compound of the formula (IAb) in a diluent, for example, dichloromethane.

The reaction of the above-mentioned preparation process (C) can be conducted in an adequate diluent As examples of the diluent used in that case there can be mentioned ethers, for example, ethyl ether, methyl ethyl ether, isopropyl ether, butyl ether, dioxane, dimethoxyethane (DME), tetrahydrofuran (THF), diethylene glycol dimethyl ether (DGM), etc.; ketones, for example, acetone, methyl ethyl ketone (MEK), methyl isopropyl ketone, methyl isobutyl ketone (MIBK), etc.; nitriles, for example, acetonitrile, propionitrile, acrylonitrile, etc.; esters, for example, ethyl acetate, amyl acetate, etc.; acid amides, for example, dimethylformamide (DMF), dimethylacetamide (DMA), N-methylpyrrolidone, 1,3-dimethyl-2-imidazolidinone, hexamethyl phosphoric triamide (HMPA), etc.; sulfones, sulfoxides, for example, dimethyl sulfoxide (DMSO), sulfolane, etc.; bases, for example, pyridine etc.

The preparation process (C) can be conducted in the presence of an organic base and as organic base usable in that case there can be mentioned tertiary amines, dialkylaminoanilines and pyridines, for example, triethylamine, 1,1,4,4-tetramethylethylenediamine (TMEDA), N,N-dimethylaniline, N,N-diethylaniline, pyridine, 4-dimethylaminopyridine (DMAP), 1,4-diazabicyclo[2.2.2]octane (DABCO), 1,8-diazabicyclo[5.4.0]undec-7-ene (DBU), etc.

The preparation process (C) can be conducted in a substantially wide range of temperature. Generally it is preferably conducted at the temperatures in a range of about 0-about 150° C., particularly about 50-about 80° C. Although said reaction is conducted desirably under normal pressure, it can be operated also under elevated pressure or under reduced pressure.

In conducting the preparation process (C), a compound of the formula (IA) can be obtained, for example, by reacting 1-10 mole amount of a cyanide, for example, potassium cyanide, to 1 mole of a compound of the formula (IAc) in a diluent, for example, DMF.

The reaction of the above-mentioned preparation process (D) can be conducted in an adequate diluent. As examples of the diluent used in that case there can be mentioned aliphatic, alicyclic and aromatic hydrocarbons (may be optionally chlorinated), for example, pentane, hexane, cyclohexane, petroleum ether, ligroine, benzene, toluene, xylene, dichloromethane, chloroform, carbon tetrachloride, 1,2-dichloroethane, chlorobenzene, dichlorobenzene, etc.; ethers, for example, ethyl ether, methyl ethyl ether, isopropyl ether, butyl ether, dioxane, dimethoxyethane (DME), tetrahydrofuran (THF), diethylene glycol dimethyl ether (DGM), etc.; ketones, for example, acetone, methyl ethyl ketone (MEK), methyl isopropyl ketone, methyl isobutyl ketone (MIBK), etc.; nitriles, for example, acetonitrile, propionitrile, acrylonitrile, etc.; esters, for example, ethyl acetate, amyl acetate, etc.; acid amides, for example, dimethylformamide (DMF), dimethylacetamide (DMA), N-methylpyrrolidone, 1,3-dimethyl-2-imidazolidinone, hexamethyl phosphoric triamide (HMPA), etc.; sulfones, sulfoxides, for example, dimethyl sulfoxide (DMSO), sulfolane, etc.; bases, for example, pyridine etc.

The preparation process (D) can be conducted in a substantially wide range of temperature. Generally it is preferably conducted at the temperatures in a range of about 0-about 150° C., particularly about 20-about 70° C. Although said reaction is conducted desirably under normal pressure, it can be operated also under elevated pressure or under reduced pressure.

In conducting the preparation process (D), a compound of the formula (IA) can be obtained, for example, by reacting 2-10 mole amount of an oxidizing agent, for example, potassium permanganate, to 1 mole of a compound of the formula (IAd) in a diluent, for example, acetone.

The active compounds are suitable for protecting plants and plant organs, for increasing the harvest yields, for improving the quality of the harvested material and for controlling animal pests, in particular insects, arachnids and nematodes, which are encountered in agriculture, in forests, in gardens and leisure facilities, in the protection of stored products and of materials, and in the hygiene sector, and have good plant tolerance and favourable toxicity to warm-blooded animals and are tolerated well by the environment. They may be preferably employed as plant protection agents. They are active against normally sensitive and resistance species and against all or some stages of development.

The effective component compounds of the formula (I), according to the present invention, show strong insecticidal action. They can, therefore, be used as insecticidal agents. And the effective component compounds of the formula (I), according to the present invention, exhibit exact controlling effect against harmful insects parasitic on cultured plants without phytotoxicity against cultured plants. The effective component compounds of the formula (I), according to the present invention, can be used for controlling a wide variety of pests, for example, harmful sucking insects, biting insects and other plant-parasitic pests, stored grain pests, hygienic pests, etc. and applied for their extermination.

As examples of such pests there can be mentioned the following pests:

As insects, there can be mentioned coleoptera pests, for example, Callosobruchus Chinensis, Sitophilus zeamais, Tribolium castaneum, Epilachna vigintioctomaculata, Agriotes fuscicollis, Anoiala rufocuprea, Leptinotarsa decemlineata, Diabrotica spp., Manochamus altematus, Lissorhoptrus oryzophilus, Lyctus bruneus;

Lepidoptera pests, for example, Lymantria dispar, Malacosoma neustria, Pieris rapae, Spodoptera litura, Mamestra brassicae, Chilo suppressalis, Pyrausta nubilalis, Ephestia cautella, Adoxophyes orana, Carpocapsa pomonella, Agrotis fucosa, Galleria mellonella, Plutella maculipennis, Heliothis virescens, Phyllocnistis citrella;

Hemiptera pests, for example, Nephotettix cincticeps, Nilaparvata lugens, Pseudococcus comstocki, Unaspis yanonensis, Myzus persicae, Aphis pomi, Aphis gossypii, Rhopalosiphum pseudobrassicas, Stephanitis nashi, Nazara spp., Cimex lectularius, Trialeurodes vaporariorum, Psylla spp.;

Orthoptera pests, for example, Blatella germanica, Periplaneta americana, Gryllotalpa africana, Locusta migratoria migratoriodes;

Hoinoptera pests, for example, Reticulitermes speratus, Coptotermes fornosanus;

Diptera pests, for example, Musca domestica, Aedes aegypti, Hylemia platura, Culex pipiens, Anopheles slnensis, Culex tritaeniorhynchus, etc.

Moreover, as mites there can be mentioned, for example, Tetranychus telarius, Tetranychus urticae, Panonychus citri, Aculops pelekassi, Tarsonemus spp. etc.

Furthermore, as nematodes there can be mentioned; for example, Meloidogyne incognita, Bursaphelenchus lignicolus Mamiya et Kiyohara, Aphelenchoides basseyi, Heterodera glycines, Pratylenchus spp. etc.

In addition, in the field of veterinary medicine, the effective component compounds of the formula (I), according to the present invention, can be effectively used against various harmful animal-parasitic pests (endoparasites and ectoparasites), for example, insects and helminthes. As examples of such animal-parasitic pests there can be mentioned the following pests:

As insects there can be mentioned, for example, Gastrophilus spp., Stomoxys spp., Trichodectes spp., Rhodnius spp., Ctenocephalides canis, etc.

As mites there can be mentioned, for example, Ornithodorosspp., Ixodes spp., Boophilus spp., etc.

In the present invention substances having insecticidal action against pests, which include all of them, are in some cases called as insecticides.

All plants and plant parts can be treated in accordance with the invention. Plants are to be understood as meaning in the present context all plants and plant populations such as desired and undesired wild plants or crop plants (including naturally occurring crop plants). Crop plants can be plants which can be obtained by conventional plant breeding and optimization methods or by biotechnological and genetic engineering methods or by combinations of these methods, including the transgenic plants and including the plant cultivars protectable or not protectable by plant breeders' rights. Plant parts are to be understood as meaning all parts and organs of plants above and below the ground, such as shoot, leaf, flower and root, examples which may be mentioned being leaves, needles, stalks, stems, flowers, fruit bodies, fruits, seeds, roots, tubers and rhizomes. The plant parts also include harvested material, and vegetative and generative propagation material, for example cuttings, tubers, rhizomes, offshoots and seeds.

Treatment according to the invention of the plants and plant parts with the active compounds is carried out directly or by allowing the compounds to act on the surroundings, environment or storage space by the customary treatment methods, for example by immersion, spraying, evaporation, fogging, scattering, painting on, injection and, in the case of propagation material, in particular in the case of seeds, also by applying one or more coats.

The effective component compounds of the formula (I), according to the present invention, can be converted into the customary formulation forms, when they are used as insecticides. As formulation forms there can be mentioned, for example, solutions, emulsions, wettable powders, water dispersible granules, suspensions, powders, foams, pastes, tablets, granules, aerosols, natural and synthetic materials impregnated with active compound, microcapsules, seed coating agents, formulations used with burning equipment (as burning equipment, for example, fumigation and smoking cartridges, cans, coils, etc.), ULV [cold mist, warm mist], etc.

These formulations can be produced according to per se known methods, for example, by mixing the effective component compounds with extenders, namely liquid diluents; liquefied gas diluents; solid diluents or carriers, and optionally with surface-active agents, namely emulsifiers and/or dispersants and/or foam-forming agents.

In case that water is used as extender, for example, organic solvents can also be used as auxiliary solvents.

As liquid diluents or carriers there can be mentioned, for example, aromatic hydrocarbons (for example, xylene, toluene, alkylnaphthalene etc.), chlorinated aromatic or chlorinated aliphatic hydrocarbons (for example, chlorobenzenes, ethylene chlorides, methylene chloride, etc.), aliphatic hydrocarbons [for example, cyclohexane etc. or paraffins (for example, mineral oil fractions etc.)], alcohols (for example, butanol, glycols and their ethers, esters, etc.), ketones (for example, acetone, methyl ethyl ketone, methyl isobutyl ketone, cyclohexanone, etc.), strongly polar solvents (for example, dimethylformamide, dimethyl sulfoxide, etc.), and water.

Liquefied gas diluents or carriers are substances that are gases at normal temperature and pressure and there can be mentioned, for example, aerosol propellants such as butane, propane, nitrogen gas, carbon dioxide, halogenated hydrocarbons.

As solid diluents there can be mentioned, for example, ground natural minerals (for example, kaolin, clay, talc, chalk, quartz, attapulgite, montmorillonite, diatomaceous earth, etc.), ground synthetic minerals (for example, highly dispersed silicic acid, alumina, silicates, etc.).

As solid carriers for granules there can be mentioned, for example, crushed and fractionated rocks (for example, calcite, marble, pumice, sepiolite, dolomite, etc.) synthetic granules of inorganic and organic meals, particles of organic materials (for example, saw dust, coconut shells, maize cobs, tobacco stalks, etc.) etc.

As emulsifiers and/or foam-forming agents there can be mentioned, for example, nonionic and anionic emulsifiers [for example, polyoxyethylene fatty acid esters, polyoxyethylene fatty acid alcohol ethers (for example, alkylaryl polyglycol ethers, alkylsulfonates, alkylsulfates, arylsulfonates, etc.)], albumin hydrolysis products etc.

Dispersants include, for example, lignin sulfite waste liquor, methyl cellulose, etc.

Tackifiers can also be used in formulations (powders, granules, emulsifiable concentrates). As said tackifiers there can be mentioned, for example, carboxymethyl cellulose, natural and synthetic polymers (for example, gum Arabic, polyvinyl alcohol, polyvinyl acetate, etc.).

Colorants can also be used. As said colorants there can be mentioned, for example, inorganic pigments (for example, iron oxide, titanium oxide, Prussian Blue, etc,), organic dyestuffs such as alizarin dyestuffs, azo dyestuffs or metal phthalocyanine dyestuffs, and further trace nutrients such as salts of iron, manganese, boron, copper, cobalt, molybdenum and zinc.

Said formulations can contain the aforementioned effective component compounds of the amount in the range of generally 0.1 to 95% by weight, preferably 0.5 to 90% by weight.

The effective component compounds of the formula (I), according to the present invention, can exist also as a mixed agent with other active compounds, for example, insecticides, poisonous baits, bactericides, miticides, nematicides, fungicides, growth regulators or herbicides in the form of their commercially useful formulations and in the application forms prepared from such formulations. Here, as the above-mentioned insecticides, there can be mentioned, for example, organophosphorous agents, carbamate agents, carboxylate type chemicals, chlorinated hydrocarbon type chemicals, insecticidal substances produced by microorganisms, etc.

Further, the effective component compounds of the formula (I), according to the present invention, can exist also as a mixed agent with a synergist and such formulations and application forms can be mentioned as commercially useful. Said synergist itself must not be active, but is a compound that enhances the action of the active compound.

The content of the effective component compounds of the formula (I), according to the present invention, in a commercially useful application form can be varied in a wide range.

The concentration of the effective component compounds of the formula (I), according to the present invention, at the time of application can be, for example, in the range of 0.0000001 to 100% by weight, preferably 0.00001 to 1% by weight.

The effective component compounds of the formula (I), according to the present invention, can be applied by usual methods suitable to the application forms.

In case of application against hygiene pests and pests of stored products the effective component compounds of the present invention have a good stability to alkali on limed substrates and further show an excellent residual effectiveness on wood and soil.

As already mentioned above, it is possible to treat all plants and their parts according to the invention. In a preferred embodiment, wild plant species and plant cultivars, or those obtained by conventional biological breeding methods, such as crossing or protoplast fusion, and parts thereof, are treated. In a further preferred embodiment, transgenic plants and plant cultivars obtained by genetic engineering, if appropriate in combination with conventional methods (Genetically Modified Organisms), and parts thereof are treated. The term “parts” or “parts of plants” or “plant parts” has been explained above.

Particularly preferably, plants of the plant cultivars which are in each case commercially available or in use are treated according to the invention. Plant cultivars are to be understood as meaning plants having novel properties (“traits”) which have been obtained by conventional breeding, by mutagenesis or by recombinant DNA techniques. These can be cultivars, bio- or genotypes.

Depending on the plant species or plant cultivars, their location and growth conditions (soils, climate, vegetation period, diet), the treatment according to the invention may also result in superadditive (“synergistic”) effects. Thus, for example, reduced application rates and/or a widening of the activity spectrum and/or an increase in the activity of the substances and compositions to be used according to the invention, better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products are possible which exceed the effects which were actually to be expected.

The transgenic plants or plant cultivars (i.e. those obtained by genetic engineering) which are preferably to be treated according to the invention include all plants which, in the genetic modification, received genetic material which imparted particularly advantageous, useful traits to these plants. Examples of such traits are better plant growth, increased tolerance to high or low temperatures, increased tolerance to drought or to water or soil salt content, increased flowering performance, easier harvesting, accelerated maturation, higher harvest yields, better quality and/or a higher nutritional value of the harvested products, better storage stability and/or processability of the harvested products. Further and particularly emphasized examples of such traits are a better defence of the plants against animal and microbial pests, such as against insects, mites, phytopathogenic fungi, bacteria and/or viruses, and also increased tolerance of the plants to certain herbicidally active compounds. Examples of transgenic plants which may be mentioned are the important crop plants, such as cereals (wheat, rice), maize, soya beans, potatoes, cotton, tobacco, oilseed rape and also fruit plants (with the fruits apples, pears, citrus fruits and grapes), and particular emphasis is given to maize, soya beans, potatoes, cotton, tobacco and oilseed rape. Traits that are emphasized are in particular increased defence of the plants against insects, arachnids, nematodes and worms by toxins formed in the plants, in particular those formed in the plants by the genetic material from Bacillus thuringiensis (for example by the genes CryIA(a), CryIA(b), CryIA(c), CryIIA, CryIIIA, CryIIIB2, Cry9c, Cry2Ab, Cry3Bb and CryIF and also combinations thereof) (hereinbelow referred to as “Bt plants”). Traits that are also particularly emphasized are the increased defence of the plants against fungi, bacteria and viruses by systemic acquired resistance (SAR), systemin, phytoalexins, elicitors and resistance genes and correspondingly expressed proteins and toxins. Traits that are furthermore particularly emphasized are the increased tolerance of the plants to certain herbicidally active compounds, for example imidazolinones, sulphonylureas, glyphosate or phosphinotricin (for example the “PAT” gene). The genes which impart the desired traits in question can also be present in combination with one another in the transgenic plants. Examples of “Bt plants” which may be mentioned are maize varieties, cotton varieties, soya bean varieties and potato varieties which are sold under the trade names YIELD GARD® (for example maize, cotton, soya beans), KnockOut® (for example maize), StarLink® (for example maize), Boilgard® (cotton), Nucotn® (cotton) and NewLeaf® (potato). Examples of herbicide-tolerant plants which may be mentioned are maize varieties, cotton varieties and soya bean varieties which are sold under the trade names Roundup Ready® (tolerance to glyphosate, for example maize, cotton, soya bean), Liberty Link® (tolerance to phosphinotricin, for example oilseed rape), IMI® (tolerance to imidazolinones) and STS® (tolerance to sulphonylureas, for example maize). Herbicide-resistant plants (plants bred in a conventional manner for herbicide tolerance) which may be mentioned include the varieties sold under the name Clearfield® (for example maize). Of course, these statements also apply to plant cultivars having these genetic traits or genetic traits still to be developed, which plants will be developed and/or marketed in the future.

Then the present invention will be described more specifically by examples. The present invention, however, should not be restricted only to them in any way.

### SYNTHESIS EXAMPLE 1

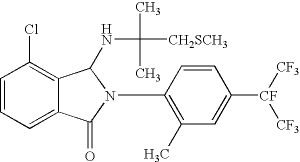

3,4-Dichloro-2-[2-methyl-4-(1,2,2,2-tetrafluoro-1-trifluoromethylethyl)phenyl]-2,3diydroisoindol-1-one (4.0 g) and 1,1-dimethyl-2-methythioethyl-amine (1.5 g) were stirred in tetrahydrofuran in the presence of triethylamine (1.8 g) at room temperature for 20 hours. After finishing the reaction, the solvent was distilled off and the obtained residue was dissolved in ethyl acetate, washed with water and saturated aqueous solution of sodium chloride, and dried with sodium sulfate. After distilling off the solvent, the obtained residue was purified by silica gel column chromatography (eluted with hexane, ethyl acetate) to obtain 4-chloro-3-(1,1-dimethyl-2-methythioethylamino)-2-[2-methyl4-(1,2,2,2-tetrafluoro-1-trifluoromethylethyl)phenyl]-2,3-dihydroisoindol-1-one (2.92 g, mp. 54-59° C.)

### SYNTHESIS EXAMPLE 2

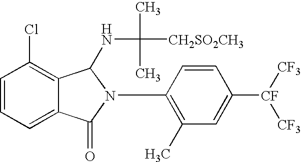

4-Chloro-3-(1,1-dimethyl-2-methythioethylamino)-2-[2-methyl-4-(1,2,2,2-tetrafluoro-1-trifluoromethylethyl)phenyl]-2,3-dihydroisoindol-1-one (510 mg) in dichloromethane was stirred with 3-chloroperbenzoic acid (405 mg) at room temperature for 5 hours. After finishing the reaction, the reaction mixture was treated with saturated aqueous solution of sodium thiosulfate and saturated aqueous solution of sodium hydrogen carbonate. The separated organic layer was washed with saturated aqueous solution of sodium chloride, dried with sodium sulfate and the solvent was distilled off. The obtained residue was purified by silica gel column chromatography (eluted with hexane, ethyl acetate) to obtain 4-chloro-3-(2-methanesulfonyl-1,1-dimethylethylamino)-2-[2-methyl-4-(1,2,2,2-tetrafluoro-1-trifluoromethylethyl)phenyl]-2,3-dihydroisoindol-1-one (410 mg, mp. 154-156° C.).

### SYNTHESIS EXAMPLE 3

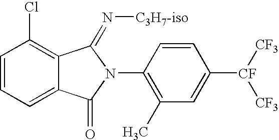

4-Chloro-3-isopropylamino-2-[2-methyl-4-(1,2,2,2-tetrafluoro-1-trifluoromethylethyl)phenyl]-2,3-di-hydroisoindol-1-one (0.3 g) and potassium cyanide (0.5 g) were stirred in N,N-dimethylformamide at 120° C. for 5 hours. After finishing the reaction, the reaction mixture was cooled, dissolved in ethyl acetate and washed consecutively with water and saturated aqueous solution of sodium chloride. The solvent was distilled off under reduced pressure and the obtained residue was purified by silica gel column chromatography (eluted with hexane: ethyl acetate=5:1) to obtain 4-chloro-3-isopropyl-imino-2-[2-methyl-4-(1,2,2,2-tetrafluoro-1-trifluoromethylethyl)phenyl]-2,3-dihydroisoindol-1-one (410 mg).

¹H-NMR (CDCl₃, 400 MHz): δ=0.94 (3H, d, J=6.1 Hz), 1.01 (3H, d, J=6.1 Hz), 2.32 (3H, s), 3.30-3.40 (1H, m), 7.41 (1H, d, J=8.3 Hz), 7.54 (1H, dd, J=8.0, 7.4 Hz), 7.56 (1H, br, d, J=8.3 Hz), 7.60 (1H, br s), 7.69 (1H, dd, J=8.0, 0.9 Hz), 7.83 (1H, dd, J=7.4, 0.9 Hz) ppm.

### SYNTHESIS EXAMPLE 4

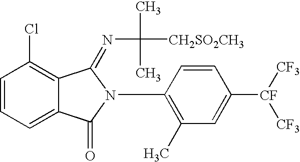

4-Chloro-3-(1,1-dimethyl-2-methythioethylamino)-2-[2-methyl-4-(1,2,2,2-tetrafluoro-1-trifluoromethylethyl)phenyl]-2,3-dihydroisoindol-1-one (1.5 g) was refluxed for 1 hour in acetone in the presence of potassium permanganate (6.7 g). After finishing the reaction, the solvent was distilled off under reduced pressure and the obtained residue was purified by silica gel column chromatography (eluted with hexane, ethyl acetate) to obtain 4-chloro-3-(2-methanesufonyl-1,1-dimethylethylimino)-2-[2-methyl-4-(1,2,2,2-tetrafluoro-1-trifluoromethylethyl)phenyl]-2,3-dihydroisoindol-1-one (660 mg, mp. 141-142° C.).

### SYNTHESIS EXAMPLE 5

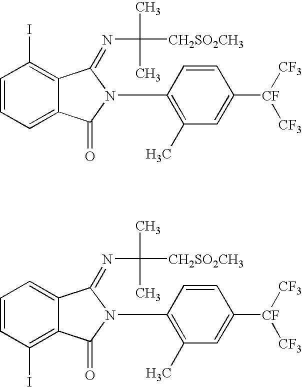

A mixture of 3-(1,1-dimethyl-2-methythioethylamino)-4-iodo-2-[2-methyl-4-(1,2,2,2-tetrafluoro-1-trifluoromethylethyl)phenyl]-2,3-dihydro-isoindol-1-one and 3-(1,1-dimethyl-2-methythioethylamino)-7-iodo-2-[2-methyl-4-(1,2,2,2-1-tetrafluoro-1-trifluoromethylethyl)phenyl]-2,3-dihydro-isoindol-1-one at about 1 to 1 (0.9 g) was refluxed for 5 hours in acetone in the presence of potassium permanganate (2.24 g). After finishing the reaction, the solvent was distilled off under reduced pressure and the obtained residue was purified by silica gel column chromatography (eluted with hexane, ethyl acetate) to obtain 4-iodo-3-(2-methanesufonyl-1,1-dimethylethylimino)-2-[2-methyl-4-(1,2,2,2-tetrafluoro-1-trifluoromethylethyl)phenyl]-2,3-dihydroisoindol-1-one (0.1 g, mp. 102-109° C., ¹H-NMR(1)) and 7-iodo-3-(2-methanesufonyl-1,1-dimethylethylimino)-2-[2-methyl-(1,2,2,2-tetrafluoro-1-trifluoromethylethyl)phenyl]-2,3-dihydroisoindol-1-one (0.4 g, ¹H-NMR(2)).

¹H-NMR(1) (CDCl₃, 400 MHz): δ=1.06 (3H, s), 1.22 (3H, s), 2.31 (3H, s), 2.91 (3H, s), 3.52 (1H, d, J=4.0 Hz), 3.66 (1H, d, J=4.0 Hz), 7.33 (1H, dd, J=7.5, 7.5 Hz), 7.39 (1H, d, J=8.2 Hz), 7.60 (1H, br d, J=8.2 Hz), 7.62 (1H, br s), 7.92 (1H, dd, J=7.5, 0.9 Hz), 8.25(1H, dd, J=7.5, 0.9 Hz) ppm.

¹H-NMR(2) (DMSO-d6, 400 MHz): δ=1.66 (3H, s), 1.67 (3H, s), 2.00 (3H, s), 2.22 (3H, s), 3.35 (2H, br s), 7.61-7.65 (3H, m), 7.70 (1H, br s), 8.28 (1H, d, J=7.9 Hz), 8.33 (1H, dd, J=7.9 Hz) ppm.

### SYNTHESIS EXAMPLE 6

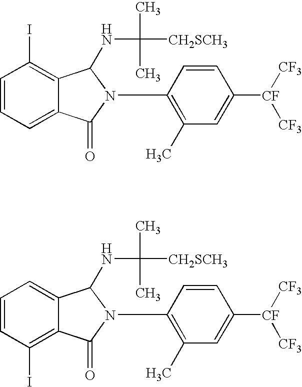

A mixture of 3-chloro-4-iodo-2-[2-methyl-4-(1,2,2,2-tetrafluoro-1-trifluoromethylethyl)phenyl]-2,3-dihydro-isoindol-1-one and 3-chloro-7-iodo-2-[2-methyl-4-(1,2,2,2-tetrafluoro-1-trifluoromethyl-ethyl)phenyl]-2,3-dihydro-isoindol-1-one at about 1 to 1 (2.7 g) and 1,1-dimethyl-2-methylthioethylamine (1.8 g) were stirred in tetrahydrofuran in the presence of triethylamine (1.8 g) at room temperature for 20 hours. After finishing the reaction, the solvent was distilled off and the obtained residue was dissolved in ethyl acetate, washed with water and saturated aqueous solution of sodium chloride, and dried with sodium sulfate. After distilling off the solvent, the obtained residue was purified by silica gel column chromatography (eluted with hexane, ethyl acetate) to obtain a mixture of 3-(1,1-dimethyl-2-methylthioethylamino-4iodo-2-[2-methyl-4-(1,2,2,2-tetrafluoro-1-trifluoromethylethyl)-phenyl]-2,3-dihydroisoindol-1-one and 3-(1,1-dimethyl-2-methylthioethylamino-7-iodo-2-[2-methyl-4-(1,2,2,2-tetrafluoro-1-trifluoromethylethyl)phenyl]-2,3-dihydroisoindol-1-one (2.0 g). The mixture was used for the next reaction without further separation and purification.

The compounds obtained in the same manner to the above-mentioned Synthesis Examples 1-6 are shown in the following Table 1-5, together with the compounds synthesized in the Synthesis Examples 1-6.

The examples of the compounds in case that the compounds of the formula (IA) of the present invention represent the formula 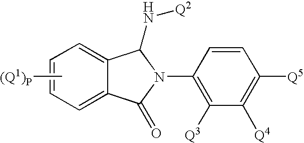
are shown in Table 1,
the examples of the compounds in case that they represent the formula 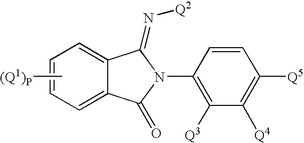
are shown in Table 2,
the examples of the compounds in case that they represent the formula 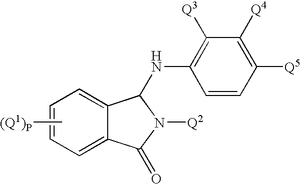
are shown in Table 3,
the examples of the compounds in case that they represent the formula 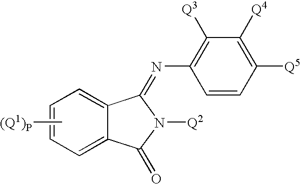
are shown in Table 4, and
the examples of the compounds in case that they represent the formula

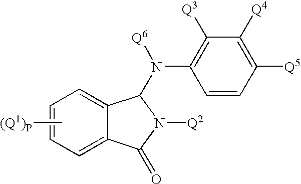

are shown in Table 5.

TABLE 1

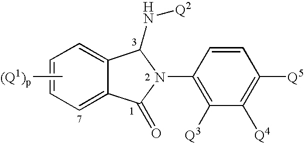

| Comp. No. | (Q¹)ₚ | Q² | Q³ | Q⁴ | Q⁵ | mp (° C.) or n_{D}²⁰ |
|---|---|---|---|---|---|---|
| 1-1 | H | CH(CH₃)₂ | CH₃ | H | CF(CF₃)₂ | |
| 1-2 | H | C(CH₃)₂CH₂SCH₃ | CH₃ | H | CF(CF₃)₂ | *1 |
| 1-3 | H | C(CH₃)₂CH₂SOCH₃ | CH₃ | H | CF(CF₃)₂ | |
| 1-4 | H | C(CH₃)₂CH₂SO₂CH₃ | CH₃ | H | CF(CF₃)₂ | 85-89 |
| 1-5 | H | CH(CH₃)CH₂SCH₃ | CH₃ | H | CF(CF₃)₂ | |
| 1-6 | H | CH(CH₃)CH₂SOCH₃ | CH₃ | H | CF(CF₃)₂ | |
| 1-7 | H | CH(CH₃)CH₂SO₂CH₃ | CH₃ | H | CF(CF₃)₂ | |
| 1-8 | H | CH(CH₃)₂ | H | H | CF(CF₃)₂ | |
| 1-9 | H | C(CH₃)₂CH₂SCH₃ | H | H | CF(CF₃)₂ | |
| 1-10 | H | C(CH₃)₂CH₂SOCH₃ | H | H | CF(CF₃)₂ | |
| 1-11 | H | C(CH₃)₂CH₂SO₂CH₃ | H | H | CF(CF₃)₂ | |
| 1-12 | H | CH(CH₃)CH₂SCH₃ | H | H | CF(CF₃)₂ | |
| 1-13 | H | CH(CH₃)CH₂SOCH₃ | H | H | CF(CF₃)₂ | |
| 1-14 | H | CH(CH₃)CH₂SO₂CH₃ | H | H | CF(CF₃)₂ | |
| 1-15 | H | CH(CH₃)₂ | Cl | Cl | Cl | |
| 1-16 | H | C(CH₃)₂CH₂SCH₃ | Cl | Cl | Cl | |
| 1-17 | H | C(CH₃)₂CH₂SOCH₃ | Cl | Cl | Cl | |
| 1-18 | H | C(CH₃)₂CH₂SO₂CH₃ | Cl | Cl | Cl | |
| 1-19 | H | CH(CH₃)CH₂SCH₃ | Cl | Cl | Cl | |
| 1-20 | H | CH(CH₃)CH₂SOCH₃ | Cl | Cl | Cl | |
| 1-21 | H | CH(CH₃)CH₂SO₂CH₃ | Cl | Cl | Cl | |
| 1-22 | H | CH(CH₃)₂ | CH₃ | H | OCF₃ | |
| 1-23 | H | C(CH₃)₂CH₂SCH₃ | CH₃ | H | OCF₃ | |
| 1-24 | H | C(CH₃)₂CH₂SOCH₃ | CH₃ | H | OCF₃ | |
| 1-25 | H | C(CH₃)₂CH₂SO₂CH₃ | CH₃ | H | OCF₃ | |
| 1-26 | H | CH(CH₃)CH₂SCH₃ | CH₃ | H | OCF₃ | |
| 1-27 | H | CH(CH₃)CH₂SOCH₃ | CH₃ | H | OCF₃ | |
| 1-28 | H | CH(CH₃)CH₂SO₂CH₃ | CH₃ | H | OCF₃ | |
| 1-29 | H | CH(CH₃)CH₂SO₂CH₃ | CH₃ | H | Cl | |
| 1-30 | 4-Cl | CH(CH₃)₂ | CH₃ | H | CF(CF₃)₂ | 54-59 |
| 1-31 | 4-Cl | C(CH₃)₂CH₂SCH₃ | CH₃ | H | CF(CF₃)₂ | 54-59 |
| 1-32 | 4-Cl | C(CH₃)₂CH₂SOCH₃ | CH₃ | H | CF(CF₃)₂ | 85-89 |
| 1-33 | 4-Cl | C(CH₃)₂CH₂SO₂CH₃ | CH₃ | H | CF(CF₃)₂ | 154-156 |
| 1-34 | 4-Cl | CH(CH₃)CH₂SCH₃ | CH₃ | H | CF(CF₃)₂ | 1.528 |
| 1-35 | 4-Cl | CH(CH₃)CH₂SOCH₃ | CH₃ | H | CF(CF₃)₂ | 76-78 |
| 1-36 | 4-Cl | CH(CH₃)CH₂SO₂CH₃ | CH₃ | H | CF(CF₃)₂ | 82-88 |
| 1-37 | 4-Cl | CH(CH₃)₂ | H | H | CF(CF₃)₂ | |
| 1-38 | 4-Cl | C(CH₃)₂CH₂SCH₃ | H | H | CF(CF₃)₂ | |
| 1-39 | 4-Cl | C(CH₃)₂CH₂SOCH₃ | H | H | CF(CF₃)₂ | |
| 1-40 | 4-Cl | C(CH₃)₂CH₂SO₂CH₃ | H | H | CF(CF₃)₂ | |
| 1-41 | 4-Cl | CH(CH₃)CH₂SCH₃ | H | H | CF(CF₃)₂ | |
| 1-42 | 4-Cl | CH(CH₃)CH₂SOCH₃ | H | H | CF(CF₃)₂ | |
| 1-43 | 4-Cl | CH(CH₃)CH₂SO₂CH₃ | H | H | CF(CF₃)₂ | |
| 1-44 | 4-Cl | CH(CH₃)₂ | Cl | Cl | Cl | |
| 1-45 | 4-Cl | C(CH₃)₂CH₂SCH₃ | Cl | Cl | Cl | |
| 1-46 | 4-Cl | C(CH₃)₂CH₂SOCH₃ | Cl | Cl | Cl | |
| 1-47 | 4-Cl | C(CH₃)₂CH₂SO₂CH₃ | Cl | Cl | Cl | |
| 1-48 | 4-Cl | CH(CH₃)CH₂SCH₃ | Cl | Cl | Cl | 49-52 |
| 1-49 | 4-Cl | CH(CH₃)CH₂SOCH₃ | Cl | Cl | Cl | |
| 1-50 | 4-Cl | CH(CH₃)CH₂SO₂CH₃ | Cl | Cl | OCF₃ | |
| 1-52 | 4-Cl | C(CH₃)₂CH₂SCH₃ | CH₃ | H | OCF₃ | |
| 1-53 | 4-Cl | C(CH₃)₂CH₂SOCH₃ | CH₃ | H | OCF₃ | |
| 1-54 | 4-Cl | C(CH₃)₂CH₂SO₂CH₃ | CH₃ | H | OCF₃ | |
| 1-55 | 4-Cl | CH(CH₃)CH₂SCH₃ | CH₃ | H | OCF₃ | 1.552 |
| 1-56 | 4-Cl | CH(CH₃)CH₂SOCH₃ | CH₃ | H | OCF₃ | |
| 1-57 | 4-Cl | CH(CH₃)CH₂SO₂CH₃ | CH₃ | H | OCF₃ | *3 |
| 1-58 | 7-Cl | CH(CH₃)₂ | CH₃ | H | CF(CF₃)₂ | |
| 1-59 | 7-Cl | C(CH₃)₂CH₂SCH₃ | CH₃ | H | CF(CF₃)₂ | 50-53 |
| 1-60 | 7-Cl | C(CH₃)₂CH₂SOCH₃ | CH₃ | H | CF(CF₃)₂ | |
| 1-61 | 7-Cl | C(CH₃)₂CH₂SO₂CH₃ | CH₃ | H | CF(CF₃)₂ | *4 |
| 1-62 | 7-Cl | CH(CH₃)CH₂SCH₃ | CH₃ | H | CF(CF₃)₂ | |
| 1-63 | 7-Cl | CH(CH₃)CH₂SOCH₃ | CH₃ | H | CF(CF₃)₂ | |
| 1-64 | 7-Cl | CH(CH₃)CH₂SO₂CH₃ | CH₃ | H | CF(CF₃)₂ | |
| 1-65 | 7-Cl | CH(CH₃)₂ | H | H | CF(CF₃)₂ | |
| 1-66 | 7-Cl | C(CH₃)₂CH₂SCH₃ | H | H | CF(CF₃)₂ | |
| 1-67 | 7-Cl | C(CH₃)₂CH₂SOCH₃ | H | H | CF(CF₃)₂ | |
| 1-68 | 7-Cl | C(CH₃)₂CH₂SO₂CH₃ | H | H | CF(CF₃)₂ | |
| 1-69 | 7-Cl | CH(CH₃)CH₂SCH₃ | H | H | CF(CF₃)₂ | |
| 1-70 | 7-Cl | CH(CH₃)CH₂SOCH₃ | H | H | CF(CF₃)₂ | |
| 1-71 | 7-Cl | CH(CH₃)CH₂SO₂CH₃ | H | H | CF(CF₃)₂ | |
| 1-72 | 7-Cl | CH(CH₃)₂ | Cl | Cl | Cl | |
| 1-73 | 7-Cl | C(CH₃)₂CH₂SCH₃ | Cl | Cl | Cl | |
| 1-74 | 7-Cl | C(CH₃)₂CH₂SOCH₃ | Cl | Cl | Cl | |
| 1-75 | 7-Cl | C(CH₃)₂CH₂SO₂CH₃ | Cl | Cl | Cl | |
| 1-76 | 7-Cl | CH(CH₃)CH₂SCH₃ | Cl | Cl | Cl | |
| 1-77 | 7-Cl | CH(CH₃)CH₂SOCH₃ | Cl | Cl | Cl | |
| 1-78 | 7-Cl | CH(CH₃)CH₂SO₂CH₃ | Cl | Cl | Cl | |
| 1-79 | 7-Cl | CH(CH₃)₂ | CH₃ | H | OCF₃ | |
| 1-80 | 7-Cl | C(CH₃)₂CH₂SCH₃ | CH₃ | H | OCF₃ | |
| 1-81 | 7-Cl | C(CH₃)₂CH₂SOCH₃ | CH₃ | H | OCF₃ | |
| 1-83 | 7-Cl | CH(CH₃)CH₂SCH₃ | CH₃ | H | OCF₃ | |
| 1-84 | 7-Cl | CH(CH₃)CH₂SOCH₃ | CH₃ | H | OCF₃ | |
| 1-85 | 7-Cl | CH(CH₃)CH₂SO₂CH₃ | CH₃ | H | OCF₃ | |
| 1-86 | 4,7-Cl₂ | CH(CH₃)CH₂SCH₃ | CH₃ | H | CF(CF₃)₂ | 154-155 |
| 1-87 | 4,5,6,7-Cl₄ | CH(CH₃)CH₂SCH₃ | CH₃ | H | CF(CF₃)₂ | 128-131 |
| 1-88 | 4,7-Cl₂ | CH(CH₃)CH₂SO₂CH₃ | CH₃ | H | CF(CF₃)₂ | 1.4799 |
| 1-89 | 4,5,6,7-Cl₄ | CH(CH₃)CH₂SO₂CH₃ | CH₃ | H | CF(CF₃)₂ | 113-114 |
| 1-90 | 4-Br | CH(CH₃)₂ | CH₃ | H | CF(CF₃)₂ | |
| 1-91 | 4-Br | C(CH₃)₂CH₂SCH₃ | CH₃ | H | CF(CF₃)₂ | |
| 1-93 | 4-Br | C(CH₃)₂CH₂SO₂CH₃ | CH₃ | H | CF(CF₃)₂ | |
| 1-94 | 4-Br | CH(CH₃)CH₂SCH₃ | CH₃ | H | CF(CF₃)₂ | |
| 1-95 | 4-Br | CH(CH₃)CH₂SOCH₃ | CH₃ | H | CF(CF₃)₂ | |
| 1-96 | 4-Br | CH(CH₃)CH₂SO₂CH₃ | CH₃ | H | CF(CF₃)₂ | |
| 1-98 | 4-Br | C(CH₃)₂CH₂SCH₃ | H | H | CF(CF₃)₂ | |
| 1-99 | 4-Br | C(CH₃)₂CH₂SOCH₃ | H | H | CF(CF₃)₂ | |
| 1-100 | 4-Br | C(CH₃)₂CH₂SO₂CH₃ | H | H | CF(CF₃)₂ | |
| 1-101 | 4-Br | CH(CH₃)CH₂SCH₃ | H | H | CF(CF₃)₂ | |
| 1-102 | 4-Br | CH(CH₃)CH₂SOCH₃ | H | H | CF(CF₃)₂ | |
| 1-103 | 4-Br | CH(CH₃)CH₂SO₂CH₃ | H | H | CF(CF₃)₂ | |
| 1-104 | 4-Br | CH(CH₃)₂ | Cl | Cl | Cl | |
| 1-105 | 4-Br | C(CH₃)₂CH₂SCH₃ | Cl | Cl | Cl | |
| 1-106 | 4-Br | C(CH₃)₂CH₂SOCH₃ | Cl | Cl | Cl | |
| 1-107 | 4-Br | C(CH₃)₂CH₂SO₂CH₃ | Cl | Cl | Cl | |
| 1-108 | 4-Br | CH(CH₃)CH₂SCH₃ | Cl | Cl | Cl | |
| 1-109 | 4-Br | CH(CH₃)CH₂SOCH₃ | Cl | Cl | Cl | |
| 1-110 | 4-Br | CH(CH₃)CH₂SO₂CH₃ | Cl | Cl | Cl | |
| 1-111 | 4-Br | CH(CH₃)₂ | CH₃ | H | OCF₃ | |
| 1-112 | 4-Br | C(CH₃)₂CH₂SCH₃ | CH₃ | H | OCF₃ | |
| 1-113 | 4-Br | C(CH₃)₂CH₂SOCH₃ | CH₃ | H | OCF₃ | |
| 1-114 | 4-Br | C(CH₃)₂CH₂SO₂CH₃ | CH₃ | H | OCF₃ | |
| 1-115 | 4-Br | CH(CH₃)CH₂SCH₃ | CH₃ | H | OCF₃ | |
| 1-116 | 4-Br | CH(CH₃)CH₂SOCH₃ | CH₃ | H | OCF₃ | |
| 1-117 | 4-Br | CH(CH₃)CH₂SO₂CH₃ | CH₃ | H | OCF₃ | |
| 1-118 | 7-Br | CH(CH₃)₂ | CH₃ | H | CF(CF₃)₂ | |
| 1-119 | 7-Br | C(CH₃)₂CH₂SCH₃ | CH₃ | H | CF(CF₃)₂ | |
| 1-120 | 7-Br | C(CH₃)₂CH₂SOCH₃ | CH₃ | H | CF(CF₃)₂ | |
| 1-121 | 7-Br | C(CH₃)₂CH₂SO₂CH₃ | CH₃ | H | CF(CF₃)₂ | |
| 1-122 | 7-Br | CH(CH₃)CH₂SCH₃ | CH₃ | H | CF(CF₃)₂ | |
| 1-123 | 7-Br | CH(CH₃)CH₂SOCH₃ | CH₃ | H | CF(CF₃)₂ | |
| 1-124 | 7-Br | CH(CH₃)CH₂SO₂CH₃ | CH₃ | H | CF(CF₃)₂ | |
| 1-125 | 7-Br | CH(CH₃)₂ | H | H | CF(CF₃)₂ | |
| 1-126 | 7-Br | C(CH₃)₂CH₂SCH₃ | H | H | CF(CF₃)₂ | |
| 1-127 | 7-Br | C(CH₃)₂CH₂SOCH₃ | H | H | CF(CF₃)₂ | |
| 1-128 | 7-Br | C(CH₃)₂CH₂SO₂CH₃ | H | H | CF(CF₃)₂ | |
| 1-129 | 7-Br | CH(CH₃)CH₂SCH₃ | H | H | CF(CF₃)₂ | |
| 1-130 | 7-Br | CH(CH₃)CH₂SOCH₃ | H | H | CF(CF₃)₂ | |
| 1-131 | 7-Br | CH(CH₃)CH₂SO₂CH₃ | H | H | CF(CF₃)₂ | |
| 1-132 | 7-Br | CH(CH₃)₂ | Cl | Cl | Cl | |
| 1-133 | 7-Br | C(CH₃)₂CH₂SCH₃ | Cl | Cl | Cl | |
| 1-134 | 7-Br | C(CH₃)₂CH₂SOCH₃ | Cl | Cl | Cl | |
| 1-135 | 7-Br | C(CH₃)₂CH₂SO₂CH₃ | Cl | Cl | Cl | |
| 1-136 | 7-Br | CH(CH₃)CH₂SCH₃ | Cl | Cl | Cl | |
| 1-137 | 7-Br | CH(CH₃)CH₂SOCH₃ | Cl | Cl | Cl | |
| 1-138 | 7-Br | CH(CH₃)CH₂SO₂CH₃ | Cl | Cl | Cl | |
| 1-139 | 7-Br | CH(CH₃)₂ | CH₃ | H | OCF₃ | |
| 1-140 | 7-Br | C(CH₃)₂CH₂SCH₃ | CH₃ | H | OCF₃ | |
| 1-141 | 7-Br | C(CH₃)₂CH₂SOCH₃ | CH₃ | H | OCF₃ | |
| 1-142 | 7-Br | C(CH₃)₂CH₂SO₂CH₃ | CH₃ | H | OCF₃ | |
| 1-143 | 7-Br | CH(CH₃)CH₂SCH₃ | CH₃ | H | OCF₃ | |
| 1-144 | 7-Br | CH(CH₃)CH₂SOCH₃ | CH₃ | H | OCF₃ | |
| 1-145 | 7-Br | CH(CH₃)CH₂SO₂CH₃ | CH₃ | H | OCF₃ | |
| 1-146 | 4,5,6,7-Br₄ | CH(CH₃)CH₂SCH₃ | CH₃ | H | CF(CF₃)₂ | 169-171 |
| 1-147 | 4,5,6,7-Br₄ | CH(CH₃)CH₂SO₂CH₃ | CH₃ | H | CF(CF₃)₂ | 126-131 |
| 1-148 | 4-I | CH(CH₃)₂ | CH₃ | H | CF(CF₃)₂ | |
| 1-149 | 4-I | C(CH₃)₂CH₂SCH₃ | CH₃ | H | CF(CF₃)₂ | 64-68 |
| 1-150 | 4-I | C(CH₃)₂CH₂SOCH₃ | CH₃ | H | CF(CF₃)₂ | 101-106 |
| 1-151 | 4-I | C(CH₃)₂CH₂SO₂CH₃ | CH₃ | H | CF(CF₃)₂ | *5 |
| 1-152 | 4-I | CH(CH₃)CH₂SCH₃ | CH₃ | H | CF(CF₃)₂ | 53-59 |
| 1-153 | 4-I | CH(CH₃)CH₂SOCH₃ | CH₃ | H | CF(CF₃)₂ | |
| 1-154 | 4-I | CH(CH₃)CH₂SO₂CH₃ | CH₃ | H | CF(CF₃)₂ | |
| 1-155 | 4-I | CH(CH₃)₂ | H | H | CF(CF₃)₂ | |
| 1-156 | 4-I | C(CH₃)₂CH₂SCH₃ | H | H | CF(CF₃)₂ | |
| 1-157 | 4-I | C(CH₃)₂CH₂SOCH₃ | H | H | CF(CF₃)₂ | |
| 1-158 | 4-I | C(CH₃)₂CH₂SO₂CH₃ | H | H | CF(CF₃)₂ | |
| 1-159 | 4-I | CH(CH₃)CH₂SCH₃ | H | H | CF(CF₃)₂ | |
| 1-160 | 4-I | CH(CH₃)CH₂SOCH₃ | H | H | CF(CF₃)₂ | |
| 1-161 | 4-I | CH(CH₃)CH₂SO₂CH₃ | H | H | CF(CF₃)₂ | |
| 1-162 | 4-I | CH(CH₃)₂ | Cl | Cl | Cl | |
| 1-163 | 4-I | C(CH₃)₂CH₂SCH₃ | Cl | Cl | Cl | |
| 1-164 | 4-I | C(CH₃)₂CH₂SOCH₃ | Cl | Cl | Cl | |
| 1-165 | 4-I | C(CH₃)₂CH₂SO₂CH₃ | Cl | Cl | Cl | |
| 1-166 | 4-I | CH(CH₃)CH₂SCH₃ | Cl | Cl | Cl | |
| 1-167 | 4-I | CH(CH₃)CH₂SOCH₃ | Cl | Cl | Cl | |
| 1-168 | 4-I | CH(CH₃)CH₂SO₂CH₃ | Cl | Cl | Cl | |
| 1-169 | 4-I | CH(CH₃)₂ | CH₃ | H | OCF₃ | |
| 1-170 | 4-I | C(CH₃)₂CH₂SCH₃ | CH₃ | H | OCF₃ | |
| 1-171 | 4-I | C(CH₃)₂CH₂SOCH₃ | CH₃ | H | OCF₃ | |
| 1-172 | 4-I | C(CH₃)₂CH₂SO₂CH₃ | CH₃ | H | OCF₃ | |
| 1-173 | 4-I | CH(CH₃)CH₂SCH₃ | CH₃ | H | OCF₃ | |
| 1-174 | 4-I | CH(CH₃)CH₂SOCH₃ | CH₃ | H | OCF₃ | |
| 1-175 | 4-I | CH(CH₃)CH₂SO₂CH₃ | CH₃ | H | OCF₃ | |
| 1-176 | 7-I | CH(CH₃)₂ | CH₃ | H | CF(CF₃)₂ | |
| 1-177 | 7-I | C(CH₃)₂CH₂SCH₃ | CH₃ | H | CF(CF₃)₂ | |
| 1-178 | 7-I | C(CH₃)₂CH₂SOCH₃ | CH₃ | H | CF(CF₃)₂ | 96-100 |
| 1-179 | 7-I | C(CH₃)₂CH₂SO₂CH₃ | CH₃ | H | CF(CF₃)₂ | *6 |
| 1-180 | 7-I | CH(CH₃)CH₂SCH₃ | CH₃ | H | CF(CF₃)₂ | |
| 1-181 | 7-I | CH(CH₃)CH₂SOCH₃ | CH₃ | H | CF(CF₃)₂ | |
| 1-182 | 7-I | CH(CH₃)CH₂SO₂CH₃ | CH₃ | H | CF(CF₃)₂ | |
| 1-183 | 7-I | CH(CH₃₎₂ | H | H | CF(CF₃)₂ | |
| 1-184 | 7-I | C(CH₃)₂CH₂SCH₃ | H | H | CF(CF₃)₂ | |
| 1-185 | 7-I | C(CH₃)₂CH₂SOCH₃ | H | H | CF(CF₃)₂ | |
| 1-186 | 7-I | C(CH₃)₂CH₂SO₂CH₃ | H | H | CF(CF₃)₂ | |
| 1-187 | 7-I | CH(CH₃)CH₂SCH₃ | H | H | CF(CF₃)₂ | |
| 1-188 | 7-I | CH(CH₃)CH₂SOCH₃ | H | H | CF(CF₃)₂ | |
| 1-189 | 7-I | CH(CH₃)CH₂SO₂CH₃ | H | H | CF(CF₃)₂ | |
| 1-190 | 7-I | CH(CH₃)₂ | Cl | Cl | Cl | |
| 1-191 | 7-I | C(CH₃)₂CH₂SCH₃ | Cl | Cl | Cl | |
| 1-192 | 7-I | C(CH₃)₂CH₂SOCH₃ | Cl | Cl | Cl | |
| 1-193 | 7-I | C(CH₃)₂CH₂SO₂CH₃ | Cl | Cl | Cl | |
| 1-194 | 7-I | CH(CH₃)CH₂SCH₃ | Cl | Cl | Cl | |
| 1-195 | 7-I | CH(CH₃)CH₂SOCH₃ | Cl | Cl | Cl | |
| 1-196 | 7-I | CH(CH₃)CH₂SO₂CH₃ | Cl | Cl | Cl | |
| 1-197 | 7-I | CH(CH₃)₂ | CH₃ | H | OCF₃ | |
| 1-198 | 7-I | C(CH₃)₂CH₂SCH₃ | CH₃ | H | OCF₃ | |
| 1-199 | 7-I | C(CH₃)₂CH₂SOCH₃ | CH₃ | H | OCF₃ | |
| 1-200 | 7-I | C(CH₃)₂CH₂SO₂CH₃ | CH₃ | H | OCF₃ | |
| 1-201 | 7-I | CH(CH₃)CH₂SCH₃ | CH₃ | H | OCF₃ | |
| 1-202 | 7-I | CH(CH₃)CH₂SOCH₃ | CH₃ | H | OCF₃ | |
| 1-203 | 7-I | CH(CH₃)CH₂SO₂CH₃ | CH₃ | H | OCF₃ | |
| 1-204 | 4-F | CH(CH₃)₂ | CH₃ | H | CF(CF₃)₂ | |
| 1-205 | 4-F | C(CH₃)₂CH₂SCH₃ | CH₃ | H | CF(CF₃)₂ | |
| 1-206 | 4-F | C(CH₃)₂CH₂SOCH₃ | CH₃ | H | CF(CF₃)₂ | |
| 1-207 | 4-F | C(CH₃)₂CH₂SO₂CH₃ | CH₃ | H | CF(CF₃)₂ | |
| 1-208 | 4-F | CH(CH₃)CH₂SCH₃ | CH₃ | H | CF(CF₃)₂ | *7 |
| 1-209 | 4-F | CH(CH₃CH₂SOCH₃ | CH₃ | H | CF(CF₃)₂ | |
| 1-210 | 4-F | CH(CH₃)CH₂SO₂CH₃ | CH₃ | H | CF(CF₃)₂ | 1.495 |
| 1-211 | 4-F | CH(CH₃)₂ | H | H | CF(CF₃)₂ | |
| 1-212 | 4-F | C(CH₃)₂CH₂SCH₃ | H | H | CF(CF₃)₂ | |
| 1-213 | 4-F | C(CH₃)₂CH₂SOCH₃ | H | H | CF(CF₃)₂ | |
| 1-214 | 4-F | C(CH₃)₂CH₂SO₂CH₃ | H | H | CF(CF₃)₂ | |
| 1-215 | 4-F | CH(CH₃)CH₂SCH₃ | H | H | CF(CF₃)₂ | |
| 1-216 | 4-F | CH(CH₃)CH₂SOCH₃ | H | H | CF(CF₃)₂ | |
| 1-217 | 4-F | CH(CH₃)CH₂SO₂CH₃ | H | H | CF(CF₃)₂ | |
| 1-218 | 4-F | CH(CH₃)₂ | Cl | Cl | Cl | |
| 1-219 | 4-F | C(CH₃)₂CH₂SCH₃ | Cl | Cl | Cl | |
| 1-220 | 4-F | C(CH₃)₂CH₂SOCH₃ | Cl | Cl | Cl | |
| 1-221 | 4-F | C(CH₃)₂CH₂SO₂CH₃ | Cl | Cl | Cl | |
| 1-222 | 4-F | CH(CH₃)CH₂SCH₃ | Cl | Cl | Cl | |
| 1-223 | 4-F | CH(CH₃)CH₂SOCH₃ | Cl | Cl | Cl | |
| 1-224 | 4-F | CH(CH₃)CH₂SO₂CH₃ | Cl | Cl | Cl | |
| 1-225 | 4-F | CH(CH₃)₂ | CH₃ | H | OCF₃ | |
| 1-226 | 4-F | C(CH₃)₂CH₂SCH₃ | CH₃ | H | OCF₃ | |
| 1-227 | 4-F | C(CH₃)₂CH₂SOCH₃ | CH₃ | H | OCF₃ | |
| 1-228 | 4-F | C(CH₃)₂CH₂SO₂CH₃ | CH₃ | H | OCF₃ | |
| 1-229 | 4-F | CH(CH₃)CH₂SCH₃ | CH₃ | H | OCF₃ | |
| 1-230 | 4-F | CH(CH₃)CH₂SOCH₃ | CH₃ | H | OCF₃ | |
| 1-231 | 4-F | CH(CH₃)CH₂SO₂CH₃ | CH₃ | H | OCF₃ | |
| 1-232 | 7-F | CH(CH₃)₂ | CH₃ | H | CF(CF₃)₂ | |
| 1-233 | 7-F | C(CH₃)₂CH₂SCH₃ | CH₃ | H | CF(CF₃)₂ | |
| 1-234 | 7-F | C(CH₃)₂CH₂SOCH₃ | CH₃ | H | CF(CF₃)₂ | |
| 1-235 | 7-F | C(CH₃)₂CH₂SO₂CH₃ | CH₃ | H | CF(CF₃)₂ | |
| 1-236 | 7-F | CH(CH₃)CH₂SCH₃ | CH₃ | H | CF(CF₃)₂ | 88-91 |
| 1-237 | 7-F | CH(CH₃)CH₂SOCH₃ | CH₃ | H | CF(CF₃)₂ | |
| 1-238 | 7-F | CH(CH₃)CH₂SO₂CH₃ | CH₃ | H | CF(CF₃)₂ | 1.5035 |
| 1-239 | 7-F | CH(CH₃)₂ | H | H | CF(CF₃)₂ | |
| 1-240 | 7-F | C(CH₃)₂CH₂SCH₃ | H | H | CF(CF₃)₂ | |
| 1-241 | 7-F | C(CH₃)₂CH₂SOCH₃ | H | H | CF(CF₃)₂ | |
| 1-242 | 7-F | C(CH₃)₂CH₂SO₂CH₃ | H | H | CF(CF₃)₂ | |
| 1-243 | 7-F | CH(CH₃)CH₂SCH₃ | H | H | CF(CF₃)₂ | |
| 1-244 | 7-F | CH(CH₃)CH₂SOCH₃ | H | H | CF(CF₃)₂ | |
| 1-245 | 7-F | CH(CH₃)CH₂SO₂CH₃ | H | H | CF(CF₃)₂ | |
| 1-246 | 7-F | CH(CH₃)₂ | Cl | Cl | Cl | |
| 1-247 | 7-F | C(CH₃)₂CH₂SCH₃ | Cl | Cl | Cl | |
| 1-248 | 7-F | C(CH₃)₂CH₂SOCH₃ | Cl | Cl | Cl | |
| 1-249 | 7-F | C(CH₃)₂CH₂SO₂CH₃ | Cl | Cl | Cl | |
| 1-250 | 7-F | CH(CH₃)CH₂SCH₃ | Cl | Cl | Cl | |
| 1-251 | 7-F | CH(CH₃)CH₂SOCH₃ | Cl | Cl | Cl | |
| 1-252 | 7-F | CH(CH₃)CH₂SO₂CH₃ | Cl | Cl | Cl | |
| 1-253 | 7-F | CH(CH₃)₂ | CH₃ | H | OCF₃ | |
| 1-254 | 7-F | C(CH₃)₂CH₂SCH₃ | CH₃ | H | OCF₃ | |
| 1-255 | 7-F | C(CH₃)₂CH₂SOCH₃ | CH₃ | H | OCF₃ | |
| 1-256 | 7-F | C(CH₃)₂CH₂SO₂CH₃ | CH₃ | H | OCF₃ | |
| 1-257 | 7-F | CH(CH₃)CH₂SCH₃ | CH₃ | H | OCF₃ | |
| 1-258 | 7-F | CH(CH₃)CH₂SOCH₃ | CH₃ | H | OCF₃ | |
| 1-259 | 7-F | CH(CH₃)CH₂SO₂CH₃ | CH₃ | H | OCF₃ | |
| 1-260 | 4,7-F₂ | CH(CH₃)CH₂SCH₃ | CH₃ | H | CF(CF₃)₂ | *8 |
| 1-261 | 4,5,6,7-F₄ | CH(CH₃)CH₂SCH₃ | CH₃ | H | CF(CF₃)₂ | |
| 1-262 | 4,7-F₂ | CH(CH₃)CH₂SO₂CH₃ | CH₃ | H | CF(CF₃)₂ | 1.4872 |
| 1-263 | 4-NO₂ | CH(CH₃)₂ | CH₃ | H | CF(CF₃)₂ | |
| 1-264 | 4-NO₂ | C(CH₃)₂CH₂SCH₃ | CH₃ | H | CF(CF₃)₂ | 113-115 |
| 1-265 | 4-NO₂ | C(CH₃)₂CH₂SOCH₃ | CH₃ | H | CF(CF₃)₂ | |
| 1-266 | 4-NO₂ | C(CH₃)₂CH₂SO₂CH₃ | CH₃ | H | CF(CF₃)₂ | |
| 1-267 | 4-NO₂ | CH(CH₃)CH₂SCH₃ | CH₃ | H | CF(CF₃)₂ | 1.525 |
| 1-268 | 4-NO₂ | CH(CH₃)CH₂SOCH₃ | CH₃ | H | CF(CF₃)₂ | |
| 1-269 | 4-NO₂ | CH(CH₃)CH₂SO₂CH₃ | CH₃ | H | CF(CF₃)₂ | 118-123 |
| 1-270 | 4-NO₂ | CH(CH₃)₂ | H | H | CF(CF₃)₂ | |
| 1-271 | 4-NO₂ | C(CH₃)₂CH₂SCH₃ | H | H | CF(CF₃)₂ | |
| 1-272 | 4-NO₂ | C(CH₃)₂CH₂SOCH₃ | H | H | CF(CF₃)₂ | |
| 1-273 | 4-NO₂ | C(CH₃)₂CH₂SO₂CH₃ | H | H | CF(CF₃)₂ | |
| 1-274 | 4-NO₂ | CH(CH₃)CH₂SCH₃ | H | H | CF(CF₃)₂ | |
| 1-275 | 4-NO₂ | CH(CH₃)CH₂SOCH₃ | H | H | CF(CF₃)₂ | |
| 1-276 | 4-NO₂ | CH(CH₃)CH₂SO₂CH₃ | H | H | CF(CF₃)₂ | |
| 1-277 | 4-NO₂ | CH(CH₃)₂ | Cl | Cl | Cl | |
| 1-278 | 4-NO₂ | C(CH₃)₂CH₂SCH₃ | Cl | Cl | Cl | |
| 1-279 | 4-NO₂ | C(CH₃)₂CH₂SOCH₃ | Cl | Cl | Cl | |
| 1-280 | 4-NO₂ | C(CH₃)₂CH₂SO₂CH₃ | Cl | Cl | Cl | |
| 1-281 | 4-NO₂ | CH(CH₃)CH₂SCH₃ | Cl | Cl | Cl | |
| 1-282 | 4-NO₂ | CH(CH₃)CH₂SOCH₃ | Cl | Cl | Cl | |
| 1-283 | 4-NO₂ | CH(CH₃)CH₂SO₂CH₃ | Cl | Cl | Cl | |
| 1-284 | 4-NO₂ | CH(CH₃)₂ | CH₃ | H | OCF₃ | |
| 1-285 | 4-NO₂ | C(CH₃)₂CH₂SCH₃ | CH₃ | H | OCF₃ | |
| 1-286 | 4-NO₂ | C(CH₃)₂CH₂SOCH₃ | CH₃ | H | OCF₃ | |
| 1-287 | 4-NO₂ | C(CH₃)₂CH₂SO₂CH₃ | CH₃ | H | OCF₃ | |
| 1-288 | 4-NO₂ | CH(CH₃)CH₂SCH₃ | CH₃ | H | OCF₃ | |
| 1-289 | 4-NO₂ | CH(CH₃)CH₂SOCH₃ | CH₃ | H | OCF₃ | |
| 1-290 | 4-NO₂ | CH(CH₃)CH₂SO₂CH₃ | CH₃ | H | OCF₃ | |
| 1-291 | 7-NO₂ | CH(CH₃)₂ | CH₃ | H | CF(CF₃)₂ | |
| 1-292 | 7-NO₂ | C(CH₃)₂CH₂SCH₃ | CH₃ | H | CF(CF₃)₂ | |
| 1-293 | 7-NO₂ | C(CH₃)₂CH₂SOCH₃ | CH₃ | H | CF(CF₃)₂ | |
| 1-294 | 7-NO₂ | C(CH₃)₂CH₂SO₂CH₃ | CH₃ | H | CF(CF₃)₂ | |
| 1-295 | 7-NO₂ | CH(CH₃)CH₂SCH₃ | CH₃ | H | CF(CF₃)₂ | *9 |
| 1-296 | 7-NO₂ | CH(CH₃)CH₂SOCH₃ | CH₃ | H | CF(CF₃)₂ | |
| 1-297 | 7-NO₂ | CH(CH₃)CH₂SO₂CH₃ | CH₃ | H | CF(CF₃)₂ | 1.5071 |
| 1-298 | 7-NO₂ | CH(CH₃)₂ | H | H | CF(CF₃)₂ | |
| 1-299 | 7-NO₂ | C(CH₃)₂CH₂SCH₃ | H | H | CF(CF₃)₂ | |
| 1-300 | 7-NO₂ | C(CH₃)₂CH₂SOCH₃ | H | H | CF(CF₃)₂ | |
| 1-301 | 7-NO₂ | C(CH₃)₂CH₂SO₂CH₃ | H | H | CF(CF₃)₂ | |
| 1-302 | 7-NO₂ | CH(CH₃)CH₂SCH₃ | H | H | CF(CF₃)₂ | |
| 1-303 | 7-NO₂ | CH(CH₃)CH₂SOCH₃ | H | H | CF(CF₃)₂ | |
| 1-304 | 7-NO₂ | CH(CH₃)CH₂SO₂CH₃ | H | H | CF(CF₃)₂ | |
| 1-305 | 7-NO₂ | CH(CH₃)₂ | Cl | Cl | Cl | |
| 1-306 | 7-NO₂ | C(CH₃)₂CH₂SCH₃ | Cl | Cl | Cl | |
| 1-307 | 7-NO₂ | C(CH₃)₂CH₂SOCH₃ | Cl | Cl | Cl | |
| 1-308 | 7-NO₂ | C(CH₃)₂CH₂SO₂CH₃ | Cl | Cl | Cl | |
| 1-309 | 7-NO₂ | CH(CH₃)CH₂SCH₃ | Cl | Cl | Cl | |
| 1-310 | 7-NO₂ | CH(CH₃)CH₂SOCH₃ | Cl | Cl | Cl | |
| 1-311 | 7-NO₂ | CH(CH₃)CH₂SO₂CH₃ | Cl | Cl | Cl | |
| 1-312 | 7-NO₂ | CH(CH₃)₂ | CH₃ | H | OCF₃ | |
| 1-313 | 7-NO₂ | C(CH₃)₂CH₂SCH₃ | CH₃ | H | OCF₃ | |
| 1-314 | 7-NO₂ | C(CH₃)₂CH₂SOCH₃ | CH₃ | H | OCF₃ | |
| 1-315 | 7-NO₂ | C(CH₃)₂CH₂SO₂CH₃ | CH₃ | H | OCF₃ | |
| 1-316 | 7-NO₂ | CH(CH₃)CH₂SCH₃ | CH₃ | H | OCF₃ | |
| 1-317 | 7-NO₂ | CH(CH₃)CH₂SOCH₃ | CH₃ | H | OCF₃ | |
| 1-318 | 7-NO₂ | CH(CH₃)CH₂SO₂CH₃ | CH₃ | H | OCF₃ | |
| 1-319 | 4-CF₃ | CH(CH₃)₂ | CH₃ | H | CF(CF₃)₂ | |
| 1-320 | 4-CF₃ | C(CH₃)₂CH₂SCH₃ | CH₃ | H | CF(CF₃)₂ | |
| 1-321 | 4-CF₃ | C(CH₃)₂CH₂SOCH₃ | CH₃ | H | CF(CF₃)₂ | |
| 1-322 | 4-CF₃ | C(CH₃)₂CH₂SO₂CH₃ | CH₃ | H | CF(CF₃)₂ | |
| 1-323 | 4-CF₃ | CH(CH₃)CH₂SCH₃ | CH₃ | H | CF(CF₃)₂ | |
| 1-324 | 4-CF₃ | CH(CH₃)CH₂SOCH₃ | CH₃ | H | CF(CF₃)₂ | |
| 1-325 | 4-CF₃ | CH(CH₃)CH₂SO₂CH₃ | CH₃ | H | CF(CF₃)₂ | |
| 1-326 | 4-CF₃ | CH(CH₃)₂ | H | H | CF(CF₃)₂ | |
| 1-327 | 4-CF₃ | C(CH₃)₂CH₂SCH₃ | H | H | CF(CF₃)₂ | |
| 1-328 | 4-CF₃ | C(CH₃)₂CH₂SOCH₃ | H | H | CF(CF₃)₂ | |
| 1-329 | 4-CF₃ | C(CH₃)₂CH₂SO₂CH₃ | H | H | CF(CF₃)₂ | |
| 1-330 | 4-CF₃ | CH(CH₃)CH₂SCH₃ | H | H | CF(CF₃)₂ | |
| 1-331 | 4-CF₃ | CH(CH₃)CH₂SOCH₃ | H | H | CF(CF₃)₂ | |
| 1-332 | 4-CF₃ | CH(CH₃)CH₂SO₂CH₃ | H | H | CF(CF₃)₂ | |
| 1-333 | 4-CF₃ | CH(CH₃)₂ | Cl | Cl | Cl | |
| 1-334 | 4-CF₃ | C(CH₃)₂CH₂SCH₃ | Cl | Cl | Cl | |
| 1-335 | 4-CF₃ | C(CH₃)₂CH₂SOCH₃ | Cl | Cl | Cl | |
| 1-336 | 4-CF₃ | C(CH₃)₂CH₂SO₂CH₃ | Cl | Cl | Cl | |
| 1-337 | 4-CF₃ | CH(CH₃)CH₂SCH₃ | Cl | Cl | Cl | |
| 1-338 | 4-CF₃ | CH(CH₃)CH₂SOCH₃ | Cl | Cl | Cl | |
| 1-339 | 4-CF₃ | CH(CH₃)CH₂SO₂CH₃ | Cl | Cl | Cl | |
| 1-340 | 4-CF₃ | CH(CH₃)₂ | CH₃ | H | OCF₃ | |
| 1-341 | 4-CF₃ | C(CH₃)₂CH₂SCH₃ | CH₃ | H | OCF₃ | |
| 1-342 | 4-CF₃ | C(CH₃)₂CH₂SOCH₃ | CH₃ | H | OCF₃ | |
| 1-343 | 4-CF₃ | C(CH₃)₂CH₂SO₂CH₃ | CH₃ | H | OCF₃ | |
| 1-344 | 4-CF₃ | CH(CH₃)CH₂SCH₃ | CH₃ | H | OCF₃ | |
| 1-345 | 4-CF₃ | CH(CH₃)CH₂SOCH₃ | CH₃ | H | OCF₃ | |
| 1-346 | 4-CF₃ | CH(CH₃)CH₂SO₂CH₃ | CH₃ | H | OCF₃ | |
| 1-347 | 7-CF₃ | CH(CH₃)₂ | CH₃ | H | CF(CF₃)₂ | |
| 1-348 | 7-CF₃ | C(CH₃)₂CH₂SCH₃ | CH₃ | H | CF(CF₃)₂ | |
| 1-349 | 7-CF₃ | C(CH₃)₂CH₂SOCH₃ | CH₃ | H | CF(CF₃)₂ | |
| 1-350 | 7-CF₃ | C(CH₃)₂CH₂SO₂CH₃ | CH₃ | H | CF(CF₃)₂ | |
| 1-351 | 7-CF₃ | CH(CH₃)CH₂SCH₃ | CH₃ | H | CF(CF₃)₂ | |
| 1-352 | 7-CF₃ | CH(CH₃)CH₂SOCH₃ | CH₃ | H | CF(CF₃)₂ | |
| 1-353 | 7-CF₃ | CH(CH₃)CH₂SO₂CH₃ | CH₃ | H | CF(CF₃)₂ | |
| 1-354 | 7-CF₃ | CH(CH₃)₂ | H | H | CF(CF₃)₂ | |
| 1-355 | 7-CF₃ | C(CH₃)₂CH₂SCH₃ | H | H | CF(CF₃)₂ | |
| 1-356 | 7-CF₃ | C(CH₃)₂CH₂SOCH₃ | H | H | CF(CF₃)₂ | |
| 1-357 | 7-CF₃ | C(CH₃)₂CH₂SO₂CH₃ | H | H | CF(CF₃)₂ | |
| 1-358 | 7-CF₃ | CH(CH₃)CH₂SCH₃ | H | H | CF(CF₃)₂ | |
| 1-359 | 7-CF₃ | CH(CH₃)CH₂SOCH₃ | H | H | CF(CF₃)₂ | |
| 1-360 | 7-CF₃ | CH(CH₃)CH₂SO₂CH₃ | H | H | CF(CF₃)₂ | |
| 1-361 | 7-CF₃ | CH(CH₃)₂ | Cl | Cl | Cl | |
| 1-362 | 7-CF₃ | C(CH₃)₂CH₂SCH₃ | Cl | Cl | Cl | |
| 1-363 | 7-CF₃ | C(CH₃)₂CH₂SOCH₃ | Cl | Cl | Cl | |
| 1-364 | 7-CF₃ | C(CH₃)₂CH₂SO₂CH₃ | Cl | Cl | Cl | |
| 1-365 | 7-CF₃ | CH(CH₃)CH₂SCH₃ | Cl | Cl | Cl | |
| 1-366 | 7-CF₃ | CH(CH₃)CH₂SOCH₃ | Cl | Cl | Cl | |
| 1-367 | 7-CF₃ | CH(CH₃)CH₂SO₂CH₃ | Cl | Cl | Cl | |
| 1-368 | 7-CF₃ | CH(CH₃)₂ | CH₃ | H | OCF₃ | |
| 1-369 | 7-CF₃ | C(CH₃)₂CH₂SCH₃ | CH₃ | H | OCF₃ | |
| 1-370 | 7-CF₃ | C(CH₃)₂CH₂SOCH₃ | CH₃ | H | OCF₃ | |
| 1-371 | 7-CF₃ | C(CH₃)₂CH₂SO₂CH₃ | CH₃ | H | OCF₃ | |
| 1-372 | 7-CF₃ | CH(CH₃)CH₂SCH₃ | CH₃ | H | OCF₃ | |
| 1-373 | 7-CF₃ | CH(CH₃)CH₂SOCH₃ | CH₃ | H | OCF₃ | |
| 1-374 | 7-CF₃ | CH(CH₃)CH₂SO₂CH₃ | CH₃ | H | OCF₃ | |
| 1-375 | 4-CH₃ | CH(CH₃)₂ | CH₃ | H | CF(CF₃)₂ | |
| 1-376 | 4-CH₃ | C(CH₃)₂CH₂SCH₃ | CH₃ | H | CF(CF₃)₂ | |
| 1-377 | 4-CH₃ | C(CH₃)₂CH₂SOCH₃ | CH₃ | H | CF(CF₃)₂ | |
| 1-378 | 4-CH₃ | C(CH₃)₂CH₂SO₂CH₃ | CH₃ | H | CF(CF₃)₂ | |
| 1-379 | 4-CH₃ | CH(CH₃)CH₂SCH₃ | CH₃ | H | CF(CF₃)₂ | 104-107 |
| 1-380 | 4-CH₃ | CH(CH₃)CH₂SOCH₃ | CH₃ | H | CF(CF₃)₂ | |
| 1-381 | 4-CH₃ | CH(CH₃)CH₂SO₂CH₃ | CH₃ | H | CF(CF₃)₂ | |
| 1-382 | 4-CH₃ | CH(CH₃)₂ | H | H | CF(CF₃)₂ | |
| 1-383 | 4-CH₃ | C(CH₃)₂CH₂SCH₃ | H | H | CF(CF₃)₂ | |
| 1-384 | 4-CH₃ | C(CH₃)₂CH₂SOCH₃ | H | H | CF(CF₃)₂ | |
| 1-385 | 4-CH₃ | C(CH₃)₂CH₂SO₂CH₃ | H | H | CF(CF₃)₂ | |
| 1-386 | 4-CH₃ | CH(CH₃)CH₂SCH₃ | H | H | CF(CF₃)₂ | |
| 1-387 | 4-CH₃ | CH(CH₃)CH₂SOCH₃ | H | H | CF(CF₃)₂ | |
| 1-388 | 4-CH₃ | CH(CH₃)CH₂SO₂CH₃ | H | H | CF(CF₃)₂ | |
| 1-389 | 4-CH₃ | CH(CH₃)₂ | Cl | Cl | Cl | |
| 1-390 | 4-CH₃ | C(CH₃)₂CH₂SCH₃ | Cl | Cl | Cl | |
| 1-391 | 4-CH₃ | C(CH₃)₂CH₂SOCH₃ | Cl | Cl | Cl | |
| 1-392 | 4-CH₃ | C(CH₃)₂CH₂SO₂CH₃ | Cl | Cl | Cl | |
| 1-393 | 4-CH₃ | CH(CH₃)CH₂SCH₃ | Cl | Cl | Cl | |
| 1-394 | 4-CH₃ | CH(CH₃)CH₂SOCH₃ | Cl | Cl | Cl | |
| 1-395 | 4-CH₃ | CH(CH₃)CH₂SO₂CH₃ | Cl | Cl | Cl | |
| 1-396 | 4-CH₃ | CH(CH₃)₂ | CH₃ | H | OCF₃ | |
| 1-397 | 4-CH₃ | C(CH₃)₂CH₂SCH₃ | CH₃ | H | OCF₃ | |
| 1-398 | 4-CH₃ | C(CH₃)₂CH₂SOCH₃ | CH₃ | H | OCF₃ | |
| 1-399 | 4-CH₃ | C(CH₃)₂CH₂SO₂CH₃ | CH₃ | H | OCF₃ | |
| 1-400 | 4-CH₃ | CH(CH₃)CH₂SCH₃ | CH₃ | H | OCF₃ | |
| 1-401 | 4-CH₃ | CH(CH₃)CH₂SOCH₃ | CH₃ | H | OCF₃ | |
| 1-402 | 4-CH₃ | CH(CH₃)CH₂SO₂CH₃ | CH₃ | H | OCF₃ | |
| 1-403 | 7-CH₃ | CH(CH₃)₂ | CH₃ | H | CF(CF₃)₂ | |
| 1-404 | 7-CH₃ | C(CH₃)₂CH₂SCH₃ | CH₃ | H | CF(CF₃)₂ | 132-134 |
| 1-405 | 7-CH₃ | C(CH₃)₂CH₂SOCH₃ | CH₃ | H | CF(CF₃)₂ | |
| 1-406 | 7-CH₃ | C(CH₃)₂CH₂SO₂CH₃ | CH₃ | H | CF(CF₃)₂ | |
| 1-407 | 7-CH₃ | CH(CH₃)CH₂SCH₃ | CH₃ | H | CF(CF₃)₂ | 106-110 |
| 1-408 | 7-CH₃ | CH(CH₃)CH₂SOCH₃ | CH₃ | H | CF(CF₃)₂ | |
| 1-409 | 7-CH₃ | CH(CH₃)CH₂SO₂CH₃ | CH₃ | H | CF(CF₃)₂ | 174-175 |
| 1-410 | 7-CH₃ | CH(CH₃)₂ | H | H | CF(CF₃)₂ | |
| 1-411 | 7-CH₃ | C(CH₃)₂CH₂SCH₃ | H | H | CF(CF₃)₂ | |
| 1-412 | 7-CH₃ | C(CH₃)₂CH₂SOCH₃ | H | H | CF(CF₃)₂ | |
| 1-413 | 7-CH₃ | C(CH₃)₂CH₂SO₂CH₃ | H | H | CF(CF₃)₂ | |
| 1-414 | 7-CH₃ | CH(CH₃)CH₂SCH₃ | H | H | CF(CF₃)₂ | |
| 1-415 | 7-CH₃ | CH(CH₃)CH₂SOCH₃ | H | H | CF(CF₃)₂ | |
| 1-416 | 7-CH₃ | CH(CH₃)CH₂SO₂CH₃ | H | H | CF(CF₃)₂ | |
| 1-417 | 7-CH₃ | CH(CH₃)₂ | Cl | Cl | Cl | |
| 1-418 | 7-CH₃ | C(CH₃)₂CH₂SCH₃ | Cl | Cl | Cl | |
| 1-419 | 7-CH₃ | C(CH₃)₂CH₂SOCH₃ | Cl | Cl | Cl | |
| 1-420 | 7-CH₃ | C(CH₃)₂CH₂SO₂CH₃ | Cl | Cl | Cl | |
| 1-421 | 7-CH₃ | CH(CH₃)CH₂SCH₃ | Cl | Cl | Cl | |
| 1-422 | 7-CH₃ | CH(CH₃)CH₂SOCH₃ | Cl | Cl | Cl | |
| 1-423 | 7-CH₃ | CH(CH₃)CH₂SO₂CH₃ | Cl | Cl | Cl | |
| 1-424 | 7-CH₃ | CH(CH₃)₂ | CH₃ | H | OCF₃ | |
| 1-425 | 7-CH₃ | C(CH₃)₂CH₂SCH₃ | CH₃ | H | OCF₃ | |
| 1-426 | 7-CH₃ | C(CH₃)₂CH₂SOCH₃ | CH₃ | H | OCF₃ | |
| 1-427 | 7-CH₃ | C(CH₃)₂CH₂SO₂CH₃ | CH₃ | H | OCF₃ | |
| 1-428 | 7-CH₃ | CH(CH₃)CH₂SCH₃ | CH₃ | H | OCF₃ | |
| 1-429 | 7-CH₃ | CH(CH₃)CH₂SOCH₃ | CH₃ | H | OCF₃ | |
| 1-430 | 7-CH₃ | CH(CH₃)CH₂SO₂CH₃ | CH₃ | H | OCF₃ | |
| 1-431 | 4-OCF₃ | CH(CH₃)₂ | CH₃ | H | CF(CF₃)₂ | |
| 1-432 | 4-OCF₃ | C(CH₃)₂CH₂SCH₃ | CH₃ | H | CF(CF₃)₂ | |
| 1-433 | 4-OCF₃ | C(CH₃)₂CH₂SOCH₃ | CH₃ | H | CF(CF₃)₂ | |
| 1-434 | 4-OCF₃ | C(CH₃)₂CH₂SO₂CH₃ | CH₃ | H | CF(CF₃)₂ | |
| 1-435 | 4-OCF₃ | CH(CH₃)CH₂SCH₃ | CH₃ | H | CF(CF₃)₂ | |
| 1-436 | 4-OCF₃ | CH(CH₃)CH₂SOCH₃ | CH₃ | H | CF(CF₃)₂ | |
| 1-437 | 4-OCF₃ | CH(CH₃)CH₂SO₂CH₃ | CH₃ | H | CF(CF₃)₂ | |
| 1-438 | 4-OCF₃ | CH(CH₃)₂ | H | H | CF(CF₃)₂ | |
| 1-439 | 4-OCF₃ | C(CH₃)₂CH₂SCH₃ | H | H | CF(CF₃)₂ | |
| 1-440 | 4-OCF₃ | C(CH₃)₂CH₂SOCH_{3 H} | H | CF(CF₃)₂ | | |
| 1-441 | 4-OCF₃ | C(CH₃)₂CH₂SO₂CH₃ | H | H | CF(CF₃)₂ | |
| 1-442 | 4-OCF₃ | CH(CH₃)CH₂SCH₃ | H | H | CF(CF₃)₂ | |
| 1-443 | 4-OCF₃ | CH(CH₃)CH₂SOCH₃ | H | H | CF(CF₃)₂ | |
| 1-444 | 4-OCF₃ | CH(CH₃)CH₂SO₂CH₃ | H | H | CF(CF₃)₂ | |
| 1-445 | 4-OCF₃ | CH(CH₃)₂ | Cl | Cl | Cl | |
| 1-446 | 4-OCF₃ | C(CH₃)₂CH₂SCH₃ | Cl | Cl | Cl | |
| 1-447 | 4-OCF₃ | C(CH₃)₂CH₂SOCH₃ | Cl | Cl | Cl | |
| 1-448 | 4-OCF₃ | C(CH₃)₂CH₂SO₂CH₃ | Cl | Cl | Cl | |
| 1-449 | 4-OCF₃ | CH(CH₃)CH₂SCH₃ | Cl | Cl | Cl | |
| 1-450 | 4-OCF₃ | CH(CH₃)CH₂SOCH₃ | Cl | Cl | Cl | |
| 1-451 | 4-OCF₃ | CH(CH₃)CH₂SO₂CH₃ | Cl | Cl | Cl | |
| 1-452 | 4-OCF₃ | CH(CH₃)₂ | CH₃ | H | OCF₃ | |
| 1-453 | 4-OCF₃ | C(CH₃)₂CH₂SCH₃ | CH₃ | H | OCF₃ | |
| 1-454 | 4-OCF₃ | C(CH₃)₂CH₂SOCH₃ | CH₃ | H | OCF₃ | |
| 1-455 | 4-OCF₃ | C(CH₃)₂CH₂SO₂CH₃ | CH₃ | H | OCF₃ | |
| 1-456 | 4-OCF₃ | CH(CH₃)CH₂SCH₃ | CH₃ | H | OCF₃ | |
| 1-457 | 4-OCF₃ | CH(CH₃)CH₂SOCH₃ | CH₃ | H | OCF₃ | |
| 1-458 | 4-OCF₃ | CH(CH₃)CH₂SO₂CH₃ | CH₃ | H | OCF₃ | |
| 1-459 | 7-OCF₃ | CH(CH₃)₂ | CH₃ | H | CF(CF₃)₂ | |
| 1-460 | 7-OCF₃ | C(CH₃)₂CH₂SCH₃ | CH₃ | H | CF(CF₃)₂ | |
| 1-461 | 7-OCF₃ | C(CH₃)₂CH₂SOCH₃ | CH₃ | H | CF(CF₃)₂ | |
| 1-462 | 7-OCF₃ | C(CH₃)₂CH₂SO₂CH₃ | CH₃ | H | CF(CF₃)₂ | |
| 1-463 | 7-OCF₃ | CH(CH₃)CH₂SCH₃ | CH₃ | H | CF(CF₃)₂ | |
| 1-464 | 7-OCF₃ | CH(CH₃)CH₂SOCH₃ | CH₃ | H | CF(CF₃)₂ | |
| 1-465 | 7-OCF₃ | CH(CH₃)CH₂SO₂CH₃ | CH₃ | H | CF(CF₃)₂ | |
| 1-466 | 7-OCF₃ | CH(CH₃)₂ | H | H | CF(CF₃)₂ | |
| 1-467 | 7-OCF₃ | C(CH₃)₂CH₂SCH₃ | H | H | CF(CF₃)₂ | |
| 1-468 | 7-OCF₃ | C(CH₃)₂CH₂SOCH₃ | H | H | CF(CF₃)₂ | |
| 1-469 | 7-OCF₃ | C(CH₃)₂CH₂SO₂CH₃ | H | H | CF(CF₃)₂ | |
| 1-470 | 7-OCF₃ | CH(CH₃)CH₂SCH₃ | H | H | CF(CF₃)₂ | |
| 1-471 | 7-OCF₃ | CH(CH₃)CH₂SOCH₃ | H | H | CF(CF₃)₂ | |
| 1-472 | 7-OCF₃ | CH(CH₃)CH₂SO₂CH₃ | H | H | CF(CF₃)₂ | |
| 1-473 | 7-OCF₃ | CH(CH₃)₂ | Cl | Cl | Cl | |
| 1-474 | 7-OCF₃ | C(CH₃)₂CH₂SCH₃ | Cl | Cl | Cl | |
| 1-475 | 7-OCF₃ | C(CH₃)₂CH₂SOCH₃ | Cl | Cl | Cl | |
| 1-476 | 7-OCF₃ | C(CH₃)₂CH₂SO₂CH₃ | Cl | Cl | Cl | |
| 1-477 | 7-OCF₃ | CH(CH₃)CH₂SCH₃ | Cl | Cl | Cl | |
| 1-478 | 7-OCF₃ | CH(CH₃)CH₂SOCH₃ | Cl | Cl | Cl | |
| 1-479 | 7-OCF₃ | CH(CH₃)CH₂SO₂CH₃ | Cl | Cl | Cl | |
| 1-480 | 7-OCF₃ | CH(CH₃)₂ | CH₃ | H | OCF₃ | |
| 1-481 | 7-OCF₃ | C(CH₃)₂CH₂SCH₃ | CH₃ | H | OCF₃ | |
| 1-482 | 7-OCF₃ | C(CH₃)₂CH₂SOCH₃ | CH₃ | H | OCF₃ | |
| 1-483 | 7-OCF₃ | C(CH₃)₂CH₂SO₂CH₃ | CH₃ | H | OCF₃ | |
| 1-484 | 7-OCF₃ | CH(CH₃)CH₂SCH₃ | CH₃ | H | OCF₃ | |
| 1-485 | 7-OCF₃ | CH(CH₃)CH₂SOCH₃ | CH₃ | H | OCF₃ | |
| 1-486 | 7-OCF₃ | CH(CH₃)CH₂SO₂CH₃ | CH₃ | H | OCF₃ | |
| 1-487 | 4-OCH₃ | CH(CH₃)₂ | CH₃ | H | CF(CF₃)₂ | |
| 1-488 | 4-OCH₃ | C(CH₃)₂CH₂SCH₃ | CH₃ | H | CF(CF₃)₂ | |
| 1-489 | 4-OCH₃ | C(CH₃)₂CH₂SOCH₃ | CH₃ | H | CF(CF₃)₂ | |
| 1-490 | 4-OCH₃ | C(CH₃)₂CH₂SO₂CH₃ | CH₃ | H | CF(CF₃)₂ | |
| 1-491 | 4-OCH₃ | CH(CH₃)CH₂SCH₃ | CH₃ | H | CF(CF₃)₂ | |
| 1-492 | 4-OCH₃ | CH(CH₃)CH₂SOCH₃ | CH₃ | H | CF(CF₃)₂ | |
| 1-493 | 4-OCH₃ | CH(CH₃)CH₂SO₂CH₃ | CH₃ | H | CF(CF₃)₂ | |
| 1-494 | 4-OCH₃ | CH(CH₃)₂ | H | H | CF(CF₃)₂ | |
| 1-495 | 4-OCH₃ | C(CH₃)₂CH₂SCH₃ | H | H | CF(CF₃)₂ | |
| 1-496 | 4-OCH₃ | C(CH₃)₂CH₂SOCH₃ | H | H | CF(CF₃)₂ | |
| 1-497 | 4-OCH₃ | C(CH₃)₂CH₂SO₂CH₃ | H | H | CF(CF₃)₂ | |
| 1-498 | 4-OCH₃ | CH(CH₃)CH₂SCH₃ | H | H | CF(CF₃)₂ | |
| 1-499 | 4-OCH₃ | CH(CH₃)CH₂SOCH₃ | H | H | CF(CF₃)₂ | |
| 1-500 | 4-OCH₃ | CH(CH₃)CH₂SO₂CH₃ | H | H | CF(CF₃)₂ | |
| 1-501 | 4-OCH₃ | CH(CH₃)₂ | Cl | Cl | Cl | |
| 1-502 | 4-OCH₃ | C(CH₃)₂CH₂SCH₃ | Cl | Cl | Cl | |
| 1-503 | 4-OCH₃ | C(CH₃)₂CH₂SOCH₃ | Cl | Cl | Cl | |
| 1-504 | 4-OCH₃ | C(CH₃)₂CH₂SO₂CH₃ | Cl | Cl | Cl | |
| 1-505 | 4-OCH₃ | CH(CH₃)CH₂SCH₃ | Cl | Cl | Cl | |
| 1-506 | 4-OCH₃ | CH(CH₃)CH₂SOCH₃ | Cl | Cl | Cl | |
| 1-507 | 4-OCH₃ | CH(CH₃)CH₂SO₂CH₃ | Cl | Cl | Cl | |
| 1-508 | 4-OCH₃ | CH(CH₃)₂ | CH₃ | H | OCF₃ | |
| 1-509 | 4-OCH₃ | C(CH₃)₂CH₂SCH₃ | CH₃ | H | OCF₃ | |
| 1-510 | 4-OCH₃ | C(CH₃)₂CH₂SOCH₃ | CH₃ | H | OCF₃ | |
| 1-511 | 4-OCH₃ | C(CH₃)₂CH₂SO₂CH₃ | CH₃ | H | OCF₃ | |
| 1-512 | 4-OCH₃ | CH(CH₃)CH₂SCH₃ | CH₃ | H | OCF₃ | |
| 1-513 | 4-OCH₃ | CH(CH₃)CH₂SOCH₃ | CH₃ | H | OCF₃ | |
| 1-514 | 4-OCH₃ | CH(CH₃)CH₂SO₂CH₃ | CH₃ | H | OCF₃ | |
| 1-515 | 7-OCH₃ | CH(CH₃)₂ | CH₃ | H | CF(CF₃)₂ | |
| 1-516 | 7-OCH₃ | C(CH₃)₂CH₂SCH₃ | CH₃ | H | CF(CF₃)₂ | |
| 1-517 | 7-OCH₃ | C(CH₃)₂CH₂SOCH₃ | CH₃ | H | CF(CF₃)₂ | |
| 1-518 | 7-OCH₃ | C(CH₃)₂CH₂SO₂CH₃ | CH₃ | H | CF(CF₃)₂ | |
| 1-519 | 7-OCH₃ | CH(CH₃)CH₂SCH₃ | CH₃ | H | CF(CF₃)₂ | |
| 1-520 | 7-OCH₃ | CH(CH₃)CH₂SOCH₃ | CH₃ | H | CF(CF₃)₂ | |
| 1-521 | 7-OCH₃ | CH(CH₃)CH₂SO₂CH₃ | CH₃ | H | CF(CF₃)₂ | |
| 1-522 | 7-OCH₃ | CH(CH₃)₂ | H | H | CF(CF₃)₂ | |
| 1-523 | 7-OCH₃ | C(CH₃)₂CH₂SCH₃ | H | H | CF(CF₃)₂ | |
| 1-524 | 7-OCH₃ | C(CH₃)₂CH₂SOCH₃ | H | H | CF(CF₃)₂ | |
| 1-525 | 7-OCH₃ | C(CH₃)₂CH₂SO₂CH₃ | H | H | CF(CF₃)₂ | |
| 1-526 | 7-OCH₃ | CH(CH₃)CH₂SCH₃ | H | H | CF(CF₃)₂ | |
| 1-527 | 7-OCH₃ | CH(CH₃)CH₂SOCH₃ | H | H | CF(CF₃)₂ | |
| 1-528 | 7-OCH₃ | CH(CH₃)CH₂SO₂CH₃ | H | H | CF(CF₃)₂ | |
| 1-529 | 7-OCH₃ | CH(CH₃)₂ | Cl | Cl | Cl | |
| 1-530 | 7-OCH₃ | C(CH₃)₂CH₂SCH₃ | Cl | Cl | Cl | |
| 1-531 | 7-OCH₃ | C(CH₃)₂CH₂SOCH₃ | Cl | Cl | Cl | |
| 1-532 | 7-OCH₃ | C(CH₃)₂CH₂SO₂CH₃ | Cl | Cl | Cl | |
| 1-533 | 7-OCH₃ | CH(CH₃)CH₂SCH₃ | Cl | Cl | Cl | |
| 1-534 | 7-OCH₃ | CH(CH₃)CH₂SOCH₃ | Cl | Cl | Cl | |
| 1-535 | 7-OCH₃ | CH(CH₃)CH₂SO₂CH₃ | Cl | Cl | Cl | |
| 1-536 | 7-OCH₃ | CH(CH₃)₂ | CH₃ | H | OCF₃ | |
| 1-537 | 7-OCH₃ | C(CH₃)₂CH₂SCH₃ | CH₃ | H | OCF₃ | |
| 1-538 | 7-OCH₃ | C(CH₃)₂CH₂SOCH₃ | CH₃ | H | OCF₃ | |
| 1-539 | 7-OCH₃ | C(CH₃)₂CH₂SO₂CH₃ | CH₃ | H | OCF₃ | |
| 1-540 | 7-OCH₃ | CH(CH₃)CH₂SCH₃ | CH₃ | H | OCF₃ | |
| 1-541 | 7-OCH₃ | CH(CH₃)CH₂SOCH₃ | CH₃ | H | OCF₃ | |
| 1-542 | 7-OCH₃ | CH(CH₃)CH₂SO₂CH₃ | CH₃ | H | OCF₃ | |
| 1-543 | 4-SCH₃ | CH(CH₃)₂ | CH₃ | H | CF(CF₃)₂ | |
| 1-544 | 4-SCH₃ | C(CH₃)₂CH₂SCH₃ | CH₃ | H | CF(CF₃)₂ | |
| 1-545 | 4-SCH₃ | C(CH₃)₂CH₂SOCH₃ | CH₃ | H | CF(CF₃)₂ | |
| 1-546 | 4-SCH₃ | C(CH₃)₂CH₂SO₂CH₃ | CH₃ | H | CF(CF₃)₂ | |
| 1-547 | 4-SCH₃ | CH(CH₃)CH₂SCH₃ | CH₃ | H | CF(CF₃)₂ | |
| 1-548 | 4-SCH₃ | CH(CH₃)CH₂SOCH₃ | CH₃ | H | CF(CF₃)₂ | |
| 1-549 | 4-SCH₃ | CH(CH₃)CH₂SO₂CH₃ | CH₃ | H | CF(CF₃)₂ | |
| 1-550 | 4-SCH₃ | CH(CH₃)₂ | H | H | CF(CF₃)₂ | |
| 1-551 | 4-SCH₃ | C(CH₃)₂CH₂SCH₃ | H | H | CF(CF₃)₂ | |
| 1-552 | 4-SCH₃ | C(CH₃)₂CH₂SOCH₃ | H | H | CF(CF₃)₂ | |
| 1-553 | 4-SCH₃ | C(CH₃)₂CH₂SO₂CH₃ | H | H | CF(CF₃)₂ | |
| 1-554 | 4-SCH₃ | CH(CH₃)CH₂SCH₃ | H | H | CF(CF₃)₂ | |
| 1-555 | 4-SCH₃ | CH(CH₃)CH₂SOCH₃ | H | H | CF(CF₃)₂ | |
| 1-556 | 4-SCH₃ | CH(CH₃)CH₂SO₂CH₃ | H | H | CF(CF₃)₂ | |
| 1-557 | 4-SCH₃ | CH(CH₃)₂ | Cl | Cl | Cl | |
| 1-558 | 4-SCH₃ | C(CH₃)₂CH₂SCH₃ | Cl | Cl | Cl | |
| 1-559 | 4-SCH₃ | C(CH₃)₂CH₂SOCH₃ | Cl | Cl | Cl | |
| 1-560 | 4-SCH₃ | C(CH₃)₂CH₂SO₂CH₃ | Cl | Cl | Cl | |
| 1-561 | 4-SCH₃ | CH(CH₃)CH₂SCH₃ | Cl | Cl | Cl | |
| 1-562 | 4-SCH₃ | CH(CH₃)CH₂SOCH₃ | Cl | Cl | Cl | |
| 1-563 | 4-SCH₃ | CH(CH₃)CH₂SO₂CH₃ | Cl | Cl | Cl | |
| 1-564 | 4-SCH₃ | CH(CH₃)₂ | CH₃ | H | OCF₃ | |
| 1-565 | 4-SCH₃ | C(CH₃)₂CH₂SCH₃ | CH₃ | H | OCF₃ | |
| 1-566 | 4-SCH₃ | C(CH₃)₂CH₂SOCH₃ | CH₃ | H | OCF₃ | |
| 1-567 | 4-SCH₃ | C(CH₃)₂CH₂SO₂CH₃ | CH₃ | H | OCF₃ | |
| 1-568 | 4-SCH₃ | CH(CH₃)CH₂SCH₃ | CH₃ | H | OCF₃ | |
| 1-569 | 4-SCH₃ | CH(CH₃)CH₂SOCH₃ | CH₃ | H | OCF₃ | |
| 1-570 | 4-SCH₃ | CH(CH₃)CH₂SO₂CH₃ | CH₃ | H | OCF₃ | |
| 1-571 | 7-SCH₃ | CH(CH₃)₂ | CH₃ | H | CF(CF₃)₂ | |
| 1-572 | 7-SCH₃ | C(CH₃)₂CH₂SCH₃ | CH₃ | H | CF(CF₃)₂ | |
| 1-573 | 7-SCH₃ | C(CH₃)₂CH₂SOCH₃ | CH₃ | H | CF(CF₃)₂ | |
| 1-574 | 7-SCH₃ | C(CH₃)₂CH₂SO₂CH₃ | CH₃ | H | CF(CF₃)₂ | |
| 1-575 | 7-SCH₃ | CH(CH₃)CH₂SCH₃ | CH₃ | H | CF(CF₃)₂ | |
| 1-576 | 7-SCH₃ | CH(CH₃)CH₂SOCH₃ | CH₃ | H | CF(CF₃)₂ | |
| 1-577 | 7-SCH₃ | CH(CH₃)CH₂SO₂CH₃ | CH₃ | H | CF(CF₃)₂ | |
| 1-578 | 7-SCH₃ | CH(CH₃)₂ | H | H | CF(CF₃)₂ | |
| 1-579 | 7-SCH₃ | C(CH₃)₂CH₂SCH₃ | H | H | CF(CF₃)₂ | |
| 1-580 | 7-SCH₃ | C(CH₃)₂CH₂SOCH₃ | H | H | CF(CF₃)₂ | |
| 1-581 | 7-SCH₃ | C(CH₃)₂CH₂SO₂CH₃ | H | H | CF(CF₃)₂ | |
| 1-582 | 7-SCH₃ | CH(CH₃)CH₂SCH₃ | H | H | CF(CF₃)₂ | |
| 1-583 | 7-SCH₃ | CH(CH₃)CH₂SOCH₃ | H | H | CF(CF₃)₂ | |
| 1-584 | 7-SCH₃ | CH(CH₃)CH₂SO₂CH₃ | H | H | CF(CF₃)₂ | |
| 1-585 | 7-SCH₃ | CH(CH₃)₂ | Cl | Cl | Cl | |
| 1-586 | 7-SCH₃ | C(CH₃)₂CH₂SCH₃ | Cl | Cl | Cl | |
| 1-587 | 7-SCH₃ | C(CH₃)₂CH₂SOCH₃ | Cl | Cl | Cl | |
| 1-588 | 7-SCH₃ | C(CH₃)₂CH₂SO₂CH₃ | Cl | Cl | Cl | |
| 1-589 | 7-SCH₃ | CH(CH₃)CH₂SCH₃ | Cl | Cl | Cl | |
| 1-590 | 7-SCH₃ | CH(CH₃)CH₂SOCH₃ | Cl | Cl | Cl | |
| 1-591 | 7-SCH₃ | CH(CH₃)CH₂SO₂CH₃ | Cl | Cl | Cl | |
| 1-592 | 7-SCH₃ | CH(CH₃)₂ | CH₃ | H | OCF₃ | |
| 1-593 | 7-SCH₃ | C(CH₃)₂CH₂SCH₃ | CH₃ | H | OCF₃ | |
| 1-594 | 7-SCH₃ | C(CH₃)₂CH₂SOCH₃ | CH₃ | H | OCF₃ | |
| 1-595 | 7-SCH₃ | C(CH₃)₂CH₂SO₂CH₃ | CH₃ | H | OCF₃ | |
| 1-596 | 7-SCH₃ | CH(CH₃)CH₂SCH₃ | CH₃ | H | OCF₃ | |
| 1-597 | 7-SCH₃ | CH(CH₃)CH₂SOCH₃ | CH₃ | H | OCF₃ | |
| 1-598 | 7-SCH₃ | CH(CH₃)CH₂SO₂CH₃ | CH₃ | H | OCF₃ | |
| 1-599 | 4-SO₂CH₃ | CH(CH₃)₂ | CH₃ | H | CF(CF₃)₂ | |
| 1-600 | 4-SO₂CH₃ | C(CH₃)₂CH₂SCH₃ | CH₃ | H | CF(CF₃)₂ | |
| 1-601 | 4-SO₂CH₃ | C(CH₃)₂CH₂SOCH₃ | CH₃ | H | CF(CF₃)₂ | |
| 1-602 | 4-SO₂CH₃ | C(CH₃)₂CH₂SO₂CH₃ | CH₃ | H | CF(CF₃)₂ | |
| 1-603 | 4-SO₂CH₃ | CH(CH₃)CH₂SCH₃ | CH₃ | H | CF(CF₃)₂ | 170-175 |
| 1-604 | 4-SO₂CH₃ | CH(CH₃)CH₂SOCH₃ | CH₃ | H | CF(CF₃)₂ | |
| 1-605 | 4-SO₂CH₃ | CH(CH₃)CH₂SO₂CH₃ | CH₃ | H | CF(CF₃)₂ | 104-109 |
| 1-606 | 4-SO₂CH₃ | CH(CH₃)₂ | H | H | CF(CF₃)₂ | |
| 1-607 | 4-SO₂CH₃ | C(CH₃)₂CH₂SCH₃ | H | H | CF(CF₃)₂ | |
| 1-608 | 4-SO₂CH₃ | C(CH₃)₂CH₂SOCH₃ | H | H | CF(CF₃)₂ | |
| 1-609 | 4-SO₂CH₃ | C(CH₃)₂CH₂SO₂CH₃ | H | H | CF(CF₃)₂ | |
| 1-610 | 4-SO₂CH₃ | CH(CH₃)CH₂SCH₃ | H | H | CF(CF₃)₂ | |
| 1-611 | 4-SO₂CH₃ | CH(CH₃)CH₂SOCH₃ | H | H | CF(CF₃)₂ | |
| 1-612 | 4-SO₂CH₃ | CH(CH₃)CH₂SO₂CH₃ | H | H | CF(CF₃)₂ | |
| 1-613 | 4-SO₂CH₃ | CH(CH₃)₂ | Cl | Cl | Cl | |
| 1-614 | 4-SO₂CH₃ | C(CH₃)₂CH₂SCH₃ | Cl | Cl | Cl | |
| 1-615 | 4-SO₂CH₃ | C(CH₃)₂CH₂SOCH₃ | Cl | Cl | Cl | |
| 1-616 | 4-SO₂CH₃ | C(CH₃)₂CH₂SO₂CH₃ | Cl | Cl | Cl | |
| 1-617 | 4-SO₂CH₃ | CH(CH₃)CH₂SCH₃ | Cl | Cl | Cl | |
| 1-618 | 4-SO₂CH₃ | CH(CH₃)CH₂SOCH₃ | Cl | Cl | Cl | |
| 1-619 | 4-SO₂CH₃ | CH(CH₃)CH₂SO₂CH₃ | Cl | Cl | Cl | |
| 1-620 | 4-SO₂CH₃ | CH(CH₃)₂ | CH₃ | H | OCF₃ | |
| 1-621 | 4-SO₂CH₃ | C(CH₃)₂CH₂SCH₃ | CH₃ | H | OCF₃ | |
| 1-622 | 4-SO₂CH₃ | C(CH₃)₂CH₂SOCH₃ | CH₃ | H | OCF₃ | |
| 1-623 | 4-SO₂CH₃ | C(CH₃)₂CH₂SO₂CH₃ | CH₃ | H | OCF₃ | |
| 1-624 | 4-SO₂CH₃ | CH(CH₃)CH₂SCH₃ | CH₃ | H | OCF₃ | |
| 1-625 | 4-SO₂CH₃ | CH(CH₃)CH₂SOCH₃ | CH₃ | H | OCF₃ | |
| 1-626 | 4-SO₂CH₃ | CH(CH₃)CH₂SO₂CH₃ | CH₃ | H | OCF₃ | |
| 1-627 | 7-SO₂CH₃ | CH(CH₃)₂ | CH₃ | H | CF(CF₃)₂ | |
| 1-628 | 7-SO₂CH₃ | C(CH₃)₂CH₂SCH₃ | CH₃ | H | CF(CF₃)₂ | |
| 1-629 | 7-SO₂CH₃ | C(CH₃)₂CH₂SOCH₃ | CH₃ | H | CF(CF₃)₂ | |
| 1-630 | 7-SO₂CH₃ | C(CH₃)₂CH₂SO₂CH₃ | CH₃ | H | CF(CF₃)₂ | |
| 1-631 | 7-SO₂CH₃ | CH(CH₃)CH₂SCH₃ | CH₃ | H | CF(CF₃)₂ | 60-63 |
| 1-632 | 7-SO₂CH₃ | CH(CH₃)CH₂SOCH₃ | CH₃ | H | CF(CF₃)₂ | |
| 1-633 | 7-SO₂CH₃ | CH(CH₃)CH₂SO₂CH₃ | CH₃ | H | CF(CF₃)₂ | |
| 1-634 | 7-SO₂CH₃ | CH(CH₃)₂ | H | H | CF(CF₃)₂ | |
| 1-635 | 7-SO₂CH₃ | C(CH₃)₂CH₂SCH₃ | H | H | CF(CF₃)₂ | |
| 1-636 | 7-SO₂CH₃ | C(CH₃)₂CH₂SOCH₃ | H | H | CF(CF₃)₂ | |
| 1-637 | 7-SO₂CH₃ | C(CH₃)₂CH₂SO₂CH₃ | H | H | CF(CF₃)₂ | |
| 1-638 | 7-SO₂CH₃ | CH(CH₃)CH₂SCH₃ | H | H | CF(CF₃)₂ | |
| 1-639 | 7-SO₂CH₃ | CH(CH₃)CH₂SOCH₃ | H | H | CF(CF₃)₂ | |
| 1-640 | 7-SO₂CH₃ | CH(CH₃)CH₂SO₂CH₃ | H | H | CF(CF₃)₂ | |
| 1-641 | 7-SO₂CH₃ | CH(CH₃)₂ | Cl | Cl | Cl | |
| 1-642 | 7-SO₂CH₃ | C(CH₃)₂CH₂SCH₃ | Cl | Cl | Cl | |
| 1-643 | 7-SO₂CH₃ | C(CH₃)₂CH₂SOCH₃ | Cl | Cl | Cl | |
| 1-644 | 7-SO₂CH₃ | C(CH₃)₂CH₂SO₂CH₃ | Cl | Cl | Cl | |
| 1-645 | 7-SO₂CH₃ | CH(CH₃)CH₂SCH₃ | Cl | Cl | Cl | |
| 1-646 | 7-SO₂CH₃ | CH(CH₃)CH₂SOCH₃ | Cl | Cl | Cl | |
| 1-647 | 7-SO₂CH₃ | CH(CH₃)CH₂SO₂CH₃ | Cl | Cl | Cl | |
| 1-648 | 7-SO₂CH₃ | CH(CH₃)₂ | CH₃ | H | OCF₃ | |
| 1-649 | 7-SO₂CH₃ | C(CH₃)₂CH₂SCH₃ | CH₃ | H | OCF₃ | |
| 1-650 | 7-SO₂CH₃ | C(CH₃)₂CH₂SOCH₃ | CH₃ | H | OCF₃ | |
| 1-651 | 7-SO₂CH₃ | C(CH₃)₂CH₂SO₂CH₃ | CH₃ | H | OCF₃ | |
| 1-652 | 7-SO₂CH₃ | CH(CH₃)CH₂SCH₃ | CH₃ | H | OCF₃ | |
| 1-653 | 7-SO₂CH₃ | CH(CH₃)CH₂SOCH₃ | CH₃ | H | OCF₃ | |
| 1-654 | 7-SO₂CH₃ | CH(CH₃)CH₂SO₂CH₃ | CH₃ | H | OCF₃ | |
| 1-655 | 4-OSO₂CH₃ | CH(CH₃)₂ | CH₃ | H | CF(CF₃)₂ | |
| 1-656 | 4-OSO₂CH₃ | C(CH₃)₂CH₂SCH₃ | CH₃ | H | CF(CF₃)₂ | 59-61 |
| 1-657 | 4-OSO₂CH₃ | C(CH₃)₂CH₂SOCH₃ | CH₃ | H | CF(CF₃)₂ | |
| 1-658 | 4-OSO₂CH₃ | C(CH₃)₂CH₂SO₂CH₃ | CH₃ | H | CF(CF₃)₂ | |
| 1-659 | 4-OSO₂CH₃ | CH(CH₃)CH₂SCH₃ | CH₃ | H | CF(CF₃)₂ | |
| 1-660 | 4-OSO₂CH₃ | CH(CH₃)CH₂SOCH₃ | CH₃ | H | CF(CF₃)₂ | |
| 1-661 | 4-OSO_{2=l CH}₃ | CH(CH₃)CH₂SO₂CH₃ | CH₃ | H | CF(CF₃)₂ | |
| 1-662 | 4-OSO₂CH₃ | CH(CH₃)₂ | H | H | CF(CF₃)₂ | |
| 1-663 | 4-OSO₂CH₃ | C(CH₃)₂CH₂SCH₃ | H | H | CF(CF₃)₂ | |
| 1-664 | 4-OSO₂CH₃ | C(CH₃)₂CH₂SOCH₃ | H | H | CF(CF₃)₂ | |
| 1-665 | 4-OSO₂CH₃ | C(CH₃)₂CH₂SO₂CH₃ | H | H | CF(CF₃)₂ | |
| 1-666 | 4-OSO₂CH₃ | CH(CH₃)CH₂SCH₃ | H | H | CF(CF₃)₂ | |
| 1-667 | 4-OSO₂CH₃ | CH(CH₃)CH₂SOCH₃ | H | H | CF(CF₃)₂ | |
| 1-668 | 4-OSO₂CH₃ | CH(CH₃)CH₂SO₂CH₃ | H | H | CF(CF₃)₂ | |
| 1-669 | 4-OSO₂CH₃ | CH(CH₃)₂ | Cl | Cl | Cl | |
| 1-670 | 4-OSO₂CH₃ | C(CH₃)₂CH₂SCH₃ | Cl | Cl | Cl | |
| 1-671 | 4-OSO₂CH₃ | C(CH₃)₂CH₂SOCH₃ | Cl | Cl | Cl | |
| 1-672 | 4-OSO₂CH₃ | C(CH₃)₂CH₂SO₂CH₃ | Cl | Cl | Cl | |
| 1-673 | 4-OSO₂CH₃ | CH(CH₃)CH₂SCH₃ | Cl | Cl | Cl | |
| 1-674 | 4-OSO₂CH₃ | CH(CH₃)CH₂SOCH₃ | Cl | Cl | Cl | |
| 1-675 | 4-OSO₂CH₃ | CH(CH₃)CH₂SO₂CH₃ | Cl | Cl | Cl | |
| 1-676 | 4-OSO₂CH₃ | CH(CH₃)₂ | CH₃ | H | OCF₃ | |
| 1-677 | 4-OSO₂CH₃ | C(CH₃)₂CH₂SCH₃ | CH₃ | H | OCF₃ | |
| 1-678 | 4-OSO₂CH₃ | C(CH₃)₂CH₂SOCH₃ | CH₃ | H | OCF₃ | |
| 1-679 | 4-OSO₂CH₃ | C(CH₃)₂CH₂SO₂CH₃ | CH₃ | H | OCF₃ | |
| 1-680 | 4-OSO₂CH₃ | CH(CH₃)CH₂SCH₃ | CH₃ | H | OCF₃ | |
| 1-681 | 4-OSO₂CH₃ | CH(CH₃)CH₂SOCH₃ | CH₃ | H | OCF₃ | |
| 1-682 | 4-OSO₂CH₃ | CH(CH₃)CH₂SO₂CH₃ | CH₃ | H | OCF₃ | |
| 1-683 | 7-OSO₂CH₃ | CH(CH₃)₂ | CH₃ | H | CF(CF₃)₂ | |
| 1-684 | 7-OSO₂CH₃ | C(CH₃)₂CH₂SCH₃ | CH₃ | H | CF(CF₃)₂ | 60-63 |
| 1-685 | 7-OSO₂CH₃ | C(CH₃)₂CH₂SOCH₃ | CH₃ | H | CF(CF₃)₂ | |
| 1-686 | 7-OSO₂CH₃ | C(CH₃)₂CH₂SO₂CH₃ | CH₃ | H | CF(CF₃)₂ | |
| 1-687 | 7-OSO₂CH₃ | CH(CH₃)CH₂SCH₃ | CH₃ | H | CF(CF₃)₂ | |
| 1-688 | 7-OSO₂CH₃ | CH(CH₃)CH₂SOCH₃ | CH₃ | H | CF(CF₃)₂ | |
| 1-689 | 7-OSO₂CH₃ | CH(CH₃)CH₂SO₂CH₃ | CH₃ | H | CF(CF₃)₂ | |
| 1-690 | 7-OSO₂CH₃ | CH(CH₃)₂ | H | H | CF(CF₃)₂ | |
| 1-691 | 7-OSO₂CH₃ | C(CH₃)₂CH₂SCH₃ | H | H | CF(CF₃)₂ | |
| 1-692 | 7-OSO₂CH₃ | C(CH₃)₂CH₂SOCH₃ | H | H | CF(CF₃)₂ | |
| 1-693 | 7-OSO₂CH₃ | C(CH₃)₂CH₂SO₂CH₃ | H | H | CF(CF₃)₂ | |
| 1-694 | 7-OSO₂CH₃ | CH(CH₃)CH₂SCH₃ | H | H | CF(CF₃)₂ | |
| 1-695 | 7-OSO₂CH₃ | CH(CH₃)CH₂SOCH₃ | H | H | CF(CF₃)₂ | |
| 1-696 | 7-OSO₂CH₃ | CH(CH₃)CH₂SO₂CH₃ | H | H | CF(CF₃)₂ | |
| 1-697 | 7-OSO₂CH₃ | CH(CH₃)₂ | Cl | Cl | Cl | |
| 1-698 | 7-OSO₂CH₃ | C(CH₃)₂CH₂SCH₃ | Cl | Cl | Cl | |
| 1-699 | 7-OSO₂CH₃ | C(CH₃)₂CH₂SOCH₃ | Cl | Cl | Cl | |
| 1-700 | 7-OSO₂CH₃ | C(CH₃)₂CH₂SO₂CH₃ | Cl | Cl | Cl | |
| 1-701 | 7-OSO₂CH₃ | CH(CH₃)CH₂SCH₃ | Cl | Cl | Cl | |
| 1-702 | 7-OSO₂CH₃ | CH(CH₃)CH₂SOCH₃ | Cl | Cl | Cl | |
| 1-703 | 7-OSO₂CH₃ | CH(CH₃)CH₂SO₂CH₃ | Cl | Cl | Cl | |
| 1-704 | 7-OSO₂CH₃ | CH(CH₃)₂ | CH₃ | H | OCF₃ | |
| 1-705 | 7-OSO₂CH₃ | C(CH₃)₂CH₂SCH₃ | CH₃ | H | OCF₃ | |
| 1-706 | 7-OSO₂CH₃ | C(CH₃)₂CH₂SOCH₃ | CH₃ | H | OCF₃ | |
| 1-707 | 7-OSO₂CH₃ | C(CH₃)₂CH₂SO₂CH₃ | CH₃ | H | OCF₃ | |
| 1-708 | 7-OSO₂CH₃ | CH(CH₃)CH₂SCH₃ | CH₃ | H | OCF₃ | |
| 1-709 | 7-OSO₂CH₃ | CH(CH₃)CH₂SOCH₃ | CH₃ | H | OCF₃ | |
| 1-710 | 7-OSO₂CH₃ | CH(CH₃)CH₂SO₂CH₃ | CH₃ | H | OCF₃ | |

*1. ¹H-NMR (CDCl₃, 90 MHz): δ = 0.8(3H, s), 1.0(3H, s), 2.0(3H, s), 2.2-2.5(6H, m), 5.6-5.9(1H, m), 7.3-7.9(7H, m) ppm.
*2. ¹H-NMR (CDCl₃, 90 MHz): δ = 0.9(3H/2, d, J=1.8Hz), 1.2(3H/2, d, J=1.8Hz), 2.4-3.0(3H, m), 2.7(3H, s), 2.8(3H, s), 3.2-3.6(1H, m), 6.0(1H, d, J=3.3Hz), 7.3-7.8(5H, m) ppm.
*3. ¹H-NMR (CDCl₃, 90 MHz): δ = 1.3(3H, d, J=1.8Hz), 2.3(3H, s), 2.6(3H, s), 2.7(2H, br s), 3.2-3.5(1H, m), 5.8(1H, br s), 7.1-7.8(6H, m) ppm.
*4. ¹H-NMR (CDCl₃, 90 MHz): δ = 1.4(3H, br s), 1.8(3H, br s), 2.1(3H, br s), 2.8(3H, s), 2.9(2H, br s), 5.8(1H, br s), 7.3-7.6(6H, m) ppm.
*5. ¹H-NMR (CDCl₃, 90 MHz): δ = 1.0(3H, br s), 1.5(3H, br s), 2.4(3H, br s), 2.8(3H, s), 2.6-3.2(2H, m), 5.9(1H, m), 7.2-8.0(6H, m) ppm.
*6. ¹H-NMR (CDCl₃, 90 MHz): δ = 1.5(3H, br s), 1.8(3H, br s), 2.2-2.4(2H, m), 2.8(3H, br s), 2.9(3H, br s), 7.3-8.0(7H, m) ppm.
*7. ¹H-NMR (CDCl₃, 90 MHz): δ = 0.8(3H/2, d, J=1.8Hz), 1.1(3H/2, d, J=1.8Hz), 1.8(3H/2, br s), 1.9(3H/2, br s), 2.0-2.3(2H, m), 2.4(3H, s), 2.8-3.0(1H, m), 6.0(1H, br s), 7.3-7.8(6H, m) ppm.
*8. ¹H-NMR (CDCl₃, 90 MHz): δ = 0.8(3H/2, d, J=1.8Hz), 1.1(3H/2, d, J=1.8Hz), 1.8(3H/2, br s), 1.9(3H/2, br s), 2.0-2.3(2H, m), 2.4(3H, s), 2.8-3.0(1H, m), 6.0(1H, br s), 7.1-7.6(5H, m) ppm.
*9. ¹H-NMR (CDCl₃, 90 MHz): δ = 0.6(3H/2, d, J=1.8Hz), 1.1(3H/2, d, J=1.8Hz), 1.8(3H/2,1 br s), 1.9(3H/2, br s), 2.0-2.3(2H, m), 2.4(3H, s), 2.8-3.0(1H, m), 6.0(1H, br s), 7.3-7.9(6H, m) ppm.

TABLE 2

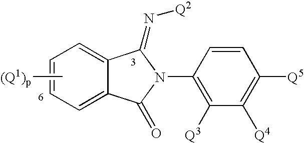

| Comp. No. | (Q¹)ₚ | Q² | Q³ | Q⁴ | Q⁵ | mp (° C.) or n_{D}²⁰ |
|---|---|---|---|---|---|---|
| 2-1 | H | CH(CH₃)₂ | CH₃ | H | CF(CF₃)₂ | |
| 2-2 | H | C(CH₃)₂CH₂SCH₃ | CH₃ | H | CF(CF₃)₂ | |
| 2-3 | H | C(CH₃)₂CH₂SOCH₃ | CH₃ | H | CF(CF₃)₂ | |
| 2-4 | H | C(CH₃)₂CH₂SO₂CH₃ | CH₃ | H | CF(CF₃)₂ | 91-95 |
| 2-5 | H | CH(CH₃)CH₂SCH₃ | CH₃ | H | CF(CF₃)₂ | |
| 2-6 | H | CH(CH₃)CH₂SOCH₃ | CH₃ | H | CF(CF₃)₂ | |
| 2-7 | H | CH(CH₃)CH₂SO₂CH₃ | CH₃ | H | CF(CF₃)₂ | |
| 2-8 | H | CH(CH₃)₂ | H | H | CF(CF₃)₂ | |
| 2-9 | H | C(CH₃)₂CH₂SCH₃ | H | H | CF(CF₃)₂ | |
| 2-10 | H | C(CH₃)₂CH₂SOCH₃ | H | H | CF(CF₃)₂ | |
| 2-11 | H | C(CH₃)₂CH₂SO₂CH₃ | H | H | CF(CF₃)₂ | |
| 2-12 | H | CH(CH₃)CH₂SCH₃ | H | H | CF(CF₃)₂ | |
| 2-13 | H | CH(CH₃)CH₂SOCH₃ | H | H | CF(CF₃)₂ | |
| 2-14 | H | CH(CH₃)CH₂SO₂CH₃ | H | H | CF(CF₃)₂ | |
| 2-15 | H | CH(CH₃)₂ | Cl | Cl | Cl | |
| 2-16 | H | C(CH₃)₂CH₂SCH₃ | Cl | Cl | Cl | |
| 2-17 | H | C(CH₃)₂CH₂SOCH₃ | Cl | Cl | Cl | |
| 2-18 | H | C(CH₃)₂CH₂SO₂CH₃ | Cl | Cl | Cl | |
| 2-19 | H | CH(CH₃)CH₂SCH₃ | Cl | Cl | Cl | |
| 2-20 | H | CH(CH₃)CH₂SOCH₃ | Cl | Cl | Cl | |
| 2-21 | H | CH(CH₃)CH₂SO₂CH₃ | Cl | Cl | Cl | |
| 2-22 | H | CH(CH₃)₂ | CH₃ | H | OCF₃ | |
| 2-23 | H | C(CH₃)₂CH₂SCH₃ | CH₃ | H | OCF₃ | |
| 2-24 | H | C(CH₃)₂CH₂SOCH₃ | CH₃ | H | OCF₃ | |
| 2-25 | H | C(CH₃)₂CH₂SO₂CH₃ | CH₃ | H | OCF₃ | |
| 2-26 | H | CH(CH₃)CH₂SCH₃ | CH₃ | H | OCF₃ | |
| 2-27 | H | CH(CH₃)CH₂SOCH₃ | CH₃ | H | OCF₃ | |
| 2-28 | H | CH(CH₃)CH₂SO₂CH₃ | CH₃ | H | OCF₃ | |
| 2-29 | 4-Cl | CH(CH₃)₂ | CH₃ | H | CF(CF₃)₂ | *1 |
| 2-30 | 4-Cl | C(CH₃)₂CH₂SCH₃ | CH₃ | H | CF(CF₃)₂ | |
| 2-31 | 4-Cl | C(CH₃)₂CH₂SOCH₃ | CH₃ | H | CF(CF₃)₂ | |
| 2-32 | 4-Cl | C(CH₃)₂CH₂SO₂CH₃ | CH₃ | H | CF(CF₃)₂ | 141-142 |
| 2-33 | 4-Cl | CH(CH₃)CH₂SCH₃ | CH₃ | H | CF(CF₃)₂ | *2 |
| 2-34 | 4-Cl | CH(CH₃)CH₂SOCH₃ | CH₃ | H | CF(CF₃)₂ | |
| 2-35 | 4-Cl | CH(CH₃)CH₂SO₂CH₃ | CH₃ | H | CF(CF₃)₂ | 171-173 |
| 2-36 | 4-Cl | CH(CH₃)₂ | H | H | CF(CF₃)₂ | |
| 2-37 | 4-Cl | C(CH₃)₂CH₂SCH₃ | H | H | CF(CF₃)₂ | |
| 2-38 | 4-Cl | C(CH₃)₂CH₂SOCH₃ | H | H | CF(CF₃)₂ | |
| 2-39 | 4-Cl | C(CH₃)₂CH₂SO₂CH₃ | H | H | CF(CF₃)₂ | |
| 2-40 | 4-Cl | CH(CH₃)CH₂SCH₃ | H | H | CF(CF₃)₂ | |
| 2-41 | 4-Cl | CH(CH₃)CH₂SOCH₃ | H | H | CF(CF₃)₂ | |
| 2-42 | 4-Cl | CH(CH₃)CH₂SO₂CH₃ | H | H | CF(CF₃)₂ | |
| 2-43 | 4-Cl | CH(CH₃)₂ | Cl | Cl | Cl | |
| 2-44 | 4-Cl | C(CH₃)₂CH₂SCH₃ | Cl | Cl | Cl | |
| 2-45 | 4-Cl | C(CH₃)₂CH₂SOCH₃ | Cl | Cl | Cl | |
| 2-46 | 4-Cl | C(CH₃)₂CH₂SO₂CH₃ | Cl | Cl | Cl | |
| 2-47 | 4-Cl | CH(CH₃)CH₂SCH₃ | Cl | Cl | Cl | |
| 2-48 | 4-Cl | CH(CH₃)CH₂SOCH₃ | Cl | Cl | Cl | |
| 2-49 | 4-Cl | CH(CH₃)CH₂SO₂CH₃ | Cl | Cl | Cl | |
| 2-50 | 4-Cl | CH(CH₃)₂ | CH₃ | H | OCF₃ | |
| 2-51 | 4-Cl | C(CH₃)₂CH₂SCH₃ | CH₃ | H | OCF₃ | |
| 2-52 | 4-Cl | C(CH₃)₂CH₂SOCH₃ | CH₃ | H | OCF₃ | |
| 2-53 | 4-Cl | C(CH₃)₂CH₂SO₂CH₃ | CH₃ | H | OCF₃ | |
| 2-54 | 4-Cl | CH(CH₃)CH₂SCH₃ | CH₃ | H | OCF₃ | |
| 2-55 | 4-Cl | CH(CH₃)CH₂SOCH₃ | CH₃ | H | OCF₃ | |
| 2-56 | 4-Cl | CH(CH₃)CH₂SO₂CH₃ | CH₃ | H | OCF₃ | |
| 2-57 | 7-Cl | CH(CH₃)₂ | CH₃ | H | CF(CF₃)₂ | |
| 2-58 | 7-Cl | C(CH₃)₂CH₂SCH₃ | CH₃ | H | CF(CF₃)₂ | |
| 2-59 | 7-Cl | C(CH₃)₂CH₂SOCH₃ | CH₃ | H | CF(CF₃)₂ | |
| 2-60 | 7-Cl | C(CH₃)₂CH₂SO₂CH₃ | CH₃ | H | CF(CF₃)₂ | 196-204 |
| 2-61 | 7-Cl | CH(CH₃)CH₂SCH₃ | CH₃ | H | CF(CF₃)₂ | |
| 2-62 | 7-Cl | CH(CH₃)CH₂SOCH₃ | CH₃ | H | CF(CF₃)₂ | |
| 2-63 | 7-Cl | CH(CH₃)CH₂SO₂CH₃ | CH₃ | H | CF(CF₃)₂ | |
| 2-64 | 7-Cl | CH(CH₃)₂ | H | H | CF(CF₃)₂ | |
| 2-65 | 7-Cl | C(CH₃)₂CH₂SCH₃ | H | H | CF(CF₃)₂ | |
| 2-66 | 7-Cl | C(CH₃)₂CH₂SOCH₃ | H | H | CF(CF₃)₂ | |
| 2-67 | 7-Cl | C(CH₃)₂CH₂SO₂CH₃ | H | H | CF(CF₃)₂ | |
| 2-68 | 7-Cl | CH(CH₃)CH₂SCH₃ | H | H | CF(CF₃)₂ | |
| 2-69 | 7-Cl | CH(CH₃)CH₂SOCH₃ | H | H | CF(CF₃)₂ | |
| 2-70 | 7-Cl | CH(CH₃)CH₂SO₂CH₃ | H | H | CF(CF₃)₂ | |
| 2-71 | 7-Cl | CH(CH₃)₂ | Cl | Cl | Cl | |
| 2-72 | 7-Cl | C(CH₃)₂CH₂SCH₃ | Cl | Cl | Cl | |
| 2-73 | 7-Cl | C(CH₃)₂CH₂SOCH₃ | Cl | Cl | Cl | |
| 2-74 | 7-Cl | C(CH₃)₂CH₂SO₂CH₃ | Cl | Cl | Cl | |
| 2-75 | 7-Cl | CH(CH₃)CH₂SCH₃ | Cl | Cl | Cl | |
| 2-76 | 7-Cl | CH(CH₃)CH₂SOCH₃ | Cl | Cl | Cl | |
| 2-77 | 7-Cl | CH(CH₃)CH₂SO₂CH₃ | Cl | Cl | Cl | |
| 2-78 | 7-Cl | CH(CH₃)₂ | CH₃ | H | OCF₃ | |
| 2-79 | 7-Cl | C(CH₃)₂CH₂SCH₃ | CH₃ | H | OCF₃ | |
| 2-80 | 7-Cl | C(CH₃)₂CH₂SOCH₃ | CH₃ | H | OCF₃ | |
| 2-81 | 7-Cl | C(CH₃)₂CH₂SO₂CH₃ | CH₃ | H | OCF₃ | |
| 2-82 | 7-Cl | CH(CH₃)CH₂SCH₃ | CH₃ | H | OCF₃ | |
| 2-83 | 7-Cl | CH(CH₃)CH₂SOCH₃ | CH₃ | H | OCF₃ | |
| 2-84 | 7-Cl | CH(CH₃)CH₂SO₂CH₃ | CH₃ | H | OCF₃ | |
| 2-85 | 4-Br | CH(CH₃)₂ | CH₃ | H | CF(CF₃)₂ | |
| 2-86 | 4-Br | C(CH₃)₂CH₂SCH₃ | CH₃ | H | CF(CF₃)₂ | |
| 2-87 | 4-Br | C(CH₃)₂CH₂SOCH₃ | CH₃ | H | CF(CF₃)₂ | |
| 2-88 | 4-Br | C(CH₃)₂CH₂SO₂CH₃ | CH₃ | H | CF(CF₃)₂ | |
| 2-89 | 4-Br | CH(CH₃)CH₂SCH₃ | CH₃ | H | CF(CF₃)₂ | |
| 2-90 | 4-Br | CH(CH₃)CH₂SOCH₃ | CH₃ | H | CF(CF₃)₂ | |
| 2-91 | 4-Br | CH(CH₃)CH₂SO₂CH₃ | CH₃ | H | CF(CF₃)₂ | |
| 2-92 | 4-Br | CH(CH₃)₂ | H | H | CF(CF₃)₂ | |
| 2-93 | 4-Br | C(CH₃)₂CH₂SCH₃ | H | H | CF(CF₃)₂ | |
| 2-94 | 4-Br | C(CH₃)₂CH₂SOCH₃ | H | H | CF(CF₃)₂ | |
| 2-95 | 4-Br | C(CH₃)₂CH₂SO₂CH₃ | H | H | CF(CF₃)₂ | |
| 2-96 | 4-Br | CH(CH₃)CH₂SCH₃ | H | H | CF(CF₃)₂ | |
| 2-97 | 4-Br | CH(CH₃)CH₂SOCH₃ | H | H | CF(CF₃)₂ | |
| 2-98 | 4-Br | CH(CH₃)CH₂SO₂CH₃ | H | H | CF(CF₃)₂ | |
| 2-99 | 4-Br | CH(CH₃)₂ | Cl | Cl | Cl | |
| 2-100 | 4-Br | C(CH₃)₂CH₂SCH₃ | Cl | Cl | Cl | |
| 2-101 | 4-Br | C(CH₃)₂CH₂SOCH₃ | Cl | Cl | Cl | |
| 2-102 | 4-Br | C(CH₃)₂CH₂SO₂CH₃ | Cl | Cl | Cl | |
| 2-103 | 4-Br | CH(CH₃)CH₂SCH3 | Cl | Cl | Cl | |
| 2-104 | 4-Br | CH(CH₃)CH₂SOCH₃ | Cl | Cl | Cl | |
| 2-105 | 4-Br | CH(CH₃)CH₂SO₂CH₃ | Cl | Cl | Cl | |
| 2-106 | 4-Br | CH(CH₃)₂ | CH₃ | H | OCF₃ | |
| 2-107 | 4-Br | C(CH₃)₂CH₂SCH₃ | CH₃ | H | OCF₃ | |
| 2-108 | 4-Br | C(CH₃)₂CH₂SOCH₃ | CH₃ | H | OCF₃ | |
| 2-109 | 4-Br | C(CH₃)₂CH₂SO₂CH₃ | CH₃ | H | OCF₃ | |
| 2-110 | 4-Br | CH(CH₃)CH₂SCH₃ | CH₃ | H | OCF₃ | |
| 2-111 | 4-Br | CH(CH₃)CH₂SOCH₃ | CH₃ | H | OCF₃ | |
| 2-112 | 4-Br | CH(CH₃)CH₂SO₂CH₃ | CH₃ | H | OCF₃ | |
| 2-113 | 7-Br | CH(CH₃)₂ | CH₃ | H | CF(CF₃)₂ | |
| 2-114 | 7-Br | C(CH₃)₂CH₂SCH₃ | CH₃ | H | CF(CF₃)₂ | |
| 2-115 | 7-Br | C(CH₃)₂CH₂SOCH₃ | CH₃ | H | CF(CF₃)₂ | |
| 2-116 | 7-Br | C(CH₃)₂CH₂SO₂CH₃ | CH₃ | H | CF(CF₃)₂ | |
| 2-117 | 7-Br | CH(CH₃)CH₂SCH₃ | CH₃ | H | CF(CF₃)₂ | |
| 2-118 | 7-Br | CH(CH₃)CH₂SOCH₃ | CH₃ | H | CF(CF₃)₂ | |
| 2-119 | 7-Br | CH(CH₃)CH₂SO₂CH₃ | CH₃ | H | CF(CF₃)₂ | |
| 2-120 | 7-Br | CH(CH₃)₂ | H | H | CF(CF₃)₂ | |
| 2-121 | 7-Br | C(CH₃)₂CH₂SCH₃ | H | H | CF(CF₃)₂ | |
| 2-122 | 7-Br | C(CH₃)₂CH₂SOCH₃ | H | H | CF(CF₃)₂ | |
| 2-123 | 7-Br | C(CH₃)₂CH₂SO₂CH₃ | H | H | CF(CF₃)₂ | |
| 2-124 | 7-Br | CH(CH₃)CH₂SCH₃ | H | H | CF(CF₃)₂ | |
| 2-125 | 7-Br | CH(CH₃)CH₂SOCH₃ | H | H | CF(CF₃)₂ | |
| 2-126 | 7-Br | CH(CH₃)CH₂SO₂CH₃ | H | H | CF(CF₃)₂ | |
| 2-127 | 7-Br | CH(CH₃)₂ | Cl | Cl | Cl | |
| 2-128 | 7-Br | C(CH₃)₂CH₂SCH₃ | Cl | Cl | Cl | |
| 2-129 | 7-Br | C(CH₃)₂CH₂SOCH₃ | Cl | Cl | Cl | |
| 2-130 | 7-Br | C(CH₃)₂CH₂SO₂CH₃ | Cl | Cl | Cl | |
| 2-131 | 7-Br | CH(CH₃)CH₂SCH₃ | Cl | Cl | Cl | |
| 2-132 | 7-Br | CH(CH₃)CH₂SOCH₃ | Cl | Cl | Cl | |
| 2-133 | 7-Br | CH(CH₃)CH₂SO₂CH₃ | Cl | Cl | Cl | |
| 2-134 | 7-Br | CH(CH₃)₂ | CH₃ | H | OCF₃ | |
| 2-135 | 7-Br | C(CH₃)₂CH₂SCH₃ | CH₃ | H | OCF₃ | |
| 2-136 | 7-Br | C(CH₃)₂CH₂SOCH₃ | CH₃ | H | OCF₃ | |
| 2-137 | 7-Br | C(CH₃)₂CH₂SO₂CH₃ | CH₃ | H | OCF₃ | |
| 2-138 | 7-Br | CH(CH₃)CH₂SCH₃ | CH₃ | H | OCF₃ | |
| 2-139 | 7-Br | CH(CH₃)CH₂SOCH₃ | CH₃ | H | OCF₃ | |
| 2-140 | 7-Br | CH(CH₃)CH₂SO₂CH₃ | CH₃ | H | OCF₃ | |
| 2-141 | 4-I | CH(CH₃)₂ | CH₃ | H | CF(CF₃)₂ | 105-111 |
| 2-142 | 4-I | C(CH₃)₂CH₂SCH₃ | CH₃ | H | CF(CF₃)₂ | |
| 2-143 | 4-I | C(CH₃)₂CH₂SOCH₃ | CH₃ | H | CF(CF₃)₂ | |
| 2-144 | 4-I | C(CH₃)₂CH₂SO₂CH₃ | CH₃ | H | CF(CF₃)₂ | 102-109, *3 |
| 2-145 | 4-I | CH(CH₃)CH₂SCH₃ | CH₃ | H | CF(CF₃)₂ | |
| 2-146 | 4-I | CH(CH₃)CH₂SOCH₃ | CH₃ | H | CF(CF₃)₂ | |
| 2-147 | 4-I | CH(CH₃)CH₂SO₂CH₃ | CH₃ | H | CF(CF₃)₂ | |
| 2-148 | 4-I | CH(CH₃)₂ | H | H | CF(CF₃)₂ | |
| 2-149 | 4-I | C(CH₃)₂CH₂SCH₃ | H | H | CF(CF₃)₂ | |
| 2-150 | 4-I | C(CH₃)₂CH₂SOCH₃ | H | H | CF(CF₃)₂ | |
| 2-151 | 4-I | C(CH₃)₂CH₂SO₂CH₃ | H | H | CF(CF₃)₂ | |
| 2-152 | 4-I | CH(CH₃)CH₂SCH₃ | H | H | CF(CF₃)₂ | |
| 2-153 | 4-I | CH(CH₃)CH₂SOCH₃ | H | H | CF(CF₃)₂ | |
| 2-154 | 4-I | CH(CH₃)CH₂SO₂CH₃ | H | H | CF(CF₃)₂ | |
| 2-155 | 4-I | CH(CH₃)₂ | Cl | Cl | Cl | |
| 2-156 | 4-I | C(CH₃)₂CH₂SCH₃ | Cl | Cl | Cl | |
| 2-157 | 4-I | C(CH₃)₂CH₂SOCH₃ | Cl | Cl | Cl | |
| 2-158 | 4-I | C(CH₃)₂CH₂SO₂CH₃ | Cl | Cl | Cl | |
| 2-159 | 4-I | CH(CH₃)CH₂SCH₃ | Cl | Cl | Cl | |
| 2-160 | 4-I | CH(CH₃)CH₂SOCH₃ | Cl | Cl | Cl | |
| 2-161 | 4-I | CH(CH₃)CH₂SO₂CH₃ | Cl | Cl | Cl | |
| 2-162 | 4-I | CH(CH₃)₂ | Cl | Cl | Cl | |
| 2-163 | 4-I | C(CH₃)₂CH₂SCH₃ | CH₃ | H | OCF₃ | |
| 2-164 | 4-I | C(CH₃)₂CH₂SOCH₃ | CH₃ | H | OCF₃ | |
| 2-165 | 4-I | C(CH₃)₂CH₂SO₂CH₃ | CH₃ | H | OCF₃ | |
| 2-166 | 4-I | CH(CH₃)CH₂SCH₃ | CH₃ | H | OCF₃ | |
| 2-167 | 4-I | CH(CH₃)CH₂SOCH₃ | CH₃ | H | OCF₃ | |
| 2-168 | 4-I | CH(CH₃)CH₂SO₂CH₃ | CH₃ | H | OCF₃ | |
| 2-169 | 7-I | CH(CH₃)₂ | CH₃ | H | CF(CF₃)₂ | |
| 2-170 | 7-I | C(CH₃)₂CH₂SCH₃ | CH₃ | H | CF(CF₃)₂ | |
| 2-171 | 7-I | C(CH₃)₂CH₂SOCH₃ | CH₃ | H | CF(CF₃)₂ | |
| 2-172 | 7-I | C(CH₃)₂CH₂SO₂CH₃ | CH₃ | H | CF(CF₃)₂ | |
| 2-173 | 7-I | CH(CH₃)CH₂SCH₃ | CH₃ | H | CF(CF₃)₂ | |
| 2-174 | 7-I | CH(CH₃)CH₂SOCH₃ | CH₃ | H | CF(CF₃)₂ | |
| 2-175 | 7-I | CH(CH₃)CH₂SO₂CH₃ | CH₃ | H | CF(CF₃)₂ | |
| 2-176 | 7-I | CH(CH₃)₂ | H | H | CF(CF₃)₂ | |
| 2-177 | 7-I | C(CH₃)₂CH₂SCH₃ | H | H | CF(CF₃)₂ | |
| 2-178 | 7-I | C(CH₃)₂CH₂SOCH₃ | H | H | CF(CF₃)₂ | |
| 2-179 | 7-I | C(CH₃)₂CH₂SO₂CH₃ | H | H | CF(CF₃)₂ | |
| 2-180 | 7-I | CH(CH₃)CH₂SCH₃ | H | H | CF(CF₃)₂ | |
| 2-181 | 7-I | CH(CH₃)CH₂SOCH₃ | H | H | CF(CF₃)₂ | |
| 2-182 | 7-I | CH(CH₃)CH₂SO₂CH₃ | H | H | CF(CF₃)₂ | |
| 2-183 | 7-I | CH(CH₃)₂ | Cl | Cl | Cl | |
| 2-184 | 7-I | C(CH₃)₂CH₂SCH₃ | Cl | Cl | Cl | |
| 2-185 | 7-I | C(CH₃)₂CH₂SOCH₃ | Cl | Cl | Cl | |
| 2-186 | 7-I | C(CH₃)₂CH₂SO₂CH₃ | Cl | Cl | Cl | |
| 2-187 | 7-I | CH(CH₃)CH₂SCH₃ | Cl | Cl | Cl | |
| 2-188 | 7-I | CH(CH₃)CH₂SOCH₃ | Cl | Cl | Cl | |
| 2-189 | 7-I | CH(CH₃)CH₂SO₂CH₃ | Cl | Cl | Cl | |
| 2-190 | 7-I | CH(CH₃)₂ | CH₃ | H | OCF₃ | |
| 2-191 | 7-I | C(CH₃)₂CH₂SCH₃ | CH₃ | H | OCF₃ | |
| 2-192 | 7-I | C(CH₃)₂CH₂SOCH₃ | CH₃ | H | OCF₃ | |
| 2-193 | 7-I | C(CH₃)₂CH₂SO₂CH₃ | CH₃ | H | OCF₃ | |
| 2-194 | 7-I | CH(CH₃)CH₂SCH₃ | CH₃ | H | OCF₃ | |
| 2-195 | 7-I | CH(CH₃)CH₂SOCH₃ | CH₃ | H | OCF₃ | |
| 2-196 | 7-I | CH(CH₃)CH₂SO₂CH₃ | CH₃ | H | OCF₃ | |
| 2-197 | 4-F | CH(CH₃)₂ | CH₃ | H | CF(CF₃)₂ | |
| 2-198 | 4-F | C(CH₃)₂CH₂SCH₃ | CH₃ | H | CF(CF₃)₂ | |
| 2-199 | 4-F | C(CH₃)₂CH₂SOCH₃ | CH₃ | H | CF(CF₃)₂ | |
| 2-200 | 4-F | C(CH₃)₂CH₂SO₂CH₃ | CH₃ | H | CF(CF₃)₂ | |
| 2-201 | 4-F | CH(CH₃)CH₂SCH₃ | CH₃ | H | CF(CF₃)₂ | |
| 2-202 | 4-F | CH(CH₃)CH₂SOCH₃ | CH₃ | H | CF(CF₃)₂ | |
| 2-203 | 4-F | CH(CH₃)CH₂SO₂CH₃ | CH₃ | H | CF(CF₃)₂ | |
| 2-204 | 4-F | CH(CH₃)₂ | H | H | CF(CF₃)₂ | |
| 2-205 | 4-F | C(CH₃)₂CH₂SCH₃ | H | H | CF(CF₃)₂ | |
| 2-206 | 4-F | C(CH₃)₂CH₂SOCH₃ | H | H | CF(CF₃)₂ | |
| 2-207 | 4-F | C(CH₃)₂CH₂SO₂CH₃ | H | H | CF(CF₃)₂ | |
| 2-208 | 4-F | CH(CH₃)CH₂SCH₃ | H | H | CF(CF₃)₂ | |
| 2-209 | 4-F | CH(CH₃)CH₂SOCH₃ | H | H | CF(CF₃)₂ | |
| 2-210 | 4-F | CH(CH₃)CH₂SO₂CH₃ | H | H | CF(CF₃)₂ | |
| 2-211 | 4-F | CH(CH₃)₂ | Cl | Cl | Cl | |
| 2-212 | 4-F | C(CH₃)₂CH₂SCH₃ | Cl | Cl | Cl | |
| 2-213 | 4-F | C(CH₃)₂CH₂SOCH₃ | Cl | Cl | Cl | |
| 2-214 | 4-F | C(CH₃)₂CH₂SO₂CH₃ | Cl | Cl | Cl | |
| 2-215 | 4-F | CH(CH₃)CH₂SCH₃ | Cl | Cl | Cl | |
| 2-216 | 4-F | CH(CH₃)CH₂SOCH₃ | Cl | Cl | Cl | |
| 2-217 | 4-F | CH(CH₃)CH₂SO₂CH₃ | Cl | Cl | Cl | |
| 2-218 | 4-F | CH(CH₃)₂ | CH₃ | H | OCF₃ | |
| 2-219 | 4-F | C(CH₃)₂CH₂SCH₃ | CH₃ | H | OCF₃ | |
| 2-220 | 4-F | C(CH₃)₂CH₂SOCH₃ | CH₃ | H | OCF₃ | |
| 2-221 | 4-F | C(CH₃)₂CH₂SO₂CH₃ | CH₃ | H | OCF₃ | |
| 2-222 | 4-F | CH(CH₃)CH₂SCH₃ | CH₃ | H | OCF₃ | |
| 2-223 | 4-F | CH(CH₃)CH₂SOCH₃ | CH₃ | H | OCF₃ | |
| 2-224 | 4-F | CH(CH₃)CH₂SO₂CH₃ | CH₃ | H | OCF₃ | |
| 2-225 | 7-F | CH(CH₃)₂ | CH₃ | H | CF(CF₃)₂ | |
| 2-226 | 7-F | C(CH₃)₂CH₂SCH₃ | CH₃ | H | CF(CF₃)₂ | |
| 2-227 | 7-F | C(CH₃)₂CH₂SOCH₃ | CH₃ | H | CF(CF₃)₂ | |
| 2-228 | 7-F | C(CH₃)₂CH₂SO₂CH₃ | CH₃ | H | CF(CF₃)₂ | |
| 2-229 | 7-F | CH(CH₃)CH₂SCH₃ | CH₃ | H | CF(CF₃)₂ | |
| 2-230 | 7-F | CH(CH₃)CH₂SOCH₃ | CH₃ | H | CF(CF₃)₂ | |
| 2-231 | 7-F | CH(CH₃)CH₂SO₂CH₃ | CH₃ | H | CF(CF₃)₂ | |
| 2-232 | 7-F | CH(CH₃)₂ | H | H | CF(CF₃)₂ | |
| 2-233 | 7-F | C(CH₃)₂CH₂SCH₃ | H | H | CF(CF₃)₂ | |
| 2-234 | 7-F | C(CH₃)₂CH₂SOCH₃ | H | H | CF(CF₃)₂ | |
| 2-235 | 7-F | C(CH₃)₂CH₂SO₂CH₃ | H | H | CF(CF₃)₂ | |
| 2-236 | 7-F | CH(CH₃)CH₂SCH₃ | H | H | CF(CF₃)₂ | |
| 2-237 | 7-F | CH(CH₃)CH₂SOCH₃ | H | H | CF(CF₃)₂ | |
| 2-238 | 7-F | CH(CH₃)CH₂SO₂CH₃ | H | H | CF(CF₃)₂ | |
| 2-239 | 7-F | CH(CH₃)₂ | Cl | Cl | Cl | |
| 2-240 | 7-F | C(CH₃)₂CH₂SCH₃ | Cl | Cl | Cl | |
| 2-241 | 7-F | C(CH₃)₂CH₂SOCH₃ | Cl | Cl | Cl | |
| 2-242 | 7-F | C(CH₃)₂CH₂SO₂CH₃ | Cl | Cl | Cl | |
| 2-243 | 7-F | CH(CH₃)CH₂SCH₃ | Cl | Cl | Cl | |
| 2-244 | 7-F | CH(CH₃)CH₂SOCH₃ | Cl | Cl | Cl | |
| 2-245 | 7-F | CH(CH₃)CH₂SO₂CH₃ | Cl | Cl | Cl | |
| 2-246 | 7-F | CH(CH₃)₂ | CH₃ | H | OCF₃ | |
| 2-247 | 7-F | C(CH₃)₂CH₂SCH₃ | CH₃ | H | OCF₃ | |
| 2-248 | 7-F | C(CH₃)₂CH₂SOCH₃ | CH₃ | H | OCF₃ | |
| 2-249 | 7-F | C(CH₃)₂CH₂SO₂CH₃ | CH₃ | H | OCF₃ | |
| 2-250 | 7-F | CH(CH₃)CH₂SCH₃ | CH₃ | H | OCF₃ | |
| 2-251 | 7-F | CH(CH₃)CH₂SOCH₃ | CH₃ | H | OCF₃ | |
| 2-252 | 7-F | CH(CH₃)CH₂SO₂CH₃ | CH₃ | H | OCF₃ | |
| 2-253 | 4-NO₂ | CH(CH₃)₂ | CH₃ | H | CF(CF₃)₂ | |
| 2-254 | 4-NO₂ | C(CH₃)₂CH₂SCH₃ | CH₃ | H | CF(CF₃)₂ | |
| 2-255 | 4-NO₂ | C(CH₃)₂CH₂SOCH₃ | CH₃ | H | CF(CF₃)₂ | |
| 2-256 | 4-NO₂ | C(CH₃)₂CH₂SO₂CH₃ | CH₃ | H | CF(CF₃)₂ | |
| 2-257 | 4-NO₂ | CH(CH₃)CH₂SCH₃ | CH₃ | H | CF(CF₃)₂ | |
| 2-258 | 4-NO₂ | CH(CH₃)CH₂SOCH₃ | CH₃ | H | CF(CF₃)₂ | |
| 2-259 | 4-NO₂ | CH(CH₃)CH₂SO₂CH₃ | CH₃ | H | CF(CF₃)₂ | |
| 2-260 | 4-NO₂ | CH(CH₃)₂ | H | H | CF(CF₃)₂ | |
| 2-261 | 4-NO₂ | C(CH₃)₂CH₂SCH₃ | H | H | CF(CF₃)₂ | |
| 2-262 | 4-NO₂ | C(CH₃)₂CH₂SOCH₃ | H | H | CF(CF₃)₂ | |
| 2-263 | 4-NO₂ | C(CH₃)₂CH₂SO₂CH₃ | H | H | CF(CF₃)₂ | |
| 2-264 | 4-NO₂ | CH(CH₃)CH₂SCH₃ | H | H | CF(CF₃)₂ | |
| 2-265 | 4-NO₂ | CH(CH₃)CH₂SOCH₃ | H | H | CF(CF₃)₂ | |
| 2-266 | 4-NO₂ | CH(CH₃)CH₂SO₂CH₃ | H | H | CF(CF₃)₂ | |
| 2-267 | 4-NO₂ | CH(CH₃)₂ | Cl | Cl | Cl | |
| 2-268 | 4-NO₂ | C(CH₃)₂CH₂SCH₃ | Cl | Cl | Cl | |
| 2-269 | 4-NO₂ | C(CH₃)₂CH₂SOCH₃ | Cl | Cl | Cl | |
| 2-270 | 4-NO₂ | C(CH₃)₂CH₂SO₂CH₃ | Cl | Cl | Cl | |
| 2-271 | 4-NO₂ | CH(CH₃)CH₂SCH₃ | Cl | Cl | Cl | |
| 2-272 | 4-NO₂ | CH(CH₃)CH₂SOCH₃ | Cl | Cl | Cl | |
| 2-273 | 4-NO₂ | CH(CH₃)CH₂SO₂CH₃ | Cl | Cl | Cl | |
| 2-274 | 4-NO₂ | CH(CH₃)₂ | CH₃ | H | OCF₃ | |
| 2-275 | 4-NO₂ | C(CH₃)₂CH₂SCH₃ | CH₃ | H | OCF₃ | |
| 2-276 | 4-NO₂ | C(CH₃)₂CH₂SOCH₃ | CH₃ | H | OCF₃ | |
| 2-277 | 4-NO₂ | C(CH₃)₂CH₂SO₂CH₃ | CH₃ | H | OCF₃ | |
| 2-278 | 4-NO₂ | CH(CH₃)CH₂SCH₃ | CH₃ | H | OCF₃ | |
| 2-279 | 4-NO₂ | CH(CH₃)CH₂SOCH₃ | CH₃ | H | OCF₃ | |
| 2-280 | 4-NO₂ | CH(CH₃)CH₂SO₂CH₃ | CH₃ | H | OCF₃ | |
| 2-281 | 7-NO₂ | CH(CH₃)₂ | CH₃ | H | CF(CF₃)₂ | |
| 2-282 | 7-NO₂ | C(CH₃)₂CH₂SCH₃ | CH₃ | H | CF(CF₃)₂ | |
| 2-283 | 7-NO₂ | C(CH₃)₂CH₂SOCH₃ | CH₃ | H | CF(CF₃)₂ | |
| 2-284 | 7-NO₂ | C(CH₃)₂CH₂SO₂CH₃ | CH₃ | H | CF(CF₃)₂ | |
| 2-285 | 7-NO₂ | CH(CH₃)CH₂SCH₃ | CH₃ | H | CF(CF₃)₂ | |
| 2-286 | 7-NO₂ | CH(CH₃)CH₂SOCH₃ | CH₃ | H | CF(CF₃)₂ | |
| 2-287 | 7-NO₂ | CH(CH₃)CH₂SO₂CH₃ | CH₃ | H | CF(CF₃)₂ | |
| 2-288 | 7-NO₂ | CH(CH₃)₂ | H | H | CF(CF₃)₂ | |
| 2-289 | 7-NO₂ | C(CH₃)₂CH₂SCH₃ | H | H | CF(CF₃)₂ | |
| 2-290 | 7-NO₂ | C(CH₃)₂CH₂SOCH₃ | H | H | CF(CF₃)₂ | |
| 2-291 | 7-NO₂ | C(CH₃)₂CH₂SO₂CH₃ | H | H | CF(CF₃)₂ | |
| 2-292 | 7-NO₂ | CH(CH₃)CH₂SCH₃ | H | H | CF(CF₃)₂ | |
| 2-293 | 7-NO₂ | CH(CH₃)CH₂SOCH₃ | H | H | CF(CF₃)₂ | |
| 2-294 | 7-NO₂ | CH(CH₃)CH₂SO₂CH₃ | H | H | CF(CF₃)₂ | |
| 2-295 | 7-NO₂ | CH(CH₃)₂ | Cl | Cl | Cl | |
| 2-296 | 7-NO₂ | C(CH₃)₂CH₂SCH₃ | Cl | Cl | Cl | |
| 2-297 | 7-NO₂ | C(CH₃)₂CH₂SOCH₃ | Cl | Cl | Cl | |
| 2-298 | 7-NO₂ | C(CH₃)₂CH₂SO₂CH₃ | Cl | Cl | Cl | |
| 2-299 | 7-NO₂ | CH(CH₃)CH₂SCH₃ | Cl | Cl | Cl | |
| 2-300 | 7-NO₂ | CH(CH₃)CH₂SOCH₃ | Cl | Cl | Cl | |
| 2-301 | 7-NO₂ | CH(CH₃)CH₂SO₂CH₃ | Cl | Cl | Cl | |
| 2-302 | 7-NO₂ | CH(CH₃)₂ | CH₃ | H | OCF₃ | |
| 2-303 | 7-NO₂ | C(CH₃)₂CH₂SCH₃ | CH₃ | H | OCF₃ | |
| 2-304 | 7-NO₂ | C(CH₃)₂CH₂SOCH₃ | CH₃ | H | OCF₃ | |
| 2-305 | 7-NO₂ | C(CH₃)₂CH₂SO₂CH₃ | CH₃ | H | OCF₃ | |
| 2-306 | 7-NO₂ | CH(CH₃)CH₂SCH₃ | CH₃ | H | OCF₃ | |
| 2-307 | 7-NO₂ | CH(CH₃)CH₂SOCH₃ | CH₃ | H | OCF₃ | |
| 2-308 | 7-NO₂ | CH(CH₃)CH₂SO₂CH₃ | CH₃ | H | OCF₃ | |
| 2-309 | 4-CF₃ | CH(CH₃)₂ | CH₃ | H | CF(CF₃)₂ | |
| 2-310 | 4-CF₃ | C(CH₃)₂CH₂SCH₃ | CH₃ | H | CF(CF₃)₂ | |
| 2-311 | 4-CF₃ | C(CH₃)₂CH₂SOCH₃ | CH₃ | H | CF(CF₃)₂ | |
| 2-312 | 4-CF₃ | C(CH₃)₂CH₂SO₂CH₃ | CH₃ | H | CF(CF₃)₂ | |
| 2-313 | 4-CF₃ | CH(CH₃)CH₂SCH₃ | CH₃ | H | CF(CF₃)₂ | |
| 2-314 | 4-CF₃ | CH(CH₃)CH₂SOCH₃ | CH₃ | H | CF(CF₃)₂ | |
| 2-315 | 4-CF₃ | CH(CH₃)CH₂SO₂CH₃ | CH₃ | H | CF(CF₃)₂ | |
| 2-316 | 4-CF₃ | CH(CH₃)₂ | H | H | CF(CF₃)₂ | |
| 2-317 | 4-CF₃ | C(CH₃)₂CH₂SCH₃ | H | H | CF(CF₃)₂ | |
| 2-318 | 4-CF₃ | C(CH₃)₂CH₂SOCH₃ | H | H | CF(CF₃)₂ | |
| 2-319 | 4-CF₃ | C(CH₃)₂CH₂SO₂CH₃ | H | H | CF(CF₃)₂ | |
| 2-320 | 4-CF₃ | CH(CH₃)CH₂SCH₃ | H | H | CF(CF₃)₂ | |
| 2-321 | 4-CF₃ | CH(CH₃)CH₂SOCH₃ | H | H | CF(CF₃)₂ | |
| 2-322 | 4-CF₃ | CH(CH₃)CH₂SO₂CH₃ | H | H | CF(CF₃)₂ | |
| 2-323 | 4-CF₃ | CH(CH₃)₂ | Cl | Cl | Cl | |
| 2-324 | 4-CF₃ | C(CH₃)₂CH₂SCH₃ | Cl | Cl | Cl | |
| 2-325 | 4-CF₃ | C(CH₃)₂CH₂SOCH₃ | Cl | Cl | Cl | |
| 2-326 | 4-CF₃ | C(CH₃)₂CH₂SO₂CH₃ | Cl | Cl | Cl | |
| 2-327 | 4-CF₃ | CH(CH₃)CH₂SCH₃ | Cl | Cl | Cl | |
| 2-328 | 4-CF₃ | CH(CH₃)CH₂SOCH₃ | Cl | Cl | Cl | |
| 2-329 | 4-CF₃ | CH(CH₃)CH₂SO₂CH₃ | Cl | Cl | Cl | |
| 2-330 | 4-CF₃ | CH(CH₃)₂ | CH₃ | H | OCF₃ | |
| 2-331 | 4-CF₃ | C(CH₃)₂CH₂SCH₃ | CH₃ | H | OCF₃ | |
| 2-332 | 4-CF₃ | C(CH₃)₂CH₂SOCH₃ | CH₃ | H | OCF₃ | |
| 2-333 | 4-CF₃ | C(CH₃)₂CH₂SO₂CH₃ | CH₃ | H | OCF₃ | |
| 2-334 | 4-CF₃ | CH(CH₃)CH₂SCH₃ | CH₃ | H | OCF₃ | |
| 2-335 | 4-CF₃ | CH(CH₃)CH₂SOCH₃ | CH₃ | H | OCF₃ | |
| 2-336 | 4-CF₃ | CH(CH₃)CH₂SO₂CH₃ | CH₃ | H | OCF₃ | |
| 2-337 | 7-CF₃ | CH(CH₃)₂ | CH₃ | H | CF(CF₃)₂ | |
| 2-338 | 7-CF₃ | C(CH₃)₂CH₂SCH₃ | CH₃ | H | CF(CF₃)₂ | |
| 2-339 | 7-CF₃ | C(CH₃)₂CH₂SOCH₃ | CH₃ | H | CF(CF₃)₂ | |
| 2-340 | 7-CF₃ | C(CH₃)₂CH₂SO₂CH₃ | CH₃ | H | CF(CF₃)₂ | |
| 2-341 | 7-CF₃ | CH(CH₃)CH₂SCH₃ | CH₃ | H | CF(CF₃)₂ | |
| 2-342 | 7-CF₃ | CH(CH₃)CH₂SOCH₃ | CH₃ | H | CF(CF₃)₂ | |
| 2-343 | 7-CF₃ | CH(CH₃)CH₂SO₂CH₃ | CH₃ | H | CF(CF₃)₂ | |
| 2-344 | 7-CF₃ | CH(CH₃)CH₂ | H | H | CF(CF₃)₂ | |
| 2-345 | 7-CF₃ | C(CH₃)₂CH₂SCH₃ | H | H | CF(CF₃)₂ | |
| 2-346 | 7-CF₃ | C(CH₃)₂CH₂SOCH₃ | H | H | CF(CF₃)₂ | |
| 2-347 | 7-CF₃ | C(CH₃)₂CH₂SO₂CH₃ | H | H | CF(CF₃)₂ | |
| 2-348 | 7-CF₃ | CH(CH₃)CH₂SCH₃ | H | H | CF(CF₃)₂ | |
| 2-349 | 7-CF₃ | CH(CH₃)CH₂SOCH₃ | H | H | CF(CF₃)₂ | |
| 2-350 | 7-CF₃ | CH(CH₃)CH₂SO₂CH₃ | H | H | CF(CF₃)₂ | |
| 2-351 | 7-CF₃ | CH(CH₃)₂ | Cl | Cl | Cl | |
| 2-352 | 7-CF₃ | C(CH₃)₂CH₂SCH₃ | Cl | Cl | Cl | |
| 2-353 | 7-CF₃ | C(CH₃)₂CH₂SOCH₃ | Cl | Cl | Cl | |
| 2-354 | 7-CF₃ | C(CH₃)₂CH₂SO₂CH₃ | Cl | Cl | Cl | |
| 2-355 | 7-CF₃ | CH(CH₃)CH₂SCH₃ | Cl | Cl | Cl | |
| 2-356 | 7-CF₃ | CH(CH₃)CH₂SOCH₃ | Cl | Cl | Cl | |
| 2-357 | 7-CF₃ | CH(CH₃)CH₂SO₂CH₃ | Cl | Cl | Cl | |
| 2-358 | 7-CF₃ | CH(CH₃)₂ | CH₃ | H | OCF₃ | |
| 2-359 | 7-CF₃ | C(CH₃)₂CH₂SCH₃ | CH₃ | H | OCF₃ | |
| 2-360 | 7-CF₃ | C(CH₃)₂CH₂SOCH₃ | CH₃ | H | OCF₃ | |
| 2-361 | 7-CF₃ | C(CH₃)₂CH₂SO₂CH₃ | CH₃ | H | OCF₃ | |
| 2-362 | 7-CF₃ | CH(CH₃)CH₂SCH₃ | CH₃ | H | OCF₃ | |
| 2-363 | 7-CF₃ | CH(CH₃)CH₂SOCH₃ | CH₃ | H | OCF₃ | |
| 2-364 | 7-CF₃ | CH(CH₃)CH₂SO₂CH₃ | CH₃ | H | OCF₃ | |
| 2-365 | 4-CH₃ | CH(CH₃)₂ | CH₃ | H | CF(CF₃)₂ | |
| 2-366 | 4-CH₃ | C(CH₃)₂CH₂SCH₃ | CH₃ | H | CF(CF₃)₂ | |
| 2-367 | 4-CH₃ | C(CH₃)₂CH₂SOCH₃ | CH₃ | H | CF(CF₃)₂ | |
| 2-368 | 4-CH₃ | C(CH₃)₂CH₂SO₂CH₃ | CH₃ | H | CF(CF₃)₂ | |
| 2-369 | 4-CH₃ | CH(CH₃)CH₂SCH₃ | CH₃ | H | CF(CF₃)₂ | |
| 2-370 | 4-CH₃ | CH(CH₃)CH₂SOCH₃ | CH₃ | H | CF(CF₃)₂ | |
| 2-371 | 4-CH₃ | CH(CH₃)CH₂SO₂CH₃ | CH₃ | H | CF(CF₃)₂ | |
| 2-372 | 4-CH₃ | CH(CH₃)₂ | H | H | CF(CF₃)₂ | |
| 2-373 | 4-CH₃ | C(CH₃)₂CH₂SCH₃ | H | H | CF(CF₃)₂ | |
| 2-374 | 4-CH₃ | C(CH₃)₂CH₂SOCH₃ | H | H | CF(CF₃)₂ | |
| 2-375 | 4-CH₃ | C(CH₃)₂CH₂SO₂CH₃ | H | H | CF(CF₃)₂ | |
| 2-376 | 4-CH₃ | CH(CH₃)CH₂SCH₃ | H | H | CF(CF₃)₂ | |
| 2-377 | 4-CH₃ | CH(CH₃)CH₂SOCH₃ | H | H | CF(CF₃)₂ | |
| 2-378 | 4-CH₃ | CH(CH₃)CH₂SO₂CH₃ | H | H | CF(CF₃)₂ | |
| 2-379 | 4-CH₃ | CH(CH₃)₂ | Cl | Cl | Cl | |
| 2-380 | 4-CH₃ | C(CH₃)₂CH₂SCH₃ | Cl | Cl | Cl | |
| 2-381 | 4-CH₃ | C(CH₃)₂CH₂SOCH₃ | Cl | Cl | Cl | |
| 2-382 | 4-CH₃ | C(CH₃)₂CH₂SO₂CH₃ | Cl | Cl | Cl | |
| 2-383 | 4-CH₃ | CH(CH₃)CH₂SCH₃ | Cl | Cl | Cl | |
| 2-384 | 4-CH₃ | CH(CH₃)CH₂SOCH₃ | Cl | Cl | Cl | |
| 2-385 | 4-CH₃ | CH(CH₃)CH₂SO₂CH₃ | Cl | Cl | Cl | |
| 2-386 | 4-CH₃ | CH(CH₃)₂ | CH₃ | H | OCF₃ | |
| 2-387 | 4-CH₃ | C(CH₃)₂CH₂SCH₃ | CH₃ | H | OCF₃ | |
| 2-388 | 4-CH₃ | C(CH₃)₂CH₂SOCH₃ | CH₃ | H | OCF₃ | |
| 2-389 | 4-CH₃ | C(CH₃)₂CH₂SO₂CH₃ | CH₃ | H | OCF₃ | |
| 2-390 | 4-CH₃ | CH(CH₃)CH₂SCH₃ | CH₃ | H | OCF₃ | |
| 2-391 | 4-CH₃ | CH(CH₃)CH₂SOCH₃ | CH₃ | H | OCF₃ | |
| 2-392 | 4-CH₃ | CH(CH₃)CH₂SO₂CH₃ | CH₃ | H | OCF₃ | |
| 2-393 | 7-CH₃ | CH(CH₃)₂ | CH₃ | H | CF(CF₃)₂ | |
| 2-394 | 7-CH₃ | C(CH₃)₂CH₂SCH₃ | CH₃ | H | CF(CF₃)₂ | |
| 2-395 | 7-CH₃ | C(CH₃)₂CH₂SOCH₃ | CH₃ | H | CF(CF₃)₂ | |
| 2-396 | 7-CH₃ | C(CH₃)₂CH₂SO₂CH₃ | CH₃ | H | CF(CF₃)₂ | |
| 2-397 | 7-CH₃ | CH(CH₃)CH₂SCH₃ | CH₃ | H | CF(CF₃)₂ | |
| 2-398 | 7-CH₃ | CH(CH₃)CH₂SOCH₃ | CH₃ | H | CF(CF₃)₂ | |
| 2-399 | 7-CH₃ | CH(CH₃)CH₂SO₂CH₃ | CH₃ | H | CF(CF₃)₂ | |
| 2-400 | 7-CH₃ | CH(CH₃)₂ | H | H | CF(CF₃)₂ | |
| 2-401 | 7-CH₃ | C(CH₃)₂CH₂SCH₃ | H | H | CF(CF₃)₂ | |
| 2-402 | 7-CH₃ | C(CH₃)₂CH₂SOCH₃ | H | H | CF(CF₃)₂ | |
| 2-403 | 7-CH₃ | C(CH₃)₂CH₂SO₂CH₃ | H | H | CF(CF₃)₂ | |
| 2-404 | 7-CH₃ | CH(CH₃)CH₂SCH₃ | H | H | CF(CF₃)₂ | |
| 2-405 | 7-CH₃ | CH(CH₃)CH₂SOCH₃ | H | H | CF(CF₃)₂ | |
| 2-406 | 7-CH₃ | CH(CH₃)CH₂SO₂CH₃ | H | H | CF(CF₃)₂ | |
| 2-407 | 7-CH₃ | CH(CH₃)₂ | Cl | Cl | Cl | |
| 2-408 | 7-CH₃ | C(CH₃)₂CH₂SCH₃ | Cl | Cl | Cl | |
| 2-409 | 7-CH₃ | C(CH₃)₂CH₂SOCH₃ | Cl | Cl | Cl | |
| 2-410 | 7-CH₃ | C(CH₃)₂CH₂SO₂CH₃ | Cl | Cl | Cl | |
| 2-411 | 7-CH₃ | CH(CH₃)CH₂SCH₃ | Cl | Cl | Cl | |
| 2-412 | 7-CH₃ | CH(CH₃)CH₂SOCH₃ | Cl | Cl | Cl | |
| 2-413 | 7-CH₃ | CH(CH₃)CH₂SO₂CH₃ | Cl | Cl | Cl | |
| 2-414 | 7-CH₃ | CH(CH₃)₂ | CH₃ | H | OCF₃ | |
| 2-415 | 7-CH₃ | C(CH₃)₂CH₂SCH₃ | CH₃ | H | OCF₃ | |
| 2-416 | 7-CH₃ | C(CH₃)₂CH₂SOCH₃ | CH₃ | H | OCF₃ | |
| 2-417 | 7-CH₃ | C(CH₃)₂CH₂SO₂CH₃ | CH₃ | H | OCF₃ | |
| 2-418 | 7-CH₃ | CH(CH₃)CH₂SCH₃ | CH₃ | H | OCF₃ | |
| 2-419 | 7-CH₃ | CH(CH₃)CH₂SOCH₃ | CH₃ | H | OCF₃ | |
| 2-420 | 7-CH₃ | CH(CH₃)CH₂SO₂CH₃ | CH₃ | H | OCF₃ | |
| 2-421 | 4-OCF₃ | CH(CH₃)₂ | CH₃ | H | CF(CF₃)₂ | |
| 2-422 | 4-OCF₃ | C(CH₃)₂CH₂SCH₃ | CH₃ | H | CF(CF₃)₂ | |
| 2-423 | 4-OCF₃ | C(CH₃)₂CH₂SOCH₃ | CH₃ | H | CF(CF₃)₂ | |
| 2-424 | 4-OCF₃ | C(CH₃)₂CH₂SO₂CH₃ | CH₃ | H | CF(CF₃)₂ | |
| 2-425 | 4-OCF₃ | CH(CH₃)CH₂SCH₃ | CH₃ | H | CF(CF₃)₂ | |
| 2-426 | 4-OCF₃ | CH(CH₃)CH₂SOCH₃ | CH₃ | H | CF(CF₃)₂ | |
| 2-427 | 4-OCF₃ | CH(CH₃)CH₂SO₂CH₃ | CH₃ | H | CF(CF₃)₂ | |
| 2-428 | 4-OCF₃ | CH(CH₃)₂ | H | H | CF(CF₃)₂ | |
| 2-429 | 4-OCF₃ | C(CH₃)₂CH₂SCH₃ | H | H | CF(CF₃)₂ | |
| 2-430 | 4-OCF₃ | C(CH₃)₂CH₂SOCH₃ | H | H | CF(CF₃)₂ | |
| 2-431 | 4-OCF₃ | C(CH₃)₂CH₂SO₂CH₃ | H | H | CF(CF₃)₂ | |
| 2-432 | 4-OCF₃ | CH(CH₃)CH₂SCH₃ | H | H | CF(CF₃)₂ | |
| 2-433 | 4-OCF₃ | CH(CH₃)CH₂SOCH₃ | H | H | CF(CF₃)₂ | |
| 2-434 | 4-OCF₃ | CH(CH₃)CH₂SO₂CH₃ | H | H | CF(CF₃)₂ | |
| 2-435 | 4-OCF₃ | CH(CH₃)₂ | Cl | Cl | Cl | |
| 2-436 | 4-OCF₃ | CH(CH₃)₂CH₂SCH₃ | Cl | Cl | Cl | |
| 2-437 | 4-OCF₃ | C(CH₃)₂CH₂SOCH₃ | Cl | Cl | Cl | |
| 2-438 | 4-OCF₃ | C(CH₃)₂CH₂SO₂CH₃ | Cl | Cl | Cl | |
| 2-439 | 4-OCF₃ | CH(CH₃)CH₂SCH₃ | Cl | Cl | Cl | |
| 2-440 | 4-OCF₃ | CH(CH₃)CH₂SOCH₃ | Cl | Cl | Cl | |
| 2-441 | 4-OCF₃ | CH(CH₃)CH₂SO₂CH₃ | Cl | Cl | Cl | |
| 2-442 | 4-OCF₃ | CH(CH₃)₂ | CH₃ | H | OCF₃ | |
| 2-443 | 4-OCF₃ | C(CH₃)₂CH₂SCH₃ | CH₃ | H | OCF₃ | |
| 2-444 | 4-OCF₃ | C(CH₃)₂CH₂SOCH₃ | CH₃ | H | OCF₃ | |
| 2-445 | 4-OCF₃ | C(CH₃)₂CH₂SO₂CH₃ | CH₃ | H | OCF₃ | |
| 2-446 | 4-OCF₃ | CH(CH₃)CH₂SCH₃ | CH₃ | H | OCF₃ | |
| 2-447 | 4-OCF₃ | CH(CH₃)CH₂SOCH₃ | CH₃ | H | OCF₃ | |
| 2-448 | 4-OCF₃ | CH(CH₃)CH₂SO₂CH₃ | CH₃ | H | OCF₃ | |
| 2-449 | 7-OCF₃ | CH(CH₃)₂ | CH₃ | H | CF(CF₃)₂ | |
| 2-450 | 7-OCF₃ | C(CH₃)₂CH₂SCH₃ | CH₃ | H | CF(CF₃)₂ | |
| 2-451 | 7-OCF₃ | C(CH₃)₂CH₂SOCH₃ | CH₃ | H | CF(CF₃)₂ | |
| 2-452 | 7-OCF₃ | C(CH₃)₂CH₂SO₂CH₃ | CH₃ | H | CF(CF₃)₂ | |
| 2-453 | 7-OCF₃ | CH(CH₃)CH₂SCH₃ | CH₃ | H | CF(CF₃)₂ | |
| 2-454 | 7-OCF₃ | CH(CH₃)CH₂SOCH₃ | CH₃ | H | CF(CF₃)₂ | |
| 2-455 | 7-OCF₃ | CH(CH₃)CH₂SO₂CH₃ | CH₃ | H | CF(CF₃)₂ | |
| 2-456 | 7-OCF₃ | CH(CH₃)₂ | H | H | CF(CF₃)₂ | |
| 2-457 | 7-OCF₃ | C(CH₃)₂CH₂SCH₃ | H | H | CF(CF₃)₂ | |
| 2-458 | 7-OCF₃ | C(CH₃)₂CH₂SOCH₃ | H | H | CF(CF₃)₂ | |
| 2-459 | 7-OCF₃ | C(CH₃)₂CH₂SO₂CH₃ | H | H | CF(CF₃)₂ | |
| 2-460 | 7-OCF₃ | CH(CH₃)CH₂SCH₃ | H | H | CF(CF₃)₂ | |
| 2-461 | 7-OCF₃ | CH(CH₃)CH₂SOCH₃ | H | H | CF(CF₃)₂ | |
| 2-462 | 7-OCF₃ | CH(CH₃)CH₂SO₂CH₃ | H | H | CF(CF₃)₂ | |
| 2-463 | 7-OCF₃ | CH(CH₃)₂ | Cl | Cl | Cl | |
| 2-464 | 7-OCF₃ | C(CH₃)₂CH₂SCH₃ | Cl | Cl | Cl | |
| 2-465 | 7-OCF₃ | C(CH₃)₂CH₂SOCH₃ | Cl | Cl | Cl | |
| 2-466 | 7-OCF₃ | C(CH₃)₂CH₂SO₂CH₃ | Cl | Cl | Cl | |
| 2-467 | 7-OCF₃ | CH(CH₃)CH₂SCH₃ | Cl | Cl | Cl | |
| 2-468 | 7-OCF₃ | CH(CH₃)CH₂SOCH₃ | Cl | Cl | Cl | |
| 2-469 | 7-OCF₃ | CH(CH₃)CH₂SO₂CH₃ | Cl | Cl Cl | | |
| 2-470 | 7-OCF₃ | CH(CH₃)₂ | CH₃ | H | OCF₃ | |
| 2-471 | 7-OCF₃ | C(CH₃)₂CH₂SCH₃ | CH₃ | H | OCF₃ | |
| 2-472 | 7-OCF₃ | C(CH₃)₂CH₂SOCH₃ | CH₃ | H | OCF₃ | |
| 2-473 | 7-OCF₃ | C(CH₃)₂CH₂SO₂CH₃ | CH₃ | H | OCF₃ | |
| 2-474 | 7-OCF₃ | CH(CH₃)CH₂SCH₃ | CH₃ | H | OCF₃ | |
| 2-475 | 7-OCF₃ | CH(CH₃)CH₂SOCH₃ | CH₃ | H | OCF₃ | |
| 2-476 | 7-OCF₃ | CH(CH₃)CH₂SO₂CH₃ | CH₃ | H | OCF₃ | |
| 2-477 | 4-OCH₃ | CH(CH₃)₂ | CH₃ | H | CF(CF₃)₂ | |
| 2-478 | 4-OCH₃ | C(CH₃)₂CH₂SCH₃ | CH₃ | H | CF(CF₃)₂ | |
| 2-479 | 4-OCH₃ | C(CH₃)₂CH₂SOCH₃ | CH₃ | H | CF(CF₃)₂ | |
| 2-480 | 4-OCH₃ | C(CH₃)₂CH₂SO₂CH₃ | CH₃ | H | CF(CF₃)₂ | |
| 2-481 | 4-OCH₃ | CH(CH₃)CH₂SCH₃ | CH₃ | H | CF(CF₃)₂ | |
| 2-482 | 4-OCH₃ | CH(CH₃)CH₂SOCH₃ | CH₃ | H | CF(CF₃)₂ | |
| 2-483 | 4-OCH₃ | CH(CH₃)CH₂SO₂CH₃ | CH₃ | H | CF(CF₃)₂ | |
| 2-484 | 4-OCH₃ | CH(CH₃)₂ | H | H | CF(CF₃)₂ | |
| 2-485 | 4-OCH₃ | C(CH₃)₂CH₂SCH₃ | H | H | CF(CF₃)₂ | |
| 2-486 | 4-OCH₃ | C(CH₃)₂CH₂SOCH₃ | H | H | CF(CF₃)₂ | |
| 2-487 | 4-OCH₃ | C(CH₃)₂CH₂SO₂CH₃ | H | H | CF(CF₃)₂ | |
| 2-488 | 4-OCH₃ | CH(CH₃)CH₂SCH₃ | H | H | CF(CF₃)₂ | |
| 2-489 | 4-OCH₃ | CH(CH₃)CH₂SOCH₃ | H | H | CF(CF₃)₂ | |
| 2-490 | 4-OCH₃ | CH(CH₃)CH₂SO₂CH₃ | H | H | CF(CF₃)₂ | |
| 2-491 | 4-OCH₃ | CH(CH₃)₂ | Cl | Cl | Cl | |
| 2-492 | 4-OCH₃ | C(CH₃)₂CH₂SCH₃ | Cl | Cl | Cl | |
| 2-493 | 4-OCH₃ | C(CH₃)₂CH₂SOCH₃ | Cl | Cl | Cl | |
| 2-494 | 4-OCH₃ | C(CH₃)₂CH₂SO₂CH₃ | Cl | Cl | Cl | |
| 2-495 | 4-OCH₃ | CH(CH₃)CH₂SCH₃ | Cl | Cl | Cl | |
| 2-496 | 4-OCH₃ | CH(CH₃)CH₂SOCH₃ | Cl | Cl | Cl | |
| 2-497 | 4-OCH₃ | CH(CH₃)CH₂SO₂CH₃ | Cl | Cl | Cl | |
| 2-498 | 4-OCH₃ | CH(CH₃)₂ | CH₃ | H | OCF₃ | |
| 2-499 | 4-OCH₃ | C(CH₃)₂CH₂SCH₃ | CH₃ | H | OCF₃ | |
| 2-500 | 4-OCH₃ | C(CH₃)₂CH₂SOCH₃ | CH₃ | H | OCF₃ | |
| 2-501 | 4-OCH₃ | C(CH₃)₂CH₂SO₂CH₃ | CH₃ | H | OCF₃ | |
| 2-502 | 4-OCH₃ | CH(CH₃)CH₂SCH₃ | CH₃ | H | OCF₃ | |
| 2-503 | 4-OCH₃ | CH(CH₃)CH₂SOCH₃ | CH₃ | H | OCF₃ | |
| 2-504 | 4-OCH₃ | CH(CH₃)CH₂SO₂CH₃ | CH₃ | H | OCF₃ | |
| 2-505 | 7-OCH₃ | CH(CH₃)₂ | CH₃ | H | CF(CF₃)₂ | |
| 2-506 | 7-OCH₃ | C(CH₃)₂CH₂SCH₃ | CH₃ | H | CF(CF₃)₂ | |
| 2-507 | 7-OCH₃ | C(CH₃)₂CH₂SOCH₃ | CH₃ | H | CF(CF₃)₂ | |
| 2-508 | 7-OCH₃ | C(CH₃)₂CH₂SO₂CH₃ | CH₃ | H | CF(CF₃)₂ | |
| 2-509 | 7-OCH₃ | CH(CH₃)CH₂SCH₃ | CH₃ | H | CF(CF₃)₂ | |
| 2-510 | 7-OCH₃ | CH(CH₃)CH₂SOCH₃ | CH₃ | H | CF(CF₃)₂ | |
| 2-511 | 7-OCH₃ | CH(CH₃)CH₂SO₂CH₃ | CH₃ | H | CF(CF₃)₂ | |
| 2-512 | 7-OCH₃ | CH(CH₃)₂ | H | H | CF(CF₃)₂ | |
| 2-513 | 7-OCH₃ | C(CH₃)₂CH₂SCH₃ | H | H | CF(CF₃)₂ | |
| 2-514 | 7-OCH₃ | C(CH₃)₂CH₂SOCH₃ | H | H | CF(CF₃)₂ | |
| 2-515 | 7-OCH₃ | C(CH₃)₂CH₂SO₂CH₃ | H | H | CF(CF₃)₂ | |
| 2-516 | 7-OCH₃ | CH(CH₃)CH₂SCH₃ | H | H | CF(CF₃)₂ | |
| 2-517 | 7-OCH₃ | CH(CH₃)CH₂SOCH₃ | H | H | CF(CF₃)₂ | |
| 2-518 | 7-OCH₃ | CH(CH₃)CH₂SO₂CH₃ | H | H | CF(CF₃)₂ | |
| 2-519 | 7-OCH₃ | CH(CH₃)₂ | Cl | Cl | Cl | |
| 2-520 | 7-OCH₃ | C(CH₃)₂CH₂SCH₃ | Cl | Cl | Cl | |
| 2-521 | 7-OCH₃ | C(CH₃)₂CH₂SOCH₃ | Cl | Cl | Cl | |
| 2-522 | 7-OCH₃ | C(CH₃)₂CH₂SO₂CH₃ | Cl | Cl | Cl | |
| 2-523 | 7-OCH₃ | CH(CH₃)CH₂SCH₃ | Cl | Cl | Cl | |
| 2-524 | 7-OCH₃ | CH(CH₃)CH₂SOCH₃ | Cl | Cl | Cl | |
| 2-525 | 7-OCH₃ | CH(CH₃)CH₂SO₂CH₃ | Cl | Cl | Cl | |
| 2-526 | 7-OCH₃ | CH(CH₃)₂ | CH₃ | H | OCF₃ | |
| 2-527 | 7-OCH₃ | C(CH₃)₂CH₂SCH₃ | CH₃ | H | OCF₃ | |
| 2-528 | 7-OCH₃ | C(CH₃)₂CH₂SOCH₃ | CH₃ | H | OCF₃ | |
| 2-529 | 7-OCH₃ | C(CH₃)₂CH₂SO₂CH₃ | CH₃ | H | OCF₃ | |
| 2-530 | 7-OCH₃ | CH(CH₃)CH₂SCH₃ | CH₃ | H | OCF₃ | |
| 2-531 | 7-OCH₃ | CH(CH₃)CH₂SOCH₃ | CH₃ | H | OCF₃ | |
| 2-532 | 7-OCH₃ | CH(CH₃)CH₂SO₂CH₃ | CH₃ | H | OCF₃ | |
| 2-533 | 4-SCH₃ | CH(CH₃)₂ | CH₃ | H | CF(CF₃)₂ | |
| 2-534 | 4-SCH₃ | C(CH₃)₂CH₂SCH₃ | CH₃ | H | CF(CF₃)₂ | |
| 2-535 | 4-SCH₃ | C(CH₃)₂SOCH₃ | CH₃ | H | CF(CF₃)₂ | |
| 2-536 | 4-SCH₃ | C(CH₃)₂CH₂SO₂CH₃ | CH₃ | H | CF(CF₃)₂ | |
| 2-537 | 4-SCH₃ | CH(CH₃)CH₂SCH₃ | CH₃ | H | CF(CF₃)₂ | |
| 2-538 | 4-SCH₃ | CH(CH₃)CH₂SOCH₃ | CH₃ | H | CF(CF₃)₂ | |
| 2-539 | 4-SCH₃ | CH(CH₃)CH₂SO₂CH₃ | CH₃ | H | CF(CF₃)₂ | |
| 2-540 | 4-SCH₃ | CH(CH₃)₂ | H | H | CF(CF₃)₂ | |
| 2-541 | 4-SCH₃ | C(CH₃)₂CH₂SCH₃ | H | H | CF(CF₃)₂ | |
| 2-542 | 4-SCH₃ | C(CH₃)₂CH₂SOCH₃ | H | H | CF(CF₃)₂ | |
| 2-543 | 4-SCH₃ | C(CH₃)₂CH₂SO₂CH₃ | H | H | CF(CF₃)₂ | |
| 2-544 | 4-SCH₃ | CH(CH₃)CH₂SCH₃ | H | H | CF(CF₃)₂ | |
| 2-545 | 4-SCH₃ | CH(CH₃)CH₂SOCH₃ | H | H | CF(CF₃)₂ | |
| 2-546 | 4-SCH₃ | CH(CH₃)CH₂SO₂CH₃ | H | H | CF(CF₃)₂ | |
| 2-547 | 4-SCH₃ | CH(CH₃)₂ | Cl | Cl | Cl | |
| 2-548 | 4-SCH₃ | C(CH₃)₂CH₂SCH₃ | Cl | Cl | Cl | |
| 2-549 | 4-SCH₃ | C(CH₃)₂CH₂SOCH₃ | Cl | Cl | Cl | |
| 2-550 | 4-SCH₃ | C(CH₃)₂CH₂SO₂CH₃ | Cl | Cl | Cl | |
| 2-551 | 4-SCH₃ | CH(CH₃)CH₂SCH₃ | Cl | Cl | Cl | |
| 2-552 | 4-SCH₃ | CH(CH₃)CH₂SOCH₃ | Cl | Cl | Cl | |
| 2-553 | 4-SCH₃ | CH(CH₃)CH₂SO₂CH₃ | Cl | Cl | Cl | |
| 2-554 | 4-SCH₃ | CH(CH₃)₂ | CH₃ | H | OCF₃ | |
| 2-555 | 4-SCH₃ | C(CH₃)₂CH₂SCH₃ | CH₃ | H | OCF₃ | |
| 2-556 | 4-SCH₃ | C(CH₃)₂CH₂SOCH₃ | CH₃ | H | OCF₃ | |
| 2-557 | 4-SCH₃ | C(CH₃)₂CH₂SO₂CH₃ | CH₃ | H | OCF₃ | |
| 2-558 | 4-SCH₃ | CH(CH₃)CH₂SCH₃ | CH₃ | H | OCF₃ | |
| 2-559 | 4-SCH₃ | CH(CH₃)CH₂SOCH₃ | CH₃ | H | OCF₃ | |
| 2-560 | 4-SCH₃ | CH(CH₃)CH₂SO₂CH₃ | CH₃ | H | OCF₃ | |
| 2-561 | 7-SCH₃ | CH(CH₃)₂ | CH₃ | H | CF(CF₃)₂ | |
| 2-562 | 7-SCH₃ | C(CH₃)₂CH₂SCH₃ | CH₃ | H | CF(CF₃)₂ | |
| 2-563 | 7-SCH₃ | C(CH₃)₂CH₂SOCH₃ | CH₃ | H | CF(CF₃)₂ | |
| 2-564 | 7-SCH₃ | C(CH₃)₂CH₂SO₂CH₃ | CH₃ | H | CF(CF₃)₂ | |
| 2-565 | 7-SCH₃ | CH(CH₃)CH₂SCH₃ | CH₃ | H | CF(CF₃)₂ | |
| 2-566 | 7-SCH₃ | CH(CH₃)CH₂SOCH₃ | CH₃ | H | CF(CF₃)₂ | |
| 2-567 | 7-SCH₃ | CH(CH₃)CH₂SO₂CH₃ | CH₃ | H | CF(CF₃)₂ | |
| 2-568 | 7-SCH₃ | CH(CH₃)₂ | H | H | CF(CF₃)₂ | |
| 2-569 | 7-SCH₃ | C(CH₃)₂CH₂SCH₃ | H | H | CF(CF₃)₂ | |
| 2-570 | 7-SCH₃ | C(CH₃)₂CH₂SOCH₃ | H | H | CF(CF₃)₂ | |
| 2-571 | 7-SCH₃ | C(CH₃)₂CH₂SO₂CH₃ | H | H | CF(CF₃)₂ | |
| 2-572 | 7-SCH₃ | CH(CH₃)CH₂SCH₃ | H | H | CF(CF₃)₂ | |
| 2-573 | 7-SCH₃ | CH(CH₃)CH₂SOCH₃ | H | H | CF(CF₃)₂ | |
| 2-574 | 7-SCH₃ | CH(CH₃)CH₂SO₂CH₃ | H | H | CF(CF₃)₂ | |
| 2-575 | 7-SCH₃ | CH(CH₃)₂ | Cl | Cl | Cl | |
| 2-576 | 7-SCH₃ | C(CH₃)₂CH₂SCH₃ | Cl | Cl | Cl | |
| 2-577 | 7-SCH₃ | C(CH₃)₂CH₂SOCH₃ | Cl | Cl | Cl | |
| 2-578 | 7-SCH₃ | C(CH₃)₂CH₂SO₂CH₃ | Cl | Cl | Cl | |
| 2-579 | 7-SCH₃ | CH(CH₃)CH₂SCH₃ | Cl | Cl | Cl | |
| 2-580 | 7-SCH₃ | CH(CH₃)CH₂SOCH₃ | Cl | Cl | Cl | |
| 2-581 | 7-SCH₃ | CH(CH₃)CH₂SO₂CH₃ | Cl | Cl | Cl | |
| 2-582 | 7-SCH₃ | CH(CH₃)₂ | CH₃ | H | OCF₃ | |
| 2-583 | 7-SCH₃ | C(CH₃)₂CH₂SCH₃ | CH₃ | H | OCF₃ | |
| 2-584 | 7-SCH₃ | C(CH₃)₂CH₂SOCH₃ | CH₃ | H | OCF₃ | |
| 2-585 | 7-SCH₃ | C(CH₃)₂CH₂SO₂CH₃ | CH₃ | H | OCF₃ | |
| 2-586 | 7-SCH₃ | CH(CH₃)CH₂SCH₃ | CH₃ | H | OCF₃ | |
| 2-587 | 7-SCH₃ | CH(CH₃)CH₂SOCH₃ | CH₃ | H | OCF₃ | |
| 2-588 | 7-SCH₃ | CH(CH₃)CH₂SO₂CH₃ | CH₃ | H | OCF₃ | |
| 2-589 | 4-SO₂CH₃ | CH(CH₃)₂ | CH₃ | H | CF(CF₃)₂ | |
| 2-590 | 4-SO₂CH₃ | C(CH₃)₂CH₂SCH₃ | CH₃ | H | CF(CF₃)₂ | |
| 2-591 | 4-SO₂CH₃ | C(CH₃)₂CH₂SOCH₃ | CH₃ | H | CF(CF₃)₂ | |
| 2-592 | 4-SO₂CH₃ | C(CH₃)₂CH₂SO₂CH₃ | CH₃ | H | CF(CF₃)₂ | |
| 2-593 | 4-SO₂CH₃ | CH(CH₃)CH₂SCH₃ | CH₃ | H | CF(CF₃)₂ | |
| 2-594 | 4-SO₂CH₃ | CH(CH₃)CH₂SOCH₃ | CH₃ | H | CF(CF₃)₂ | |
| 2-595 | 4-SO₂CH₃ | CH(CH₃)CH₂SO₂CH₃ | CH₃ | H | CF(CF₃)₂ | |
| 2-596 | 4-SO₂CH₃ | CH(CH₃)₂ | H | H | CF(CF₃)₂ | |
| 2-597 | 4-SO₂CH₃ | C(CH₃)₂CH₂SCH₃ | H | H | CF(CF₃)₂ | |
| 2-598 | 4-SO₂CH₃ | C(CH₃)₂CH₂SOCH₃ | H | H | CF(CF₃)₂ | |
| 2-599 | 4-SO₂CH₃ | C(CH₃)₂CH₂SO₂CH₃ | H | H | CF(CF₃)₂ | |
| 2-600 | 4-SO₂CH₃ | CH(CH₃)CH₂SCH₃ | H | H | CF(CF₃)₂ | |
| 2-601 | 4-SO₂CH₃ | CH(CH₃)CH₂SOCH₃ | H | H | CF(CF₃)₂ | |
| 2-602 | 4-SO₂CH₃ | CH(CH₃)CH₂SO₂CH₃ | H | H | CF(CF₃)₂ | |
| 2-603 | 4-SO₂CH₃ | CH(CH₃)₂ | Cl | Cl | Cl | |
| 2-604 | 4-SO₂CH₃ | C(CH₃)₂CH₂SCH₃ | Cl | Cl | Cl | |
| 2-605 | 4-SO₂CH₃ | C(CH₃)₂CH₂SOCH₃ | Cl | Cl | Cl | |
| 2-606 | 4-SO₂CH₃ | C(CH₃)₂CH₂SO₂CH₃ | Cl | Cl | Cl | |
| 2-607 | 4-SO₂CH₃ | CH(CH₃)CH₂SCH₃ | Cl | Cl | Cl | |
| 2-608 | 4-SO₂CH₃ | CH(CH₃)CH₂SOCH₃ | Cl | Cl | Cl | |
| 2-609 | 4-SO₂CH₃ | CH(CH₃)CH₂SO₂CH₃ | Cl | Cl | Cl | |
| 2-610 | 4-SO₂CH₃ | CH(CH₃)₂ | CH₃ | H | OCF₃ | |
| 2-611 | 4-SO₂CH₃ | C(CH₃)₂CH₂SCH₃ | CH₃ | H | OCF₃ | |
| 2-612 | 4-SO₂CH₃ | C(CH₃)₂CH₂SOCH₃ | CH₃ | H | OCF₃ | |
| 2-613 | 4-SO₂CH₃ | C(CH₃)₂CH₂SO₂CH₃ | CH₃ | H | OCF₃ | |
| 2-614 | 4-SO₂CH₃ | CH(CH₃)CH₂SCH₃ | CH₃ | H | OCF₃ | |
| 2-615 | 4-SO₂CH₃ | CH(CH₃)CH₂SOCH₃ | CH₃ | H | OCF₃ | |
| 2-616 | 4-SO₂CH₃ | CH(CH₃)CH₂SO₂CH₃ | CH₃ | H | OCF₃ | |
| 2-617 | 7-SO₂CH₃ | CH(CH₃)₂ | CH₃ | H | CF(CF₃)₂ | |
| 2-618 | 7-SO₂CH₃ | C(CH₃)₂CH₂SCH₃ | CH₃ | H | CF(CF₃)₂ | |
| 2-619 | 7-SO₂CH₃ | C(CH₃)₂CH₂SOCH₃ | CH₃ | H | CF(CF₃)₂ | |
| 2-620 | 7-SO₂CH₃ | C(CH₃)₂CH₂SO₂CH₃ | CH₃ | H | CF(CF₃)₂ | |
| 2-621 | 7-SO₂CH₃ | CH(CH₃)CH₂SCH₃ | CH₃ | H | CF(CF₃)₂ | |
| 2-622 | 7-SO₂CH₃ | CH(CH₃)CH₂SOCH₃ | CH₃ | H | CF(CF₃)₂ | |
| 2-623 | 7-SO₂CH₃ | CH(CH₃)CH₂SO₂CH₃ | CH₃ | H | CF(CF₃)₂ | |
| 2-624 | 7-SO₂CH₃ | CH(CH₃)₂ | H | H | CF(CF₃)₂ | |
| 2-625 | 7-SO₂CH₃ | C(CH₃)₂CH₂SCH₃ | H | H | CF(CF₃)₂ | |
| 2-626 | 7-SO₂CH₃ | C(CH₃)₂CH₂SOCH₃ | H | H | CF(CF₃)₂ | |
| 2-627 | 7-SO₂CH₃ | C(CH₃)₂CH₂SO₂CH₃ | H | H | CF(CF₃)₂ | |
| 2-628 | 7-SO₂CH₃ | CH(CH₃)CH₂SCH₃ | H | H | CF(CF₃)₂ | |
| 2-629 | 7-SO₂CH₃ | CH(CH₃)CH₂SOCH₃ | H | H | CF(CF₃)₂ | |
| 2-630 | 7-SO₂CH₃ | CH(CH₃)CH₂SO₂CH₃ | H | H | CF(CF₃)₂ | |
| 2-631 | 7-SO₂CH₃ | CH(CH₃)₂ | Cl | Cl | Cl | |
| 2-632 | 7-SO₂CH₃ | C(CH₃)₂CH₂SCH₃ | Cl | Cl | Cl | |
| 2-633 | 7-SO₂CH₃ | C(CH₃)₂CH₂SOCH₃ | Cl | Cl | Cl | |
| 2-634 | 7-SO₂CH₃ | C(CH₃)₂CH₂SO₂CH₃ | Cl | Cl | Cl | |
| 2-635 | 7-SO₂CH₃ | CH(CH₃)CH₂SCH₃ | Cl | Cl | Cl | |
| 2-636 | 7-SO₂CH₃ | CH(CH₃)CH₂SOCH₃ | Cl | Cl | Cl | |
| 2-637 | 7-SO₂CH₃ | CH(CH₃)CH₂SO₂CH₃ | Cl | Cl | Cl | |
| 2-638 | 7-SO₂CH₃ | CH(CH₃)₂ | CH₃ | H | OCF₃ | |
| 2-639 | 7-SO₂CH₃ | C(CH₃)₂CH₂SCH₃ | CH₃ | H | OCF₃ | |
| 2-640 | 7-SO₂CH₃ | C(CH₃)₂CH₂SOCH₃ | CH₃ | H | OCF₃ | |
| 2-641 | 7-SO₂CH₃ | C(CH₃)₂CH₂SO₂CH₃ | CH₃ | H | OCF₃ | |
| 2-642 | 7-SO₂CH₃ | CH(CH₃)CH₂SCH₃ | CH₃ | H | OCF₃ | |
| 2-643 | 7-SO₂CH₃ | CH(CH₃)CH₂SOCH₃ | CH₃ | H | OCF₃ | |
| 2-644 | 7-SO₂CH₃ | CH(CH₃)CH₂SO₂CH₃ | CH₃ | H | OCF₃ | |
| 2-645 | 4-OSO₂CH₃ | CH(CH₃)₂ | CH₃ | H | CF(CF₃)₂ | |
| 2-646 | 4-OSO₂CH₃ | C(CH₃)₂CH₂SCH₃ | CH₃ | H | CF(CF₃)₂ | |
| 2-647 | 4-OSO₂CH₃ | C(CH₃)₂CH₂SOCH₃ | CH₃ | H | CF(CF₃)₂ | |
| 2-648 | 4-OSO₂CH₃ | C(CH₃)₂CH₂SO₂CH₃ | CH₃ | H | CF(CF₃)₂ | |
| 2-649 | 4-OSO₂CH₃ | CH(CH₃)CH₂SCH₃ | CH₃ | H | CF(CF₃)₂ | |
| 2-650 | 4-OSO₂CH₃ | CH(CH₃)CH₂SOCH₃ | CH₃ | H | CF(CF₃)₂ | |
| 2-651 | 4-OSO₂CH₃ | CH(CH₃)CH₂SO₂CH₃ | CH₃ | H | CF(CF₃)₂ | |
| 2-652 | 4-OSO₂CH₃ | CH(CH₃)₂ | H | H | CF(CF₃)₂ | |
| 2-653 | 4-OSO₂CH₃ | C(CH₃)₂CH₂SCH₃ | H | H | CF(CF₃)₂ | |
| 2-654 | 4-OSO₂CH₃ | C(CH₃)₂CH₂SOCH₃ | H | H | CF(CF₃)₂ | |
| 2-655 | 4-OSO₂CH₃ | C(CH₃)₂CH₂SO₂CH₃ | H | H | CF(CF₃)₂ | |
| 2-656 | 4-OSO₂CH₃ | CH(CH₃)CH₂SCH₃ | H | H | CF(CF₃)₂ | |
| 2-657 | 4-OSO₂CH₃ | CH(CH₃)CH₂SOCH₃ | H | H | CF(CF₃)₂ | |
| 2-658 | 4-OSO₂CH₃ | CH(CH₃)CH₂SO₂CH₃ | H | H | CF(CF₃)₂ | |
| 2-659 | 4-OSO₂CH₃ | CH(CH₃)₂ | Cl | Cl | Cl | |
| 2-660 | 4-OSO₂CH₃ | C(CH₃)₂CH₂SCH₃ | Cl | Cl | Cl | |
| 2-661 | 4-OSO₂CH₃ | C(CH₃)₂CH₂SOCH₃ | Cl | Cl | Cl | |
| 2-662 | 4-OSO₂CH₃ | C(CH₃)₂CH₂SO₂CH₃ | Cl | Cl | Cl | |
| 2-663 | 4-OSO₂CH₃ | CH(CH₃)CH₂SCH₃ | Cl | Cl | Cl | |
| 2-664 | 4-OSO₂CH₃ | CH(CH₃)CH₂SOCH₃ | Cl | Cl | Cl | |
| 2-665 | 4-OSO₂CH₃ | CH(CH₃)CH₂SO₂CH₃ | Cl | Cl | Cl | |
| 2-666 | 4-OSO₂CH₃ | CH(CH₃)₂ | CH₃ | H | OCF₃ | |
| 2-667 | 4-OSO₂CH₃ | C(CH₃)₂CH₂SCH₃ | CH₃ | H | OCF₃ | |
| 2-668 | 4-OSO₂CH₃ | C(CH₃)₂CH₂SOCH₃ | CH₃ | H | OCF₃ | |
| 2-669 | 4-OSO₂CH₃ | C(CH₃)₂CH₂SO₂CH₃ | CH₃ | H | OCF₃ | |
| 2-670 | 4-OSO₂CH₃ | CH(CH₃)CH₂SCH₃ | CH₃ | H | OCF₃ | |
| 2-671 | 4-OSO₂CH₃ | CH(CH₃)CH₂SOCH₃ | CH₃ | H | OCF₃ | |
| 2-672 | 4-OSO₂CH₃ | CH(CH₃)CH₂SO₂CH₃ | CH₃ | H | OCF₃ | |
| 2-673 | 7-OSO₂CH₃ | CH(CH₃)₂ | CH₃ | H | CF(CF₃)₂ | |
| 2-674 | 7-OSO₂CH₃ | C(CH₃)₂CH₂SCH₃ | CH₃ | H | CF(CF₃)₂ | |
| 2-675 | 7-OSO₂CH₃ | C(CH₃)₂CH₂SOCH₃ | CH₃ | H | CF(CF₃)₂ | |
| 2-676 | 7-OSO₂CH₃ | C(CH₃)₂CH₂SO₂CH₃ | CH₃ | H | CF(CF₃)₂ | |
| 2-677 | 7-OSO₂CH₃ | CH(CH₃)CH₂SCH₃ | CH₃ | H | CF(CF₃)₂ | |
| 2-678 | 7-OSO₂CH₃ | CH(CH₃)CH₂SOCH₃ | CH₃ | H | CF(CF₃)₂ | |
| 2-679 | 7-OSO₂CH₃ | CH(CH₃)CH₂SO₂CH₃ | CH₃ | H | CF(CF₃)₂ | |
| 2-680 | 7-OSO₂CH₃ | CH(CH₃)₂ | H | H | CF(CF₃)₂ | |
| 2-681 | 7-OSO₂CH₃ | C(CH₃)₂CH₂SCH₃ | H | H | CF(CF₃)₂ | |
| 2-682 | 7-OSO₂CH₃ | C(CH₃)₂CH₂SOCH₃ | H | H | CF(CF₃)₂ | |
| 2-683 | 7-OSO₂CH₃ | C(CH₃)₂CH₂SO₂CH₃ | H | H | CF(CF₃)₂ | |
| 2-684 | 7-OSO₂CH₃ | CH(CH₃)CH₂SCH₃ | H | H | CF(CF₃)₂ | |
| 2-685 | 7-OSO₂CH₃ | CH(CH₃)CH₂SOCH₃ | H | H | CF(CF₃)₂ | |
| 2-686 | 7-OSO₂CH₃ | CH(CH₃)CH₂SO₂CH₃ | H | H | CF(CF₃)₂ | |
| 2-687 | 7-OSO₂CH₃ | CH(CH₃)₂ | Cl | Cl | Cl | |
| 2-688 | 7-OSO₂CH₃ | C(CH₃)₂CH₂SCH₃ | Cl | Cl | Cl | |
| 2-689 | 7-OSO₂CH₃ | C(CH₃)₂CH₂SOCH₃ | Cl | Cl | Cl | |
| 2-690 | 7-OSO₂CH₃ | C(CH₃)₂CH₂SO₂CH₃ | Cl | Cl | Cl | |
| 2-691 | 7-OSO₂CH₃ | CH(CH₃)CH₂SCH₃ | Cl | Cl | Cl | |
| 2-692 | 7-OSO₂CH₃ | CH(CH₃)CH₂SOCH₃ | Cl | Cl | Cl | |
| 2-693 | 7-OSO₂CH₃ | CH(CH₃)CH₂SO₂CH₃ | Cl | Cl | Cl | |
| 2-694 | 7-OSO₂CH₃ | CH(CH₃)₂ | CH₃ | H | OCF₃ | |
| 2-695 | 7-OSO₂CH₃ | C(CH₃)₂CH₂SCH₃ | CH₃ | H | OCF₃ | |
| 2-696 | 7-OSO₂CH₃ | C(CH₃)₂CH₂SOCH₃ | CH₃ | H | OCF₃ | |
| 2-697 | 7-OSO₂CH₃ | C(CH₃)₂CH₂SO₂CH₃ | CH₃ | H | OCF₃ | |
| 2-698 | 7-OSO₂CH₃ | CH(CH₃)CH₂SCH₃ | CH₃ | H | OCF₃ | |
| 2-699 | 7-OSO₂CH₃ | CH(CH₃)CH₂SOCH₃ | CH₃ | H | OCF₃ | |
| 2-700 | 7-OSO₂CH₃ | CH(CH₃)CH₂SO₂CH₃ | CH₃ | H | OCF₃ | |

*1. ¹H-NMR (CDCl₃, 400 MHz): δ = 0.94(3H, d, J=6.1Hz), 1.01(3H, d, J=6.1Hz), 2.32(3H, s), 3.30-3.40(1H, m), 7.41(1H, d, J=8.3Hz), 7.54(1H, dd, J=8.0, 7.4Hz), 7.56(1H, br d, J=8.3Hz), 7.60(1H, br s), 7.69(1H, dd, J=8.0, 0.9Hz), 7.83(1H, dd, J=7.4, 0.9Hz) ppm.
*2. ¹H-NMR (CDCl₃, 90 MHz): δ = 0.9(3H, s), 1.0(3H, s), 2.9(3H, s), 2.4(3H, s), 3.3-3.6(2H, m), 6.7(1H, d, J=2.4Hz), 7.3-7.9(6H, m) ppm.
*3. ¹H-NMR (CDCl₃, 400 MHz): δ = 1.06(3H, s), 1.22(3H, s), 2.31(3H, s), 2.91(3H, s), 3.52(1H, d, J=4.0Hz), 3.66(1H, d, J=4.0Hz), 7.33(1H, dd, J=7.5, 7.5Hz), 7.39(1H, d, J=8.2Hz), 7.60(1H, br d, J=8.2Hz), 7.62(1H, br s), 7.92(1H, dd, J=7.5, 0.9Hz), 8.25(1H, dd, J=7.5, 0.9Hz) ppm.
*4. ¹H-NMR (DMSO-d₆, 400 MHz): δ = 1.66(3H, s), 1.67(3H, s), 2.00(3H, s), 2.22(3H, s), 3.35(2H, br s), 7.61-7.65(3H, m), 7.70(1H, br s), 8.28(1H, d, J=7.9Hz), 8.33(1H, dd, J=7.9Hz) ppm.

TABLE 3

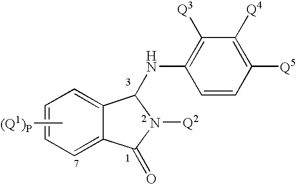

| Comp. | | | | | | mp (° C.) |
|---|---|---|---|---|---|---|
| No. | (Q¹)_{P} | Q² | Q³ | Q⁴ | Q⁵ | or n_{D}²⁰ |
| 3-1 | H | CH(CH₃)₂ | CH₃ | H | CF(CF₃)₂ | |
| 3-2 | H | C(CH₃)₂CH₂SCH₃ | CH₃ | H | CF(CF₃)₂ | |
| 3-3 | H | C(CH₃)₂CH₂SOCH₃ | CH₃ | H | CF(CF₃)₂ | |
| 3-4 | H | C(CH₃)₂CH₂SO₂CH₃ | CH₃ | H | CF(CF₃)₂ | |
| 3-5 | H | CH(CH₃)CH₂SCH₃ | CH₃ | H | CF(CF₃)₂ | |
| 3-6 | H | CH(CH₃)CH₂SOCH₃ | CH₃ | H | CF(CF₃)₂ | |
| 3-7 | H | CH(CH₃)CH₂SO₂CH₃ | CH₃ | H | CF(CF₃)₂ | |
| 3-8 | H | CH(CH₃)₂ | H | H | CF(CF₃)₂ | |
| 3-9 | H | C(CH₃)₂CH₂SCH₃ | H | H | CF(CF₃)₂ | |
| 3-10 | H | C(CH₃)₂CH₂SOCH₃ | H | H | CF(CF₃)₂ | |
| 3-11 | H | C(CH₃)₂CH₂SO₂CH₃ | H | H | CF(CF₃)₂ | |
| 3-12 | H | CH(CH₃)CH₂SCH₃ | H | H | CF(CF₃)₂ | |
| 3-13 | H | CH(CH₃)CH₂SOCH₃ | H | H | CF(CF₃)₂ | |
| 3-14 | H | CH(CH₃)CH₂SO₂CH₃ | H | H | CF(CF₃)₂ | |
| 3-15 | H | CH(CH₃)₂ | Cl | Cl | Cl | |
| 3-16 | H | C(CH₃)₂CH₂SCH₃ | Cl | Cl | Cl | |
| 3-17 | H | C(CH₃)₂CH₂SOCH₃ | Cl | Cl | Cl | |
| 3-18 | H | C(CH₃)₂CH₂SO₂CH₃ | Cl | Cl | Cl | |
| 3-19 | H | CH(CH₃)CH₂SCH₃ | Cl | Cl | Cl | |
| 3-20 | H | CH(CH₃)CH₂SOCH₃ | Cl | Cl | Cl | |
| 3-21 | H | CH(CH₃)CH₂SO₂CH₃ | Cl | Cl | Cl | |
| 3-22 | H | CH(CH₃)₂ | CH₃ | H | OCF₃ | |
| 3-23 | H | C(CH₃)₂CH₂SCH₃ | CH₃ | H | OCF | |
| 3-24 | H | C(CH₃)₂CH₂SOCH₃ | CH₃ | H | OCF₃ | |
| 3-25 | H | C(CH₃)₂CH₂SO₂CH₃ | CH₃ | H | OCF₃ | |
| 3-26 | H | CH(CH₃)CH₂SCH₃ | CH₃ | H | OCF₃ | |
| 3-27 | H | CH(CH₃)CH₂SOCH₃ | CH₃ | H | OCF₃ | |
| 3-28 | H | CH(CH₃)CH₂SO₂CH₃ | CH₃ | H | OCF₃ | |
| 3-29 | H | CH(CH₃)₂ | Cl | H | Cl | |
| 3-30 | H | C(CH₃)₂CH₂SCH₃ | Cl | H | Cl | |
| 3-31 | H | C(CH₃)₂CH₂SOCH₃ | Cl | H | Cl | |
| 3-32 | H | C(CH₃)₂CH₂SO₂CH₃ | Cl | H | Cl | |
| 3-33 | H | CH(CH₃)CH₂SCH₃ | Cl | H | Cl | |
| 3-34 | H | CH(CH₃)CH₂SOCH₃ | Cl | H | Cl | |
| 3-35 | H | CH(CH₃)CH₂SO₂CH₃ | Cl | H | Cl | |
| 3-36 | H | CH(CH₃)₂ | H | Cl | Cl | |
| 3-37 | H | C(CH₃)₂CH₂SCH₃ | H | Cl | Cl | |
| 3-38 | H | C(CH₃)₂CH₂SOCH₃ | H | Cl | Cl | |
| 3-39 | H | C(CH₃)₂CH₂SO₂CH₃ | H | Cl | Cl | |
| 3-40 | H | CH(CH₃)CH₂SCH₃ | H | Cl | Cl | |
| 3-41 | H | CH(CH₃)CH₂SOCH₃ | H | Cl | Cl | |
| 3-42 | H | CH(CH₃)CH₂SO₂CH₃ | H | Cl | Cl | |
| 3-43 | H | CH(CH₃)₂ | Cl | Cl | H | |
| 3-44 | H | C(CH₃)₂CH₂SCH₃ | Cl | Cl | H | |
| 3-45 | H | C(CH₃)₂CH₂SOCH₃ | Cl | Cl | H | |
| 3-46 | H | C(CH₃)₂CH₂SO₂CH₃ | Cl | Cl | H | |
| 3-47 | H | CH(CH₃)CH₂SCH₃ | Cl | Cl | H | |
| 3-48 | H | CH(CH₃)CH₂SOCH₃ | Cl | Cl | H | |
| 3-49 | H | CH(CH₃)CH₂SO₂CH₃ | Cl | Cl | H | |
| 3-50 | H | CH(CH₃)₂ | Cl | H | CF₃ | |
| 3-51 | H | C(CH₃)₂CH₂SCH₃ | Cl | H | CF₃ | |
| 3-52 | H | C(CH₃)₂CH₂SOCH₃ | Cl | H | CF₃ | |
| 3-53 | H | C(CH₃)₂CH₂SO₂CH₃ | Cl | H | CF₃ | |
| 3-54 | H | CH(CH₃)CH₂SCH₃ | Cl | H | CF₃ | |
| 3-55 | H | CH(CH₃)CH₂SOCH₃ | Cl | H | CF₃ | |
| 3-56 | H | CH(CH₃)CH₂SO₂CH₃ | Cl | H | CF₃ | |
| 3-57 | H | CH(CH₃)₂ | Cl | H | CF₃ | |
| 3-58 | H | C(CH₃)₂CH₂SCH₃ | Cl | H | CF₃ | |
| 3-59 | H | C(CH₃)₂CH₂SOCH₃ | Cl | H | CF₃ | |
| 3-60 | H | C(CH₃)₂CH₂SO₂CH₃ | Cl | H | CF₃ | |
| 3-61 | H | CH(CH₃)CH₂SCH₃ | Cl | H | CF₃ | |
| 3-62 | H | CH(CH₃)CH₂SOCH₃ | Cl | H | CF₃ | |
| 3-63 | H | CH(CH₃)CH₂SO₂CH₃ | Cl | H | CF₃ | |
| 3-64 | H | CH(CH₃)₂ | H | H | Cl | |
| 3-65 | H | C(CH₃)₂CH₂SCH₃ | H | H | Cl | |
| 3-66 | H | C(CH₃)₂CH₂SOCH₃ | H | H | Cl | |
| 3-67 | H | C(CH₃)₂CH₂SO₂CH₃ | H | H | Cl | |
| 3-68 | H | CH(CH₃)CH₂SCH₃ | H | H | Cl | |
| 3-69 | H | CH(CH₃)CH₂SOCH₃ | H | H | Cl | |
| 3-70 | H | CH(CH₃)CH₂SO₂CH₃ | H | H | Cl | |
| 3-71 | H | CH(CH₃)₂ | CH₃ | H | Cl | |
| 3-72 | H | C(CH₃)₂CH₂SCH₃ | CH₃ | H | Cl | |
| 3-73 | H | C(CH₃)₂CH₂SOCH₃ | CH₃ | H | Cl | |
| 3-74 | H | C(CH₃)₂CH₂SO₂CH₃ | CH₃ | H | Cl | |
| 3-75 | H | CH(CH₃)CH₂SCH₃ | CH₃ | H | Cl | |
| 3-76 | H | CH(CH₃)CH₂SOCH₃ | CH₃ | H | Cl | |
| 3-77 | H | CH(CH₃)CH₂SO₂CH₃ | CH₃ | H | Cl | |
| 3-78 | H | CH(CH₃)₂ | H | H | OCF₃ | |
| 3-79 | H | C(CH₃)₂CH₂SCH₃ | H | H | OCF₃ | |
| 3-80 | H | C(CH₃)₂CH₂SOCH₃ | H | H | OCF₃ | |
| 3-81 | H | C(CH₃)₂CH₂SO₂CH₃ | H | H | OCF₃ | |
| 3-82 | H | CH(CH₃)CH₂SCH₃ | H | H | OCF₃ | |
| 3-83 | H | CH(CH₃)CH₂SOCH₃ | H | H | OCF₃ | |
| 3-84 | H | CH(CH₃)CH₂SO₂CH₃ | H | H | OCF₃ | |
| 3-85 | H | CH(CH₃)₂ | H | H | CF₃ | |
| 3-86 | H | C(CH₃)₂CH₂SCH₃ | H | H | CF₃ | |
| 3-87 | H | C(CH₃)₂CH₂SOCH₃ | H | H | CF₃ | |
| 3-88 | H | C(CH₃)₂CH₂SO₂CH₃ | H | H | CF₃ | |
| 3-89 | H | CH(CH₃)CH₂SCH₃ | H | H | CF₃ | |
| 3-90 | H | CH(CH₃)CH₂SOCH₃ | H | H | CF₃ | |
| 3-91 | H | CH(CH₃)CH₂SO₂CH₃ | H | H | CF₃ | |
| 3-92 | H | CH(CH₃)₂ | H | H | Ph-4-CF₃ | |
| 3-93 | H | C(CH₃)₂CH₂SCH₃ | H | H | Ph-4-CF₃ | |
| 3-94 | H | C(CH₃)₂CH₂SOCH₃ | H | H | Ph-4-CF₃ | |
| 3-95 | H | C(CH₃)₂CH₂SO₂CH₃ | H | H | Ph-4-CF₃ | |
| 3-96 | H | CH(CH₃)CH₂SCH₃ | H | H | Ph-4-CF₃ | |
| 3-97 | H | CH(CH₃)CH₂SOCH₃ | H | H | Ph-4-CF₃ | |
| 3-98 | H | CH(CH₃)CH₂SO₂CH₃ | H | H | Ph-4-CF₃ | |
| 3-99 | H | CH(CH₃)₂ | F | F | CF₃ | |
| 3-100 | H | C(CH₃)₂CH₂SCH₃ | F | F | CF₃ | |
| 3-101 | H | C(CH₃)₂CH₂SOCH₃ | F | F | CF₃ | |
| 3-102 | H | C(CH₃)₂CH₂SO₂CH₃ | F | F | CF₃ | |
| 3-103 | H | CH(CH₃)CH₂SCH₃ | F | F | CF₃ | |
| 3-104 | H | CH(CH₃)CH₂SOCH₃ | F | F | CF₃ | |
| 3-105 | H | CH(CH₃)CH₂SO₂CH₃ | F | F | CF₃ | |
| 3-106 | H | CH(CH₃)₂ | CH₃ | H | COH(CF₃)₂ | |
| 3-107 | H | C(CH₃)₂CH₂SCH₃ | CH₃ | H | COH(CF₃)₂ | |
| 3-108 | H | C(CH₃)₂CH₂SOCH₃ | CH₃ | H | COH(CF₃)₂ | |
| 3-109 | H | C(CH₃)₂CH₂SO₂CH₃ | CH₃ | H | COH(CF₃)₂ | |
| 3-110 | H | CH(CH₃)CH₂SCH₃ | CH₃ | H | COH(CF₃)₂ | |
| 3-111 | H | CH(CH₃)CH₂SOCH₃ | CH₃ | H | COH(CF₃)₂ | |
| 3-112 | H | CH(CH₃)CH₂SO₂CH₃ | CH₃ | H | COH(CF₃)₂ | |
| 3-113 | 4-Cl | CH(CH₃)₂ | CH₃ | H | CF(CF₃)₂ | |
| 3-114 | 4-Cl | C(CH₃)₂CH₂SCH₃ | CH₃ | H | CF(CF₃)₂ | |
| 3-115 | 4-Cl | C(CH₃)₂CH₂SOCH₃ | CH₃ | H | CF(CF₃)₂ | |
| 3-116 | 4-Cl | C(CH₃)₂CH₂SO₂CH₃ | CH₃ | H | CF(CF₃)₂ | |
| 3-117 | 4-Cl | CH(CH₃)CH₂SCH₃ | CH₃ | H | CF(CF₃)₂ | 64-70 |
| 3-118 | 4-Cl | CH(CH₃)CH₂SOCH₃ | CH₃ | H | CF(CF₃)₂ | |
| 3-119 | 4-Cl | CH(CH₃)CH₂SO₂CH₃ | CH₃ | H | CF(CF₃)₂ | 103-108 |
| 3-120 | 4-Cl | CH(CH₃)₂ | H | H | CF(CF₃)₂ | |
| 3-121 | 4-Cl | C(CH₃)₂CH₂SCH₃ | H | H | CF(CF₃)₂ | |
| 3-122 | 4-Cl | C(CH₃)₂CH₂SOCH₃ | H | H | CF(CF₃)₂ | |
| 3-123 | 4-Cl | C(CH₃)₂CH₂SO₂CH₃ | H | H | CF(CF₃)₂ | |
| 3-124 | 4-Cl | CH(CH₃)CH₂SCH₃ | H | H | CF(CF₃)₂ | |
| 3-125 | 4-Cl | CH(CH₃)CH₂SOCH₃ | H | H | CF(CF₃)₂ | |
| 3-126 | 4-Cl | CH(CH₃)CH₂SO₂CH₃ | H | H | CF(CF₃)₂ | |
| 3-127 | 4-Cl | CH(CH₃)₂ | Cl | Cl | Cl | |
| 3-128 | 4-Cl | C(CH₃)₂CH₂SCH₃ | Cl | Cl | Cl | |
| 3-129 | 4-Cl | C(CH₃)₂CH₂SOCH₃ | Cl | Cl | Cl | |
| 3-130 | 4-Cl | C(CH₃)₂CH₂SO₂CH₃ | Cl | Cl | Cl | |
| 3-131 | 4-Cl | CH(CH₃)CH₂SCH₃ | Cl | Cl | Cl | |
| 3-132 | 4-Cl | CH(CH₃)CH₂SOCH₃ | Cl | Cl | Cl | |
| 3-133 | 4-Cl | CH(CH₃)CH₂SO₂CH₃ | Cl | Cl | Cl | |
| 3-134 | 4-Cl | CH(CH₃)₂ | CH₃ | H | OCF₃ | |
| 3-135 | 4-Cl | C(CH₃)₂CH₂SCH₃ | CH₃ | H | OCF₃ | |
| 3-136 | 4-Cl | C(CH₃)₂CH₂SOCH₃ | CH₃ | H | OCF₃ | |
| 3-137 | 4-Cl | C(CH₃)₂CH₂SO₂CH₃CH₃ | H | OCF₃ | | |
| 3-138 | 4-Cl | CH(CH₃)CH₂SCH₃ | CH₃ | H | OCF₃ | |
| 3-139 | 4-Cl | CH(CH₃)CH₂SOCH₃ | CH₃ | H | OCF₃ | |
| 3-140 | 4-Cl | CH(CH₃)CH₂SO₂CH₃ | CH₃ | H | OCF₃ | |
| 3-141 | 4-Cl | CH(CH₃)₂ | Cl | H | Cl | |
| 3-142 | 4-Cl | C(CH₃)₂CH₂SCH₃ | Cl | H | Cl | |
| 3-143 | 4-Cl | C(CH₃)₂CH₂SOCH₃ | Cl | H | Cl | |
| 3-144 | 4-Cl | C(CH₃)₂CH₂SO₂CH₃ | Cl | H | Cl | |
| 3-145 | 4-Cl | CH(CH₃)CH₂SCH₃ | Cl | H | Cl | |
| 3-146 | 4-Cl | CH(CH₃)CH₂SOCH₃ | Cl | H | Cl | |
| 3-147 | 4-Cl | CH(CH₃)CH₂SO₂CH₃ | Cl | H | Cl | |
| 3-148 | 4-Cl | CH(CH₃)₂ | H | Cl | Cl | |
| 3-149 | 4-Cl | C(CH₃)₂CH₂SCH₃ | H | Cl | Cl | |
| 3-150 | 4-Cl | C(CH₃)₂CH₂SOCH₃ | H | Cl | Cl | |
| 3-151 | 4-Cl | C(CH₃)₂CH₂SO₂CH₃ | H | Cl | Cl | |
| 3-152 | 4-Cl | CH(CH₃)CH₂SCH₃ | H | Cl | Cl | |
| 3-153 | 4-Cl | CH(CH₃)CH₂SOCH₃ | H | Cl | Cl | |
| 3-154 | 4-Cl | CH(CH₃)CH₂SO₂CH₃ | H | Cl | Cl | |
| 3-155 | 4-Cl | CH(CH₃)₂ | Cl | Cl | H | |
| 3-156 | 4-Cl | C(CH₃)₂CH₂SCH₃ | Cl | Cl | H | |
| 3-157 | 4-Cl | C(CH₃)₂CH₂SOCH₃ | Cl | Cl | H | |
| 3-158 | 4-Cl | C(CH₃)₂CH₂SO₂CH₃ | Cl | Cl | H | |
| 3-159 | 4-Cl | CH(CH₃)CH₂SCH₃ | Cl | Cl | H | |
| 3-160 | 4-Cl | CH(CH₃)CH₂SOCH₃ | Cl | Cl | H | |
| 3-161 | 4-Cl | CH(CH₃)CH₂SO₂CH₃ | Cl | Cl | H | |
| 3-162 | 4-Cl | CH(CH₃)₂ | Cl | H | CF₃ | |
| 3-163 | 4-Cl | C(CH₃)₂CH₂SCH₃ | Cl | H | CF₃ | |
| 3-164 | 4-Cl | C(CH₃)₂CH₂SOCH₃ | Cl | H | CF₃ | |
| 3-165 | 4-Cl | C(CH₃)₂CH₂SO₂CH₃ | Cl | H | CF₃ | |
| 3-166 | 4-Cl | CH(CH₃)CH₂SCH₃ | Cl | H | CF₃ | |
| 3-167 | 4-Cl | CH(CH₃)CH₂SOCH₃ | Cl | H | CF₃ | |
| 3-168 | 4-Cl | CH(CH₃)CH₂SO₂CH₃ | Cl | H | CF₃ | |
| 3-169 | 4-Cl | CH(CH₃)₂ | Cl | H | CF₃ | |
| 3-170 | 4-Cl | C(CH₃)₂CH₂SCH₃ | Cl | H | CF₃ | |
| 3-171 | 4-Cl | C(CH₃)₂CH₂SOCH₃ | Cl | H | CF₃ | |
| 3-172 | 4-Cl | C(CH₃)₂CH₂SO₂CH₃ | Cl | H | CF₃ | |
| 3-173 | 4-Cl | CH(CH₃)CH₂SCH₃ | Cl | H | CF₃ | |
| 3-174 | 4-Cl | CH(CH₃)CH₂SOCH₃ | Cl | H | CF₃ | |
| 3-175 | 4-Cl | CH(CH₃)CH₂SO₂CH₃ | Cl | H | CF₃ | |
| 3-176 | 4-Cl | CH(CH₃)₂ | H | H | Cl | |
| 3-177 | 4-Cl | C(CH₃)₂CH₂SCH₃ | H | H | Cl | |
| 3-178 | 4-Cl | C(CH₃)₂CH₂SOCH₃ | H | H | Cl | |
| 3-179 | 4-Cl | C(CH₃)₂CH₂SO₂CH₃ | H | H | Cl | |
| 3-180 | 4-Cl | CH(CH₃)CH₂SCH₃ | H | H | Cl | |
| 3-181 | 4-Cl | CH(CH₃)CH₂SOCH₃ | H | H | Cl | |
| 3-182 | 4-Cl | CH(CH₃)CH₂SO₂CH₃ | H | H | Cl | |
| 3-183 | 4-Cl | CH(CH₃)₂ | CH₃ | H | Cl | |
| 3-184 | 4-Cl | C(CH₃)₂CH₂SCH₃ | CH₃ | H | Cl | |
| 3-185 | 4-Cl | C(CH₃)₂CH₂SOCH₃ | CH₃ | H | Cl | |
| 3-186 | 4-Cl | C(CH₃)₂CH₂SO₂CH₃ | CH₃ | H | Cl | |
| 3-187 | 4-Cl | CH(CH₃)CH₂SCH₃ | CH₃ | H | Cl | |
| 3-188 | 4-Cl | CH(CH₃)CH₂SOCH₃ | CH₃ | H | Cl | |
| 3-189 | 4-Cl | CH(CH₃)CH₂SO₂CH₃ | CH₃ | H | Cl | |
| 3-190 | 4-Cl | CH(CH₃)₂ | H | H | OCF₃ | |
| 3-191 | 4-Cl | C(CH₃)₂CH₂SCH₃ | H | H | OCF₃ | |
| 3-192 | 4-Cl | C(CH₃)₂CH₂SOCH₃ | H | H | OCF₃ | |
| 3-193 | 4-Cl | C(CH₃)₂CH₂SO₂CH₃ | H | H | OCF₃ | |
| 3-194 | 4-Cl | CH(CH₃)CH₂SCH₃ | H | H | OCF₃ | |
| 3-195 | 4-Cl | CH(CH₃)CH₂SOCH₃ | H | H | OCF₃ | |
| 3-196 | 4-Cl | CH(CH₃)CH₂SO₂CH₃ | H | H | OCF₃ | |
| 3-197 | 4-Cl | CH(CH₃)₂ | H | H | CF₃ | |
| 3-198 | 4-Cl | C(CH₃)₂CH₂SCH₃ | H | H | CF₃ | |
| 3-199 | 4-Cl | C(CH₃)₂CH₂SOCH₃ | H | H | CF₃ | |
| 3-200 | 4-Cl | C(CH₃)₂CH₂SO₂CH₃ | H | H | CF₃ | |
| 3-201 | 4-Cl | CH(CH₃)CH₂SCH₃ | H | H | CF₃ | |
| 3-202 | 4-Cl | CH(CH₃)CH₂SOCH₃ | H | H | CF₃ | |
| 3-203 | 4-Cl | CH(CH₃)CH₂SO₂CH₃ | H | H | CF₃ | |
| 3-204 | 4-Cl | CH(CH₃)₂ | H | H | Ph-4-CF₃ | |
| 3-205 | 4-Cl | C(CH₃)₂CH₂SCH₃ | H | H | Ph-4-CF₃ | |
| 3-206 | 4-Cl | C(CH₃)₂CH₂SOCH₃ | H | H | Ph-4-CF₃ | |
| 3-207 | 4-Cl | C(CH₃)₂CH₂SO₂CH₃ | H | H | Ph-4-CF₃ | |
| 3-208 | 4-Cl | CH(CH₃)CH₂SCH₃ | H | H | Ph-4-CF₃ | |
| 3-209 | 4-Cl | CH(CH₃)CH₂SOCH₃ | H | H | Ph-4-CF₃ | |
| 3-210 | 4-Cl | CH(CH₃)CH₂SO₂CH₃ | H | H | Ph-4-CF₃ | |
| 3-211 | 4-Cl | CH(CH₃)₂ | F | F | CF₃ | |
| 3-212 | 4-Cl | C(CH₃)₂CH₂SCH₃ | F | F | CF₃ | |
| 3-213 | 4-Cl | C(CH₃)₂CH₂SOCH₃ | F | F | CF₃ | |
| 3-214 | 4-Cl | C(CH₃)₂CH₂SO₂CH₃ | F | F | CF₃ | |
| 3-215 | 4-Cl | CH(CH₃)CH₂SCH₃ | F | F | CF₃ | |
| 3-216 | 4-Cl | CH(CH₃)CH₂SOCH₃ | F | F | CF₃ | |
| 3-217 | 4-Cl | CH(CH₃)CH₂SO₂CH₃ | F | F | CF₃ | |
| 3-218 | 4-Cl | CH(CH₃)₂ | CH₃ | H | COH(CF₃)₂ | |
| 3-219 | 4-Cl | C(CH₃)₂CH₂SCH₃ | CH₃ | H | COH(CF₃)₂ | |
| 3-220 | 4-Cl | C(CH₃)₂CH₂SOCH₃ | CH₃ | H | COH(CF₃)₂ | |
| 3-221 | 4-Cl | C(CH₃)₂CH₂SO₂CH₃ | CH₃ | H | CCH(CF₃)₂ | |
| 3-222 | 4-Cl | CH(CH₃)CH₂SCH₃ | CH₃ | H | COH(CF₃)₂ | |
| 3-223 | 4-Cl | CH(CH₃)CH₂SOCH₃ | CH₃ | H | COH(CF₃)₂ | |
| 3-224 | 4-Cl | CH(CH₃)CH₂SO₂CH₃ | CH₃ | H | COH(CF₃)₂ | |
| 3-225 | 7-Cl | CH(CH₃)₂ | CH₃ | H | CF(CF₃)₂ | 168-169 |
| 3-226 | 7-Cl | C(CH₃)₂CH₂SCH₃ | CH₃ | H | CF(CF₃)₂ | 191-193 |
| 3-227 | 7-Cl | C(CH₃)₂CH₂SOCH₃ | CH₃ | H | CF(CF₃)₂ | 243-244 |
| 3-228 | 7-Cl | C(CH₃)₂CH₂SO₂CH₃ | CH₃ | H | CF(CF₃)₂ | 87-92 |
| 3-229 | 7-Cl | CH(CH₃)CH₂SCH₃ | CH₃ | H | CF(CF₃)₂ | 77-81 |
| 3-230 | 7-Cl | CH(CH₃)CH₂SOCH₃ | CH₃ | H | CF(CF₃)₂ | |
| 3-231 | 7-Cl | CH(CH₃)CH₂SO₂CH₃ | CH₃ | H | CF(CF₃)₂ | 96-101 |
| 3-232 | 7-Cl | CH(CH₃)₂ | H | H | CF(CF₃)₂ | 146-148 |
| 3-233 | 7-Cl | C(CH₃)₂CH₂SCH₃ | H | H | CF(CF₃)₂ | |
| 3-234 | 7-Cl | C(CH₃)₂CH₂SOCH₃ | H | H | CF(CF₃)₂ | |
| 3-235 | 7-Cl | C(CH₃)₂CH₂SO₂CH₃ | H | H | CF(CF₃)₂ | |
| 3-236 | 7-Cl | CH(CH₃)CH₂SCH₃ | H | H | CF(CF₃)₂ | |
| 3-237 | 7-Cl | CH(CH₃)CH₂SOCH₃ | H | H | CF(CF₃)₂ | |
| 3-238 | 7-Cl | CH(CH₃)CH₂SO₂CH₃ | H | H | CF(CF₃)₂ | |
| 3-239 | 7-Cl | CH(CH₃)₂ | Cl | Cl | Cl | 212-216 |
| 3-240 | 7-Cl | C(CH₃)₂CH₂SCH₃ | Cl | Cl | Cl | |
| 3-241 | 7-Cl | C(CH₃)₂CH₂SOCH₃ | Cl | Cl | Cl | |
| 3-242 | 7-Cl | C(CH₃)₂CH₂SO₂CH₃ | Cl | Cl | Cl | |
| 3-243 | 7-Cl | CH(CH₃)CH₂SCH₃ | Cl | Cl | Cl | |
| 3-244 | 7-Cl | CH(CH₃)CH₂SOCH₃ | Cl | Cl | Cl | |
| 3-245 | 7-Cl | CH(CH₃)CH₂SO₂CH₃ | Cl | Cl | Cl | |
| 3-246 | 7-Cl | CH(CH₃)₂ | CH₃ | H | OCF₃ | 81-84 |
| 3-247 | 7-Cl | C(CH₃)₂CH₂SCH₃CH₃ | H | OCF₃ | | |
| 3-248 | 7-Cl | C(CH₃)₂CH₂SOCH₃ | CH₃ | H | OCF₃ | |
| 3-249 | 7-Cl | C(CH₃)₂CH₂SO₂CH₃ | CH₃ | H | OCF₃ | |
| 3-250 | 7-Cl | CH(CH₃)CH₂SCH₃CH₃ | H | OCF₃ | | |
| 3-251 | 7-Cl | CH(CH₃)CH₂SOCH₃ | CH₃ | H | OCF₃ | |
| 3-252 | 7-Cl | CH(CH₃)CH₂SO₂CH₃ | CH₃ | H | OCF₃ | |
| 3-253 | 7-Cl | CH(CH₃)₂ | Cl | H | Cl | 152-154 |
| 3-254 | 7-Cl | C(CH₃)₂CH₂SCH₃ | Cl | H | Cl | |
| 3-255 | 7-Cl | C(CH₃)₂CH₂SOCH₃ | Cl | H | Cl | |
| 3-256 | 7-Cl | C(CH₃)₂CH₂SO₂CH₃ | Cl | H | Cl | |
| 3-257 | 7-Cl | CH(CH₃)CH₂SCH₃ | Cl | H | Cl | |
| 3-258 | 7-Cl | CH(CH₃)CH₂SOCH₃ | Cl | H | Cl | |
| 3-259 | 7-Cl | CH(CH₃)CH₂SO₂CH₃ | Cl | H | Cl | |
| 3-260 | 7-Cl | CH(CH₃)₂ | H | Cl | Cl | 201-202 |
| 3-261 | 7-Cl | C(CH₃)₂CH₂SCH₃ | H | Cl | Cl | |
| 3-262 | 7-Cl | C(CH₃)₂CH₂SOCH₃ | H | Cl | Cl | |
| 3-263 | 7-Cl | C(CH₃)₂CH₂SO₂CH₃ | H | Cl | Cl | |
| 3-264 | 7-Cl | CH(CH₃)CH₂SCH₃ | H | Cl | Cl | |
| 3-265 | 7-Cl | CH(CH₃)CH₂SOCH₃ | H | Cl | Cl | |
| 3-266 | 7-Cl | CH(CH₃)CH₂SO₂CH₃ | H | Cl | Cl | |
| 3-267 | 7-Cl | CH(CH₃)₂ | Cl | Cl | H | 206-208 |
| 3-268 | 7-Cl | C(CH₃)₂CH₂SCH₃ | Cl | Cl | H | |
| 3-269 | 7-Cl | C(CH₃)₂CH₂SOCH₃ | Cl | Cl | H | |
| 3-270 | 7-Cl | C(CH₃)₂CH₂SO₂CH₃ | Cl | Cl | H | |
| 3-271 | 7-Cl | CH(CH₃)CH₂SCH₃ | Cl | Cl | H | |
| 3-272 | 7-Cl | CH(CH₃)CH₂SOCH₃ | Cl | Cl | H | |
| 3-273 | 7-Cl | CH(CH₃)CH₂SO₂CH₃ | Cl | Cl | H | |
| 3-274 | 7-Cl | CH(CH₃)₂ | Cl | H | CF₃ | 122-136 |
| 3-275 | 7-Cl | C(CH₃)₂CH₂SCH₃ | Cl | H | CF₃ | |
| 3-276 | 7-Cl | C(CH₃)₂CH₂SOCH₃ | Cl | H | CF₃ | |
| 3-277 | 7-Cl | C(CH₃)₂CH₂SO₂CH₃ | Cl | H | CF₃ | |
| 3-278 | 7-Cl | CH(CH₃)CH₂SCH₃ | Cl | H | CF₃ | |
| 3-279 | 7-Cl | CH(C₃)CH₂SOCH₃ | Cl | H | CF₃ | |
| 3-280 | 7-Cl | CH(CH₃)CH₂SO₂CH₃ | Cl | H | CF₃ | |
| 3-281 | 7-Cl | CH(CH₃)₂ | Cl | H | CF₃ | |
| 3-282 | 7-Cl | C(CH₃)₂CH₂SCH₃ | Cl | H | CF₃ | |
| 3-283 | 7-Cl | C(CH₃)₂CH₂SOCH₃ | Cl | H | CF₃ | |
| 3-284 | 7-Cl | C(CH₃)₂CH₂SO₂CH₃Cl | H | CF₃ | | |
| 3-285 | 7-Cl | CH(CH₃)CH₂SCH₃ | Cl | H | CF₃ | |
| 3-286 | 7-Cl | CH(CH₃)CH₂SOCH₃ | Cl | H | CF₃ | |
| 3-287 | 7-Cl | CH(CH₃)CH₂SO₂CH₃ | Cl | H | CF₃ | |
| 3-288 | 7-Cl | CH(CH₃)₂ | H | H | Cl | 214-216 |
| 3-289 | 7-Cl | C(CH₃)₂CH₂SCH₃ | H | H | Cl | |
| 3-290 | 7-Cl | C(CH₃)₂CH₂SOCH₃ | H | H | Cl | |
| 3-291 | 7-Cl | C(CH₃)₂CH₂SO₂CH₃ | H | H | Cl | |
| 3-292 | 7-Cl | CH(CH₃)CH₂SCH₃ | H | H | Cl | |
| 3-293 | 7-Cl | CH(CH₃)CH₂SOCH₃ | H | H | Cl | |
| 3-294 | 7-Cl | CH(CH₃)CH₂SO₂CH₃ | H | H | Cl | |
| 3-295 | 7-Cl | CH(CH₃)₂ | CH₃ | H | Cl | 201-208 |
| 3-296 | 7-Cl | C(CH₃)₂CH₂SCH₃ | CH₃ | H | Cl | |
| 3-297 | 7-Cl | C(CH₃)₂CH₂SOCH₃ | CH₃ | H | Cl | |
| 3-298 | 7-Cl | C(CH₃)₂CH₂SO₂CH₃ | CH₃ | H | Cl | |
| 3-299 | 7-Cl | CH(CH₃)CH₂SCH₃ | CH₃ | H | Cl | |
| 3-300 | 7-Cl | CH(CH₃)CH₂SOCH₃ | CH₃ | H | Cl | |
| 3-301 | 7-Cl | CH(CH₃)CH₂SO₂CH₃ | CH₃ | H | Cl | |
| 3-302 | 7-Cl | CH(CH₃)₂ | H | H | OCF₃ | 174-179 |
| 3-303 | 7-Cl | C(CH₃)₂CH₂SCH₃ | H | H | OCF₃ | |
| 3-304 | 7-Cl | C(CH₃)₂CH₂SOCH₃ | H | H | OCF₃ | |
| 3-305 | 7-Cl | C(CH₃)₂CH₂SO₂CH₃ | H | H | OCF₃ | |
| 3-306 | 7-Cl | CH(CH₃)CH₂SCH₃ | H | H | OCF₃ | |
| 3-307 | 7-Cl | CH(CH₃)CH₂SOCH₃ | H | H | OCF₃ | |
| 3-308 | 7-Cl | CH(CH₃)CH₂SO₂CH₃ | H | H | OCF₃ | |
| 3-309 | 7-Cl | CH(CH₃)₂ | H | H | CF₃ | 176-177 |
| 3-310 | 7-Cl | C(CH₃)₂CH₂SCH₃ | H | H | CF₃ | |
| 3-311 | 7-Cl | C(CH₃)₂CH₂SOCH₃ | H | H | CF₃ | |
| 3-312 | 7-Cl | C(CH₃)₂CH₂SO₂CH₃ | H | H | CF₃ | |
| 3-313 | 7-Cl | CH(CH₃)CH₂SCH₃ | H | H | CF₃ | |
| 3-314 | 7-Cl | CH(CH₃)CH₂SOCH₃ | H | H | CF₃ | |
| 3-315 | 7-Cl | CH(CH₃)CH₂SO₂CH₃ | H | H | CF₃ | |
| 3-316 | 7-Cl | CH(CH₃)₂ | H | H | Ph-4-CF₃ | 210-212 |
| 3-317 | 7-Cl | C(CH₃)₂CH₂SCH₃ | H | H | Ph-4-CF₃ | |
| 3-318 | 7-Cl | C(CH₃)₂CH₂SOCH₃ | H | H | Ph-4-CF₃ | |
| 3-319 | 7-Cl | C(CH₃)₂CH₂SO₂CH₃ | H | H | Ph-4-CF₃ | |
| 3-320 | 7-Cl | CH(CH₃)CH₂SCH₃ | H | H | Ph-4-CF₃ | |
| 3-321 | 7-Cl | CH(CH₃)CH₂SOCH₃ | H | H | Ph-4-CF₃ | |
| 3-322 | 7-Cl | CH(CH₃)CH₂SO₂CH₃ | H | H | Ph-4-CF₃ | |
| 3-323 | 7-Cl | CH(CH₃)₂ | F | F | CF₃ | 196-198 |
| 3-324 | 7-Cl | C(CH₃)₂CH₂SCH₃ | F | F | CF₃ | |
| 3-325 | 7-Cl | C(CH₃)₂CH₂SOCH₃ | F | F | CF₃ | |
| 3-326 | 7-Cl | C(CH₃)₂CH₂SO₂CH₃ | F | F | CF₃ | |
| 3-327 | 7-Cl | CH(CH₃)CH₂SCH₃ | F | F | CF₃ | |
| 3-328 | 7-Cl | CH(CH₃)CH₂SOCH₃ | F | F | CF₃ | |
| 3-329 | 7-Cl | CH(CH₃)CH₂SO₂CH₃ | F | F | CF₃ | |
| 3-330 | 7-Cl | CH(CH₃)₂ | CH₃ | H | CCH(CF₃)₂ | >250 |
| 3-331 | 7-Cl | C(CH₃)₂CH₂SCH₃ | CH₃ | H | COH(CF₃)₂ | |
| 3-332 | 7-Cl | C(CH₃)₂CH₂SOCH₃ | CH₃ | H | COH(CF₃)₂ | |
| 3-333 | 7-Cl | C(CH₃)₂CH₂SO₂CH₃CH₃ | H | COH(CF₃)₂ | | |
| 3-334 | 7-Cl | CH(CH₃)CH₂SCH₃ | CH₃ | H | COH(CF₃)₂ | |
| 3-335 | 7-Cl | CH(CH₃)CH₂SOCH₃ | CH₃ | H | COH(CF₃)₂ | |
| 3-336 | 7-Cl | CH(CH₃)CH₂SO₂CH₃ | CH₃ | H | COH(CF₃)₂ | |
| 3-337 | 4-Br | CH(CH₃)₂ | CH₃ | H | CF(CF₃)₂ | |
| 3-338 | 4-Br | C(CH₃)₂CH₂SCH₃ | CH₃ | H | CF(CF₃)₂ | |
| 3-339 | 4-Br | C(CH₃)₂CH₂SOCH₃ | CH₃ | H | CF(CF₃)₂ | |
| 3-340 | 4-Br | C(CH₃)₂CH₂SO₂CH₃ | CH₃ | H | CF(CF₃)₂ | |
| 3-341 | 4-Br | CH(CH₃)CH₂SCH₃ | CH₃ | H | CF(CF₃)₂ | |
| 3-342 | 4-Br | CH(CH₃)CH₂SOCH₃ | CH₃ | H | CF(CF₃)₂ | |
| 3-343 | 4-Br | CH(CH₃)CH₂SO₂CH₃ | CH₃ | H | CF(CF₃)₂ | |
| 3-344 | 4-Br | CH(CH₃)₂ | H | H | CF(CF₃)₂ | |
| 3-345 | 4-Br | C(CH₃)₂CH₂SCH₃ | H | H | CF(CF₃)₂ | |
| 3-346 | 4-Br | O(CH₃)₂CH₂SOCH₃ | H | H | CF(CF₃)₂ | |
| 3-347 | 4-Br | C(CH₃)₂CH₂SO₂CH₃ | H | H | CF(CF₃)₂ | |
| 3-348 | 4-Br | CH(CH₃)CH₂SCH₃ | H | H | CF(CF₃)₂ | |
| 3-349 | 4-Br | CH(CH₃)CH₂SOCH₃ | H | H | CF(CF₃)₂ | |
| 3-350 | 4-Br | CH(CH₃)CH₂SO₂CH₃ | H | H | CF(CF₃)₂ | |
| 3-351 | 4-Br | CH(CH₃)₂ | Cl | Cl | Cl | |
| 3-352 | 4-Br | O(CH₃)₂CH₂SCH₃ | Cl | Cl | Cl | |
| 3-353 | 4-Br | O(CH₃)₂CH₂SOCH₃ | Cl | Cl | Cl | |
| 3-354 | 4-Br | O(CH₃)₂CH₂SO₂CH₃ | Cl | Cl | Cl | |
| 3-355 | 4-Br | CH(CH₃)CH₂SCH₃ | Cl | Cl | Cl | |
| 3-356 | 4-Br | CH(CH₃)CH₂SOCH₃ | Cl | Cl | Cl | |
| 3-357 | 4-Br | CH(CH₃)CH₂SO₂CH₃ | Cl | Cl | Cl | |
| 3-358 | 4-Br | CH(CH₃)₂ | CH₃ | H | OCF₃ | |
| 3-359 | 4-Br | O(CH₃)₂CH₂SCH₃ | CH₃ | H | OCF₃ | |
| 3-360 | 4-Br | O(CH₃)₂CH₂SOCH₃ | CH₃ | H | OCF₃ | |
| 3-361 | 4-Br | C(CH₃)₂CH₂SO₂CH₃ | CH₃ | H | OCF₃ | |
| 3-362 | 4-Br | CH(CH₃)₂CH₂SCH₃ | CH₃ | H | OCF₃ | |
| 3-363 | 4-Br | CH(CH₃)CH₂SOCH₃ | CH₃ | H | OCF₃ | |
| 3-364 | 4-Br | CH(CH₃)CH₂SO₂CH₃ | CH₃ | H | OCF₃ | |
| 3-365 | 4-Br | CH(CH₃)₂ | Cl | H | Cl | |
| 3-366 | 4-Br | C(CH₃)₂CH₂SCH₃ | Cl | H | Cl | |
| 3-367 | 4-Br | C(CH₃)₂CH₂SOCH₃ | Cl | H | Cl | |
| 3-368 | 4-Br | C(CH₃)₂CH₂SO₂CH₃ | Cl | H | Cl | |
| 3-369 | 4-Br | CH(CH₃)CH₂SCH₃ | Cl | H | Cl | |
| 3-370 | 4-Br | CH(CH₃)CH₂SOCH₃ | Cl | H | Cl | |
| 3-371 | 4-Br | CH(CH₃)CH₂SO₂CH₃ | Cl | H | Cl | |
| 3-372 | 4-Br | CH(CH₃)₂ | H | Cl | Cl | |
| 3-373 | 4-Br | O(CH₃)₂CH₂SCH₃ | H | Cl | Cl | |
| 3-374 | 4-Br | O(CH₃)₂CH₂SOCH₃ | H | Cl | Cl | |
| 3-375 | 4-Br | C(CH₃)₂CH₂SO₂CH₃ | H | Cl | Cl | |
| 3-376 | 4-Br | CH(CH₃)CH₂SCH₃ | H | Cl | Cl | |
| 3-377 | 4-Br | CH(CH₃)CH₂SOCH₃ | H | Cl | Cl | |
| 3-378 | 4-Br | CH(CH₃)CH₂SO₂CH₃ | H | Cl | Cl | |
| 3-379 | 4-Br | CH(CH₃)₂ | Cl | Cl | H | |
| 3-380 | 4-Br | C(CH₃)₂CH₂SCH₃ | Cl | Cl | H | |
| 3-381 | 4-Br | C(CH₃)₂CH₂SOCH₃ | Cl | Cl | H | |
| 3-382 | 4-Br | C(CH₃)₂CH₂SO₂CH₃ | Cl | Cl | H | |
| 3-383 | 4-Br | CH(CH₃)CH₂SCH₃ | Cl | Cl | H | |
| 3-384 | 4-Br | CH(CH₃)CH₂SOCH₃ | Cl | Cl | H | |
| 3-385 | 4-Br | CH(CH₃)CH₂SO₂CH₃ | Cl | Cl | H | |
| 3-386 | 4-Br | CH(CH₃)₂ | Cl | H | CF₃ | |
| 3-387 | 4-Br | C(CH₃)₂CH₂SCH₃ | Cl | H | CF₃ | |
| 3-388 | 4-Br | C(CH₃)₂CH₂SOCH₃ | Cl | H | CF₃ | |
| 3-389 | 4-Br | C(CH₃)₂CH₂SO₂CH₃ | Cl | H | CF₃ | |
| 3-390 | 4-Br | CH(CH₃)CH₂SCH₃ | Cl | H | CF₃ | |
| 3-391 | 4-Br | CH(CH₃)CH₂SOCH₃ | Cl | H | CF₃ | |
| 3-392 | 4-Br | CH(CH₃)CH₂SO₂CH₃ | Cl | H | CF₃ | |
| 3-393 | 4-Br | CH(CH₃)₂ | Cl | H | CF₃ | |
| 3-394 | 4-Br | C(CH₃)₂CH₂SCH₃ | Cl | H | CF₃ | |
| 3-395 | 4-Br | C(CH₃)₂CH₂SOCH₃ | Cl | H | CF₃ | |
| 3-396 | 4-Br | C(CH₃)₂CH₂SO₂CH₃ | Cl | H | CF₃ | |
| 3-397 | 4-Br | CH(CH₃)CH₂SCH₃ | Cl | H | CF₃ | |
| 3-398 | 4-Br | CH(CH₃)CH₂SOCH₃ | Cl | H | CF₃ | |
| 3-399 | 4-Br | CH(CH₃)CH₂SO₂CH₃ | Cl | H | CF₃ | |
| 3-400 | 4-Br | CH(CH₃)₂ | H | H | Cl | |
| 3-401 | 4-Br | C(CH₃)₂CH₂SCH₃ | H | H | Cl | |
| 3-402 | 4-Br | C(CH₃)₂CH₂SOCH₃ | H | H | Cl | |
| 3-403 | 4-Br | C(CH₃)₂CH₂SO₂CH₃ | H | H | Cl | |
| 3-404 | 4-Br | CH(CH₃)CH₂SCH₃ | H | H | Cl | |
| 3-405 | 4-Br | CH(CH₃)CH₂SOCH₃ | H | H | Cl | |
| 3-406 | 4-Br | CH(CH₃)CH₂SO₂CH₃ | H | H | Cl | |
| 3-407 | 4-Br | CH(CH₃)₂ | CH₃ | H | Cl | |
| 3-408 | 4-Br | C(CH₃)₂CH₂SCH₃ | CH₃ | H | Cl | |
| 3-409 | 4-Br | C(CH₃)₂CH₂SOCH₃ | CH₃ | H | Cl | |
| 3-410 | 4-Br | C(CH₃)₂CH₂SO₂CH₃ | CH₃ | H | Cl | |
| 3-411 | 4-Br | CH(CH₃)CH₂SCH₃ | CH₃ | H | Cl | |
| 3-412 | 4-Br | CH(CH₃)CH₂SOCH₃ | CH₃ | H | Cl | |
| 3-413 | 4-Br | CH(CH₃)CH₂SO₂CH₃ | CH₃ | H | Cl | |
| 3-414 | 4-Br | CH(CH₃)₂ | H | H | OCF₃ | |
| 3-415 | 4-Br | C(CH₃)₂CH₂SCH₃ | H | H | OCF₃ | |
| 3-416 | 4-Br | C(CH₃)₂CH₂SOCH₃ | H | H | OCF₃ | |
| 3-417 | 4-Br | C(CH₃)₂CH₂SO₂CH₃ | H | H | OCF₃ | |
| 3-418 | 4-Br | CH(CH₃)CH₂SCH₃ | H | H | OCF₃ | |
| 3-419 | 4-Br | CH(CH₃)CH₂SOCH₃ | H | H | OCF₃ | |
| 3-420 | 4-Br | CH(CH₃)CH₂SO₂CH₃ | H | H | OCF₃ | |
| 3-421 | 4-Br | CH(CH₃)₂ | H | H | CF₃ | |
| 3-422 | 4-Br | C(CH₃)₂CH₂SCH₃ | H | H | CF₃ | |
| 3-423 | 4-Br | C(CH₃)₂CH₂SOCH₃ | H | H | CF₃ | |
| 3-424 | 4-Br | C(CH₃)₂CH₂SO₂CH₃ | H | H | CF₃ | |
| 3-425 | 4-Br | CH(CH₃)CH₂SCH₃ | H | H | CF₃ | |
| 3-426 | 4-Br | CH(CH₃)CH₂SOCH₃ | H | H | CF₃ | |
| 3-427 | 4-Br | CH(CH₃)CH₂SO₂CH₃ | H | H | CF₃ | |
| 3-428 | 4-Br | CH(CH₃)₂ | H | H | Ph-4-CF₃ | |
| 3-429 | 4-Br | C(CH₃)₂CH₂SCH₃ | H | H | Ph-4-CF₃ | |
| 3-430 | 4-Br | C(CH₃)₂CH₂SOCH₃ | H | H | Ph-4-CF₃ | |
| 3-431 | 4-Br | C(CH₃)₂CH₂SO₂CH₃ | H | H | Ph-4-CF₃ | |
| 3-432 | 4-Br | CH(CH₃)CH₂SCH₃ | H | H | Ph-4-CF₃ | |
| 3-433 | 4-Br | CH(CH₃)CH₂SOCH₃ | H | H | Ph-4-CF₃ | |
| 3-434 | 4-Br | CH(CH₃)CH₂SO₂CH₃ | H | H | Ph-4-CF₃ | |
| 3-435 | 4-Br | CH(CH₃)₂ | F | F | CF₃ | |
| 3-436 | 4-Br | C(CH₃)₂CH₂SCH₃ | F | F | CF₃ | |
| 3-437 | 4-Br | C(CH₃)₂CH₂SOCH₃ | F | F | CF₃ | |
| 3-438 | 4-Br | C(CH₃)₂CH₂SO₂CH₃ | F | F | CF₃ | |
| 3-439 | 4-Br | CH(CH₃)CH₂SCH₃ | F | F | CF₃ | |
| 3-440 | 4-Br | CH(CH₃)CH₂SOCH₃ | F | F | CF₃ | |
| 3-441 | 4-Br | CH(CH₃)CH₂SO₂CH₃ | F | F | CF₃ | |
| 3-442 | 4-Br | CH(CH₃)₂ | CH₃ | H | COH(CF₃)₂ | |
| 3-443 | 4-Br | C(CH₃)₂CH₂SCH₃ | CH₃ | H | COH(CF₃)₂ | |
| 3-444 | 4-Br | C(CH₃)₂CH₂SOCH₃ | CH₃ | H | COH(CF₃)₂ | |
| 3-445 | 4-Br | C(CH₃)₂CH₂SO₂CH₃ | CH₃ | H | COH(CF₃)₂ | |
| 3-446 | 4-Br | CH(CH₃)CH₂SCH₃ | CH₃ | H | COH(CF₃)₂ | |
| 3-447 | 4-Br | CH(CH₃)CH₂SOCH₃ | CH₃ | H | COH(CF₃)₂ | |
| 3-448 | 4-Br | CH(CH₃)CH₂SO₂CH₃ | CH₃ | H | COH(CF₃)₂ | |
| 3-449 | 7-Br | CH(CH₃)₂ | CH₃ | H | CF(CF₃)₂ | |
| 3-450 | 7-Br | C(CH₃)₂CH₂SCH₃ | CH₃ | H | CF(CF₃)₂ | |
| 3-451 | 7-Br | C(CH₃)₂CH₂SOCH₃ | CH₃ | H | CF(CF₃)₂ | |
| 3-452 | 7-Br | C(CH₃)₂CH₂SO₂CH₃ | CH₃ | H | CF(CF₃)₂ | |
| 3-453 | 7-Br | CH(CH₃)CH₂SCH₃ | CH₃ | H | CF(CF₃)₂ | |
| 3-454 | 7-Br | CH(CH₃)CH₂SOCH₃ | CH₃ | H | CF(CF₃)₂ | |
| 3-455 | 7-Br | CH(CH₃)CH₂SO₂CH₃ | CH₃ | H | CF(CF₃)₂ | |
| 3-456 | 7-Br | CH(CH₃)₂ | H | H | CF(CF₃)₂ | |
| 3-457 | 7-Br | C(CH₃)₂CH₂SCH₃ | H | H | CF(CF₃)₂ | |
| 3-458 | 7-Br | C(CH₃)₂CH₂SOCH₃ | H | H | CF(CF₃)₂ | |
| 3-459 | 7-Br | C(CH₃)₂CH₂SO₂CH₃ | H | H | CF(CF₃)₂ | |
| 3-460 | 7-Br | CH(CH₃)CH₂SCH₃ | H | H | CF(CF₃)₂ | |
| 3-461 | 7-Br | CH(CH₃)CH₂SOCH₃ | H | H | CF(CF₃)₂ | |
| 3-462 | 7-Br | CH(CH₃)CH₂SO₂CH₃ | H | H | CF(CF₃)₂ | |
| 3-463 | 7-Br | CH(CH₃)₂ | Cl | Cl | Cl | |
| 3-464 | 7-Br | C(CH₃)₂CH₂SCH₃ | Cl | Cl | Cl | |
| 3-465 | 7-Br | C(CH₃)₂CH₂SOCH₃ | Cl | Cl | Cl | |
| 3-466 | 7-Br | C(CH₃)₂CH₂SO₂CH₃ | Cl | Cl | Cl | |
| 3-467 | 7-Br | CH(CH₃)CH₂SCH₃ | Cl | Cl | Cl | |
| 3-468 | 7-Br | CH(CH₃)CH₂SOCH₃ | Cl | Cl | Cl | |
| 3-469 | 7-Br | CH(CH₃)CH₂SO₂CH₃ | Cl | Cl | Cl | |
| 3-470 | 7-Br | CH(CH₃)₂ | CH₃ | H | OCF₃ | |
| 3-471 | 7-Br | C(CH₃)₂CH₂SCH₃ | CH₃ | H | OCF₃ | |
| 3-472 | 7-Br | C(CH₃)₂CH₂SOCH₃ | CH₃ | H | OCF₃ | |
| 3-473 | 7-Br | C(CH₃)₂CH₂SO₂CH₃ | CH₃ | H | OCF₃ | |
| 3-474 | 7-Br | CH(CH₃)CH₂SCH₃ | CH₃ | H | OCF₃ | |
| 3-475 | 7-Br | CH(CH₃)CH₂SOCH₃ | CH₃ | H | OCF₃ | |
| 3-476 | 7-Br | CH(CH₃)CH₂SO₂CH₃ | CH₃ | H | OCF₃ | |
| 3-477 | 7-Br | CH(CH₃)₂ | Cl | H | Cl | |
| 3-478 | 7-Br | C(CH₃)₂CH₂SCH₃ | Cl | H | Cl | |
| 3-479 | 7-Br | C(CH₃)₂CH₂SOCH₃ | Cl | H | Cl | |
| 3-480 | 7-Br | C(CH₃)₂CH₂SO₂CH₃ | Cl | H | Cl | |
| 3-481 | 7-Br | CH(CH₃)CH₂SCH₃ | Cl | H | Cl | |
| 3-482 | 7-Br | CH(CH₃)CH₂SOCH₃ | Cl | H | Cl | |
| 3-483 | 7-Br | CH(CH₃)CH₂SO₂CH₃ | Cl | H | Cl | |
| 3-484 | 7-Br | CH(CH₃)₂ | H | Cl | Cl | |
| 3-485 | 7-Br | C(CH₃)₂CH₂SCH₃ | H | Cl | Cl | |
| 3-486 | 7-Br | C(CH₃)₂CH₂SOCH₃ | H | Cl | Cl | |
| 3-487 | 7-Br | C(CH₃)₂CH₂SO₂CH₃ | H | Cl | Cl | |
| 3-488 | 7-Br | CH(CH₃)CH₂SCH₃ | H | Cl | Cl | |
| 3-489 | 7-Br | CH(CH₃)CH₂SOCH₃ | H | Cl | Cl | |
| 3-490 | 7-Br | CH(CH₃)CH₂SO₂CH₃ | H | Cl | Cl | |
| 3-491 | 7-Br | CH(CH₃)₂ | Cl | Cl | H | |
| 3-492 | 7-Br | C(CH₃)₂CH₂SCH₃ | Cl | Cl | H | |
| 3-493 | 7-Br | C(CH₃)₂CH₂SOCH₃ | Cl | Cl | H | |
| 3-494 | 7-Br | C(CH₃)₂CH₂SO₂CH₃ | Cl | Cl | H | |
| 3-495 | 7-Br | CH(CH₃)CH₂SCH₃ | Cl | Cl | H | |
| 3-496 | 7-Br | CH(CH₃)CH₂SOCH₃ | Cl | Cl | H | |
| 3-497 | 7-Br | CH(CH₃)CH₂SO₂CH₃ | Cl | Cl | H | |
| 3-498 | 7-Br | CH(CH₃)₂ | Cl | H | CF₃ | |
| 3-499 | 7-Br | C(CH₃)₂CH₂SCH₃ | Cl | H | CF₃ | |
| 3-500 | 7-Br | C(CH₃)₂CH₂SOCH₃ | Cl | H | CF₃ | |
| 3-501 | 7-Br | C(CH₃)₂CH₂SO₂CH₃ | Cl | H | CF₃ | |
| 3-502 | 7-Br | CH(CH₃)CH₂SCH₃ | Cl | H | CF₃ | |
| 3-503 | 7-Br | CH(CH₃)CH₂SOCH₃ | Cl | H | CF₃ | |
| 3-504 | 7-Br | CH(CH₃)CH₂SO₂CH₃ | Cl | H | CF₃ | |
| 3-505 | 7-Br | CH(CH₃)₂ | Cl | H | CF₃ | |
| 3-506 | 7-Br | C(CH₃)₂CH₂SCH₃ | Cl | H | CF₃ | |
| 3-507 | 7-Br | C(CH₃)₂CH₂SOCH₃ | Cl | H | CF₃ | |
| 3-508 | 7-Br | C(CH₃)₂CH₂SO₂CH₃ | Cl | H | CF₃ | |
| 3-509 | 7-Br | CH(CH₃)CH₂SCH₃ | Cl | H | CF₃ | |
| 3-510 | 7-Br | CH(CH₃)CH₂SOCH₃ | Cl | H | CF₃ | |
| 3-511 | 7-Br | CH(CH₃)CH₂SO₂CH₃ | Cl | H | CF₃ | |
| 3-512 | 7-Br | CH(CH₃)₂ | H | H | Cl | |
| 3-513 | 7-Br | C(CH₃)₂CH₂SCH₃ | H | H | Cl | |
| 3-514 | 7-Br | C(CH₃)₂CH₂SOCH₃ | H | H | Cl | |
| 3-515 | 7-Br | C(CH₃)₂CH₂SO₂CH₃ | H | H | Cl | |
| 3-516 | 7-Br | CH(CH₃)CH₂SCH₃ | H | H | Cl | |
| 3-517 | 7-Br | CH(CH₃)CH₂SOCH₃ | H | H | Cl | |
| 3-518 | 7-Br | CH(CH₃)CH₂SO₂CH₃ | H | H | Cl | |
| 3-519 | 7-Br | CH(CH₃)₂ | CH₃ | H | Cl | |
| 3-520 | 7-Br | C(CH₃)₂CH₂SCH₃ | CH₃ | H | Cl | |
| 3-521 | 7-Br | C(CH₃)₂CH₂SOCH₃ | CH₃ | H | Cl | |
| 3-522 | 7-Br | C(CH₃)₂CH₂SO₂CH₃ | CH₃ | H | Cl | |
| 3-523 | 7-Br | CH(CH₃)CH₂SCH₃ | CH₃ | H | Cl | |
| 3-524 | 7-Br | CH(CH₃)CH₂SOCH₃ | CH₃ | H | Cl | |
| 3-525 | 7-Br | CH(CH₃)CH₂SO₂CH₃ | CH₃ | H | Cl | |
| 3-526 | 7-Br | CH(CH₃)₂ | H | H | OCF₃ | |
| 3-527 | 7-Br | C(CH₃)₂CH₂SCH₃ | H | H | OCF₃ | |
| 3-528 | 7-Br | C(CH₃)₂CH₂SOCH₃ | H | H | OCF₃ | |
| 3-529 | 7-Br | C(CH₃)₂CH₂SO₂CH₃ | H | H | OCF₃ | |
| 3-530 | 7-Br | CH(CH₃)CH₂SCH₃ | H | H | OCF₃ | |
| 3-531 | 7-Br | CH(CH₃)CH₂SOCH₃ | H | H | OCF₃ | |
| 3-532 | 7-Br | CH(CH₃)CH₂SO₂CH₃ | H | H | OCF₃ | |
| 3-533 | 7-Br | CH(CH₃)₂ | H | H | CF₃ | |
| 3-534 | 7-Br | C(CH₃)₂CH₂SCH₃ | H | H | CF₃ | |
| 3-535 | 7-Br | C(CH₃)₂CH₂SOCH₃ | H | H | CF₃ | |
| 3-536 | 7-Br | C(CH₃)₂CH₂SO₂CH₃ | H | H | CF₃ | |
| 3-537 | 7-Br | CH(CH₃)CH₂SCH₃ | H | H | CF₃ | |
| 3-538 | 7-Br | CH(CH₃)CH₂SOCH₃ | H | H | CF₃ | |
| 3-539 | 7-Br | CH(CH₃)CH₂SO₂CH₃ | H | H | CF₃ | |
| 3-540 | 7-Br | CH(CH₃)₂ | H | H | Ph-4-CF₃ | |
| 3-541 | 7-Br | C(CH₃)₂CH₂SCH₃ | H | H | Ph-4-CF₃ | |
| 3-542 | 7-Br | C(CH₃)₂CH₂SOCH₃ | H | H | Ph-4-CF₃ | |
| 3-543 | 7-Br | C(CH₃)₂CH₂SO₂CH₃ | H | H | Ph-4-CF₃ | |
| 3-544 | 7-Br | CH(CH₃)CH₂SCH₃ | H | H | Ph-4-CF₃ | |
| 3-545 | 7-Br | CH(CH₃)CH₂SOCH₃ | H | H | Ph-4-CF₃ | |
| 3-546 | 7-Br | CH(CH₃)CH₂SO₂CH₃ | H | H | Ph-4-CF₃ | |
| 3-547 | 7-Br | CH(CH₃)₂ | F | F | CF₃ | |
| 3-548 | 7-Br | C(CH₃)₂CH₂SCH₃ | F | F | CF₃ | |
| 3-549 | 7-Br | C(CH₃)₂CH₂SOCH₃ | F | F | CF₃ | |
| 3-550 | 7-Br | C(CH₃)₂CH₂SO₂CH₃ | F | F | OF3 | |
| 3-551 | 7-Br | CH(CH₃)CH₂SCH₃ | F | F | CF₃ | |
| 3-552 | 7-Br | CH(CH₃)CH₂SOCH₃ | F | F | CF₃ | |
| 3-553 | 7-Br | CH(CH₃)CH₂SO₂CH₃ | F | F | CF₃ | |
| 3-554 | 7-Br | CH(CH₃)₂ | CH₃ | H | COH(CF₃)₂ | |
| 3-555 | 7-Br | C(CH₃)₂CH₂SCH₃ | CH₃ | H | COH(CF₃)₂ | |
| 3-556 | 7-Br | C(CH₃)₂CH₂SOCH₃ | CH₃ | H | COH(CF₃)₂ | |
| 3-557 | 7-Br | C(CH₃)₂CH₂SO₂CH₃ | CH₃ | H | COH(CF₃)₂ | |
| 3-558 | 7-Br | CH(CH₃)CH₂SCH₃ | CH₃ | H | COH(CF₃)₂ | |
| 3-559 | 7-Br | CH(CH₃)CH₂SOCH₃ | CH₃ | H | COH(CF₃)₂ | |
| 3-560 | 7-Br | CH(CH₃)CH₂SO₂CH₃ | CH₃ | H | COH(CF₃)₂ | |
| 3-561 | 4-I | CH(CH₃)₂ | CH₃ | H | CF(CF₃)₂ | |
| 3-562 | 4-1 | C(CH₃)₂CH₂SCH₃ | CH₃ | H | CF(CF₃)₂ | |
| 3-563 | 4-I | C(CH₃)₂CH₂SOCH₃ | CH₃ | H | CF(CF₃)₂ | |
| 3-564 | 4-I | C(CH₃)₂CH₂SO₂CH₃ | CH₃ | H | CF(CF₃)₂ | |
| 3-565 | 4-I | CH(CH₃)CH₂SCH₃ | CH₃ | H | CF(CF₃)₂ | 80-82 |
| 3-566 | 4-I | CH(CH₃)CH₂SOCH₃ | CH₃ | H | CF(CF₃)₂ | |
| 3-567 | 4-I | CH(CH₃)CH₂SO₂CH₃ | CH₃ | H | CF(CF₃)₂ | 110-117 |
| 3-568 | 4-I | CH(CH₃)₂ | H | H | CF(CF₃)₂ | |
| 3-569 | 4-I | C(CH₃)₂CH₂SCH₃ | H | H | CF(CF3h | |
| 3-570 | 4-I | C(CH₃)₂CH₂SOCH₃ | H | H | CF(CF₃)₂ | |
| 3-571 | 4-I | C(CH₃)₂CH₂SO₂CH₃ | H | H | CF(CF₃)₂ | |
| 3-572 | 4-I | CH(CH₃)CH₂SCH₃ | H | H | CF(CF₃)₂ | |
| 3-573 | 4-I | CH(CH₃)CH₂SOCH₃ | H | H | CF(CF₃)₂ | |
| 3-574 | 4-I | CH(CH₃)CH₂SO₂CH₃ | H | H | CF(CF₃)₂ | |
| 3-575 | 4-I | CH(CH₃)₂ | Cl | Cl | Cl | |
| 3-576 | 4-I | C(CH₃)₂CH₂SCH₃ | Cl | Cl | Cl | |
| 3-577 | 4-I | C(CH₃)₂CH₂SOCH₃ | Cl | Cl | Cl | |
| 3-578 | 4-I | C(CH₃)₂CH₂SO₂CH₃ | Cl | Cl | Cl | |
| 3-579 | 4-I | CH(CH₃)CH₂SCH₃ | Cl | Cl | Cl | |
| 3-580 | 4-I | CH(CH₃)CH₂SOCH₃ | Cl | Cl | Cl | |
| 3-581 | 4-I | CH(CH₃)CH₂SO₂CH₃ | Cl | Cl | Cl | |
| 3-582 | 4-I | CH(CH₃)₂ | CH₃ | H | OCF₃ | |
| 3-583 | 4-I | C(CH₃)₂CH₂SCH₃ | CH₃ | H | OCF₃ | |
| 3-584 | 4-I | C(CH₃)₂CH₂SOCH₃ | CH₃ | H | OCF₃ | |
| 3-585 | 4-I | C(CH₃)₂CH₂SO₂CH₃ | CH₃ | H | OCF₃ | |
| 3-586 | 4-I | CH(CH₃)CH₂SCH₃ | CH₃ | H | OCF₃ | |
| 3-587 | 4-I | CH(CH₃)CH₂SOCH₃ | CH₃ | H | OCF₃ | |
| 3-588 | 4-I | CH(CH₃)CH₂SO₂CH₃ | CH₃ | H | OCF₃ | |
| 3-589 | 4-I | CH(CH₃)₂ | Cl | H | Cl | |
| 3-590 | 4-I | C(CH₃)₂CH₂SCH₃ | Cl | H | Cl | |
| 3-591 | 4-I | C(CH₃)₂CH₂SOCH₃ | Cl | H | Cl | |
| 3-592 | 4-I | C(CH₃)₂CH₂SO₂CH₃ | Cl | H | Cl | |
| 3-593 | 4-I | CH(CH₃)CH₂SCH₃ | Cl | H | Cl | |
| 3-594 | 4-I | CH(CH₃)CH₂SOCH₃ | Cl | H | Cl | |
| 3-595 | 4-1 | CH(CH₃)CH₂SO₂CH₃ | Cl | H | Cl | |
| 3-596 | 4-I | CH(CH₃)₂ | H | Cl | Cl | |
| 3-597 | 4-I | C(CH₃)₂CH₂SCH₃ | H | Cl | Cl | |
| 3-598 | 4-I | C(CH₃)₂CH₂SOCH₃ | H | Cl | Cl | |
| 3-599 | 4-I | C(CH₃)₂CH₂SO₂CH₃ | H | Cl | Cl | |
| 3-600 | 4-I | CH(CH₃)CH₂SCH₃ | H | Cl | Cl | |
| 3-601 | 4-I | CH(CH₃)CH₂SOCH₃ | H | Cl | Cl | |
| 3-602 | 4-I | CH(CH₃)CH₂SO₂CH₃ | H | Cl | Cl | |
| 3-603 | 4-I | CH(CH₃)₂ | Cl | Cl | H | |
| 3-604 | 4-I | C(CH₃)₂CH₂SCH₃ | Cl | Cl | H | |
| 3-605 | 4-I | C(CH₃)₂CH₂SOCH₃ | Cl | Cl | H | |
| 3-606 | 4-I | C(CH₃)₂CH₂SO₂CH₃ | Cl | Cl | H | |
| 3-607 | 4-I | CH(CH₃)CH₂SCH₃ | Cl | Cl | H | |
| 3-608 | 4-I | CH(CH₃)CH₂SOCH₃ | Cl | Cl | H | |
| 3-609 | 4-I | CH(CH₃)CH₂SO₂CH₃ | | Cl | Cl | H |
| 3-610 | 4-I | CH(CH₃)₂ | Cl | H | CF₃ | |
| 3-611 | 4-I | C(CH₃)₂CH₂SCH₃ | Cl | H | CF₃ | |
| 3-612 | 4-I | C(CH₃)₂CH₂SOCH₃ | Cl | H | CF₃ | |
| 3-613 | 4-I | C(CH₃)₂CH₂SO₂CH₃ | Cl | H | CF₃ | |
| 3-614 | 4-I | CH(CH₃)CH₂SCH₃ | Cl | H | CF₃ | |
| 3-615 | 4-I | CH(CH₃)CH₂SOCH₃ | Cl | H | CF₃ | |
| 3-616 | 4-I | CH(CH₃)CH₂SO₂CH₃ | Cl | H | CF₃ | |
| 3-617 | 4-I | CH(CH₃)₂ | Cl | H | CF₃ | |
| 3-618 | 4-I | C(CH₃)₂CH₂SCH₃ | Cl | H | CF₃ | |
| 3-619 | 4-I | C(CH₃)₂CH₂SOCH₃ | Cl | H | CF₃ | |
| 3-620 | 4-I | C(CH₃)₂CH₂SO₂CH₃ | Cl | H | CF₃ | |
| 3-621 | 4-I | CH(CH₃)CH₂SCH₃ | Cl | H | CF₃ | |
| 3-622 | 4-I | CH(CH₃)CH₂SOCH₃ | Cl | H | CF₃ | |
| 3-623 | 4-I | CH(CH₃)CH₂SO₂CH₃ | Cl | H | CF₃ | |
| 3-624 | 4-I | CH(CH₃)₂ | H | H | Cl | |
| 3-625 | 4-I | C(CH₃)₂CH₂SCH₃ | H | H | Cl | |
| 3-626 | 4-I | C(CH₃)₂CH₂SOCH₃ | H | H | Cl | |
| 3-627 | 4-I | C(CH₃)₂CH₂SO₂CH₃ | H | H | Cl | |
| 3-628 | 4-I | CH(CH₃)CH₂SCH₃ | H | H | Cl | |
| 3-629 | 4-I | CH(CH₃)CH₂SOCH₃ | H | H | Cl | |
| 3-630 | 4-I | CH(CH₃)CH₂SO₂CH₃ | H | H | Cl | |
| 3-631 | 4-I | CH(CH₃)₂ | CH₃ | H | Cl | |
| 3-632 | 4-I | C(CH₃)₂CH₂SCH₃ | CH₃ | H | Cl | |
| 3-633 | 4-I | C(CH₃)₂CH₂SOCH₃ | CH₃ | H | Cl | |
| 3-634 | 4-I | C(CH₃)₂CH₂SO₂CH₃ | CH₃ | H | Cl | |
| 3-635 | 4-I | CH(CH₃)CH₂SCH₃ | CH₃ | H | Cl | |
| 3-636 | 4-I | CH(CH₃)CH₂SOCH₃ | CH₃ | H | Cl | |
| 3-637 | 4-I | CH(CH₃)CH₂SO₂CH₃ | CH₃ | H | Cl | |
| 3-638 | 4-I | CH(CH₃)₂ | H | H | OCF₃ | |
| 3-639 | 4-I | C(CH₃)₂CH₂SCH₃ | H | H | OCF₃ | |
| 3-640 | 4-I | C(CH₃)₂CH₂SOCH₃ | H | H | OCF₃ | |
| 3-641 | 4-I | C(CH₃)₂CH₂SO₂CH₃ | H | H | OCF₃ | |
| 3-642 | 4-I | CH(CH₃)CH₂SCH₃ | H | H | OCF₃ | |
| 3-643 | 4-I | CH(CH₃)CH₂SOCH₃ | H | H | OCF₃ | |
| 3-644 | 4-I | CH(CH₃)CH₂SO₂CH₃ | H | H | OCF₃ | |
| 3-645 | 4-I | CH(CH₃)₂ | H | H | CF₃ | |
| 3-646 | 4-I | C(CH₃)₂CH₂SCH₃ | H | H | CF₃ | |
| 3-647 | 4-I | C(CH₃)₂CH₂SOCH₃ | H | H | CF₃ | |
| 3-648 | 4-I | C(CH₃)₂CH₂SO₂CH₃ | H | H | CF₃ | |
| 3-649 | 4-I | CH(CH₃)CH₂SCH₃ | H | H | CF₃ | |
| 3-650 | 4-I | CH(CH₃)CH₂SOCH₃ | H | H | CF₃ | |
| 3-651 | 4-I | CH(CH₃)CH₂SO₂CH₃ | H | H | CF₃ | |
| 3-652 | 4-I | CH(CH₃)₂ | H | H | Ph-4-CF₃ | |
| 3-653 | 4-I | C(CH₃)₂CH₂SCH₃ | H | H | Ph-4-CF₃ | |
| 3-654 | 4-I | C(CH₃)₂CH₂SOCH₃ | H | H | Ph-4-CF₃ | |
| 3-655 | 4-I | C(CH₃)₂CH₂SO₂CH₃ | H | H | Ph-4-CF₃ | |
| 3-656 | 4-I | CH(CH₃)CH₂SCH₃ | H | H | Ph-4-CF₃ | |
| 3-657 | 4-I | CH(CH₃)CH₂SOCH₃ | H | H | Ph-4-CF₃ | |
| 3-658 | 4-I | CH(CH₃)CH₂SO₂CH₃ | H | H | Ph-4-CF₃ | |
| 3-659 | 4-I | CH(CH₃)₂ | F | F | CF₃ | |
| 3-660 | 4-I | C(CH₃)₂CH₂SCH₃ | F | F | CF₃ | |
| 3-661 | 4-I | C(CH₃)₂CH₂SOCH₃ | F | F | CF₃ | |
| 3-662 | 4-I | C(CH₃)₂CH₂SO₂CH₃ | F | F | CF₃ | |
| 3-663 | 4-I | CH(CH₃)CH₂SCH₃ | F | F | CF₃ | |
| 3-664 | 4-I | CH(CH₃)CH₂SOCH₃ | F | F | CF₃ | |
| 3-665 | 4-I | CH(CH₃)CH₂SO₂CH₃ | F | F | CF₃ | |
| 3-666 | 4-I | CH(CH₃)₂ | CH₃ | H | COH(CF₃)₂ | |
| 3-667 | 4-I | C(CH₃)₂CH₂SCH₃ | CH₃ | H | COH(CF₃)₂ | |
| 3-668 | 4-I | C(CH₃)₂CH₂SOCH₃ | CH₃ | H | OCH(CF₃)₂ | |
| 3-669 | 4-I | C(CH₃)₂CH₂SO₂CH₃ | CH₃ | H | COH(CF₃)₂ | |
| 3-670 | 4-I | CH(CH₃)CH₂SCH₃ | CH₃ | H | COH(CF₃)₂ | |
| 3-671 | 4-I | CH(CH₃)CH₂SOCH₃ | CH₃ | H | OCH(CF₃)₂ | |
| 3-672 | 4-I | CH(CH₃)CH₂SO₂CH₃ | CH₃ | H | COH(CF₃)₂ | |
| 3-673 | 7-I | CH(CH₃)₂ | CH₃ | H | CF(CF₃)₂ | |
| 3-674 | 7-I | C(CH₃)₂CH₂SCH₃ | CH₃ | H | CF(CF₃)₂ | |
| 3-675 | 7-I | C(CH₃)₂CH₂SOCH₃ | CH₃ | H | CF(CF₃)₂ | |
| 3-676 | 7-I | C(CH₃)₂CH₂SO₂CH₃ | CH₃ | H | CF(CF₃)₂ | |
| 3-677 | 7-I | CH(CH₃)CH₂SCH₃ | CH₃ | H | CF(CF₃)₂ | 156-161 |
| 3-678 | 7-I | CH(CH₃)CH₂SOCH₃ | CH₃ | H | CF(CF₃)₂ | |
| 3-679 | 7-I | CH(CH₃)CH₂SO₂CH₃ | CH₃ | H | CF(CF₃)₂ | 108-114 |
| 3-680 | 7-I | CH(CH₃)₂ | H | H | CF(CF₃)₂ | |
| 3-681 | 7-I | C(CH₃)₂CH₂SCH₃ | H | H | CF(CF₃)₂ | |
| 3-682 | 7-I | C(CH₃)₂CH₂SOCH₃ | H | H | CF(CF₃)₂ | |
| 3-683 | 7-I | C(CH₃)₂CH₂SO₂CH₃ | H | H | CF(CF₃)₂ | |
| 3-684 | 7-I | CH(CH₃)CH₂SCH₃ | H | H | CF(CF₃)₂ | |
| 3-685 | 7-I | CH(CH₃)CH₂SOCH₃ | H | H | CF(CF₃)₂ | |
| 3-686 | 7-I | CH(CH₃)CH₂SO₂CH₃ | H | H | CF(CF₃)₂ | |
| 3-687 | 7-I | CH(CH₃)₂ | Cl | Cl | Cl | |
| 3-688 | 7-I | C(CH₃)₂CH₂SCH₃ | Cl | Cl | Cl | |
| 3-689 | 7-I | C(CH₃)₂CH₂SOCH₃ | Cl | Cl | Cl | |
| 3-690 | 7-I | C(CH₃)₂CH₂SO₂CH₃ | Cl | Cl | Cl | |
| 3-691 | 7-I | CH(CH₃)CH₂SCH₃ | Cl | Cl | Cl | |
| 3-692 | 7-I | CH(CH₃)CH₂SOCH₃ | Cl | Cl | Cl | |
| 3-693 | 7-I | CH(CH₃)CH₂SO₂CH₃ | Cl | Cl | Cl | |
| 3-694 | 7-I | CH(CH₃)₂ | CH₃ | H | OCF₃ | |
| 3-695 | 7-I | C(CH₃)₂CH₂SCH₃ | CH₃ | H | OCF₃ | |
| 3-696 | 7-I | C(CH₃)₂CH₂SOCH₃ | CH₃ | H | OCF₃ | |
| 3-697 | 7-I | C(CH₃)₂CH₂SO₂CH₃ | CH₃ | H | OCF₃ | |
| 3-698 | 7-I | CH(CH₃)CH₂SCH₃ | CH₃ | H | OCF₃ | |
| 3-699 | 7-I | CH(CH₃)CH₂SOCH₃ | CH₃ | H | OCF₃ | |
| 3-700 | 7-I | CH(CH₃)CH₂SO₂CH₃ | CH₃ | H | OCF₃ | |
| 3-701 | 7-I | CH(CH₃)₂ | Cl | H | Cl | |
| 3-702 | 7-I | C(CH₃)₂CH₂SCH₃ | Cl | H | Cl | |
| 3-703 | 7-I | C(CH₃)₂CH₂SOCH₃ | Cl | H | Cl | |
| 3-704 | 7-I | C(CH₃)₂CH₂SO₂CH₃ | Cl | H | Cl | |
| 3-705 | 7-I | CH(CH₃)CH₂SCH₃ | Cl | H | Cl | |
| 3-706 | 7-I | CH(CH₃)CH₂SOCH₃ | Cl | H | Cl | |
| 3-707 | 7-I | CH(CH₃)CH₂SO₂CH₃ | Cl | H | Cl | |
| 3-708 | 7-I | CH(CH₃)₂ | H | Cl | Cl | |
| 3-709 | 7-I | C(CH₃)₂CH₂SCH₃ | H | Cl | Cl | |
| 3-710 | 7-I | C(CH₃)₂CH₂SOCH₃ | H | Cl | Cl | |
| 3-711 | 7-I | C(CH₃)₂CH₂SO₂CH₃ | H | Cl | Cl | |
| 3-712 | 7-I | CH(CH₃)CH₂SCH₃ | H | Cl | Cl | |
| 3-713 | 7-I | CH(CH₃)CH₂SOCH₃ | H | Cl | Cl | |
| 3-714 | 7-I | CH(CH₃)CH₂SO₂CH₃ | H | Cl | Cl | |
| 3-715 | 7-I | CH(CH₃)₂ | Cl | Cl | H | |
| 3-716 | 7-I | C(CH₃)₂CH₂SCH₃ | Cl | Cl | H | |
| 3-717 | 7-I | C(CH₃)₂CH₂SOCH₃ | Cl | Cl | H | |
| 3-718 | 7-I | C(CH₃)₂CH₂SO₂CH₃ | Cl | Cl | H | |
| 3-719 | 7-I | CH(CH₃)CH₂SCH₃ | Cl | Cl | H | |
| 3-720 | 7-I | CH(CH₃)CH₂SOCH₃ | Cl | Cl | H | |
| 3-721 | 7-I | CH(CH₃)CH₂SO₂CH₃ | Cl | Cl | H | |
| 3-722 | 7-I | CH(CH₃)₂ | Cl | H | CF₃ | |
| 3-723 | 7-I | C(CH₃)₂CH₂SCH₃ | Cl | H | CF₃ | |
| 3-724 | 7-I | C(CH₃)₂CH₂SOCH₃ | Cl | H | CF₃ | |
| 3-725 | 7-I | C(CH₃)₂CH₂SO₂CH₃ | Cl | H | CF₃ | |
| 3-726 | 7-I | CH(CH₃)CH₂SCH₃ | Cl | H | CF₃ | |
| 3-727 | 7-I | CH(CH₃)CH₂SOCH₃ | Cl | H | CF₃ | |
| 3-728 | 7-I | CH(CH₃)CH₂SO₂CH₃ | Cl | H | CF₃ | |
| 3-729 | 7-I | CH(CH₃)₂ | Cl | H | CF₃ | |
| 3-730 | 7-I | C(CH₃)₂CH₂SCH₃ | Cl | H | CF₃ | |
| 3-731 | 7-I | C(CH₃)₂CH₂SOCH₃ | Cl | H | CF₃ | |
| 3-732 | 7-I | C(CH₃)₂CH₂SO₂CH₃ | Cl | H | CF₃ | |
| 3-733 | 7-I | CH(CH₃)CH₂SCH₃ | Cl | H | CF₃ | |
| 3-734 | 7-I | CH(CH₃)CH₂SOCH₃ | Cl | H | CF₃ | |
| 3-735 | 7-I | CH(CH₃)CH₂SO₂CH₃ | Cl | H | CF₃ | |
| 3-736 | 7-I | CH(CH₃)₂ | H | H | Cl | |
| 3-737 | 7-I | C(CH₃)₂CH₂SCH₃ | H | H | Cl | |
| 3-738 | 7-I | C(CH₃)₂CH₂SOCH₃ | H | H | Cl | |
| 3-739 | 7-I | C(CH₃)₂CH₂SO₂CH₃ | H | H | Cl | |
| 3-740 | 7-I | CH(CH₃)CH₂SCH₃ | H | H | Cl | |
| 3-741 | 7-I | CH(CH₃)CH₂SOCH₃ | H | H | Cl | |
| 3-742 | 7-I | CH(CH₃)CH₂SO₂CH₃ | H | H | Cl | |
| 3-743 | 7-I | CH(CH₃)₂ | CH₃ | H | Cl | |
| 3-744 | 7-I | C(CH₃)₂CH₂SCH₃ | CH₃ | H | Cl | |
| 3-745 | 7-I | C(CH₃)₂CH₂SOCH₃ | CH₃ | H | Cl | |
| 3-746 | 7-I | C(CH₃)₂CH₂SO₂CH₃ | CH₃ | H | Cl | |
| 3-747 | 7-I | CH(CH₃)CH₂SCH₃ | CH₃ | H | Cl | |
| 3-748 | 7-I | CH(CH₃)CH₂SOCH₃ | CH₃ | H | Cl | |
| 3-749 | 7-I | CH(CH₃)CH₂SO₂CH₃ | CH₃ | H | Cl | |
| 3-750 | 7-I | CH(CH₃)₂ | H | H | OCF₃ | |
| 3-751 | 7-I | C(CH₃)₂CH₂SCH₃ | H | H | OCF₃ | |
| 3-752 | 7-I | C(CH₃)₂CH₂SOCH₃ | H | H | OCF₃ | |
| 3-753 | 7-I | C(CH₃)₂CH₂SO₂CH₃ | H | H | OCF₃ | |
| 3-754 | 7-I | CH(CH₃)CH₂SCH₃ | H | H | OCF₃ | |
| 3-755 | 7-I | CH(CH₃)CH₂SOCH₃ | H | H | OCF₃ | |
| 3-756 | 7-I | CH(CH₃)CH₂SO₂CH₃ | H | H | OCF₃ | |
| 3-757 | 7-I | CH(CH₃)₂ | H | H | CF₃ | |
| 3-758 | 7-I | C(CH₃)₂CH₂SCH₃ | H | H | CF₃ | |
| 3-759 | 7-I | C(CH₃)₂CH₂SOCH₃ | H | H | CF₃ | |
| 3-760 | 7-I | C(CH₃)₂CH₂SO₂CH₃ | H | H | CF₃ | |
| 3-761 | 7-I | CH(CH₃)CH₂SCH₃ | H | H | CF₃ | |
| 3-762 | 7-I | CH(CH₃)CH₂SOCH₃ | H | H | CF₃ | |
| 3-763 | 7-I | CH(CH₃)CH₂SO₂CH₃ | H | H | CF₃ | |
| 3-764 | 7-I | CH(CH₃)₂ | H | H | Ph-4-CF₃ | |
| 3-765 | 7-I | C(CH₃)₂CH₂SCH₃ | H | H | Ph-4-CF₃ | |
| 3-766 | 7-I | C(CH₃)₂CH₂SOCH₃ | H | H | Ph-4-CF₃ | |
| 3-767 | 7-I | C(CH₃)₂CH₂SO₂CH₃ | H | H | Ph-4-CF₃ | |
| 3-768 | 7-I | CH(CH₃)CH₂SCH₃ | H | H | Ph-4-CF₃ | |
| 3-769 | 7-I | CH(CH₃)CH₂SOCH₃ | H | H | Ph-4-CF₃ | |
| 3-770 | 7-I | CH(CH₃)CH₂SO₂CH₃ | H | H | Ph-4-CF₃ | |
| 3-771 | 7-I | CH(CH₃)₂ | F | F | CF₃ | |
| 3-772 | 7-I | C(CH₃)₂CH₂SCH₃ | F | F | CF₃ | |
| 3-773 | 7-I | C(CH₃)₂CH₂SOCH₃ | F | F | CF₃ | |
| 3-774 | 7-I | C(CH₃)₂CH₂SO₂CH₃ | F | F | CF₃ | |
| 3-775 | 7-I | CH(CH₃)CH₂SCH₃ | F | F | CF₃ | |
| 3-776 | 7-I | CH(CH₃)CH₂SOCH₃ | F | F | CF₃ | |
| 3-777 | 7-I | CH(CH₃)CH₂SO₂CH₃ | F | F | CF₃ | |
| 3-778 | 7-I | CH(CH₃)₂ | CH₃ | H | COH(CF₃)₂ | |
| 3-779 | 7-I | C(CH₃)₂CH₂SCH₃ | CH₃ | H | COH(CF₃)₂ | |
| 3-780 | 7-I | C(CH₃)₂CH₂SOCH₃ | CH₃ | H | COH(CF₃)₂ | |
| 3-781 | 7-I | C(CH₃)₂CH₂SO₂CH₃ | CH₃ | H | COH(CF₃)₂ | |
| 3-782 | 7-I | CH(CH₃)CH₂SCH₃ | CH₃ | H | COH(CF₃)₂ | |
| 3-783 | 7-I | CH(CH₃)CH₂SOCH₃ | CH₃ | H | COH(CF₃)₂ | |
| 3-784 | 7-I | CH(CH₃)CH₂SO₂CH₃ | CH₃ | H | COH(CF₃)₂ | |
| 3-785 | 4-F | CH(CH₃)₂ | CH₃ | H | CF(CF₃)₂ | |
| 3-786 | 4-F | C(CH₃)₂CH₂SCH₃ | CH₃ | H | CF(CF₃)₂ | |
| 3-787 | 4-F | C(CH₃)₂CH₂SOCH₃ | CH₃ | H | CF(CF₃)₂ | |
| 3-788 | 4-F | C(CH₃)₂CH₂SO₂CH₃ | CH₃ | H | CF(CF₃)₂ | |
| 3-789 | 4-F | CH(CH₃)CH₂SCH₃ | CH₃ | H | CF(CF₃)₂ | |
| 3-790 | 4-F | CH(CH₃)CH₂SOCH₃ | CH₃ | H | CF(CF₃)₂ | |
| 3-791 | 4-F | CH(CH₃)CH₂SO₂CH₃ | CH₃ | H | CF(CF₃)₂ | |
| 3-792 | 4-F | CH(CH₃)₂ | H | H | CF(CF₃)₂ | |
| 3-793 | 4-F | C(CH₃)₂CH₂SCH₃ | H | H | CF(CF₃)₂ | |
| 3-794 | 4-F | C(CH₃)₂CH₂SOCH₃ | H | H | CF(CF₃)₂ | |
| 3-795 | 4-F | C(CH₃)₂CH₂SO₂CH₃ | H | H | CF(CF₃)₂ | |
| 3-796 | 4-F | CH(CH₃)CH₂SCH₃ | H | H | CF(CF₃)₂ | |
| 3-797 | 4-F | CH(CH₃)CH₂SOCH₃ | H | H | CF(CF₃)₂ | |
| 3-798 | 4-F | CH(CH₃)CH₂SO₂CH₃ | H | H | CF(CF₃)₂ | |
| 3-799 | 4-F | CH(CH₃)₂ | Cl | Cl | Cl | |
| 3-800 | 4-F | C(CH₃)₂CH₂SCH₃ | Cl | Cl | Cl | |
| 3-801 | 4-F | C(CH₃)₂CH₂SOCH₃ | Cl | Cl | Cl | |
| 3-802 | 4-F | C(CH₃)₂CH₂SO₂CH₃ | Cl | Cl | Cl | |
| 3-803 | 4-F | CH(CH₃)CH₂SCH₃ | Cl | Cl | Cl | |
| 3-804 | 4-F | CH(CH₃)CH₂SOCH₃ | Cl | Cl | Cl | |
| 3-805 | 4-F | CH(CH₃)CH₂SO₂CH₃ | Cl | Cl | Cl | |
| 3-806 | 4-F | CH(CH₃)₂ | CH₃ | H | OCF₃ | |
| 3-807 | 4-F | C(CH₃)₂CH₂SCH₃ | CH₃ | H | OCF₃ | |
| 3-808 | 4-F | C(CH₃)₂CH₂SOCH₃ | CH₃ | H | OCF₃ | |
| 3-809 | 4-F | C(CH₃)₂CH₂SO₂CH₃ | CH₃ | H | OCF₃ | |
| 3-810 | 4-F | CH(CH₃)CH₂SCH₃ | CH₃ | H | OCF₃ | |
| 3-811 | 4-F | CH(CH₃)CH₂SOCH₃ | CH₃ | H | OCF₃ | |
| 3-812 | 4-F | CH(CH₃)CH₂SO₂CH₃ | CH₃ | H | OCF₃ | |
| 3-813 | 4-F | CH(CH₃)₂ | Cl | H | Cl | |
| 3-814 | 4-F | C(CH₃)₂CH₂SCH₃ | Cl | H | Cl | |
| 3-815 | 4-F | C(CH₃)₂CH₂SOCH₃ | Cl | H | Cl | |
| 3-816 | 4-F | C(CH₃)₂CH₂SO₂CH₃ | Cl | H | Cl | |
| 3-817 | 4-F | CH(CH₃)CH₂SCH₃ | Cl | H | Cl | |
| 3-818 | 4-F | CH(CH₃)CH₂SOCH₃ | Cl | H | Cl | |
| 3-819 | 4-F | CH(CH₃)CH₂SO₂CH₃ | Cl | H | Cl | |
| 3-820 | 4-F | CH(CH₃)₂ | H | Cl | Cl | |
| 3-821 | 4-F | C(CH₃)₂CH₂SCH₃ | H | Cl | Cl | |
| 3-822 | 4-F | C(CH₃)₂CH₂SOCH₃ | H | Cl | Cl | |
| 3-823 | 4-F | C(CH₃)₂CH₂SO₂CH₃ | H | Cl | Cl | |
| 3-824 | 4-F | CH(CH₃)CH₂SCH₃ | H | Cl | Cl | |
| 3-825 | 4-F | CH(CH₃)CH₂SOCH₃ | H | Cl | Cl | |
| 3-826 | 4-F | CH(CH₃)CH₂SO₂CH₃ | H | Cl | Cl | |
| 3-827 | 4-F | CH(CH₃)₂ | Cl | Cl | H | |
| 3-828 | 4-F | C(CH₃)₂CH₂SCH₃ | Cl | Cl | H | |
| 3-829 | 4-F | C(CH₃)₂CH₂SOCH₃ | Cl | Cl | H | |
| 3-830 | 4-F | C(CH₃)₂CH₂SO₂CH₃ | Cl | Cl | H | |
| 3-831 | 4-F | CH(CH₃)CH₂SCH₃ | Cl | Cl | H | |
| 3-832 | 4-F | CH(CH₃)CH₂SOCH₃ | Cl | Cl | H | |
| 3-833 | 4-F | CH(CH₃)CH₂SO₂CH₃ | Cl | Cl | H | |
| 3-834 | 4-F | CH(CH₃)₂ | Cl | H | CF₃ | |
| 3-835 | 4-F | C(CH₃)₂CH₂SCH₃ | Cl | H | CF₃ | |
| 3-836 | 4-F | C(CH₃)₂CH₂SOCH₃ | Cl | H | CF₃ | |
| 3-837 | 4-F | C(CH₃)₂CH₂SO₂CH₃ | Cl | H | CF₃ | |
| 3-838 | 4-F | CH(CH₃)CH₂SCH₃ | Cl | H | CF₃ | |
| 3-839 | 4-F | CH(CH₃)CH₂SOCH₃ | Cl | H | CF₃ | |
| 3-840 | 4-F | CH(CH₃)CH₂SO₂CH₃ | Cl | H | CF₃ | |
| 3-841 | 4-F | CH(CH₃)₂ | Cl | H | CF₃ | |
| 3-842 | 4-F | C(CH₃)₂CH₂SCH₃ | Cl | H | CF₃ | |
| 3-843 | 4-F | C(CH₃)₂CH₂SOCH₃ | Cl | H | CF₃ | |
| 3-844 | 4-F | C(CH₃)₂CH₂SO₂CH₃ | Cl | H | CF₃ | |
| 3-845 | 4-F | CH(CH₃)CH₂SCH₃ | Cl | H | CF₃ | |
| 3-846 | 4-F | CH(CH₃)CH₂SOCH₃ | Cl | H | CF₃ | |
| 3-847 | 4-F | CH(CH₃)CH₂SO₂CH₃ | Cl | H | CF₃ | |
| 3-848 | 4-F | CH(CH₃)₂ | H | H | Cl | |
| 3-849 | 4-F | C(CH₃)₂CH₂SCH₃ | H | H | Cl | |
| 3-850 | 4-F | C(CH₃)₂CH₂SOCH₃ | H | H | Cl | |
| 3-851 | 4-F | C(CH₃)₂CH₂SO₂CH₃ | H | H | Cl | |
| 3-852 | 4-F | CH(CH₃)CH₂SCH₃ | H | H | Cl | |
| 3-853 | 4-F | CH(CH₃)CH₂SOCH₃ | H | H | Cl | |
| 3-854 | 4-F | CH(CH₃)CH₂SO₂CH₃ | H | H | Cl | |
| 3-855 | 4-F | CH(CH₃)₂ | CH₃ | H | Cl | |
| 3-856 | 4-F | C(CH₃)₂CH₂SCH₃ | CH₃ | H | Cl | |
| 3-857 | 4-F | C(CH₃)₂CH₂SOCH₃ | CH₃ | H | Cl | |
| 3-858 | 4-F | C(CH₃)₂CH₂SO₂CH₃ | CH₃ | H | Cl | |
| 3-859 | 4-F | CH(CH₃)CH₂SCH₃ | CH₃ | H | Cl | |
| 3-860 | 4-F | CH(CH₃)CH₂SOCH₃ | CH₃ | H | Cl | |
| 3-861 | 4-F | CH(CH₃)CH₂SO₂CH₃ | CH₃ | H | Cl | |
| 3-862 | 4-F | CH(CH₃)₂ | H | H | OCF₃ | |
| 3-863 | 4-F | C(CH₃)₂CH₂SCH₃ | H | H | OCF₃ | |
| 3-864 | 4-F | C(CH₃)₂CH₂SOCH₃ | H | H | OCF₃ | |
| 3-865 | 4-F | C(CH₃)₂CH₂SO₂CH₃ | H | H | OCF₃ | |
| 3-866 | 4-F | CH(CH₃)CH₂SCH₃ | H | H | OCF₃ | |
| 3-867 | 4-F | CH(CH₃)CH₂SOCH₃ | H | H | OCF₃ | |
| 3-868 | 4-F | CH(CH₃)CH₂SO₂CH₃ | H | H | OCF₃ | |
| 3-869 | 4-F | CH(CH₃)₂ | H | H | CF₃ | |
| 3-870 | 4-F | C(CH₃)₂CH₂SCH₃ | H | H | CF₃ | |
| 3-871 | 4-F | C(CH₃)₂CH₂SOCH₃ | H | H | CF₃ | |
| 3-872 | 4-F | C(CH₃)₂CH₂SO₂CH₃ | H | H | CF₃ | |
| 3-873 | 4-F | CH(CH₃)CH₂SCH₃ | H | H | CF₃ | |
| 3-874 | 4-F | CH(CH₃)CH₂SOCH₃ | H | H | CF₃ | |
| 3-875 | 4-F | CH(CH₃)CH₂SO₂CH₃ | H | H | CF₃ | |
| 3-876 | 4-F | CH(CH₃)₂ | H | H | Ph-4-CF₃ | |
| 3-877 | 4-F | C(CH₃)₂CH₂SCH₃ | H | H | Ph-4-CF₃ | |
| 3-878 | 4-F | C(CH₃)₂CH₂SOCH₃ | H | H | Ph-4-CF₃ | |
| 3-879 | 4-F | C(CH₃)₂CH₂SO₂CH₃ | H | H | Ph-4-CF₃ | |
| 3-880 | 4-F | CH(CH₃)CH₂SCH₃ | H | H | Ph-4-CF₃ | |
| 3-881 | 4-F | CH(CH₃)CH₂SOCH₃ | H | H | Ph-4-CF₃ | |
| 3-882 | 4-F | CH(CH₃)CH₂SO₂CH₃ | H | H | Ph-4-CF₃ | |
| 3-883 | 4-F | CH(CH₃)₂ | F | F | CF₃ | |
| 3-884 | 4-F | C(CH₃)₂CH₂SCH₃ | F | F | CF₃ | |
| 3-885 | 4-F | C(CH₃)₂CH₂SOCH₃ | F | F | CF₃ | |
| 3-886 | 4-F | C(CH₃)₂CH₂SO₂CH₃ | F | F | CF₃ | |
| 3-887 | 4-F | CH(CH₃)CH₂SCH₃ | F | F | CF₃ | |
| 3-888 | 4-F | CH(CH₃)CH₂SOCH₃ | F | F | CF₃ | |
| 3-889 | 4-F | CH(CH₃)CH₂SO₂CH₃ | F | F | CF₃ | |
| 3-890 | 4-F | CH(CH₃)₂ | CH₃ | H | COH(CF₃)₂ | |
| 3-891 | 4-F | C(CH₃)₂CH₂SCH₃ | CH₃ | H | OCH(CF₃)₂ | |
| 3-892 | 4-F | C(CH₃)₂CH₂SOCH₃ | CH₃ | H | COH(CF₃)₂ | |
| 3-893 | 4-F | C(CH₃)₂CH₂SO₂CH₃ | CH₃ | H | OCH(CF₃)₂ | |
| 3-894 | 4-F | CH(CH₃)CH₂SCH₃ | CH₃ | H | OCH(CF₃)₂ | |
| 3-895 | 4-F | CH(CH₃)CH₂SOCH₃ | CH₃ | H | OCH(CF₃)₂ | |
| 3-896 | 4-F | CH(CH₃)CH₂SO₂CH₃ | CH₃ | H | OCH(CF₃)₂ | |
| 3-897 | 7-F | CH(CH₃)₂ | CH₃ | H | CF(CF₃)₂ | |
| 3-898 | 7-F | C(CH₃)₂CH₂SCH₃ | CH₃ | H | CF(CF₃)₂ | |
| 3-899 | 7-F | C(CH₃)₂CH₂SOCH₃ | CH₃ | H | CF(CF₃)₂ | |
| 3-900 | 7-F | C(CH₃)₂CH₂SO₂CH₃ | CH₃ | H | CF(CF₃)₂ | |
| 3-901 | 7-F | CH(CH₃)CH₂SCH₃ | CH₃ | H | CF(CF₃)₂ | |
| 3-902 | 7-F | CH(CH₃)CH₂SOCH₃ | CH₃ | H | CF(CF₃)₂ | |
| 3-903 | 7-F | CH(CH₃)CH₂SO₂CH₃ | CH₃ | H | CF(CF₃)₂ | |
| 3-904 | 7-F | CH(CH₃)₂ | H | H | CF(CF₃)₂ | |
| 3-905 | 7-F | C(CH₃)₂CH₂SCH₃ | H | H | CF(CF₃)₂ | |
| 3-906 | 7-F | C(CH₃)₂CH₂SOCH₃ | H | H | CF(CF₃)₂ | |
| 3-907 | 7-F | C(CH₃)₂CH₂SO₂CH₃ | H | H | CF(CF₃)₂ | |
| 3-908 | 7-F | CH(CH₃)CH₂SCH₃ | H | H | CF(CF₃)₂ | |
| 3-909 | 7-F | CH(CH₃)CH₂SOCH₃ | H | H | CF(CF₃)₂ | |
| 3-910 | 7-F | CH(CH₃)CH₂SO₂CH₃ | H | H | CF(CF₃)₂ | |
| 3-911 | 7-F | CH(CH₃)₂ | Cl | Cl | Cl | |
| 3-912 | 7-F | C(CH₃)₂CH₂SCH₃ | Cl | Cl | Cl | |
| 3-913 | 7-F | C(CH₃)₂CH₂SOCH₃ | Cl | Cl | Cl | |
| 3-914 | 7-F | C(CH₃)₂CH₂SO₂CH₃ | Cl | Cl | Cl | |
| 3-915 | 7-F | CH(CH₃)CH₂SCH₃ | Cl | Cl | Cl | |
| 3-916 | 7-F | CH(CH₃)CH₂SOCH₃ | Cl | Cl | Cl | |
| 3-917 | 7-F | CH(CH₃)CH₂SO₂CH₃ | Cl | Cl | Cl | |
| 3-918 | 7-F | CH(CH₃)₂ | CH₃ | H | OCF₃ | |
| 3-919 | 7-F | C(CH₃)₂CH₂SCH₃ | CH₃ | H | OCF₃ | |
| 3-920 | 7-F | C(CH₃)₂CH₂SOCH₃ | CH₃ | H | OCF₃ | |
| 3-921 | 7-F | C(CH₃)₂CH₂SO₂CH₃ | CH₃ | H | OCF₃ | |
| 3-922 | 7-F | CH(CH₃)CH₂SCH₃ | CH₃ | H | OCF₃ | |
| 3-923 | 7-F | CH(CH₃)CH₂SOCH₃ | CH₃ | H | OCF₃ | |
| 3-924 | 7-F | CH(CH₃)CH₂SO₂CH₃ | CH₃ | H | OCF₃ | |
| 3-925 | 7-F | CH(CH₃)₂ | Cl | H | Cl | |
| 3-926 | 7-F | C(CH₃)₂CH₂SCH₃ | Cl | H | Cl | |
| 3-927 | 7-F | C(CH₃)₂CH₂SOCH₃ | Cl | H | Cl | |
| 3-928 | 7-F | C(CH₃)₂CH₂SO₂CH₃ | Cl | H | Cl | |
| 3-929 | 7-F | CH(CH₃)CH₂SCH₃ | Cl | H | Cl | |
| 3-930 | 7-F | CH(CH₃)CH₂SOCH₃ | Cl | H | Cl | |
| 3-931 | 7-F | CH(CH₃)CH₂SO₂CH₃ | Cl | H | Cl | |
| 3-932 | 7-F | CH(CH₃)₂ | H | Cl | Cl | |
| 3-933 | 7-F | C(CH₃)₂CH₂SCH₃ | H | Cl | Cl | |
| 3-934 | 7-F | C(CH₃)₂CH₂SOCH₃ | H | Cl | Cl | |
| 3-935 | 7-F | C(CH₃)₂CH₂SO₂CH₃ | H | Cl | Cl | |
| 3-936 | 7-F | CH(CH₃)CH₂SCH₃ | H | Cl | Cl | |
| 3-937 | 7-F | CH(CH₃)CH₂SOCH₃ | H | Cl | Cl | |
| 3-938 | 7-F | CH(CH₃)CH₂SO₂CH₃ | H | Cl | Cl | |
| 3-939 | 7-F | CH(CH₃)₂ | Cl | Cl | H | |
| 3-940 | 7-F | C(CH₃)₂CH₂SCH₃ | Cl | Cl | H | |
| 3-941 | 7-F | C(CH₃)₂CH₂SOCH₃ | Cl | Cl | H | |
| 3-942 | 7-F | C(CH₃)₂CH₂SO₂CH₃ | Cl | Cl | H | |
| 3-943 | 7-F | CH(CH₃)CH₂SCH₃ | Cl | Cl | H | |
| 3-944 | 7-F | CH(CH₃)CH₂SOCH₃ | Cl | Cl | H | |
| 3-945 | 7-F | CH(CH₃)CH₂SO₂CH₃ | Cl | Cl | H | |
| 3-946 | 7-F | CH(CH₃)₂ | Cl | H | CF₃ | |
| 3-947 | 7-F | C(CH₃)₂CH₂SCH₃ | Cl | H | CF₃ | |
| 3-948 | 7-F | C(CH₃)₂CH₂SOCH₃ | Cl | H | CF₃ | |
| 3-949 | 7-F | C(CH₃)₂CH₂SO₂CH₃ | Cl | H | CF₃ | |
| 3-950 | 7-F | CH(CH₃)CH₂SCH₃ | Cl | H | CF₃ | |
| 3-951 | 7-F | CH(CH₃)CH₂SOCH₃ | Cl | H | CF₃ | |
| 3-952 | 7-F | CH(CH₃)CH₂SO₂CH₃ | Cl | H | CF₃ | |
| 3-953 | 7-F | CH(CH₃)₂ | Cl | H | CF₃ | |
| 3-954 | 7-F | C(CH₃)₂CH₂SCH₃ | Cl | H | CF₃ | |
| 3-955 | 7-F | C(CH₃)₂CH₂SOCH₃ | Cl | H | CF₃ | |
| 3-956 | 7-F | C(CH₃)₂CH₂SO₂CH₃Cl | H | CF₃ | | |
| 3-957 | 7-F | CH(CH₃)CH₂SCH₃ | Cl | H | CF₃ | |
| 3-958 | 7-F | CH(CH₃)CH₂SOCH₃ | Cl | H | CF₃ | |
| 3-959 | 7-F | CH(CH₃)CH₂SO₂CH₃ | Cl | H | CF₃ | |
| 3-960 | 7-F | CH(CH₃)₂ | H | H | Cl | |
| 3-961 | 7-F | C(CH₃)₂CH₂SCH₃ | H | H | Cl | |
| 3-962 | 7-F | C(CH₃)₂CH₂SOCH₃ | H | H | Cl | |
| 3-963 | 7-F | C(CH₃)₂CH₂SO₂CH₃ | H | H | Cl | |
| 3-964 | 7-F | CH(CH₃)CH₂SCH₃ | H | H | Cl | |
| 3-965 | 7-F | CH(CH₃)CH₂SOCH₃ | H | H | Cl | |
| 3-966 | 7-F | CH(CH₃)CH₂SO₂CH₃ | H | H | Cl | |
| 3-967 | 7-F | CH(CH₃)₂ | CH₃ | H | Cl | |
| 3-968 | 7-F | C(CH₃)₂CH₂SCH₃ | CH₃ | H | Cl | |
| 3-969 | 7-F | C(CH₃)₂CH₂SOCH₃ | CH₃ | H | Cl | |
| 3-970 | 7-F | C(CH₃)₂CH₂SO₂CH₃ | CH₃ | H | Cl | |
| 3-971 | 7-F | CH(CH₃)CH₂SCH₃ | CH₃ | H | Cl | |
| 3-972 | 7-F | CH(CH₃)CH₂SOCH₃ | CH₃ | H | Cl | |
| 3-973 | 7-F | CH(CH₃)CH₂SO₂CH₃ | CH₃ | H | Cl | |
| 3-974 | 7-F | CH(CH₃)₂ | H | H | OCF₃ | |
| 3-975 | 7-F | C(CH₃)₂CH₂SCH₃ | H | H | OCF₃ | |
| 3-976 | 7-F | C(CH₃)₂CH₂SOCH₃ | H | H | OCF₃ | |
| 3-977 | 7-F | C(CH₃)₂CH₂SO₂CH₃ | H | H | OCF₃ | |
| 3-978 | 7-F | CH(CH₃)CH₂SCH₃ | H | H | OCF₃ | |
| 3-979 | 7-F | CH(CH₃)CH₂SOCH₃ | H | H | OCF₃ | |
| 3-980 | 7-F | CH(CH₃)CH₂SO₂CH₃ | H | H | OCF₃ | |
| 3-981 | 7-F | CH(CH₃)₂ | H | H | CF₃ | |
| 3-982 | 7-F | C(CH₃)₂CH₂SCH₃ | H | H | CF₃ | |
| 3-983 | 7-F | C(CH₃)₂CH₂SOCH₃ | H | H | CF₃ | |
| 3-984 | 7-F | C(CH₃)₂CH₂SO₂CH₃ | H | H | CF₃ | |
| 3-985 | 7-F | CH(CH₃)CH₂SCH₃ | H | H | CF₃ | |
| 3-986 | 7-F | CH(CH₃)CH₂SOCH₃ | H | H | CF₃ | |
| 3-987 | 7-F | CH(CH₃)CH₂SO₂CH₃ | H | H | CF₃ | |
| 3-988 | 7-F | CH(CH₃)₂ | H | H | Ph-4-CF₃ | |
| 3-989 | 7-F | C(CH₃)₂CH₂SCH₃ | H | H | Ph-4-CF₃ | |
| 3-990 | 7-F | C(CH₃)₂CH₂SOCH₃ | H | H | Ph-4-CF₃ | |
| 3-991 | 7-F | C(CH₃)₂CH₂SO₂CH₃ | H | H | Ph-4-CF₃ | |
| 3-992 | 7-F | CH(CH₃)CH₂SCH₃ | H | H | Ph-4-CF₃ | |
| 3-993 | 7-F | CH(CH₃)CH₂SOCH₃ | H | H | Ph-4-CF₃ | |
| 3-994 | 7-F | CH(CH₃)CH₂SO₂CH₃ | H | H | Ph-4-CF₃ | |
| 3-995 | 7-F | CH(CH₃)₂ | F | F | CF₃ | |
| 3-996 | 7-F | C(CH₃)₂CH₂SCH₃ | F | F | CF₃ | |
| 3-997 | 7-F | C(CH₃)₂CH₂SOCH₃ | F | F | CF₃ | |
| 3-998 | 7-F | C(CH₃)₂CH₂SO₂CH₃ | F | F | CF₃ | |
| 3-999 | 7-F | CH(CH₃)CH₂SCH₃ | F | F | CF₃ | |
| 3-1000 | 7-F | CH(CH₃)CH₂SOCH₃ | F | F | CF₃ | |
| 3-1001 | 7-F | CH(CH₃)CH₂SO₂CH₃ | F | F | CF₃ | |
| 3-1002 | 7-F | CH(CH₃)₂ | CH₃ | H | COH(CF₃)₂ | |
| 3-1003 | 7-F | C(CH₃)₂CH₂SCH₃ | CH₃ | H | COH(CF₃)₂ | |
| 3-1004 | 7-F | C(CH₃)₂CH₂SOCH₃ | CH₃ | H | COH(CF₃)₂ | |
| 3-1005 | 7-F | C(CH₃)₂CH₂SO₂CH₃ | CH₃ | H | COH(CF₃)₂ | |
| 3-1006 | 7-F | CH(CH₃)CH₂SCH₃ | CH₃ | H | COH(CF₃)₂ | |
| 3-1007 | 7-F | CH(CH₃)CH₂SOCH₃ | CH₃ | H | COH(CF₃)₂ | |
| 3-1008 | 7-F | CH(CH₃)CH₂SO₂CH₃ | CH₃ | H | COH(CF₃)₂ | |
| 3-1009 | 4-NO₂ | CH(CH₃)₂ | CH₃ | H | CF(CF₃)₂ | |
| 3-1010 | 4-NO₂ | C(CH₃)₂CH₂SCH₃ | CH₃ | H | CF(CF₃)₂ | |
| 3-1011 | 4-NO₂ | C(CH₃)₂CH₂SOCH₃ | CH₃ | H | CF(CF₃)₂ | |
| 3-1012 | 4-NO₂ | C(CH₃)₂CH₂SO₂CH₃ | CH₃ | H | CF(CF₃)₂ | |
| 3-1013 | 4-NO₂ | CH(CH₃)CH₂SCH₃ | CH₃ | H | CF(CF₃)₂ | |
| 3-1014 | 4-NO₂ | CH(CH₃)CH₂SOCH₃ | CH₃ | H | CF(CF₃)₂ | |
| 3-1015 | 4-NO₂ | CH(CH₃)CH₂SO₂CH₃ | CH₃ | H | CF(CF₃)₂ | |
| 3-1016 | 4-NO₂ | CH(CH₃)₂ | H | H | CF(CF₃)₂ | |
| 3-1017 | 4-NO₂ | C(CH₃)₂CH₂SCH₃ | H | H | CF(CF₃)₂ | |
| 3-1018 | 4-NO₂ | C(CH₃)₂CH₂SOCH₃ | H | H | CF(CF₃)₂ | |
| 3-1019 | 4-NO₂ | C(CH₃)₂CH₂SO₂CH₃ | H | H | CF(CF₃)₂ | |
| 3-1020 | 4-NO₂ | CH(CH₃)CH₂SCH₃ | H | H | CF(CF₃)₂ | |
| 3-1021 | 4-NO₂ | CH(CH₃)CH₂SOCH₃ | H | H | CF(CF₃)₂ | |
| 3-1022 | 4-NO₂ | CH(CH₃)CH₂SO₂CH₃ | H | H | CF(CF₃)₂ | |
| 3-1023 | 4-NO₂ | CH(CH₃)₂ | Cl | Cl | Cl | |
| 3-1024 | 4-NO₂ | C(CH₃)₂CH₂SCH₃ | Cl | Cl | Cl | |
| 3-1025 | 4-NO₂ | C(CH₃)₂CH₂SOCH₃ | Cl | Cl | Cl | |
| 3-1026 | 4-NO₂ | C(CH₃)₂CH₂SO₂CH₃ | Cl | Cl | Cl | |
| 3-1027 | 4-NO₂ | CH(CH₃)CH₂SCH₃ | Cl | Cl | Cl | |
| 3-1028 | 4-NO₂ | CH(CH₃)CH₂SOCH₃ | Cl | Cl | Cl | |
| 3-1029 | 4-NO₂ | CH(CH₃)CH₂SO₂CH₃ | Cl | Cl | Cl | |
| 3-1030 | 4-NO₂ | CH(CH₃)₂ | CH₃ | H | OCF₃ | |
| 3-1031 | 4-NO₂ | C(CH₃)₂CH₂SCH₃ | CH₃ | H | OCF₃ | |
| 3-1032 | 4-NO₂ | C(CH₃)₂CH₂SOCH₃ | CH₃ | H | OCF₃ | |
| 3-1033 | 4-NO₂ | C(CH₃)₂CH₂SO₂CH₃ | CH₃ | H | OCF₃ | |
| 3-1034 | 4-NO₂ | CH(CH₃)CH₂SCH₃ | CH₃ | H | OCF₃ | |
| 3-1035 | 4-NO₂ | CH(CH₃)CH₂SOCH₃ | CH₃ | H | OCF₃ | |
| 3-1036 | 4-NO₂ | CH(CH₃)CH₂SO₂CH₃ | CH₃ | H | OCF₃ | |
| 3-1037 | 4-NO₂ | CH(CH₃)₂ | Cl | H | Cl | |
| 3-1038 | 4-NO₂ | C(CH₃)₂CH₂SCH₃ | Cl | H | Cl | |
| 3-1039 | 4-NO₂ | C(CH₃)₂CH₂SOCH₃ | Cl | H | Cl | |
| 3-1040 | 4-NO₂ | C(CH₃)₂CH₂SO₂CH₃ | Cl | H | Cl | |
| 3-1041 | 4-NO₂ | CH(CH₃)CH₂SCH₃ | Cl | H | Cl | |
| 3-1042 | 4-NO₂ | CH(CH₃)CH₂SOCH₃ | Cl | H | Cl | |
| 3-1043 | 4-NO₂ | CH(CH₃)CH₂SO₂CH₃ | Cl | H | Cl | |
| 3-1044 | 4-NO₂ | CH(CH₃)₂ | H | Cl | Cl | |
| 3-1045 | 4-NO₂ | C(CH₃)₂CH₂SCH₃ | H | Cl | Cl | |
| 3-1046 | 4-NO₂ | C(CH₃)₂CH₂SOCH₃ | H | Cl | Cl | |
| 3-1047 | 4-NO₂ | C(CH₃)₂CH₂SO₂CH₃ | H | Cl | Cl | |
| 3-1048 | 4-NO₂ | CH(CH₃)CH₂SCH₃ | H | Cl | Cl | |
| 3-1049 | 4-NO₂ | CH(CH₃)CH₂SOCH₃ | H | Cl | Cl | |
| 3-1050 | 4-NO₂ | CH(CH₃)CH₂SO₂CH₃ | H | Cl | Cl | |
| 3-1051 | 4-NO₂ | CH(CH₃)₂ | Cl | Cl | H | |
| 3-1052 | 4-NO₂ | C(CH₃)₂CH₂SCH₃ | Cl | Cl | H | |
| 3-1053 | 4-NO₂ | C(CH₃)₂CH₂SOCH₃ | Cl | Cl | H | |
| 3-1054 | 4-NO₂ | C(CH₃)₂CH₂SO₂CH₃ | Cl | Cl | H | |
| 3-1055 | 4-NO₂ | CH(CH₃)CH₂SCH₃ | Cl | Cl | H | |
| 3-1056 | 4-NO₂ | CH(CH₃)CH₂SOCH₃ | Cl | Cl | H | |
| 3-1057 | 4-NO₂ | CH(CH₃)CH₂SO₂CH₃ | Cl | Cl | H | |
| 3-1058 | 4-NO₂ | CH(CH₃)₂ | Cl | H | CF₃ | |
| 3-1059 | 4-NO₂ | C(CH₃)₂CH₂SCH₃ | Cl | H | CF₃ | |
| 3-1060 | 4-NO₂ | C(CH₃)₂CH₂SOCH₃ | Cl | H | CF₃ | |
| 3-1061 | 4-NO₂ | C(CH₃)₂CH₂SO₂CH₃ | Cl | H | CF₃ | |
| 3-1062 | 4-NO₂ | CH(CH₃)CH₂SCH₃ | Cl | H | CF₃ | |
| 3-1063 | 4-NO₂ | CH(CH₃)CH₂SOCH₃ | Cl | H | CF₃ | |
| 3-1064 | 4-NO₂ | CH(CH₃)CH₂SO₂CH₃ | Cl | H | CF₃ | |
| 3-1065 | 4-NO₂ | CH(CH₃)₂ | Cl | H | CF₃ | |
| 3-1066 | 4-NO₂ | C(CH₃)₂CH₂SCH₃ | Cl | H | CF₃ | |
| 3-1067 | 4-NO₂ | C(CH₃)₂CH₂SOCH₃ | Cl | H | CF₃ | |
| 3-1068 | 4-NO₂ | C(CH₃)₂CH₂SO₂CH₃ | Cl | H | CF₃ | |
| 3-1069 | 4-NO₂ | CH(CH₃)CH₂SCH₃ | Cl | H | CF₃ | |
| 3-1070 | 4-NO₂ | CH(CH₃)CH₂SOCH₃ | Cl | H | CF₃ | |
| 3-1071 | 4-NO₂ | CH(CH₃)CH₂SO₂CH₃ | Cl | H | CF₃ | |
| 3-1072 | 4-NO₂ | CH(CH₃)₂ | H | H | Cl | |
| 3-1073 | 4-NO₂ | C(CH₃)₂CH₂SCH₃ | H | H | Cl | |
| 3-1074 | 4-NO₂ | C(CH₃)₂CH₂SOCH₃ | H | H | Cl | |
| 3-1075 | 4-NO₂ | C(CH₃)₂CH₂SO₂CH₃ | H | H | Cl | |
| 3-1076 | 4-NO₂ | CH(CH₃)CH₂SCH₃ | H | H | Cl | |
| 3-1077 | 4-NO₂ | CH(CH₃)CH₂SOCH₃ | H | H | Cl | |
| 3-1078 | 4-NO₂ | CH(CH₃)CH₂SO₂CH₃ | H | H | Cl | |
| 3-1079 | 4-NO₂ | CH(CH₃)₂ | CH₃ | H | Cl | |
| 3-1080 | 4-NO₂ | C(CH₃)₂CH₂SCH₃ | CH₃ | H | Cl | |
| 3-1081 | 4-NO₂ | C(CH₃)₂CH₂SOCH₃ | CH₃ | H | Cl | |
| 3-1082 | 4-NO₂ | C(CH₃)₂CH₂SO₂CH₃ | CH₃ | H | Cl | |
| 3-1083 | 4-NO₂ | CH(CH₃)CH₂SCH₃ | CH₃ | H | Cl | |
| 3-1084 | 4-NO₂ | CH(CH₃)CH₂SOCH₃ | CH₃ | H | Cl | |
| 3-1085 | 4-NO₂ | CH(CH₃)CH₂SO₂CH₃ | CH₃ | H | Cl | |
| 3-1086 | 4-NO₂ | CH(CH₃)₂ | H | H | OCF₃ | |
| 3-1087 | 4-NO₂ | C(CH₃)₂CH₂SCH₃ | H | H | OCF₃ | |
| 3-1088 | 4-NO₂ | C(CH₃)₂CH₂SOCH₃ | H | H | OCF₃ | |
| 3-1089 | 4-NO₂ | C(CH₃)₂CH₂SO₂CH₃ | H | H | OCF₃ | |
| 3-1090 | 4-NO₂ | CH(CH₃)CH₂SCH₃ | H | H | OCF₃ | |
| 3-1091 | 4-NO₂ | CH(CH₃)CH₂SOCH₃ | H | H | OCF₃ | |
| 3-1092 | 4-NO₂ | CH(CH₃)CH₂SO₂CH₃ | H | H | OCF₃ | |
| 3-1093 | 4-NO₂ | CH(CH₃)₂ | H | H | CF₃ | |
| 3-1094 | 4-NO₂ | C(CH₃)₂CH₂SCH₃ | H | H | CF₃ | |
| 3-1095 | 4-NO₂ | C(CH₃)₂CH₂SOCH₃ | H | H | CF₃ | |
| 3-1096 | 4-NO₂ | C(CH₃)₂CH₂SO₂CH₃ | H | H | CF₃ | |
| 3-1097 | 4-NO₂ | CH(CH₃)CH₂SCH₃ | H | H | CF₃ | |
| 3-1098 | 4-NO₂ | CH(CH₃)CH₂SOCH₃ | H | H | CF₃ | |
| 3-1099 | 4-NO₂ | CH(CH₃)CH₂SO₂CH₃ | H | H | CF₃ | |
| 3-1100 | 4-NO₂ | CH(CH₃)₂ | H | H | Ph-4-CF₃ | |
| 3-1101 | 4-NO₂ | C(CH₃)₂CH₂SCH₃ | H | H | Ph-4-CF₃ | |
| 3-1102 | 4-NO₂ | C(CH₃)₂CH₂SOCH₃ | H | H | Ph-4-CF₃ | |
| 3-1103 | 4-NO₂ | C(CH₃)₂CH₂SO₂CH₃ | H | H | Ph-4-CF₃ | |
| 3-1104 | 4-NO₂ | CH(CH₃)CH₂SCH₃ | H | H | Ph-4-CF₃ | |
| 3-1105 | 4-NO₂ | CH(CH₃)CH₂SOCH₃ | H | H | Ph-4-CF₃ | |
| 3-1106 | 4-NO₂ | CH(CH₃)CH₂SO₂CH₃ | H | H | Ph-4-CF₃ | |
| 3-1107 | 4-NO₂ | CH(CH₃)₂ | F | F | CF₃ | |
| 3-1108 | 4-NO₂ | C(CH₃)₂CH₂SCH₃ | F | F | CF₃ | |
| 3-1109 | 4-NO₂ | C(CH₃)₂CH₂SOCH₃ | F | F | CF₃ | |
| 3-1110 | 4-NO₂ | C(CH₃)₂CH₂SO₂CH₃ | F | F | CF₃ | |
| 3-1111 | 4-NO₂ | CH(CH₃)CH₂SCH₃ | F | F | CF₃ | |
| 3-1112 | 4-NO₂ | CH(CH₃)CH₂SOCH₃ | F | F | CF₃ | |
| 3-1113 | 4-NO₂ | CH(CH₃)CH₂SO₂CH₃ | F | F | CF₃ | |
| 3-1114 | 4-NO₂ | CH(CH₃)₂ | CH₃ | H | COH(CF₃)₂ | |
| 3-1115 | 4-NO₂ | C(CH₃)₂CH₂SCH₃ | CH₃ | H | COH(CF₃)₂ | |
| 3-1116 | 4-NO₂ | C(CH₃)₂CH₂SOCH₃ | CH₃ | H | COH(CF₃)₂ | |
| 3-1117 | 4-NO₂ | C(CH₃)₂CH₂SO₂CH₃ | CH₃ | H | COH(CF₃)₂ | |
| 3-1118 | 4-NO₂ | CH(CH₃)CH₂SCH₃ | CH₃ | H | COH(CF₃)₂ | |
| 3-1119 | 4-NO₂ | CH(CH₃)CH₂SOCH₃ | CH₃ | H | COH(CF₃)₂ | |
| 3-1120 | 4-NO₂ | CH(CH₃)CH₂SO₂CH₃ | CH₃ | H | COH(CF₃)₂ | |
| 3-1121 | 7-NO₂ | CH(CH₃)₂ | CH₃ | H | CF(CF₃)₂ | |
| 3-1122 | 7-NO₂ | C(CH₃)₂CH₂SCH₃ | CH₃ | H | CF(CF₃)₂ | |
| 3-1123 | 7-NO₂ | C(CH₃)₂CH₂SOCH₃ | CH₃ | H | CF(CF₃)₂ | |
| 3-1124 | 7-NO₂ | C(CH₃)₂CH₂SO₂CH₃ | CH₃ | H | CF(CF₃)₂ | |
| 3-1125 | 7-NO₂ | CH(CH₃)CH₂SCH₃ | CH₃ | H | CF(CF₃)₂ | |
| 3-1126 | 7-NO₂ | CH(CH₃)CH₂SOCH₃ | CH₃ | H | CF(CF₃)₂ | |
| 3-1127 | 7-NO₂ | CH(CH₃)CH₂SO₂CH₃ | CH₃ | H | CF(CF₃)₂ | |
| 3-1128 | 7-NO₂ | CH(CH₃)₂ | H | H | CF(CF₃)₂ | |
| 3-1129 | 7-NO₂ | C(CH₃)₂CH₂SCH₃ | H | H | CF(CF₃)₂ | |
| 3-1130 | 7-NO₂ | C(CH₃)₂CH₂SOCH₃ | H | H | CF(CF₃)₂ | |
| 3-1131 | 7-NO₂ | C(CH₃)₂CH₂SO₂CH₃ | H | H | CF(CF₃)₂ | |
| 3-1132 | 7-NO₂ | CH(CH₃)CH₂SCH₃ | H | H | CF(CF₃)₂ | |
| 3-1133 | 7-NO₂ | CH(CH₃)CH₂SOCH₃ | H | H | CF(CF3h | |
| 3-1134 | 7-NO₂ | CH(CH₃)CH₂SO₂CH₃ | H | H | CF(CF₃)₂ | |
| 3-1135 | 7-NO₂ | CH(CH₃)₂ | Cl | Cl | Cl | |
| 3-1136 | 7-NO₂ | C(CH₃)₂CH₂SCH₃ | Cl | Cl | Cl | |
| 3-1137 | 7-NO₂ | C(CH₃)₂CH₂SOCH₃ | Cl | Cl | Cl | |
| 3-1138 | 7-NO₂ | C(CH₃)₂CH₂SO₂CH₃ | Cl | Cl | Cl | |
| 3-1139 | 7-NO₂ | CH(CH₃)CH₂SCH₃ | Cl | Cl | Cl | |
| 3-1140 | 7-NO₂ | CH(CH₃)CH₂SOCH₃ | Cl | Cl | Cl | |
| 3-1141 | 7-NO₂ | CH(CH₃)CH₂SO₂CH₃ | Cl | Cl | Cl | |
| 3-1142 | 7-NO₂ | CH(CH₃)₂ | CH₃ | H | OCF₃ | |
| 3-1143 | 7-NO₂ | C(CH₃)₂CH₂SCH₃ | CH₃ | H | OCF₃ | |
| 3-1144 | 7-NO₂ | C(CH₃)₂CH₂SOCH₃ | CH₃ | H | OCF₃ | |
| 3-1145 | 7-NO₂ | C(CH₃)₂CH₂SO₂CH₃ | CH₃ | H | OCF₃ | |
| 3-1146 | 7-NO₂ | CH(CH₃)CH₂SCH₃ | CH₃ | H | OCF₃ | |
| 3-1147 | 7-NO₂ | CH(CH₃)CH₂SOCH₃ | CH₃ | H | OCF₃ | |
| 3-1148 | 7-NO₂ | CH(CH₃)CH₂SO₂CH₃ | CH₃ | H | OCF₃ | |
| 3-1149 | 7-NO₂ | CH(CH₃)₂ | Cl | H | Cl | |
| 3-1150 | 7-NO₂ | C(CH₃)₂CH₂SCH₃ | Cl | H | Cl | |
| 3-1151 | 7-NO₂ | C(CH₃)₂CH₂SOCH₃ | Cl | H | Cl | |
| 3-1152 | 7-NO₂ | C(CH₃)₂CH₂SO₂CH₃ | Cl | H | Cl | |
| 3-1153 | 7-NO₂ | CH(CH₃)CH₂SCH₃ | Cl | H | Cl | |
| 3-1154 | 7-NO₂ | CH(CH₃)CH₂SOCH₃ | Cl | H | Cl | |
| 3-1155 | 7-NO₂ | CH(CH₃)CH₂SO₂CH₃ | Cl | H | Cl | |
| 3-1156 | 7-NO₂ | CH(CH₃)₂ | H | Cl | Cl | |
| 3-1157 | 7-NO₂ | C(CH₃)₂CH₂SCH₃ | H | Cl | Cl | |
| 3-1158 | 7-NO₂ | C(CH₃)₂CH₂SOCH₃ | H | Cl | Cl | |
| 3-1159 | 7-NO₂ | C(CH₃)₂CH₂SO₂CH₃ | H | Cl | Cl | |
| 3-1160 | 7-NO₂ | CH(CH₃)CH₂SCH₃ | H | Cl | Cl | |
| 3-1161 | 7-NO₂ | CH(CH₃)CH₂SOCH₃ | H | Cl | Cl | |
| 3-1162 | 7-NO₂ | CH(CH₃)CH₂SO₂CH₃ | H | Cl | Cl | |
| 3-1163 | 7-NO₂ | CH(CH₃)₂ | Cl | Cl | H | |
| 3-1164 | 7-NO₂ | C(CH₃)₂CH₂SCH₃ | Cl | Cl | H | |
| 3-1165 | 7-NO₂ | C(CH₃)₂CH₂SOCH₃ | Cl | Cl | H | |
| 3-1166 | 7-NO₂ | C(CH₃)₂CH₂SO₂CH₃ | Cl | Cl | H | |
| 3-1167 | 7-NO₂ | CH(CH₃)CH₂SCH₃ | Cl | Cl | H | |
| 3-1168 | 7-NO₂ | CH(CH₃)CH₂SOCH₃ | Cl | Cl | H | |
| 3-1169 | 7-NO₂ | CH(CH₃)CH₂SO₂CH₃ | Cl | Cl | H | |
| 3-1170 | 7-NO₂ | CH(CH₃)₂ | Cl | H | CF₃ | |
| 3-1171 | 7-NO₂ | C(CH₃)₂CH₂SCH₃ | Cl | H | CF₃ | |
| 3-1172 | 7-NO₂ | C(CH₃)₂CH₂SOCH₃ | Cl | H | CF₃ | |
| 3-1173 | 7-NO₂ | C(CH₃)₂CH₂SO₂CH₃ | Cl | H | CF₃ | |
| 3-1174 | 7-NO₂ | CH(CH₃)CH₂SCH₃ | Cl | H | CF₃ | |
| 3-1175 | 7-NO₂ | CH(CH₃)CH₂SOCH₃ | Cl | H | CF₃ | |
| 3-1176 | 7-NO₂ | CH(CH₃)CH₂SO₂CH₃ | Cl | H | CF₃ | |
| 3-1177 | 7-NO₂ | CH(CH₃)₂ | Cl | H | CF₃ | |
| 3-1178 | 7-NO₂ | C(CH₃)₂CH₂SCH₃ | Cl | H | CF₃ | |
| 3-1179 | 7-NO₂ | C(CH₃)₂CH₂SOCH₃ | Cl | H | CF₃ | |
| 3-1180 | 7-NO₂ | C(CH₃)₂CH₂SO₂CH₃ | Cl | H | CF₃ | |
| 3-1181 | 7-NO₂ | CH(CH₃)CH₂SCH₃ | Cl | H | CF₃ | |
| 3-1182 | 7-NO₂ | CH(CH₃)CH₂SOCH₃ | Cl | H | CF₃ | |
| 3-1183 | 7-NO₂ | CH(CH₃)CH₂SO₂CH₃ | Cl | H | CF₃ | |
| 3-1184 | 7-NO₂ | CH(CH₃)₂ | H | H | Cl | |
| 3-1185 | 7-NO₂ | C(CH₃)₂CH₂SCH₃ | H | H | Cl | |
| 3-1186 | 7-NO₂ | C(CH₃)₂CH₂SOCH₃ | H | H | Cl | |
| 3-1187 | 7-NO₂ | C(CH₃)₂CH₂SO₂CH₃ | H | H | Cl | |
| 3-1188 | 7-NO₂ | CH(CH₃)CH₂SCH₃ | H | H | Cl | |
| 3-1189 | 7-NO₂ | CH(CH₃)CH₂SOCH₃ | H | H | Cl | |
| 3-1190 | 7-NO₂ | CH(CH₃)CH₂SO₂CH₃ | H | H | Cl | |
| 3-1191 | 7-NO₂ | CH(CH₃)₂ | CH₃ | H | Cl | |
| 3-1192 | 7-NO₂ | C(CH₃)₂CH₂SCH₃ | CH₃ | H | Cl | |
| 3-1193 | 7-NO₂ | C(CH₃)₂CH₂SOCH₃ | CH₃ | H | Cl | |
| 3-1194 | 7-NO₂ | C(CH₃)₂CH₂SO₂CH₃ | CH₃ | H | Cl | |
| 3-1195 | 7-NO₂ | CH(CH₃)CH₂SCH₃ | CH₃ | H | Cl | |
| 3-1196 | 7-NO₂ | CH(CH₃)CH₂SOCH₃ | CH₃ | H | Cl | |
| 3-1197 | 7-NO₂ | CH(CH₃)CH₂SO₂CH₃ | CH₃ | H | Cl | |
| 3-1198 | 7-NO₂ | CH(CH₃)₂ | H | H | OCF₃ | |
| 3-1199 | 7-NO₂ | C(CH₃)₂CH₂SCH₃ | H | H | OCF₃ | |
| 3-1200 | 7-NO₂ | C(CH₃)₂CH₂SOCH₃ | H | H | OCF₃ | |
| 3-1201 | 7-NO₂ | C(CH₃)₂CH₂SO₂CH₃ | H | H | OCF₃ | |
| 3-1202 | 7-NO₂ | CH(CH₃)CH₂SCH₃ | H | H | OCF₃ | |
| 3-1203 | 7-NO₂ | CH(CH₃)CH₂SOCH₃ | H | H | OCF₃ | |
| 3-1204 | 7-NO₂ | CH(CH₃)CH₂SO₂CH₃ | H | H | OCF₃ | |
| 3-1205 | 7-NO₂ | CH(CH₃)₂ | H | H | CF₃ | |
| 3-1206 | 7-NO₂ | C(CH₃)₂CH₂SCH₃ | H | H | CF₃ | |
| 3-1207 | 7-NO₂ | C(CH₃)₂CH₂SOCH₃ | H | H | CF₃ | |
| 3-1208 | 7-NO₂ | C(CH₃)₂CH₂SO₂CH₃ | H | H | CF₃ | |
| 3-1209 | 7-NO₂ | CH(CH₃)CH₂SCH₃ | H | H | CF₃ | |
| 3-1210 | 7-NO₂ | CH(CH₃)CH₂SOCH₃ | H | H | CF₃ | |
| 3-1211 | 7-NO₂ | CH(CH₃)CH₂SO₂CH₃ | H | H | CF₃ | |
| 3-1212 | 7-NO₂ | CH(CH₃)₂ | H | H | Ph-4-CF₃ | |
| 3-1213 | 7-NO₂ | C(CH₃)₂CH₂SCH₃ | H | H | Ph-4-CF₃ | |
| 3-1214 | 7-NO₂ | C(CH₃)₂CH₂SOCH₃ | H | H | Ph-4-CF₃ | |
| 3-1215 | 7-NO₂ | C(CH₃)₂CH₂SO₂CH₃ | H | H | Ph-4-CF₃ | |
| 3-1216 | 7-NO₂ | CH(CH₃)CH₂SCH₃ | H | H | Ph-4-CF₃ | |
| 3-1217 | 7-NO₂ | CH(CH₃)CH₂SOCH₃ | H | H | Ph-4-CF₃ | |
| 3-1218 | 7-NO₂ | CH(CH₃)CH₂SO₂CH₃ | H | H | Ph-4-CF₃ | |
| 3-1219 | 7-NO₂ | CH(CH₃)₂ | F | F | CF₃ | |
| 3-1220 | 7-NO₂ | C(CH₃)₂CH₂SCH₃ | F | F | CF₃ | |
| 3-1221 | 7-NO₂ | C(CH₃)₂CH₂SOCH₃ | F | F | CF₃ | |
| 3-1222 | 7-NO₂ | C(CH₃)₂CH₂SO₂CH₃ | F | F | CF₃ | |
| 3-1223 | 7-NO₂ | CH(CH₃)CH₂SCH₃ | F | F | CF₃ | |
| 3-1224 | 7-NO₂ | CH(CH₃)CH₂SOCH₃ | F | F | CF₃ | |
| 3-1225 | 7-NO₂ | CH(CH₃)CH₂SO₂CH₃ | F | F | CF₃ | |
| 3-1226 | 7-NO₂ | CH(CH₃)₂ | CH₃ | H | COH(CF₃)₂ | |
| 3-1227 | 7-NO₂ | C(CH₃)₂CH₂SCH₃ | CH₃ | H | COH(CF₃)₂ | |
| 3-1228 | 7-NO₂ | C(CH₃)₂CH₂SOCH₃ | CH₃ | H | COH(CF₃)₂ | |
| 3-1229 | 7-NO₂ | C(CH₃)₂CH₂SO₂CH₃ | CH₃ | H | COH(CF₃)₂ | |
| 3-1230 | 7-NO₂ | CH(CH₃)CH₂SCH₃ | CH₃ | H | COH(CF₃)₂ | |
| 3-1231 | 7-NO₂ | CH(CH₃)CH₂SOCH₃ | CH₃ | H | COH(CF₃)₂ | |
| 3-1232 | 7-NO₂ | CH(CH₃)CH₂SO₂CH₃ | CH₃ | H | COH(CF₃)₂ | |
| 3-1233 | 4-CF₃ | CH(CH₃)₂ | CH₃ | H | CF(CF₃)₂ | |
| 3-1234 | 4-CF₃ | C(CH₃)₂CH₂SCH₃ | CH₃ | H | CF(CF₃)₂ | |
| 3-1235 | 4-CF₃ | C(CH₃)₂CH₂SOCH₃ | CH₃ | H | CF(CF₃)₂ | |
| 3-1236 | 4-CF₃ | C(CH₃)₂CH₂SO₂CH₃ | CH₃ | H | CF(CF₃)₂ | |
| 3-1237 | 4-CF₃ | CH(CH₃)CH₂SCH₃ | CH₃ | H | CF(CF₃)₂ | |
| 3-1238 | 4-CF₃ | CH(CH₃)CH₂SOCH₃ | CH₃ | H | CF(CF₃)₂ | |
| 3-1239 | 4-CF₃ | CH(CH₃)CH₂SO₂CH₃ | CH₃ | H | CF(CF₃)₂ | |
| 3-1240 | 4-CF₃ | CH(CH₃)₂ | H | H | CF(CF₃)₂ | |
| 3-1241 | 4-CF₃ | C(CH₃)₂CH₂SCH₃ | H | H | CF(CF₃)₂ | |
| 3-1242 | 4-CF₃ | C(CH₃)₂CH₂SOCH₃ | H | H | CF(CF₃)₂ | |
| 3-1243 | 4-CF₃ | C(CH₃)₂CH₂SO₂CH₃ | H | H | CF(CF₃)₂ | |
| 3-1244 | 4-CF₃ | CH(CH₃)CH₂SCH₃ | H | H | CF(CF₃)₂ | |
| 3-1245 | 4-CF₃ | CH(CH₃)CH₂SOCH₃ | H | H | CF(CF₃)₂ | |
| 3-1246 | 4-CF₃ | CH(CH₃)CH₂SO₂CH₃ | H | H | CF(CF₃)₂ | |
| 3-1247 | 4-CF₃ | CH(CH₃)₂ | Cl | Cl | Cl | |
| 3-1248 | 4-CF₃ | C(CH₃)₂CH₂SCH₃ | Cl | Cl | Cl | |
| 3-1249 | 4-CF₃ | C(CH₃)₂CH₂SOCH₃ | Cl | Cl | Cl | |
| 3-1250 | 4-CF₃ | C(CH₃)₂CH₂SO₂CH₃ | Cl | Cl | Cl | |
| 3-1251 | 4-CF₃ | CH(CH₃)CH₂SCH₃ | Cl | Cl | Cl | |
| 3-1252 | 4-CF₃ | CH(CH₃)CH₂SOCH₃ | Cl | Cl | Cl | |
| 3-1253 | 4-CF₃ | CH(CH₃)CH₂SO₂CH₃ | Cl | Cl | Cl | |
| 3-1254 | 4-CF₃ | CH(CH₃)₂ | CH₃ | H | OCF₃ | |
| 3-1255 | 4-CF₃ | C(CH₃)₂CH₂SCH₃ | CH₃ | H | OCF₃ | |
| 3-1256 | 4-CF₃ | C(CH₃)₂CH₂SOCH₃ | CH₃ | H | OCF₃ | |
| 3-1257 | 4-CF₃ | C(CH₃)₂CH₂SO₂CH₃ | CH₃ | H | OCF₃ | |
| 3-1258 | 4-CF₃ | CH(CH₃)CH₂SCH₃ | CH₃ | H | OCF₃ | |
| 3-1259 | 4-CF₃ | CH(CH₃)CH₂SOCH₃ | CH₃ | H | OCF₃ | |
| 3-1260 | 4-CF₃ | CH(CH₃)CH₂SO₂CH₃ | CH₃ | H | OCF₃ | |
| 3-1261 | 4-CF₃ | CH(CH₃)₂ | Cl | H | Cl | |
| 3-1262 | 4-CF₃ | C(CH₃)₂CH₂SCH₃ | Cl | H | Cl | |
| 3-1263 | 4-CF₃ | C(CH₃)₂CH₂SOCH₃ | Cl | H | Cl | |
| 3-1264 | 4-CF₃ | C(CH₃)₂CH₂SO₂CH₃ | Cl | H | Cl | |
| 3-1265 | 4-CF₃ | CH(CH₃)CH₂SCH₃ | Cl | H | Cl | |
| 3-1266 | 4-CF₃ | CH(CH₃)CH₂SOCH₃ | Cl | H | Cl | |
| 3-1267 | 4-CF₃ | CH(CH₃)CH₂SO₂CH₃ | Cl | H | Cl | |
| 3-1268 | 4-CF₃ | CH(CH₃)₂ | H | Cl | Cl | |
| 3-1269 | 4-CF₃ | C(CH₃)₂CH₂SCH₃ | H | Cl | Cl | |
| 3-1270 | 4-CF₃ | C(CH₃)₂CH₂SOCH₃ | H | Cl | Cl | |
| 3-1271 | 4-CF₃ | C(CH₃)₂CH₂SO₂CH₃ | H | Cl | Cl | |
| 3-1272 | 4-CF₃ | CH(CH₃)CH₂SCH₃ | H | Cl | Cl | |
| 3-1273 | 4-CF₃ | CH(CH₃)CH₂SOCH₃ | H | Cl | Cl | |
| 3-1274 | 4-CF₃ | CH(CH₃)CH₂SO₂CH₃ | H | Cl | Cl | |
| 3-1275 | 4-CF₃ | CH(CH₃)₂ | Cl | Cl | H | |
| 3-1276 | 4-CF₃ | C(CH₃)₂CH₂SCH₃ | Cl | Cl | H | |
| 3-1277 | 4-CF₃ | C(CH₃)₂CH₂SOCH₃ | Cl | Cl | H | |
| 3-1278 | 4-CF₃ | C(CH₃)₂CH₂SO₂CH₃ | Cl | Cl | H | |
| 3-1279 | 4-CF₃ | CH(CH₃)CH₂SCH₃ | Cl | Cl | H | |
| 3-1280 | 4-CF₃ | CH(CH₃)CH₂SOCH₃ | Cl | Cl | H | |
| 3-1281 | 4-CF₃ | CH(CH₃)CH₂SO₂CH₃ | Cl | Cl | H | |
| 3-1282 | 4-CF₃ | CH(CH₃)₂ | Cl | H | CF₃ | |
| 3-1283 | 4-CF₃ | C(CH₃)₂CH₂SCH₃ | Cl | H | CF₃ | |
| 3-1284 | 4-CF₃ | C(CH₃)₂CH₂SOCH₃ | Cl | H | CF₃ | |
| 3-1285 | 4-CF₃ | C(CH₃)₂CH₂SO₂CH₃ | Cl | H | CF₃ | |
| 3-1286 | 4-CF₃ | CH(CH₃)CH₂SCH₃ | Cl | H | CF₃ | |
| 3-1287 | 4-CF₃ | CH(CH₃)CH₂SOCH₃ | Cl | H | CF₃ | |
| 3-1288 | 4-CF₃ | CH(CH₃)CH₂SO₂CH₃Cl | H | CF₃ | | |
| 3-1289 | 4-CF₃ | CH(CH₃)₂ | Cl | H | CF₃ | |
| 3-1290 | 4-CF₃ | C(CH₃)₂CH₂SCH₃ | Cl | H | CF₃ | |
| 3-1291 | 4-CF₃ | C(CH₃)₂CH₂SOCH₃ | Cl | H | CF₃ | |
| 3-1292 | 4-CF₃ | C(CH₃)₂CH₂SO₂CH₃Cl | H | CF₃ | | |
| 3-1293 | 4-CF₃ | CH(CH₃)CH₂SCH₃ | Cl | H | CF₃ | |
| 3-1294 | 4-CF₃ | CH(CH₃)CH₂SOCH₃ | Cl | H | CF₃ | |
| 3-1295 | 4-CF₃ | CH(CH₃)CH₂SO₂CH₃Cl | H | CF₃ | | |
| 3-1296 | 4-CF₃ | CH(CH₃)₂ | H | H | Cl | |
| 3-1297 | 4-CF₃ | C(CH₃)₂CH₂SCH₃ | H | H | Cl | |
| 3-1298 | 4-CF₃ | C(CH₃)₂CH₂SOCH₃ | H | H | Cl | |
| 3-1299 | 4-CF₃ | C(CH₃)₂CH₂SO₂CH₃ | H | H | Cl | |
| 3-1300 | 4-CF₃ | CH(CH₃)CH₂SCH₃ | H | H | Cl | |
| 3-1301 | 4-CF₃ | CH(CH₃)CH₂SOCH₃ | H | H | Cl | |
| 3-1302 | 4-CF₃ | CH(CH₃)CH₂SO₂CH₃ | H | H | Cl | |
| 3-1303 | 4-CF₃ | CH(CH₃)₂ | CH₃ | H | Cl | |
| 3-1304 | 4-CF₃ | C(CH₃)₂CH₂SCH₃ | CH₃ | H | Cl | |
| 3-1305 | 4-CF₃ | C(CH₃)₂CH₂SOCH₃ | CH₃ | H | Cl | |
| 3-1306 | 4-CF₃ | C(CH₃)₂CH₂SO₂CH₃ | CH₃ | H | Cl | |
| 3-1307 | 4-CF₃ | CH(CH₃)CH₂SCH₃ | CH₃ | H | Cl | |
| 3-1308 | 4-CF₃ | CH(CH₃)CH₂SOCH₃ | CH₃ | H | Cl | |
| 3-1309 | 4-CF₃ | CH(CH₃)CH₂SO₂CH₃ | CH₃ | H | Cl | |
| 3-1310 | 4-CF₃ | CH(CH₃)₂ | H | H | OCF₃ | |
| 3-1311 | 4-CF₃ | C(CH₃)₂CH₂SCH₃ | H | H | OCF₃ | |
| 3-1312 | 4-CF₃ | C(CH₃)₂CH₂SOCH₃ | H | H | OCF₃ | |
| 3-1313 | 4-CF₃ | C(CH₃)₂CH₂SO₂CH₃ | H | H | OCF₃ | |
| 3-1314 | 4-CF₃ | CH(CH₃)CH₂SCH₃ | H | H | OCF₃ | |
| 3-1315 | 4-CF₃ | CH(CH₃)CH₂SOCH₃ | H | H | OCF₃ | |
| 3-1316 | 4-CF₃ | CH(CH₃)CH₂SO₂CH₃ | H | H | OCF₃ | |
| 3-1317 | 4-CF₃ | CH(CH₃)₂ | H | H | CF₃ | |
| 3-1318 | 4-CF₃ | C(CH₃)₂CH₂SCH₃ | H | H | CF₃ | |
| 3-1319 | 4-CF₃ | C(CH₃)₂CH₂SOCH₃ | H | H | CF₃ | |
| 3-1320 | 4-CF₃ | C(CH₃)₂CH₂SO₂CH₃ | H | H | CF₃ | |
| 3-1321 | 4-CF₃ | CH(CH₃)CH₂SCH₃ | H | H | CF₃ | |
| 3-1322 | 4-CF₃ | CH(CH₃)CH₂SOCH₃ | H | H | CF₃ | |
| 3-1323 | 4-CF₃ | CH(CH₃)CH₂SO₂CH₃ | H | H | CF₃ | |
| 3-1324 | 4-CF₃ | CH(CH₃)₂ | H | H | Ph-4-CF₃ | |
| 3-1325 | 4-CF₃ | C(CH₃)₂CH₂SCH₃ | H | H | Ph-4-CF₃ | |
| 3-1326 | 4-CF₃ | C(CH₃)₂CH₂SOCH₃ | H | H | Ph-4-CF₃ | |
| 3-1327 | 4-CF₃ | C(CH₃)₂CH₂SO₂CH₃ | H | H | Ph-4-CF₃ | |
| 3-1328 | 4-CF₃ | CH(CH₃)CH₂SCH₃ | H | H | Ph-4-CF₃ | |
| 3-1329 | 4-CF₃ | CH(CH₃)CH₂SOCH₃ | H | H | Ph-4-CF₃ | |
| 3-1330 | 4-CF₃ | CH(CH₃)CH₂SO₂CH₃ | H | H | Ph-4-CF₃ | |
| 3-1331 | 4-CF₃ | CH(CH₃)₂ | F | F | CF₃ | |
| 3-1332 | 4-CF₃ | C(CH₃)₂CH₂SCH₃ | F | F | CF₃ | |
| 3-1333 | 4-CF₃ | C(CH₃)₂CH₂SOCH3. | F | F | CF₃ | |
| 3-1334 | 4-CF₃ | C(CH₃)₂CH₂SO₂CH₃ | F | F | CF₃ | |
| 3-1335 | 4-CF₃ | CH(CH₃)CH₂SCH₃ | F | F | CF₃ | |
| 3-1336 | 4-CF₃ | CH(CH₃)CH₂SOCH₃ | F | F | CF₃ | |
| 3-1337 | 4-CF₃ | CH(CH₃)CH₂SO₂CH₃ | F | F | CF₃ | |
| 3-1338 | 4-CF₃ | CH(CH₃)₂ | CH₃ | H | COH(CF₃)₂ | |
| 3-1339 | 4-CF₃ | C(CH₃)₂CH₂SCH₃ | CH₃ | H | COH(CF₃)₂ | |
| 3-1340 | 4-CF₃ | C(CH₃)₂CH₂SOCH₃ | CH₃ | H | COH(CF₃)₂ | |
| 3-1341 | 4-CF₃ | C(CH₃)₂CH₂SO₂CH₃ | CH₃ | H | COH(CF₃)₂ | |
| 3-1342 | 4-CF₃ | CH(CH₃)CH₂SCH₃ | CH₃ | H | COH(CF₃)₂ | |
| 3-1343 | 4-CF₃ | CH(CH₃)CH₂SOCH₃ | CH₃ | H | COH(CF₃)₂ | |
| 3-1344 | 4-CF₃ | CH(CH₃)CH₂SO₂CH₃ | CH₃ | H | COH(CF₃)₂ | |
| 3-1345 | 7-CF₃ | CH(CH₃)₂ | CH₃ | H | CF(CF₃)₂ | |
| 3-1346 | 7-CF₃ | C(CH₃)₂CH₂SCH₃ | CH₃ | H | CF(CF₃)₂ | |
| 3-1347 | 7-CF₃ | C(CH₃)₂CH₂SOCH₃ | CH₃ | H | CF(CF₃)₂ | |
| 3-1348 | 7-CF₃ | C(CH₃)₂CH₂SO₂CH₃ | CH₃ | H | CF(CF₃)₂ | |
| 3-1349 | 7-CF₃ | CH(CH₃)CH₂SCH₃ | CH₃ | H | CF(CF₃)₂ | |
| 3-1350 | 7-CF₃ | CH(CH₃)CH₂SOCH₃ | CH₃ | H | CF(CF₃)₂ | |
| 3-1351 | 7-CF₃ | CH(CH₃)CH₂SO₂CH₃ | CH₃ | H | CF(CF₃)₂ | |
| 3-1352 | 7-CF₃ | CH(CH₃)₂ | H | H | CF(CF₃)₂ | |
| 3-1353 | 7-CF₃ | C(CH₃)₂CH₂SCH₃ | H | H | CF(CF₃)₂ | |
| 3-1354 | 7-CF₃ | C(CH₃)₂CH₂SOCH₃ | H | H | CF(CF₃)₂ | |
| 3-1355 | 7-CF₃ | C(CH₃)₂CH₂SO₂CH₃ | H | H | CF(CF₃)₂ | |
| 3-1356 | 7-CF₃ | CH(CH₃)CH₂SCH₃ | H | H | CF(CF₃)₂ | |
| 3-1357 | 7-CF₃ | CH(CH₃)CH₂SOCH₃ | H | H | CF(CF₃)₂ | |
| 3-1358 | 7-CF₃ | CH(CH₃)CH₂SO₂CH₃ | H | H | CF(CF₃)₂ | |
| 3-1359 | 7-CF₃ | CH(CH₃)₂ | Cl | Cl | Cl | |
| 3-1360 | 7-CF₃ | C(CH₃)₂CH₂SCH₃ | Cl | Cl | Cl | |
| 3-1361 | 7-CF₃ | C(CH₃)₂CH₂SOCH₃ | Cl | Cl | Cl | |
| 3-1362 | 7-CF₃ | C(CH₃)₂CH₂SO₂CH₃ | Cl | Cl | Cl | |
| 3-1363 | 7-CF₃ | CH(CH₃)CH₂SCH₃ | Cl | Cl | Cl | |
| 3-1364 | 7-CF₃ | CH(CH₃)CH₂SOCH₃ | Cl | Cl | Cl | |
| 3-1365 | 7-CF₃ | CH(CH₃)CH₂SO₂CH₃ | Cl | Cl | Cl | |
| 3-1366 | 7-CF₃ | CH(CH₃)₂ | CH₃ | H | OCF₃ | |
| 3-1367 | 7-CF₃ | C(CH₃)₂CH₂SCH₃ | CH₃ | H | OCF₃ | |
| 3-1368 | 7-CF₃ | C(CH₃)₂CH₂SOCH₃ | CH₃ | H | OCF₃ | |
| 3-1369 | 7-CF₃ | C(CH₃)₂CH₂SO₂CH₃ | CH₃ | H | OCF₃ | |
| 3-1370 | 7-CF₃ | CH(CH₃)CH₂SCH₃ | CH₃ | H | OCF₃ | |
| 3-1371 | 7-CF₃ | CH(CH₃)CH₂SOCH₃ | CH₃ | H | OCF₃ | |
| 3-1372 | 7-CF₃ | CH(CH₃)CH₂SO₂CH₃ | CH₃ | H | OCF₃ | |
| 3-1373 | 7-CF₃ | CH(CH₃)₂ | Cl | H | Cl | |
| 3-1374 | 7-CF₃ | C(CH₃)₂CH₂SCH₃ | Cl | H | Cl | |
| 3-1375 | 7-CF₃ | C(CH₃)₂CH₂SOCH₃ | Cl | H | Cl | |
| 3-1376 | 7-CF₃ | C(CH₃)₂CH₂SO₂CH₃ | Cl | H | Cl | |
| 3-1377 | 7-CF₃ | CH(CH₃)CH₂SCH₃ | Cl | H | Cl | |
| 3-1378 | 7-CF₃ | CH(CH₃)CH₂SOCH₃ | Cl | H | Cl | |
| 3-1379 | 7-CF₃ | CH(CH₃)CH₂SO₂CH₃ | Cl | H | Cl | |
| 3-1380 | 7-CF₃ | CH(CH₃)₂ | H | Cl | Cl | |
| 3-1381 | 7-CF₃ | C(CH₃)₂CH₂SCH₃ | H | Cl | Cl | |
| 3-1382 | 7-CF₃ | C(CH₃)₂CH₂SOCH₃ | H | Cl | Cl | |
| 3-1383 | 7-CF₃ | C(CH₃)₂CH₂SO₂CH₃ | H | Cl | Cl | |
| 3-1384 | 7-CF₃ | CH(CH₃)CH₂SCH₃ | H | Cl | Cl | |
| 3-1385 | 7-CF₃ | CH(CH₃)CH₂SOCH₃ | H | Cl | Cl | |
| 3-1386 | 7-CF₃ | CH(CH₃)CH₂SO₂CH₃ | H | Cl | Cl | |
| 3-1387 | 7-CF₃ | CH(CH₃)₂ | Cl | Cl | H | |
| 3-1388 | 7-CF₃ | C(CH₃)₂CH₂SCH₃ | Cl | Cl | H | |
| 3-1389 | 7-CF₃ | C(CH₃)₂CH₂SOCH₃ | Cl | Cl | H | |
| 3-1390 | 7-CF₃ | C(CH₃)₂CH₂SO₂CH₃ | Cl | Cl | H | |
| 3-1391 | 7-CF₃ | CH(CH₃)CH₂SCH₃ | Cl | Cl | H | |
| 3-1392 | 7-CF₃ | CH(CH₃)CH₂SOCH₃ | Cl | Cl | H | |
| 3-1393 | 7-CF₃ | CH(CH₃)CH₂SO₂CH₃ | Cl | Cl | H | |
| 3-1394 | 7-CF₃ | CH(CH₃)₂ | Cl | H | CF₃ | |
| 3-1395 | 7-CF₃ | C(CH₃)₂CH₂SCH₃ | Cl | H | CF₃ | |
| 3-1396 | 7-CF₃ | C(CH₃)₂CH₂SOCH₃ | Cl | H | CF₃ | |
| 3-1397 | 7-CF₃ | C(CH₃)₂CH₂SO₂CH₃ | Cl | H | CF₃ | |
| 3-1398 | 7-CF₃ | CH(CH₃)CH₂SCH₃ | Cl | H | CF₃ | |
| 3-1399 | 7-CF₃ | CH(CH₃)CH₂SOCH₃ | Cl | H | CF₃ | |
| 3-1400 | 7-CF₃ | CH(CH₃)CH₂SO₂CH₃ | Cl | H | CF₃ | |
| 3-1401 | 7-CF₃ | CH(CH₃)₂ | Cl | H | CF₃ | |
| 3-1402 | 7-CF₃ | C(CH₃)₂CH₂SCH₃ | Cl | H | CF₃ | |
| 3-1403 | 7-CF₃ | C(CH₃)₂CH₂SOCH₃ | Cl | H | CF₃ | |
| 3-1404 | 7-CF₃ | C(CH₃)₂CH₂SO₂CH₃ | Cl | H | CF₃ | |
| 3-1405 | 7-CF₃ | CH(CH₃)CH₂SCH₃ | Cl | H | CF₃ | |
| 3-1406 | 7-CF₃ | CH(CH₃)CH₂SOCH₃ | Cl | H | CF₃ | |
| 3-1407 | 7-CF₃ | CH(CH₃)CH₂SO₂CH₃ | Cl | H | CF₃ | |
| 3-1408 | 7-CF₃ | CH(CH₃)₂ | H | H | Cl | |
| 3-1409 | 7-CF₃ | C(CH₃)₂CH₂SCH₃ | H | H | Cl | |
| 3-1410 | 7-CF₃ | C(CH₃)₂CH₂SOCH₃ | H | H | Cl | |
| 3-1411 | 7-CF₃ | C(CH₃)₂CH₂SO₂CH₃ | H | H | Cl | |
| 3-1412 | 7-CF₃ | CH(CH₃)CH₂SCH₃ | H | H | Cl | |
| 3-1413 | 7-CF₃ | CH(CH₃)CH₂SOCH₃ | H | H | Cl | |
| 3-1414 | 7-CF₃ | CH(CH₃)CH₂SO₂CH₃ | H | H | Cl | |
| 3-1415 | 7-CF₃ | CH(CH₃)₂ | CH₃ | H | Cl | |
| 3-1416 | 7-CF₃ | C(CH₃)₂CH₂SCH₃ | CH₃ | H | Cl | |
| 3-1417 | 7-CF₃ | C(CH₃)₂CH₂SOCH₃ | CH₃ | H | Cl | |
| 3-1418 | 7-CF₃ | C(CH₃)₂CH₂SO₂CH₃ | CH₃ | H | Cl | |
| 3-1419 | 7-CF₃ | CH(CH₃)CH₂SCH₃ | CH₃ | H | Cl | |
| 3-1420 | 7-CF₃ | CH(CH₃)CH₂SOCH₃ | CH₃ | H | Cl | |
| 3-1421 | 7-CF₃ | CH(CH₃)CH₂SO₂CH₃ | CH₃ | H | Cl | |
| 3-1422 | 7-CF₃ | CH(CH₃)₂ | H | H | OCF₃ | |
| 3-1423 | 7-CF₃ | C(CH₃)₂CH₂SCH₃ | H | H | OCF₃ | |
| 3-1424 | 7-CF₃ | C(CH₃)₂CH₂SOCH₃ | H | H | OCF₃ | |
| 3-1425 | 7-CF₃ | C(CH₃)₂CH₂SO₂CH₃ | H | H | OCF₃ | |
| 3-1426 | 7-CF₃ | CH(CH₃)CH₂SCH₃ | H | H | OCF₃ | |
| 3-1427 | 7-CF₃ | CH(CH₃)CH₂SOCH₃ | H | H | OCF₃ | |
| 3-1428 | 7-CF₃ | CH(CH₃)CH₂SO₂CH₃ | H | H | OCF₃ | |
| 3-1429 | 7-CF₃ | CH(CH₃)₂ | H | H | CF₃ | |
| 3-1430 | 7-CF₃ | C(CH₃)₂CH₂SCH₃ | H | H | CF₃ | |
| 3-1431 | 7-CF₃ | C(CH₃)₂CH₂SOCH₃ | H | H | CF₃ | |
| 3-1432 | 7-CF₃ | C(CH₃)₂CH₂SO₂CH₃ | H | H | CF₃ | |
| 3-1433 | 7-CF₃ | CH(CH₃)CH₂SCH₃ | H | H | CF₃ | |
| 3-1434 | 7-CF₃ | CH(CH₃)CH₂SOCH₃ | H | H | CF₃ | |
| 3-1435 | 7-CF₃ | CH(CH₃)CH₂SO₂CH₃ | H | H | CF₃ | |
| 3-1436 | 7-CF₃ | CH(CH₃)₂ | H | H | Ph-4-CF₃ | |
| 3-1437 | 7-CF₃ | C(CH₃)₂CH₂SCH₃ | H | H | Ph4-CF₃ | |
| 3-1438 | 7-CF₃ | C(CH₃)₂CH₂SOCH₃ | H | H | Ph-4-CF₃ | |
| 3-1439 | 7-CF₃ | C(CH₃)₂CH₂SO₂CH₃ | H | H | Ph-4-CF₃ | |
| 3-1440 | 7-CF₃ | CH(CH₃)CH₂SCH₃ | H | H | Ph-4-CF₃ | |
| 3-1441 | 7-CF₃ | CH(CH₃)CH₂SOCH₃ | H | H | Ph-4-CF₃ | |
| 3-1442 | 7-CF₃ | CH(CH₃)CH₂SO₂CH₃ | H | H | Ph-4-CF₃ | |
| 3-1443 | 7-CF₃ | CH(CH₃)₂ | F | F | CF₃ | |
| 3-1444 | 7-CF₃ | C(CH₃)₂CH₂SCH₃ | F | F | CF₃ | |
| 3-1445 | 7-CF₃ | C(CH₃)₂CH₂SOCH₃ | F | F | CF₃ | |
| 3-1446 | 7-CF₃ | C(CH₃)₂CH₂SO₂CH₃ | F | F | CF₃ | |
| 3-1447 | 7-CF₃ | CH(CH₃)CH₂SCH₃ | F | F | CF₃ | |
| 3-1448 | 7-CF₃ | CH(CH₃)CH₂SOCH₃ | F | F | CF₃ | |
| 3-1449 | 7-CF₃ | CH(CH₃)CH₂SO₂CH₃ | F | F | CF₃ | |
| 3-1450 | 7-CF₃ | CH(CH₃)₂ | CH₃ | H | COH(CF₃)₂ | |
| 3-1451 | 7-CF₃ | C(CH₃)₂CH₂SCH₃ | CH₃ | H | COH(CF₃)₂ | |
| 3-1452 | 7-CF₃ | C(CH₃)₂CH₂SOCH₃ | CH₃ | H | COH(CF₃)₂ | |
| 3-1453 | 7-CF₃ | C(CH₃)₂CH₂SO₂CH₃ | CH₃ | H | COH(CF₃)₂ | |
| 3-1454 | 7-CF₃ | CH(CH₃)CH₂SCH₃ | CH₃ | H | COH(CF₃)₂ | |
| 3-1455 | 7-CF₃ | CH(CH₃)CH₂SOCH₃ | CH₃ | H | COH(CF₃)₂ | |
| 3-1456 | 7-CF₃ | CH(CH₃)CH₂SO₂CH₃ | CH₃ | H | COH(CF₃)₂ | |
| 3-1457 | 4-CH₃ | CH(CH₃)₂ | CH₃ | H | CF(CF₃)₂ | |
| 3-1458 | 4-CH₃ | C(CH₃)₂CH₂SCH₃ | CH₃ | H | CF(CF₃)₂ | |
| 3-1459 | 4-CH₃ | C(CH₃)₂CH₂SOCH₃ | CH₃ | H | CF(CF₃)₂ | |
| 3-1460 | 4-CH₃ | C(CH₃)₂CH₂SO₂CH₃ | CH₃ | H | CF(CF₃)₂ | |
| 3-1461 | 4-CH₃ | CH(CH₃)CH₂SCH₃ | CH₃ | H | CF(CF₃)₂ | |
| 3-1462 | 4-CH₃ | CH(CH₃)CH₂SOCH₃ | CH₃ | H | CF(CF₃)₂ | |
| 3-1463 | 4-CH₃ | CH(CH₃)CH₂SO₂CH₃ | CH₃ | H | CF(CF₃)₂ | |
| 3-1464 | 4-CH₃ | CH(CH₃)₂ | H | H | CF(CF₃)₂ | |
| 3-1465 | 4-CH₃ | C(CH₃)₂CH₂SCH₃ | H | H | CF(CF₃)₂ | |
| 3-1466 | 4-CH₃ | C(CH₃)₂CH₂SOCH₃ | H | H | CF(CF₃)₂ | |
| 3-1467 | 4-CH₃ | C(CH₃)₂CH₂SO₂CH₃ | H | H | CF(CF₃)₂ | |
| 3-1468 | 4-CH₃ | CH(CH₃)CH₂SCH₃ | H | H | CF(CF₃)₂ | |
| 3-1469 | 4-CH₃ | CH(CH₃)CH₂SOCH₃ | H | H | CF(CF₃)₂ | |
| 3-1470 | 4-CH₃ | CH(CH₃)CH₂SO₂CH₃ | H | H | CF(CF₃)₂ | |
| 3-1471 | 4-CH₃ | CH(CH₃)₂ | Cl | Cl | Cl | |
| 3-1472 | 4-CH₃ | C(CH₃)₂CH₂SCH₃ | Cl | Cl | Cl | |
| 3-1473 | 4-CH₃ | C(CH₃)₂CH₂SOCH₃ | Cl | Cl | Cl | |
| 3-1474 | 4-CH₃ | C(CH₃)₂CH₂SO₂CH₃ | Cl | Cl | Cl | |
| 3-1475 | 4-CH₃ | CH(CH₃)CH₂SCH₃ | Cl | Cl | Cl | |
| 3-1476 | 4-CH₃ | CH(CH₃)CH₂SOCH₃ | Cl | Cl | Cl | |
| 3-1477 | 4-CH₃ | CH(CH₃)CH₂SO₂CH₃ | Cl | Cl | Cl | |
| 3-1478 | 4-CH₃ | CH(CH₃)₂ | CH₃ | H | OCF₃ | |
| 3-1479 | 4-CH₃ | C(CH₃)₂CH₂SCH₃ | CH₃ | H | OCF₃ | |
| 3-1480 | 4-CH₃ | C(CH₃)₂CH₂SOCH₃ | CH₃ | H | OCF₃ | |
| 3-1481 | 4-CH₃ | C(CH₃)₂CH₂SO₂CH₃ | CH₃ | H | OCF₃ | |
| 3-1482 | 4-CH₃ | CH(CH₃)CH₂SCH₃ | CH₃ | H | OCF₃ | |
| 3-1483 | 4-CH₃ | CH(CH₃)CH₂SOCH₃ | CH₃ | H | OCF₃ | |
| 3-1484 | 4-CH₃ | CH(CH₃)CH₂SO₂CH₃ | CH₃ | H | OCF₃ | |
| 3-1485 | 4-CH₃ | CH(CH₃)₂ | Cl | H | Cl | |
| 3-1486 | 4-CH₃ | C(CH₃)₂CH₂SCH₃ | Cl | H | Cl | |
| 3-1487 | 4-CH₃ | C(CH₃)₂CH₂SOCH₃ | Cl | H | Cl | |
| 3-1488 | 4-CH₃ | C(CH₃)₂CH₂SO₂CH₃ | Cl | H | Cl | |
| 3-1489 | 4-CH₃ | CH(CH₃)CH₂SCH₃ | Cl | H | Cl | |
| 3-1490 | 4-CH₃ | CH(CH₃)CH₂SOCH₃ | Cl | H | Cl | |
| 3-1491 | 4-CH₃ | CH(CH₃)CH₂SO₂CH₃ | Cl | H | Cl | |
| 3-1492 | 4-CH₃ | CH(CH₃)₂ | H | Cl | Cl | |
| 3-1493 | 4-CH₃ | C(CH₃)₂CH₂SCH₃ | H | Cl | Cl | |
| 3-1494 | 4-CH₃ | C(CH₃)₂CH₂SOCH₃ | H | Cl | Cl | |
| 3-1495 | 4-CH₃ | C(CH₃)₂CH₂SO₂CH₃ | H | Cl | Cl | |
| 3-1496 | 4-CH₃ | CH(CH₃)CH₂SCH₃ | H | Cl | Cl | |
| 3-1497 | 4-CH₃ | CH(CH₃)CH₂SOCH₃ | H | Cl | Cl | |
| 3-1498 | 4-CH₃ | CH(CH₃)CH₂SO₂CH₃ | H | Cl | Cl | |
| 3-1499 | 4-CH₃ | CH(CH₃)₂ | Cl | Cl | H | |
| 3-1500 | 4-CH₃ | C(CH₃)₂CH₂SCH₃ | Cl | Cl | H | |
| 3-1501 | 4-CH₃ | C(CH₃)₂CH₂SOCH₃ | Cl | Cl | H | |
| 3-1502 | 4-CH₃ | C(CH₃)₂CH₂SO₂CH₃ | Cl | Cl | H | |
| 3-1503 | 4-CH₃ | CH(CH₃)CH₂SCH₃ | Cl | Cl | H | |
| 3-1504 | 4-CH₃ | CH(CH₃)CH₂SOCH₃ | Cl | Cl | H | |
| 3-1505 | 4-CH₃ | CH(CH₃)CH₂SO₂CH₃ | Cl | Cl | H | |
| 3-1506 | 4-CH₃ | CH(CH₃)₂ | Cl | H | CF₃ | |
| 3-1507 | 4-CH₃ | C(CH₃)₂CH₂SCH₃ | Cl | H | CF₃ | |
| 3-1508 | 4-CH₃ | C(CH₃)₂CH₂SOCH₃ | Cl | H | CF₃ | |
| 3-1509 | 4-CH₃ | C(CH₃)₂CH₂SO₂CH₃ | Cl | H | CF₃ | |
| 3-1510 | 4-CH₃ | CH(CH₃)CH₂SCH₃ | Cl | H | CF₃ | |
| 3-1511 | 4-CH₃ | CH(CH₃)CH₂SOCH₃ | Cl | H | CF₃ | |
| 3-1512 | 4-CH₃ | CH(CH₃)CH₂SO₂CH₃ | Cl | H | CF₃ | |
| 3-1513 | 4-CH₃ | CH(CH₃)₂ | Cl | H | CF₃ | |
| 3-1514 | 4-CH₃ | C(CH₃)₂CH₂SCH₃ | Cl | H | CF₃ | |
| 3-1515 | 4-CH₃ | C(CH₃)₂CH₂SOCH₃ | Cl | H | CF₃ | |
| 3-1516 | 4-CH₃ | C(CH₃)₂CH₂SO₂CH₃ | Cl | H | CF₃ | |
| 3-1517 | 4-CH₃ | CH(CH₃)CH₂SCH₃ | Cl | H | CF₃ | |
| 3-1518 | 4-CH₃ | CH(CH₃)CH₂SOCH₃ | Cl | H | CF₃ | |
| 3-1519 | 4-CH₃ | CH(CH₃)CH₂SO₂CH₃ | Cl | H | CF₃ | |
| 3-1520 | 4-CH₃ | CH(CH₃)₂ | H | H | Cl | |
| 3-1521 | 4-CH₃ | C(CH₃)₂CH₂SCH₃ | H | H | Cl | |
| 3-1522 | 4-CH₃ | C(CH₃)₂CH₂SOCH₃ | H | H | Cl | |
| 3-1523 | 4-CH₃ | C(CH₃)₂CH₂SO₂CH₃ | H | H | Cl | |
| 3-1524 | 4-CH₃ | CH(CH₃)CH₂SCH₃ | H | H | Cl | |
| 3-1525 | 4-CH₃ | CH(CH₃)CH₂SOCH₃ | H | H | Cl | |
| 3-1526 | 4-CH₃ | CH(CH₃)CH₂SO₂CH₃ | H | H | Cl | |
| 3-1527 | 4-CH₃ | CH(CH₃)₂ | CH₃ | H | Cl | |
| 3-1528 | 4-CH₃ | C(CH₃)₂CH₂SCH₃ | CH₃ | H | Cl | |
| 3-1529 | 4-CH₃ | C(CH₃)₂CH₂SOCH₃ | CH₃ | H | Cl | |
| 3-1530 | 4-CH₃ | C(CH₃)₂CH₂SO₂CH₃ | CH₃ | H | Cl | |
| 3-1531 | 4-CH₃ | CH(CH₃)CH₂SCH₃ | CH₃ | H | Cl | |
| 3-1532 | 4-CH₃ | CH(CH₃)CH₂SOCH₃ | CH₃ | H | Cl | |
| 3-1533 | 4-CH₃ | CH(CH₃)CH₂SO₂CH₃ | CH₃ | H | Cl | |
| 3-1534 | 4-CH₃ | CH(CH₃)₂ | H | H | OCF₃ | |
| 3-1535 | 4-CH₃ | C(CH₃)₂CH₂SCH₃ | H | H | OCF₃ | |
| 3-1536 | 4-CH₃ | C(CH₃)₂CH₂SOCH₃ | H | H | OCF₃ | |
| 3-1537 | 4-CH₃ | C(CH₃)₂CH₂SO₂CH₃ | H | H | OCF₃ | |
| 3-1538 | 4-CH₃ | CH(CH₃)CH₂SCH₃ | H | H | OCF₃ | |
| 3-1539 | 4-CH₃ | CH(CH₃)CH₂SOCH₃ | H | H | OCF₃ | |
| 3-1540 | 4-CH₃ | CH(CH₃)CH₂SO₂CH₃ | H | H | OCF₃ | |
| 3-1541 | 4-CH₃ | CH(CH₃)₂ | H | H | CF₃ | |
| 3-1542 | 4-CH₃ | C(CH₃)₂CH₂SCH₃ | H | H | CF₃ | |
| 3-1543 | 4-CH₃ | C(CH₃)₂CH₂SOCH₃ | H | H | CF₃ | |
| 3-1544 | 4-CH₃ | C(CH₃)₂CH₂SO₂CH₃ | H | H | CF₃ | |
| 3-1545 | 4-CH₃ | CH(CH₃)CH₂SCH₃ | H | H | CF₃ | |
| 3-1546 | 4-CH₃ | CH(CH₃)CH₂SOCH₃ | H | H | CF₃ | |
| 3-1547 | 4-CH₃ | CH(CH₃)CH₂SO₂CH₃ | H | H | CF₃ | |
| 3-1548 | 4-CH₃ | CH(CH₃)₂ | H | H | Ph-4-CF₃ | |
| 3-1549 | 4-CH₃ | C(CH₃)₂CH₂SCH₃ | H | H | Ph-4-CF₃ | |
| 3-1550 | 4-CH₃ | C(CH₃)₂CH₂SOCH₃ | H | H | Ph-4-CF₃ | |
| 3-1551 | 4-CH₃ | C(CH₃)₂CH₂SO₂CH₃ | H | H | Ph-4-CF₃ | |
| 3-1552 | 4-CH₃ | CH(CH₃)CH₂SCH₃ | H | H | Ph-4-CF₃ | |
| 3-1553 | 4-CH₃ | CH(CH₃)CH₂SOCH₃ | H | H | Ph-4-CF₃ | |
| 3-1554 | 4-CH₃ | CH(CH₃)CH₂SO₂CH₃ | H | H | Ph-4-CF₃ | |
| 3-1555 | 4-CH₃ | CH(CH₃)₂ | F | F | CF₃ | |
| 3-1556 | 4-CH₃ | C(CH₃)₂CH₂SCH₃ | F | F | CF₃ | |
| 3-1557 | 4-CH₃ | C(CH₃)₂CH₂SO₂CH₃ | F | F | CF₃ | |
| 3-1558 | 4-CH₃ | C(CH₃)₂CH₂SO₂CH₃ | F | F | CF₃ | |
| 3-1559 | 4-CH₃ | CH(CH₃)CH₂SCH₃ | F | F | CF₃ | |
| 3-1560 | 4-CH₃ | CH(CH₃)CH₂SOCH₃ | F | F | CF₃ | |
| 3-1561 | 4-CH₃ | CH(CH₃)CH₂SO₂CH₃ | F | F | CF₃ | |
| 3-1562 | 4-CH₃ | CH(CH₃)₂ | CH₃ | H | COH(CF₃)₂ | |
| 3-1563 | 4-CH₃ | C(CH₃)₂CH₂SCH₃ | CH₃ | H | COH(CF₃)₂ | |
| 3-1564 | 4-CH₃ | C(CH₃)₂CH₂SOCH₃ | CH₃ | H | COH(CF₃)₂ | |
| 3-1565 | 4-CH₃ | C(CH₃)₂CH₂SO₂CH₃ | CH₃ | H | COH(CF₃)₂ | |
| 3-1566 | 4-CH₃ | CH(CH₃)CH₂SCH₃ | CH₃ | H | COH(CF₃)₂ | |
| 3-1567 | 4-CH₃ | CH(CH₃)CH₂SOCH₃ | CH₃ | H | COH(CF₃)₂ | |
| 3-1568 | 4-CH₃ | CH(CH₃)CH₂SO₂CH₃ | CH₃ | H | COH(CF₃)₂ | |
| 3-1569 | 7-CH₃ | CH(CH₃)₂ | CH₃ | H | CF(CF₃)₂ | |
| 3-1570 | 7-CH₃ | C(CH₃)₂CH₂SCH₃ | CH₃ | H | CF(CF₃)₂ | |
| 3-1571 | 7-CH₃ | C(CH₃)₂CH₂SOCH₃ | CH₃ | H | CF(CF₃)₂ | |
| 3-1572 | 7-CH₃ | C(CH₃)₂CH₂SO₂CH₃ | CH₃ | H | CF(CF₃)₂ | |
| 3-1573 | 7-CH₃ | CH(CH₃)CH₂SCH₃ | CH₃ | H | CF(CF₃)₂ | |
| 3-1574 | 7-CH₃ | CH(CH₃)CH₂SO₂CH₃ | CH₃ | H | CF(CF₃)₂ | |
| 3-1575 | 7-CH₃ | CH(CH₃)CH₂SO₂CH₃ | CH₃ | H | CF(CF₃)₂ | |
| 3-1576 | 7-CH₃ | CH(CH₃)₂ | H | H | CF(CF₃)₂ | |
| 3-1577 | 7-CH₃ | C(CH₃)₂CH₂SCH₃ | H | H | CF(CF₃)₂ | |
| 3-1578 | 7-CH₃ | C(CH₃)₂CH₂SOCH₃ | H | H | CF(CF₃)₂ | |
| 3-1579 | 7-CH₃ | C(CH₃)₂CH₂SO₂CH₃ | H | H | CF(CF₃)₂ | |
| 3-1580 | 7-CH₃ | CH(CH₃)CH₂SCH₃ | H | H | CF(CF₃)₂ | |
| 3-1581 | 7-CH₃ | CH(CH₃)CH₂SOCH₃ | H | H | CF(CF₃)₂ | |
| 3-1582 | 7-CH₃ | CH(CH₃)CH₂SO₂CH₃ | H | H | CF(CF₃)₂ | |
| 3-1583 | 7-CH₃ | CH(CH₃)₂ | Cl | Cl | Cl | |
| 3-1584 | 7-CH₃ | C(CH₃)₂CH₂SCH₃ | Cl | Cl | Cl | |
| 3-1585 | 7-CH₃ | C(CH₃)₂CH₂SOCH₃ | Cl | Cl | Cl | |
| 3-1586 | 7-CH₃ | C(CH₃)₂CH₂SO₂CH₃ | Cl | Cl | Cl | |
| 3-1587 | 7-CH₃ | CH(CH₃)CH₂SCH₃ | Cl | Cl | Cl | |
| 3-1588 | 7-CH₃ | CH(CH₃)CH₂SOCH₃ | Cl | Cl | Cl | |
| 3-1589 | 7-CH₃ | CH(CH₃)CH₂SO₂CH₃ | Cl | Cl | Cl | |
| 3-1590 | 7-CH₃ | CH(CH₃)₂ | CH₃ | H | OCF₃ | |
| 3-1591 | 7-CH₃ | C(CH₃)₂CH₂SCH₃ | CH₃ | H | OCF₃ | |
| 3-1592 | 7-CH₃ | C(CH₃)₂CH₂SOCH₃ | CH₃ | H | OCF₃ | |
| 3-1593 | 7-CH₃ | C(CH₃)₂CH₂SO₂CH₃ | CH₃ | H | OCF₃ | |
| 3-1594 | 7-CH₃ | CH(CH₃)CH₂SCH₃ | CH₃ | H | OCF₃ | |
| 3-1595 | 7-CH₃ | CH(CH₃)CH₂SOCH₃ | CH₃ | H | OCF₃ | |
| 3-1596 | 7-CH₃ | CH(CH₃)CH₂SO₂CH₃ | CH₃ | H | OCF₃ | |
| 3-1597 | 7-CH₃ | CH(CH₃)₂ | Cl | H | Cl | |
| 3-1598 | 7-CH₃ | C(CH₃)₂CH₂SCH₃ | Cl | H | Cl | |
| 3-1599 | 7-CH₃ | C(CH₃)₂CH₂SOCH₃ | Cl | H | Cl | |
| 3-1600 | 7-CH₃ | C(CH₃)₂CH₂SO₂CH₃ | Cl | H | Cl | |
| 3-1601 | 7-CH₃ | CH(CH₃)CH₂SCH₃ | Cl | H | Cl | |
| 3-1602 | 7-CH₃ | CH(CH₃)CH₂SOCH₃ | Cl | H | Cl | |
| 3-1603 | 7-CH₃ | CH(CH₃)CH₂SO₂CH₃ | Cl | H | Cl | |
| 3-1604 | 7-CH₃ | CH(CH₃)₂ | H | Cl | Cl | |
| 3-1605 | 7-CH₃ | C(CH₃)₂CH₂SCH₃ | H | Cl | Cl | |
| 3-1606 | 7-CH₃ | C(CH₃)₂CH₂SOCH₃ | H | Cl | Cl | |
| 3-1607 | 7-CH₃ | C(CH₃)₂CH₂SO₂CH₃ | H | 01 Cl | | |
| 3-1608 | 7-CH₃ | CH(CH₃)CH₂SCH₃ | H | Cl | Cl | |
| 3-1609 | 7-CH₃ | CH(CH₃)CH₂SOCH₃ | H | Cl | Cl | |
| 3-1610 | 7-CH₃ | CH(CH₃)CH₂SO₂CH₃ | H | 01 Cl | | |
| 3-1611 | 7-CH₃ | CH(CH₃)₂ | Cl | Cl | H | |
| 3-1612 | 7-CH₃ | C(CH₃)₂CH₂SCH₃ | Cl | Cl | H | |
| 3-1613 | 7-CH₃ | C(CH₃)₂CH₂SOCH₃ | Cl | Cl | H | |
| 3-1614 | 7-CH₃ | C(CH₃)₂CH₂SO₂CH₃ | Cl | Cl | H | |
| 3-1615 | 7-CH₃ | CH(CH₃)CH₂SCH₃ | Cl | Cl | H | |
| 3-1616 | 7-CH₃ | CH(CH₃)CH₂SOCH₃ | Cl | Cl | H | |
| 3-1617 | 7-CH₃ | CH(CH₃)CH₂SO₂CH₃ | Cl | Cl | H | |
| 3-1618 | 7-CH₃ | CH(CH₃)₂ | Cl | H | CF₃ | |
| 3-1619 | 7-CH₃ | C(CH₃)₂CH₂SCH₃ | Cl | H | CF₃ | |
| 3-1620 | 7-CH₃ | C(CH₃)₂CH₂SOCH₃ | Cl | H | CF₃ | |
| 3-1621 | 7-CH₃ | C(CH₃)₂CH₂SO₂CH₃ | Cl | H | CF₃ | |
| 3-1622 | 7-CH₃ | CH(CH₃)CH₂SCH₃ | Cl | H | CF₃ | |
| 3-1623 | 7-CH₃ | CH(CH₃)CH₂SOCH₃ | Cl | H | CF₃ | |
| 3-1624 | 7-CH₃ | CH(CH₃)CH₂SO₂CH₃ | Cl | H | CF₃ | |
| 3-1625 | 7-CH₃ | CH(CH₃)₂ | Cl | H | CF₃ | |
| 3-1626 | 7-CH₃ | C(CH₃)₂CH₂SCH₃ | Cl | H | CF₃ | |
| 3-1627 | 7-CH₃ | C(CH₃)₂CH₂SOCH₃ | Cl | H | CF₃ | |
| 3-1628 | 7-CH₃ | C(CH₃)₂CH₂SO₂CH₃ | Cl | H | CF₃ | |
| 3-1629 | 7-CH₃ | CH(CH₃)CH₂SCH₃ | Cl | H | CF₃ | |
| 3-1630 | 7-CH₃ | CH(CH₃)CH₂SOCH₃ | Cl | H | CF₃ | |
| 3-1631 | 7-CH₃ | CH(CH₃)CH₂SO₂CH₃ | Cl | H | CF₃ | |
| 3-1632 | 7-CH₃ | CH(CH₃)₂ | H | H | Cl | |
| 3-1633 | 7-CH₃ | C(CH₃)₂CH₂SCH₃ | H | H | Cl | |
| 3-1634 | 7-CH₃ | C(CH₃)₂CH₂SOCH₃ | H | H | Cl | |
| 3-1635 | 7-CH₃ | C(CH₃)₂CH₂SO₂CH₃ | H | H | Cl | |
| 3-1636 | 7-CH₃ | CH(CH₃)CH₂SCH₃ | H | H | Cl | |
| 3-1637 | 7-CH₃ | CH(CH₃)CH₂SOCH₃ | H | H | Cl | |
| 3-1638 | 7-CH₃ | CH(CH₃)CH₂SO₂CH₃ | H | H | Cl | |
| 3-1639 | 7-CH₃ | CH(CH₃)₂ | CH₃ | H | Cl | |
| 3-1640 | 7-CH₃ | C(CH₃)₂CH₂SCH₃ | CH₃ | H | Cl | |
| 3-1641 | 7-CH₃ | C(CH₃)₂CH₂SOCH₃ | CH₃ | H | Cl | |
| 3-1642 | 7-CH₃ | C(CH₃)₂CH₂SO₂CH₃ | CH₃ | H | Cl | |
| 3-1643 | 7-CH₃ | CH(CH₃)CH₂SCH₃ | CH₃ | H | Cl | |
| 3-1644 | 7-CH₃ | CH(CH₃)CH₂SOCH₃ | CH₃ | H | Cl | |
| 3-1645 | 7-CH₃ | CH(CH₃)CH₂SO₂CH₃ | CH₃ | H | Cl | |
| 3-1646 | 7-CH₃ | CH(CH₃)₂ | H | H | OCF₃ | |
| 3-1647 | 7-CH₃ | C(CH₃)₂CH₂SCH₃ | H | H | OCF₃ | |
| 3-1648 | 7-CH₃ | C(CH₃)₂CH₂SOCH₃ | H | H | OCF₃ | |
| 3-1649 | 7-CH₃ | C(CH₃)₂CH₂SO₂CH₃ | H | H | OCF₃ | |
| 3-1650 | 7-CH₃ | CH(CH₃)CH₂SCH₃ | H | H | OCF₃ | |
| 3-1651 | 7-CH₃ | CH(CH₃)CH₂SOCH₃ | H | H | OCF₃ | |
| 3-1652 | 7-CH₃ | CH(CH₃)CH₂SO₂CH₃ | H | H | OCF₃ | |
| 3-1653 | 7-CH₃ | CH(CH₃)₂ | H | H | CF₃ | |
| 3-1654 | 7-CH₃ | C(CH₃)₂CH₂SCH₃ | H | H | CF₃ | |
| 3-1655 | 7-CH₃ | C(CH₃)₂CH₂SOCH₃ | H | H | CF₃ | |
| 3-1656 | 7-CH₃ | C(CH₃)₂CH₂SO₂CH₃ | H | H | CF₃ | |
| 3-1657 | 7-CH₃ | CH(CH₃)CH₂SCH₃ | H | H | CF₃ | |
| 3-1658 | 7-CH₃ | CH(CH₃)CH₂SOCH₃ | H | H | CF₃ | |
| 3-1659 | 7-CH₃ | CH(CH₃)CH₂SO₂CH₃ | H | H | CF₃ | |
| 3-1660 | 7-CH₃ | CH(CH₃)₂ | H | H | Ph-4-CF₃ | |
| 3-1661 | 7-CH₃ | C(CH₃)₂CH₂SCH₃ | H | H | Ph-4-CF₃ | |
| 3-1662 | 7-CH₃ | C(CH₃)₂CH₂SOCH₃ | H | H | Ph-4-CF₃ | |
| 3-1663 | 7-CH₃ | C(CH₃)₂CH₂SO₂CH₃ | H | H | Ph-4-CF₃ | |
| 3-1664 | 7-CH₃ | CH(CH₃)CH₂SCH₃ | H | H | Ph-4-CF₃ | |
| 3-1665 | 7-CH₃ | CH(CH₃)CH₂SOCH₃ | H | H | Ph-4-CF₃ | |
| 3-1666 | 7-CH₃ | CH(CH₃)CH₂SO₂CH₃ | H | H | Ph-4-CF₃ | |
| 3-1667 | 7-CH₃ | CH(CH₃)₂ | F | F | CF₃ | |
| 3-1668 | 7-CH₃ | C(CH₃)₂CH₂SCH₃ | F | F | CF₃ | |
| 3-1669 | 7-CH₃ | C(CH₃)₂CH₂SOCH₃ | F | F | CF₃ | |
| 3-1670 | 7-CH₃ | C(CH₃)₂CH₂SO₂CH₃ | F | F | CF₃ | |
| 3-1671 | 7-CH₃ | CH(CH₃)CH₂SCH₃ | F | F | CF₃ | |
| 3-1672 | 7-CH₃ | CH(CH₃)CH₂SOCH₃ | F | F | CF₃ | |
| 3-1673 | 7-CH₃ | CH(CH₃)CH₂SO₂CH₃ | F | F | CF₃ | |
| 3-1674 | 7-CH₃ | CH(CH₃)₂ | CH₃ | H | COH(CF₃)₂ | |
| 3-1675 | 7-CH₃ | C(CH₃)₂CH₂SCH₃ | CH₃ | H | COH(CF₃)₂ | |
| 3-1676 | 7-CH₃ | C(CH₃)₂CH₂SOCH₃ | CH₃ | H | COH(CF₃)₂ | |
| 3-1677 | 7-CH₃ | C(CH₃)₂CH₂SO₂CH₃ | CH₃ | H | COH(CF₃)₂ | |
| 3-1678 | 7-CH₃ | CH(CH₃)CH₂SCH₃ | CH₃ | H | COH(CF₃)₂ | |
| 3-1679 | 7-CH₃ | CH(CH₃)CH₂SOCH₃ | CH₃ | H | COH(CF₃)₂ | |
| 3-1680 | 7-CH₃ | CH(CH₃)CH₂SO₂CH₃ | CH₃ | H | COH(CF₃)₂ | |
| 3-1681 | 4-OCF₃ | CH(CH₃)₂ | CH₃ | H | CF(CF₃)₂ | |
| 3-1682 | 4-OCF₃ | C(CH₃)₂CH₂SCH₃ | CH₃ | H | CF(CF₃)₂ | |
| 3-1683 | 4-OCF₃ | C(CH₃)₂CH₂SOCH₃ | CH₃ | H | CF(CF₃)₂ | |
| 3-1684 | 4-OCF₃ | C(CH₃)₂CH₂SO₂CH₃ | CH₃ | H | CF(CF₃)₂ | |
| 3-1685 | 4-OCF₃ | CH(CH₃)CH₂SCH₃ | CH₃ | H | CF(CF₃)₂ | |
| 3-1686 | 4-OCF₃ | CH(CH₃)CH₂SOCH₃ | CH₃ | H | CF(CF₃)₂ | |
| 3-1687 | 4-OCF₃ | CH(CH₃)CH₂SO₂CH₃ | CH₃ | H | CF(CF₃)₂ | |
| 3-1688 | 4-OCF₃ | CH(CH₃)₂ | H | H | CF(CF₃)₂ | |
| 3-1689 | 4-OCF₃ | C(CH₃)₂CH₂SCH₃ | H | H | CF(CF₃)₂ | |
| 3-1690 | 4-OCF₃ | C(CH₃)₂CH₂SOCH₃ | H | H | CF(CF₃)₂ | |
| 3-1691 | 4-OCF₃ | C(CH₃)₂CH₂SO₂CH₃ | H | H | CF(CF₃)₂ | |
| 3-1692 | 4-OCF₃ | CH(CH₃)CH₂SCH₃ | H | H | CF(CF₃)₂ | |
| 3-1693 | 4-OCF₃ | CH(CH₃)CH₂SOCH₃ | H | H | CF(CF₃)₂ | |
| 3-1694 | 4-OCF₃ | CH(CH₃)CH₂SO₂CH₃ | H | H | CF(CF₃)₂ | |
| 3-1695 | 4-OCF₃ | CH(CH₃)₂ | Cl | Cl | Cl | |
| 3-1696 | 4-OCF₃ | C(CH₃)₂CH₂SCH₃ | Cl | Cl | Cl | |
| 3-1697 | 4-OCF₃ | C(CH₃)₂CH₂SOCH₃ | Cl | Cl | Cl | |
| 3-1698 | 4-OCF₃ | C(CH₃)₂CH₂SO₂CH₃ | Cl | Cl | Cl | |
| 3-1699 | 4-OCF₃ | CH(CH₃)CH₂SCH₃ | Cl | Cl | Cl | |
| 3-1700 | 4-OCF₃ | CH(CH₃)CH₂SOCH₃ | Cl | Cl | Cl | |
| 3-1701 | 4-OCF₃ | CH(CH₃)CH₂SO₂CH₃ | Cl | Cl | Cl | |
| 3-1702 | 4-OCF₃ | CH(CH₃)₂ | CH₃ | H | OCF₃ | |
| 3-1703 | 4-OCF₃ | C(CH₃)₂CH₂SCH₃ | CH₃ | H | OCF₃ | |
| 3-1704 | 4-OCF₃ | C(CH₃)₂CH₂SOCH₃ | CH₃ | H | OCF₃ | |
| 3-1705 | 4-OCF₃ | C(CH₃)₂CH₂SO₂CH₃ | CH₃ | H | OCF₃ | |
| 3-1706 | 4-OCF₃ | CH(CH₃)CH₂SCH₃ | CH₃ | H | OCF₃ | |
| 3-1707 | 4-OCF₃ | CH(CH₃)CH₂SOCH₃ | CH₃ | H | OCF₃ | |
| 3-1708 | 4-OCF₃ | CH(CH₃)CH₂SO₂CH₃ | CH₃ | H | OCF₃ | |
| 3-1709 | 4-OCF₃ | CH(CH₃)₂ | Cl | H | Cl | |
| 3-1710 | 4-OCF₃ | C(CH₃)₂CH₂SCH₃ | Cl | H | Cl | |
| 3-1711 | 4-OCF₃ | C(CH₃)₂CH₂SOCH₃ | Cl | H | Cl | |
| 3-1712 | 4-OCF₃ | C(CH₃)₂CH₂SO₂CH₃ | Cl | H | Cl | |
| 3-1713 | 4-OCF₃ | CH(CH₃)CH₂SCH₃ | Cl | H | Cl | |
| 3-1714 | 4-OCF₃ | CH(CH₃)CH₂SOCH₃ | Cl | H | Cl | |
| 3-1715 | 4-OCF₃ | CH(CH₃)CH₂SO₂CH₃ | Cl | H | Cl | |
| 3-1716 | 4-OCF₃ | CH(CH₃)₂ | H | Cl | Cl | |
| 3-1717 | 4-OCF₃ | C(CH₃)₂CH₂SCH₃ | H | Cl | Cl | |
| 3-1718 | 4-OCF₃ | C(CH₃)₂CH₂SOCH₃ | H | Cl | Cl | |
| 3-1719 | 4-OCF₃ | C(CH₃)₂CH₂SO₂CH₃ | H | Cl | Cl | |
| 3-1720 | 4-OCF₃ | CH(CH₃)CH₂SCH₃ | H | Cl | Cl | |
| 3-1721 | 4-OCF₃ | CH(CH₃)CH₂SOCH₃ | H | Cl | Cl | |
| 3-1722 | 4-OCF₃ | CH(CH₃)CH₂SO₂CH₃ | H | Cl | Cl | |
| 3-1723 | 4-OCF₃ | CH(CH₃)₂ | Cl | Cl | H | |
| 3-1724 | 4-OCF₃ | C(CH₃)₂CH₂SCH₃ | Cl | Cl | H | |
| 3-1725 | 4-OCF₃ | C(CH₃)₂CH₂SOCH₃ | Cl | Cl | H | |
| 3-1726 | 4-OCF₃ | C(CH₃)₂CH₂SO₂CH₃ | Cl | Cl | H | |
| 3-1727 | 4-OCF₃ | CH(CH₃)CH₂SCH₃ | Cl | Cl | H | |
| 3-1728 | 4-OCF₃ | CH(CH₃)CH₂SOCH₃ | Cl | Cl | H | |
| 3-1729 | 4-OCF₃ | CH(CH₃)CH₂SO₂CH₃ | Cl | Cl | H | |
| 3-1730 | 4-OCF₃ | CH(CH₃)₂ | Cl | H | CF₃ | |
| 3-1731 | 4-OCF₃ | C(CH₃)₂CH₂SCH₃ | Cl | H | CF₃ | |
| 3-1732 | 4-OCF₃ | C(CH₃)₂CH₂SOCH₃ | Cl | H | CF₃ | |
| 3-1733 | 4-OCF₃ | C(CH₃)₂CH₂SO₂CH₃ | Cl | H | CF₃ | |
| 3-1734 | 4-OCF₃ | CH(CH₃)CH₂SCH₃ | Cl | H | CF₃ | |
| 3-1735 | 4-OCF₃ | CH(CH₃)CH₂SOCH₃ | Cl | H | CF₃ | |
| 3-1736 | 4-OCF₃ | CH(CH₃)CH₂SO₂CH₃ | Cl | H | CF₃ | |
| 3-1737 | 4-OCF₃ | CH(CH₃)₂ | Cl | H | CF₃ | |
| 3-1738 | 4-OCF₃ | C(CH₃)₂CH₂SCH₃ | Cl | H | CF₃ | |
| 3-1739 | 4-OCF₃ | C(CH₃)₂CH₂SOCH₃ | Cl | H | CF₃ | |
| 3-1740 | 4-OCF₃ | C(CH₃)₂CH₂SO₂CH₃ | Cl | H | CF₃ | |
| 3-1741 | 4-OCF₃ | CH(CH₃)CH₂SCH₃ | Cl | H | CF₃ | |
| 3-1742 | 4-OCF₃ | CH(CH₃)CH₂SOCH₃ | Cl | H | CF₃ | |
| 3-1743 | 4-OCF₃ | CH(CH₃)CH₂SO₂CH₃ | Cl | H | CF₃ | |
| 3-1744 | 4-OCF₃ | CH(CH₃)₂ | H | H | Cl | |
| 3-1745 | 4-OCF₃ | C(CH₃)₂CH₂SCH₃ | H | H | Cl | |
| 3-1746 | 4-OCF₃ | C(CH₃)₂CH₂SOCH₃ | H | H | Cl | |
| 3-1747 | 4-OCF₃ | C(CH₃)₂CH₂SO₂CH₃ | H | H | Cl | |
| 3-1748 | 4-OCF₃ | CH(CH₃)CH₂SCH₃ | H | H | Cl | |
| 3-1749 | 4-OCF₃ | CH(CH₃)CH₂SOCH₃ | H | H | Cl | |
| 3-1750 | 4-OCF₃ | CH(CH₃)CH₂SO₂CH₃ | H | H | Cl | |
| 3-1751 | 4-OCF₃ | CH(CH₃)₂ | CH₃ | H | Cl | |
| 3-1752 | 4-OCF₃ | C(CH₃)₂CH₂SCH₃ | CH₃ | H | Cl | |
| 3-1753 | 4-OCF₃ | C(CH₃)₂CH₂SOCH₃ | CH₃ | H | Cl | |
| 3-1754 | 4-OCF₃ | C(CH₃)₂CH₂SO₂CH₃ | CH₃ | H | Cl | |
| 3-1755 | 4-OCF₃ | CH(CH₃)CH₂SCH₃ | CH₃ | H | Cl | |
| 3-1756 | 4-OCF₃ | CH(CH₃)CH₂SOCH₃ | CH₃ | H | Cl | |
| 3-1757 | 4-OCF₃ | CH(CH₃)CH₂SO₂CH₃ | CH₃ | H | Cl | |
| 3-1758 | 4-OCF₃ | CH(CH₃)₂ | H | H | OCF₃ | |
| 3-1759 | 4-OCF₃ | C(CH₃)₂CH₂SCH₃ | H | H | OCF₃ | |
| 3-1760 | 4-OCF₃ | C(CH₃)₂CH₂SOCH₃ | H | H | OCF₃ | |
| 3-1761 | 4-OCF₃ | C(CH₃)₂CH₂SO₂CH₃ | H | H | OCF₃ | |
| 3-1762 | 4-OCF₃ | CH(CH₃)CH₂SCH₃ | H | H | OCF₃ | |
| 3-1763 | 4-OCF₃ | CH(CH₃)CH₂SOCH₃ | H | H | OCF3. | |
| 3-1764 | 4-OCF₃ | CH(CH₃)CH₂SO₂CH₃ | H | H | OCF₃ | |
| 3-1765 | 4-OCF₃ | CH(CH₃)₂ | H | H | CF₃ | |
| 3-1766 | 4-OCF₃ | C(CH₃)₂CH₂SCH₃ | H | H | CF₃ | |
| 3-1767 | 4-OCF₃ | C(CH₃)₂CH₂SOCH₃ | H | H | CF₃ | |
| 3-1768 | 4-OCF₃ | C(CH₃)₂CH₂SO₂CH₃ | H | H | CF₃ | |
| 3-1769 | 4-OCF₃ | CH(CH₃)CH₂SCH₃ | H | H | CF₃ | |
| 3-1770 | 4-OCF₃ | CH(CH₃)CH₂SOCH₃ | H | H | CF₃ | |
| 3-1771 | 4-OCF₃ | CH(CH₃)CH₂SO₂CH₃ | H | H | CF₃ | |
| 3-1772 | 4 OCF₃ | CH(CH₃)₂ | H | H | Ph-4-CF₃ | |
| 3-1773 | 4-OCF₃ | C(CH₃)₂CH₂SCH₃ | H | H | Ph-4-CF₃ | |
| 3-1774 | 4-OCF₃ | C(CH₃)₂CH₂SOCH₃ | H | H | Ph-4-CF₃ | |
| 3-1775 | 4-OCF₃ | C(CH₃)₂CH₂SO₂CH₃ | H | H | Ph-4-CF₃ | |
| 3-1776 | 4-OCF₃ | CH(CH₃)CH₂SCH₃ | H | H | Ph-4-CF₃ | |
| 3-1777 | 4-OCF₃ | CH(CH₃)CH₂SOCH₃ | H | H | Ph-4-CF₃ | |
| 3-1778 | 4-OCF₃ | CH(CH₃)CH₂SO₂CH₃ | H | H | Ph-4-CF₃ | |
| 3-1779 | 4-OCF₃ | CH(CH₃)₂ | F | F | CF₃ | |
| 3-1780 | 4-OCF₃ | C(CH₃)₂CH₂SCH₃ | F | F | CF₃ | |
| 3-1781 | 4-OCF₃ | C(CH₃)₂CH₂SOCH₃ | F | F | CF₃ | |
| 3-1782 | 4-OCF₃ | C(CH₃)₂CH₂SO₂CH₃ | F | F | CF₃ | |
| 3-1783 | 4-OCF₃ | CH(CH₃)CH₂SCH₃ | F | F | CF₃ | |
| 3-1784 | 4-OCF₃ | CH(CH₃)CH₂SOCH₃ | F | F | CF₃ | |
| 3-1785 | 4-OCF₃ | CH(CH₃)CH₂SO₂CH₃ | F | F | CF₃ | |
| 3-1786 | 4-OCF₃ | CH(CH₃)₂ | CH₃ | H | COH(CF₃)₂ | |
| 3-1787 | 4-OCF₃ | C(CH₃)₂CH₂SCH₃ | CH₃ | H | COH(CF₃)₂ | |
| 3-1788 | 4-OCF₃ | C(CH₃)₂CH₂SOCH₃ | CH₃ | H | COH(CF₃)₂ | |
| 3-1789 | 4-OCF₃ | C(CH₃)₂GH2SO₂CH₃ | CH₃ | H | COH(CF₃)₂ | |
| 3-1790 | 4-OCF₃ | CH(CH₃)CH₂SCH₃ | CH₃ | H | COH(CF₃)₂ | |
| 3-1791 | 4-OCF₃ | CH(CH₃)CH₂SOCH₃ | CH₃ | H | COH(CF₃)₂ | |
| 3-1792 | 4-OCF₃ | CH(CH₃)CH₂SO₂CH₃ | CH₃ | H | COH(CF₃)₂ | |
| 3-1793 | 7-OCF₃ | CH(CH₃)₂ | CH₃ | H | CF(CF₃)₂ | |
| 3-1794 | 7-OCF₃ | C(CH₃)₂CH₂SCH₃ | CH₃ | H | CF(CF₃)₂ | |
| 3-1795 | 7-OCF₃ | C(CH₃)₂CH₂SOCH₃ | CH₃ | H | CF(CF₃)₂ | |
| 3-1796 | 7-OCF₃ | C(CH₃)₂CH₂SO₂CH₃ | CH₃ | H | CF(CF₃)₂ | |
| 3-1797 | 7-OCF₃ | CH(CH₃)CH₂SCH₃ | CH₃ | H | CF(CF₃)₂ | |
| 3-1798 | 7-OCF₃ | CH(CH₃)CH₂SOCH₃ | CH₃ | H | CF(CF₃)₂ | |
| 3-1799 | 7-OCF₃ | CH(CH₃)CH₂SO₂CH₃ | CH₃ | H | CF(CF₃)₂ | |
| 3-1800 | 7-OCF₃ | CH(CH₃)₂ | H | H | CF(CF₃)₂ | |
| 3-1801 | 7-OCF₃ | C(CH₃)₂CH₂SCH₃ | H | H | CF(CF₃)₂ | |
| 3-1802 | 7-OCF₃ | C(CH₃)₂CH₂SOCH₃ | H | H | CF(CF₃)₂ | |
| 3-1803 | 7-OCF₃ | C(CH₃)₂CH₂SO₂CH₃ | H | H | CF(CF₃)₂ | |
| 3-1804 | 7-OCF₃ | CH(CH₃)CH₂SCH₃ | H | H | CF(CF₃)₂ | |
| 3-1805 | 7-OCF₃ | CH(CH₃)CH₂SOCH₃ | H | H | CF(CF₃)₂ | |
| 3-1806 | 7-OCF₃ | CH(CH₃)CH₂SO₂CH₃ | H | H | CF(CF₃)₂ | |
| 3-1807 | 7-OCF₃ | CH(CH₃)₂ | Cl | Cl | Cl | |
| 3-1808 | 7-OCF₃ | C(CH₃)₂CH₂SCH₃ | Cl | Cl | Cl | |
| 3-1809 | 7-OCF₃ | C(CH₃)₂CH₂SOCH₃ | Cl | Cl | Cl | |
| 3-1810 | 7-OCF₃ | C(CH₃)₂CH₂SO₂CH₃ | Cl | Cl | Cl | |
| 3-1811 | 7-OCF₃ | CH(CH₃)CH₂SCH₃ | Cl | Cl | Cl | |
| 3-1812 | 7-OCF₃ | CH(CH₃)CH₂SOCH₃ | Cl | Cl | Cl | |
| 3-1813 | 7-OCF₃ | CH(CH₃)CH₂SO₂CH₃ | Cl | Cl | Cl | |
| 3-1814 | 7-OCF₃ | CH(CH₃)₂ | CH₃ | H | OCF₃ | |
| 3-1815 | 7-OCF₃ | C(CH₃)₂CH₂SCH₃ | CH₃ | H | OCF₃ | |
| 3-1816 | 7-OCF₃ | C(CH₃)₂CH₂SOCH₃ | CH₃ | H | OCF₃ | |
| 3-1817 | 7-OCF₃ | C(CH₃)₂CH₂SO₂CH₃ | CH₃ | H | OCF₃ | |
| 3-1818 | 7-OCF₃ | CH(CH₃)CH₂SCH₃ | CH₃ | H | OCF₃ | |
| 3-1819 | 7-OCF₃ | CH(CH₃)CH₂SOCH₃ | CH₃ | H | OCF₃ | |
| 3-1820 | 7-OCF₃ | CH(CH₃)CH₂SO₂CH₃ | CH₃ | H | OCF₃ | |
| 3-1821 | 7-OCF₃ | CH(CH₃)₂ | Cl | H | Cl | |
| 3-1822 | 7-OCF₃ | C(CH₃)₂CH₂SCH₃ | Cl | H | Cl | |
| 3-1823 | 7-OCF₃ | C(CH₃)₂CH₂SOCH₃ | Cl | H | Cl | |
| 3-1824 | 7-OCF₃ | C(CH₃)₂CH₂SO₂CH₃ | Cl | H | Cl | |
| 3-1825 | 7-OCF₃ | CH(CH₃)CH₂SCH₃ | Cl | H | Cl | |
| 3-1826 | 7-OCF₃ | CH(CH₃)CH₂SOCH₃ | Cl | H | Cl | |
| 3-1827 | 7-OCF₃ | CH(CH₃)CH₂SO₂CH₃ | Cl | H | Cl | |
| 3-1828 | 7-OCF₃ | CH(CH₃)₂ | H | Cl | Cl | |
| 3-1829 | 7-OCF₃ | C(CH₃)₂CH₂SCH₃ | H | Cl | Cl | |
| 3-1830 | 7-OCF₃ | C(CH₃)₂CH₂SOCH₃ | H | Cl | Cl | |
| 3-1831 | 7-OCF₃ | C(CH₃)₂CH₂SO₂CH₃ | H | Cl | Cl | |
| 3-1832 | 7-OCF₃ | CH(CH₃)CH₂SCH₃ | H | Cl | Cl | |
| 3-1833 | 7-OCF₃ | CH(CH₃)CH₂SOCH₃ | H | Cl | Cl | |
| 3-1834 | 7-OCF₃ | CH(CH₃)CH₂SO₂CH₃ | H | Cl | Cl | |
| 3-1835 | 7-OCF₃ | CH(CH₃)₂ | Cl | Cl | H | |
| 3-1836 | 7-OCF₃ | C(CH₃)₂CH₂SCH₃ | Cl | Cl | H | |
| 3-1837 | 7-OCF₃ | C(CH₃)₂CH₂SOCH₃ | Cl | Cl | H | |
| 3-1838 | 7-OCF₃ | C(CH₃)₂CH₂SO₂CH₃ | Cl | Cl | H | |
| 3-1839 | 7-OCF₃ | CH(CH₃)CH₂SCH₃ | Cl | Cl | H | |
| 3-1840 | 7-OCF₃ | CH(CH₃)CH₂SOCH₃ | Cl | Cl | H | |
| 3-1841 | 7-OCF₃ | CH(CH₃)CH₂SO₂CH₃ | Cl | Cl | H | |
| 3-1842 | 7-OCF₃ | CH(CH₃)₂ | Cl | H | CF₃ | |
| 3-1843 | 7-OCF₃ | C(CH₃)₂CH₂SCH₃ | Cl | H | CF₃ | |
| 3-1844 | 7-OCF₃ | C(CH₃)₂CH₂SOCH₃ | Cl | H | CF₃ | |
| 3-1845 | 7-OCF₃ | C(CH₃)₂CH₂SO₂CH₃ | Cl | H | CF₃ | |
| 3-1846 | 7-OCF₃ | CH(CH₃)CH₂SCH₃ | Cl | H | CF₃ | |
| 3-1847 | 7-OCF₃ | CH(CH₃)CH₂SOCH₃ | Cl | H | CF₃ | |
| 3-1848 | 7-OCF₃ | CH(CH₃)CH₂SO₂CH₃ | Cl | H | CF₃ | |
| 3-1849 | 7-OCF₃ | CH(CH₃)₂ | Cl | H | CF₃ | |
| 3-1850 | 7-OCF₃ | C(CH₃)₂CH₂SCH₃ | Cl | H | CF₃ | |
| 3-1851 | 7-OCF₃ | C(CH₃)₂CH₂SOCH₃ | Cl | H | CF₃ | |
| 3-1852 | 7-OCF₃ | C(CH₃)₂CH₂SO₂CH₃ | Cl | H | CF₃ | |
| 3-1853 | 7-OCF₃ | CH(CH₃)CH₂SCH₃ | Cl | H | CF₃ | |
| 3-1854 | 7-OCF₃ | CH(CH₃)CH₂SOCH₃ | Cl | H | CF₃ | |
| 3-1855 | 7-OCF₃ | CH(CH₃)CH₂SO₂CH₃ | Cl | H | CF₃ | |
| 3-1856 | 7-OCF₃ | CH(CH₃)₂ | H | H | Cl | |
| 3-1857 | 7-OCF₃ | C(CH₃)₂CH₂SCH₃ | H | H | Cl | |
| 3-1858 | 7-OCF₃ | C(CH₃)₂CH₂SOCH₃ | H | H | Cl | |
| 3-1859 | 7-OCF₃ | C(CH₃)₂CH₂SO₂CH₃ | H | H | Cl | |
| 3-1860 | 7-OCF₃ | CH(CH₃)CH₂SCH₃ | H | H | Cl | |
| 3-1861 | 7-OCF₃ | CH(CH₃)CH₂SOCH₃ | H | H | Cl | |
| 3-1862 | 7-OCF₃ | CH(CH₃)CH₂SO₂CH₃ | H | H | Cl | |
| 3-1863 | 7-OCF₃ | CH(CH₃)₂ | CH₃ | H | Cl | |
| 3-1864 | 7-OCF₃ | C(CH₃)₂CH₂SCH₃ | CH₃ | H | Cl | |
| 3-1865 | 7-OCF₃ | C(CH₃)₂CH₂SOCH₃ | CH₃ | H | Cl | |
| 3-1866 | 7-OCF₃ | C(CH₃)₂CH₂SO₂CH₃ | CH₃ | H | Cl | |
| 3-1867 | 7-OCF₃ | CH(CH₃)CH₂SCH₃ | CH₃ | H | Cl | |
| 3-1868 | 7-OCF₃ | CH(CH₃)CH₂SOCH₃ | CH₃ | H | Cl | |
| 3-1869 | 7-OCF₃ | CH(CH₃)CH₂SO₂CH₃ | CH₃ | H | Cl | |
| 3-1870 | 7-OCF₃ | CH(CH₃)₂ | H | H | OCF₃ | |
| 3-1871 | 7-OCF₃ | C(CH₃)₂CH₂SCH₃ | H | H | OCF₃ | |
| 3-1872 | 7-OCF₃ | C(CH₃)₂CH₂SOCH₃ | H | H | OCF₃ | |
| 3-1873 | 7-OCF₃ | C(CH₃)₂CH₂SO₂CH₃ | H | H | OCF₃ | |
| 3-1874 | 7-OCF₃ | CH(CH₃)CH₂SCH₃ | H | H | OCF₃ | |
| 3-1875 | 7-OCF₃ | CH(CH₃)CH₂SOCH₃ | H | H | OCF₃ | |
| 3-1876 | 7-OCF₃ | CH(CH₃)CH₂SO₂CH₃ | H | H | OCF₃ | |
| 3-1877 | 7-OCF₃ | CH(CH₃)₂ | H | H | CF₃ | |
| 3-1878 | 7-OCF₃ | C(CH₃)₂CH₂SCH₃ | H | H | CF₃ | |
| 3-1879 | 7-OCF₃ | C(CH₃)₂CH₂SOCH₃ | H | H | CF₃ | |
| 3-1880 | 7-OCF₃ | C(CH₃)₂CH₂SO₂CH₃ | H | H | CF₃ | |
| 3-1881 | 7-OCF₃ | CH(CH₃)CH₂SCH₃ | H | H | CF₃ | |
| 3-1882 | 7-OCF₃ | CH(CH₃)CH₂SOCH₃ | H | H | CF₃ | |
| 3-1883 | 7-OCF₃ | CH(CH₃)CH₂SO₂CH₃ | H | H | CF₃ | |
| 3-1884 | 7-OCF₃ | CH(CH₃)₂ | H | H | Ph-4-CF₃ | |
| 3-1885 | 7-OCF₃ | C(CH₃)₂CH₂SCH₃ | H | H | Ph-4-CF₃ | |
| 3-1886 | 7-OCF₃ | C(CH₃)₂CH₂SOCH₃ | H | H | Ph-4-CF₃ | |
| 3-1887 | 7-OCF₃ | C(CH₃)₂CH₂SO₂CH₃ | H | H | Ph-4-CF₃ | |
| 3-1888 | 7-OCF₃ | CH(CH₃)CH₂SCH₃ | H | H | Ph-4-CF₃ | |
| 3-1889 | 7-GCF₃ | CH(CH₃)CH₂SOCH₃ | H | H | Ph-4-CF₃ | |
| 3-1890 | 7-OCF₃ | CH(CH₃)CH₂SO₂CH₃ | H | H | Ph-4-CF₃ | |
| 3-1891 | 7-OCF₃ | CH(CH₃)₂ | F | F | CF₃ | |
| 3-1892 | 7-OCF₃ | C(CH₃)₂CH₂SCH₃ | F | F | | |
| 3-1893 | 7-OCF₃ | C(CH₃)₂CH₂SOCH₃ | F | F | CF₃ | |
| 3-1894 | 7-OCF₃ | C(CH₃)₂CH₂SO₂CH₃ | F | F | CF₃ | |
| 3-1895 | 7-OCF₃ | CH(CH₃)CH₂SCH₃ | F | F | CF₃ | |
| 3-1896 | 7-OCF₃ | CH(CH₃)CH₂SOCH₃ | F | F | CF₃ | |
| 3-1897 | 7-OCF₃ | CH(CH₃)CH₂SO₂CH₃ | F | F | CF₃ | |
| 3-1898 | 7-OCF₃ | CH(CH₃)₂ | CH₃ | H | COH(CF₃)₂ | |
| 3-1899 | 7-OCF₃ | C(CH₃)₂CH₂SCH₃ | CH₃ | H | COH(CF₃)₂ | |
| 3-1900 | 7-OCF₃ | C(CH₃)₂CH₂SO₂CH₃ | CH₃ | H | COH(CF₃)₂ | |
| 3-1901 | 7-OCF₃ | C(CH₃)₂CH₂SO₂CH₃ | CH₃ | H | COH(CF₃)₂ | |
| 3-1902 | 7-OCF₃ | CH(CH₃)CH₂SCH₃ | CH₃ | H | COH(CF₃)₂ | |
| 3-1903 | 7-OCF₃ | CH(CH₃)CH₂SOCH₃ | CH₃ | H | COH(CF₃)₂ | |
| 3-1904 | 7-OCF₃ | CH(CH₃)CH₂SO₂CH₃ | CH₃ | H | COH(CF₃)₂ | |
| 3-1905 | 4-OCH₃ | CH(CH₃)₂ | CH₃ | H | CF(CF₃)₂ | |
| 3-1906 | 4-OCH₃ | C(CH₃) CH₂SCH₃ | CH₃ | H | CF(CF₃)₂ | |
| 3-1907 | 4-OCH₃ | C(CH₃)₂CH₂SOCH₃ | CH₃ | H | CF(CF₃)₂ | |
| 3-1908 | 4-OCH₃ | C(CH₃)₂CH₂SO₂CH₃ | CH₃ | H | CF(CF₃)₂ | |
| 3-1909 | 4-OCH₃ | CH(CH₃)CH₂SCH₃ | CH₃ | H | CF(CF₃)₂ | |
| 3-1910 | 4-OCH₃ | CH(CH₃)CH₂SOCH₃ | CH₃ | H | CF(CF₃)₂ | |
| 3-1911 | 4-OCH₃ | CH(CH₃)CH₂SO₂CH₃ | CH₃ | H | CF(CF₃)₂ | |
| 3-1912 | 4-OCH₃ | CH(CH₃)₂ | H | H | CF(CF₃)₂ | |
| 3-1913 | 4-OCH₃ | C(CH₃)₂CH₂SCH₃ | H | H | CF(CF₃)₂ | |
| 3-1914 | 4-OCH₃ | C(CH₃)₂CH₂SOCH₃ | H | H | CF(CF₃)₂ | |
| 3-1915 | 4-OCH₃ | C(CH₃)₂CH₂SO₂CH₃ | H | H | CF(CF₃)₂ | |
| 3-1916 | 4-OCH₃ | CH(CH₃)CH₂SCH₃ | H | H | CF(CF₃)₂ | |
| 3-1917 | 4-OCH₃ | CH(CH₃)CH₂SOCH₃ | H | H | CF(CF₃)₂ | |
| 3-1918 | 4-OCH₃ | CH(CH₃)CH₂SO₂CH₃ | H | H | CF(CF₃)₂ | |
| 3-1919 | 4-OCH₃ | CH(CH₃)₂ | Cl | Cl | Cl | |
| 3-1920 | 4-OCH₃ | C(CH₃)₂CH₂SCH₃ | Cl | Cl | Cl | |
| 3-1921 | 4-OCH₃ | C(CH₃)₂CH₂SOCH₃ | Cl | Cl | Cl | |
| 3-1922 | 4-OCH₃ | C(CH₃)₂CH₂SO₂CH₃ | Cl | Cl | Cl | |
| 3-1923 | 4-OCH₃ | CH(CH₃)CH₂SCH₃ | Cl | Cl | Cl | |
| 3-1924 | 4-OCH₃ | CH(CH₃)CH₂SOCH₃ | Cl | Cl | Cl | |
| 3-1925 | 4-OCH₃ | CH(CH₃)CH₂SO₂CH₃ | Cl | Cl | Cl | |
| 3-1926 | 4-OCH₃ | CH(CH₃)₂ | CH₃ | H | OCF₃ | |
| 3-1927 | 4-OCH₃ | C(CH₃)₂CH₂SCH₃ | CH₃ | H | OCF₃ | |
| 3-1928 | 4-OCH₃ | C(CH₃)₂CH₂SOCH₃ | CH₃ | H | OCF₃ | |
| 3-1929 | 4-OCH₃ | C(CH₃)₂CH₂SO₂CH₃ | CH₃ | H | OCF₃ | |
| 3-1930 | 4-OCH₃ | CH(CH₃)CH₂SCH₃ | CH₃ | H | OCF₃ | |
| 3-1931 | 4-OCH₃ | CH(CH₃)CH₂SOCH₃ | CH₃ | H | OCF₃ | |
| 3-1932 | 4-OCH₃ | CH(CH₃)CH₂SO₂CH₃ | CH₃ | H | OCF₃ | |
| 3-1933 | 4-OCH₃ | CH(CH₃)₂ | Cl | H | Cl | |
| 3-1934 | 4-OCH₃ | C(CH₃)₂CH₂SCH₃ | Cl | H | Cl | |
| 3-1935 | 4-OCH₃ | C(CH₃)₂CH₂SOCH₃ | Cl | H | Cl | |
| 3-1936 | 4-OCH₃ | C(CH₃)₂CH₂SO₂CH₃ | Cl | H | Cl | |
| 3-1937 | 4-OCH₃ | CH(CH₃)CH₂SCH₃ | Cl | H | Cl | |
| 3-1938 | 4-OCH₃ | CH(CH₃)CH₂SOCH₃ | Cl | H | Cl | |
| 3-1939 | 4-OCH₃ | CH(CH₃)CH₂SO₂CH₃ | Cl | H | Cl | |
| 3-1940 | 4-OCH₃ | CH(CH₃)₂ | H | Cl | Cl | |
| 3-1941 | 4-OCH₃ | C(CH₃)₂CH₂SCH₃ | H | Cl | Cl | |
| 3-1942 | 4-OCH₃ | C(CH₃)₂CH₂SOCH₃ | H | Cl | Cl | |
| 3-1943 | 4-OCH₃ | C(CH₃)₂CH₂SO₂CH₃ | H | Cl | Cl | |
| 3-1944 | 4-OCH₃ | CH(CH₃)CH₂SCH₃ | H | Cl | Cl | |
| 3-1945 | 4-OCH₃ | CH(CH₃)CH₂SOCH₃ | H | Cl | Cl | |
| 3-1946 | 4-OCH₃ | CH(CH₃)CH₂SO₂CH₃ | H | Cl | Cl | |
| 3-1947 | 4-OCH₃ | CH(CH₃)₂ | Cl | Cl | H | |
| 3-1948 | 4-OCH₃ | C(CH₃)₂CH₂SCH₃ | Cl | Cl | H | |
| 3-1949 | 4-OCH₃ | C(CH₃)₂CH₂SOCH₃ | Cl | Cl | H | |
| 3-1950 | 4-OCH₃ | C(CH₃)₂CH₂SO₂CH₃ | Cl | Cl | H | |
| 3-1951 | 4-OCH₃ | CH(CH₃)CH₂SCH₃ | Cl | Cl | H | |
| 3-1952 | 4-OCH₃ | CH(CH₃)CH₂SOCH₃ | Cl | Cl | H | |
| 3-1953 | 4-OCH₃ | CH(CH₃)CH₂SO₂CH₃ | Cl | Cl | H | |
| 3-1954 | 4-OCH₃ | CH(CH₃)₂ | Cl | H | CF₃ | |
| 3-1955 | 4-OCH₃ | C(CH₃)₂CH₂SCH₃ | Cl | H | CF₃ | |
| 3-1956 | 4-OCH₃ | C(CH₃)₂CH₂SOCH₃ | Cl | H | CF₃ | |
| 3-1957 | 4-OCH₃ | C(CH₃)₂CH₂SO₂CH₃ | Cl | H | CF₃ | |
| 3-1958 | 4-OCH₃ | CH(CH₃)CH₂SCH₃ | Cl | H | CF₃ | |
| 3-1959 | 4-OCH₃ | CH(CH₃)CH₂SOCH₃ | Cl | H | CF₃ | |
| 3-1960 | 4-OCH₃ | CH(CH₃)CH₂SO₂CH₃ | Cl | H | CF₃ | |
| 3-1961 | 4-OCH₃ | CH(CH₃)₂ | Cl | H | CF₃ | |
| 3-1962 | 4-OCH₃ | C(CH₃)₂CH₂SCH₃ | Cl | H | CF₃ | |
| 3-1963 | 4-OCH₃ | C(CH₃)₂CH₂SOCH₃ | Cl | H | CF₃ | |
| 3-1964 | 4-OCH₃ | C(CH₃)₂CH₂SO₂CH₃ | Cl | H | CF₃ | |
| 3-1965 | 4-OCH₃ | CH(CH₃)CH₂SCH₃ | Cl | H | CF₃ | |
| 3-1966 | 4-OCH₃ | CH(CH₃)CH₂SOCH₃ | Cl | H | CF₃ | |
| 3-1967 | 4-OCH₃ | CH(CH₃)CH₂SO₂CH₃ | Cl | H | CF₃ | |
| 3-1968 | 4-OCH₃ | CH(CH₃)₂ | H | H | Cl | |
| 3-1969 | 4-OCH₃ | C(CH₃)₂CH₂SCH₃ | H | H | Cl | |
| 3-1970 | 4-OCH₃ | C(CH₃)₂CH₂SOCH₃ | H | H | Cl | |
| 3-1971 | 4-OCH₃ | C(CH₃)₂CH₂SO₂CH₃ | H | H | Cl | |
| 3-1972 | 4-OCH₃ | CH(CH₃)CH₂SCH₃ | H | H | Cl | |
| 3-1973 | 4-OCH₃ | CH(CH₃)CH₂SOCH₃ | H | H | Cl | |
| 3-1974 | 4-OCH₃ | CH(CH₃)CH₂SO₂CH₃ | H | H | Cl | |
| 3-1975 | 4-OCH₃ | CH(CH₃)₂ | CH₃ | H | Cl | |
| 3-1976 | 4-OCH₃ | C(CH₃)₂CH₂SCH₃ | CH₃ | H | Cl | |
| 3-1977 | 4-OCH₃ | C(CH₃)₂CH₂SOCH₃ | CH₃ | H | Cl | |
| 3-1978 | 4-OCH₃ | C(CH₃)₂CH₂SO₂CH₃ | CH₃ | H | Cl | |
| 3-1979 | 4-OCH₃ | CH(CH₃)CH₂SCH₃ | CH₃ | H | Cl | |
| 3-1980 | 4-OCH₃ | CH(CH₃)CH₂SOCH₃ | CH₃ | H | Cl | |
| 3-1981 | 4-OCH₃ | CH(CH₃)CH₂SO₂CH₃ | CH₃ | H | Cl | |
| 3-1982 | 4-OCH₃ | CH(CH₃)₂ | H | H | OCF₃ | |
| 3-1983 | 4-OCH₃ | C(CH₃)₂CH₂SCH₃ | H | H | OCF₃ | |
| 3-1984 | 4-OCH₃ | C(CH₃)₂CH₂SOCH₃ | H | H | OCF₃ | |
| 3-1985 | 4-OCH₃ | C(CH₃)₂CH₂SO₂CH₃ | H | H | OCF₃ | |
| 3-1986 | 4-OCH₃ | CH(CH₃)CH₂SCH₃ | H | H | OCF₃ | |
| 3-1987 | 4-OCH₃ | CH(CH₃)CH₂SOCH₃ | H | H | OCF₃ | |
| 3-1988 | 4-OCH₃ | CH(CH₃)CH₂SO₂CH₃ | H | H | OCF₃ | |
| 3-1989 | 4-OCH₃ | CH(CH₃)₂ | H | H | CF₃ | |
| 3-1990 | 4-OCH₃ | C(CH₃)₂CH₂SCH₃ | H | H | CF₃ | |
| 3-1991 | 4-OCH₃ | C(CH₃)₂CH₂SOCH₃ | H | H | CF₃ | |
| 3-1992 | 4-OCH₃ | C(CH₃)₂CH₂SO₂CH₃ | H | H | CF₃ | |
| 3-1993 | 4-OCH₃ | CH(CH₃)CH₂SCH₃ | H | H | CF₃ | |
| 3-1994 | 4-OCH₃ | CH(CH₃)CH₂SOCH₃ | H | H | CF₃ | |
| 3-1995 | 4-OCH₃ | CH(CH₃)CH₂SO₂CH₃ | H | H | CF₃ | |
| 3-1996 | 4-OCH₃ | CH(CH₃)₂ | H | H | Ph-4-CF₃ | |
| 3-1997 | 4-OCH₃ | C(CH₃)₂CH₂SCH₃ | H | H | Ph-4-CF₃ | |
| 3-1998 | 4-OCH₃ | C(CH₃)₂CH₂SOCH₃ | H | H | Ph-4-CF₃ | |
| 3-1999 | 4-OCH₃ | C(CH₃)₂CH₂SO₂CH₃ | H | H | Ph-4-CF₃ | |
| 3-2000 | 4-OCH₃ | CH(CH₃)CH₂SCH₃ | H | H | Ph-4-CF₃ | |
| 3-2001 | 4-OCH₃ | CH(CH₃)CH₂SOCH₃ | H | H | Ph-4-CF₃ | |
| 3-2002 | 4-OCH₃ | CH(CH₃)CH₂SO₂CH₃ | H | H | Ph-4-CF₃ | |
| 3-2003 | 4-OCH₃ | CH(CH₃)₂ | F | F | CF₃ | |
| 3-2004 | 4-OCH₃ | C(CH₃)₂CH₂SCH₃ | F | F | CF₃ | |
| 3-2005 | 4-OCH₃ | C(CH₃)₂CH₂SOCH₃ | F | F | CF₃ | |
| 3-2006 | 4-OCH₃ | C(CH₃)₂CH₂SO₂CH₃ | F | F | CF₃ | |
| 3-2007 | 4-OCH₃ | CH(CH₃)CH₂SCH₃ | F | F | CF₃ | |
| 3-2008 | 4-OCH₃ | CH(CH₃)CH₂SOCH₃ | F | F | CF₃ | |
| 3-2009 | 4-OCH₃ | CH(CH₃)CH₂SO₂CH₃ | F | F | CF₃ | |
| 3-2010 | 4-OCH₃ | CH(CH₃)₂ | CH₃ | H | COH(CF₃)₂ | |
| 3-2011 | 4-OCH₃ | C(CH₃)₂CH₂SCH₃ | CH₃ | H | COH(CF₃)₂ | |
| 3-2012 | 4-OCH₃ | C(CH₃)₂CH₂SOCH₃ | CH₃ | H | COH(CF₃)₂ | |
| 3-2013 | 4-OCH₃ | C(CH₃)₂CH₂SO₂CH₃ | CH₃ | H | COH(CF₃)₂ | |
| 3-2014 | 4-OCH₃ | CH(CH₃)CH₂SCH₃ | CH₃ | H | COH(CF₃)₂ | |
| 3-2015 | 4-OCH₃ | CH(CH₃)CH₂SOCH₃ | CH₃ | H | COH(CF₃)₂ | |
| 3-2016 | 4-OCH₃ | CH(CH₃)CH₂SO₂CH₃ | CH₃ | H | COH(CF₃)₂ | |
| 3-2017 | 7-OCH₃ | CH(CH₃)₂ | CH₃ | H | CF(CF₃)₂ | |
| 3-2018 | 7-OCH₃ | C(CH₃)₂CH₂SCH₃ | CH₃ | H | CF(CF₃)₂ | |
| 3-2019 | 7-OCH₃ | C(CH₃)₂CH₂SOCH₃ | CH₃ | H | CF(CF₃)₂ | |
| 3-2020 | 7-OCH₃ | C(CH₃)₂CH₂SO₂CH₃ | CH₃ | H | CF(CF₃)₂ | |
| 3-2021 | 7-OCH₃ | CH(CH₃)CH₂SCH₃ | CH₃ | H | CF(CF₃)₂ | |
| 3-2022 | 7-OCH₃ | CH(CH₃)CH₂SOCH₃ | CH₃ | H | CF(CF₃)₂ | |
| 3-2023 | 7-OCH₃ | CH(CH₃)CH₂SO₂CH₃ | CH₃ | H | CF(CF₃)₂ | |
| 3-2024 | 7-OCH₃ | CH(CH₃)₂ | H | H | CF(CF₃)₂ | |
| 3-2025 | 7-OCH₃ | C(CH₃)₂CH₂SCH₃ | H | H | CF(CF₃)₂ | |
| 3-2026 | 7-OCH₃ | C(CH₃)₂CH₂SOCH₃ | H | H | CF(CF₃)₂ | |
| 3-2027 | 7-OCH₃ | C(CH₃)₂CH₂SO₂CH₃ | H | H | CF(CF₃)₂ | |
| 3-2028 | 7-OCH₃ | CH(CH₃)CH₂SCH₃ | H | H | CF(CF₃)₂ | |
| 3-2029 | 7-OCH₃ | CH(CH₃)CH₂SOCH₃ | H | H | CF(CF₃)₂ | |
| 3-2030 | 7-OCH₃ | CH(CH₃)CH₂SO₂CH₃ | H | H | CF(CF₃)₂ | |
| 3-2031 | 7-OCH₃ | CH(CH₃)₂ | Cl | Cl | Cl | |
| 3-2032 | 7-OCH₃ | C(CH₃)₂CH₂SCH₃ | Cl | Cl | Cl | |
| 3-2033 | 7-OCH₃ | C(CH₃)₂CH₂SOCH₃ | Cl | Cl | Cl | |
| 3-2034 | 7-OCH₃ | C(CH₃)₂CH₂SO₂CH₃ | Cl | Cl | Cl | |
| 3-2035 | 7-OCH₃ | CH(CH₃)CH₂SCH₃ | Cl | Cl | Cl | |
| 3-2036 | 7-OCH₃ | CH(CH₃)CH₂SOCH₃ | Cl | Cl | Cl | |
| 3-2037 | 7-OCH₃ | CH(CH₃)CH₂SO₂CH₃ | Cl | Cl | Cl | |
| 3-2038 | 7-OCH₃ | CH(CH₃)₂ | CH₃ | H | OCF₃ | |
| 3-2039 | 7-OCH₃ | C(CH₃)₂CH₂SCH₃ | CH₃ | H | OCF₃ | |
| 3-2040 | 7-OCH₃ | C(CH₃)₂CH₂SOCH₃ | CH₃ | H | OCF₃ | |
| 3-2041 | 7-OCH₃ | C(CH₃)₂CH₂SO₂CH₃ | CH₃ | H | OCF₃ | |
| 3-2042 | 7-OCH₃ | CH(CH₃)CH₂SCH₃ | CH₃ | H | OCF₃ | |
| 3-2043 | 7-OCH₃ | CH(CH₃)CH₂SOCH₃ | CH₃ | H | OCF₃ | |
| 3-2044 | 7-OCH₃ | CH(CH₃)CH₂SO₂CH₃ | CH₃ | H | OCF₃ | |
| 3-2045 | 7-OCH₃ | CH(CH₃)₂ | Cl | H | Cl | |
| 3-2046 | 7-OCH₃ | C(CH₃)₂CH₂SCH₃ | Cl | H | Cl | |
| 3-2047 | 7-OCH₃ | C(CH₃)₂CH₂SOCH₃ | Cl | H | Cl | |
| 3-2048 | 7-OCH₃ | C(CH₃)₂CH₂SO₂CH₃ | Cl | H | Cl | |
| 3-2049 | 7-OCH₃ | CH(CH₃)CH₂SCH₃ | Cl | H | Cl | |
| 3-2050 | 7-OCH₃ | CH(CH₃)CH₂SOCH₃ | Cl | H | Cl | |
| 3-2051 | 7-OCH₃ | CH(CH₃)CH₂SO₂CH₃ | Cl | H | Cl | |
| 3-2052 | 7-OCH₃ | CH(CH₃)₂ | H | Cl | Cl | |
| 3-2053 | 7-OCH₃ | C(CH₃)₂CH₂SCH₃ | H | Cl | Cl | |
| 3-2054 | 7-OCH₃ | C(CH₃)₂CH₂SOCH₃ | H | Cl | Cl | |
| 3-2055 | 7-OCH₃ | C(CH₃)₂CH₂SO₂CH₃ | H | Cl | Cl | |
| 3-2056 | 7-OCH₃ | CH(CH₃)CH₂SCH₃ | H | Cl | Cl | |
| 3-2057 | 7-OCH₃ | CH(CH₃)CH₂SOCH₃ | H | Cl | Cl | |
| 3-2058 | 7-OCH₃ | CH(CH₃)CH₂SO₂CH₃ | H | Cl | Cl | |
| 3-2059 | 7-OCH₃ | CH(CH₃)₂ | Cl | Cl | H | |
| 3-2060 | 7-OCH₃ | C(CH₃)₂CH₂SCH₃ | Cl | Cl | H | |
| 3-2061 | 7-OCH₃ | C(CH₃)₂CH₂SOCH₃ | Cl | Cl | H | |
| 3-2062 | 7-OCH₃ | C(CH₃)₂CH₂SO₂CH₃ | Cl | Cl | H | |
| 3-2063 | 7-OCH₃ | CH(CH₃)CH₂SCH₃ | Cl | Cl | H | |
| 3-2064 | 7-OCH₃ | CH(CH₃)CH₂SOCH₃ | Cl | Cl | H | |
| 3-2065 | 7-OCH₃ | CH(CH₃)CH₂SO₂CH₃ | Cl | Cl | H | |
| 3-2066 | 7-OCH₃ | CH(CH₃)₂ | Cl | H | CF₃ | |
| 3-2067 | 7-OCH₃ | C(CH₃)₂CH₂SCH₃ | Cl | H | CF₃ | |
| 3-2068 | 7-OCH₃ | C(CH₃)₂CH₂SOCH₃ | Cl | H | CF₃ | |
| 3-2069 | 7-OCH₃ | C(CH₃)₂CH₂SO₂CH₃ | Cl | H | CF₃ | |
| 3-2070 | 7-OCH₃ | CH(CH₃)CH₂SCH₃ | Cl | H | CF₃ | |
| 3-2071 | 7-OCH₃ | CH(CH₃)CH₂SOCH₃ | Cl | H | CF₃ | |
| 3-2072 | 7-OCH₃ | CH(CH₃)CH₂SO₂CH₃ | Cl | H | CF₃ | |
| 3-2073 | 7-OCH₃ | CH(CH₃)₂ | Cl | H | CF₃ | |
| 3-2074 | 7-OCH₃ | C(CH₃)₂CH₂SCH₃ | Cl | H | CF₃ | |
| 3-2075 | 7-OCH₃ | C(CH₃)₂CH₂SOCH₃ | Cl | H | CF₃ | |
| 3-2076 | 7-OCH₃ | C(CH₃)₂CH₂SO₂CH₃ | Cl | H | CF₃ | |
| 3-2077 | 7-OCH₃ | CH(CH₃)CH₂SCH₃ | Cl | H | CF₃ | |
| 3-2078 | 7-OCH₃ | CH(CH₃)CH₂SOCH₃ | Cl | H | CF₃ | |
| 3-2079 | 7-OCH₃ | CH(CH₃)CH₂SO₂CH₃ | Cl | H | CF₃ | |
| 3-2080 | 7-OCH₃ | CH(CH₃)₂ | H | H | Cl | |
| 3-2081 | 7-OCH₃ | C(CH₃)₂CH₂SCH₃ | H | H | Cl | |
| 3-2082 | 7-OCH₃ | C(CH₃)₂CH₂SOCH₃ | H | H | Cl | |
| 3-2083 | 7-OCH₃ | C(CH₃)₂CH₂SO₂CH₃ | H | H | Cl | |
| 3-2084 | 7-OCH₃ | CH(CH₃)CH₂SCH₃ | H | H | Cl | |
| 3-2085 | 7-OCH₃ | CH(CH₃)CH₂SOCH₃ | H | H | Cl | |
| 3-2086 | 7-OCH₃ | CH(CH₃)CH₂SO₂CH₃ | H | H | Cl | |
| 3-2087 | 7-OCH₃ | CH(CH₃)₂ | CH₃ | H | Cl | |
| 3-2088 | 7-OCH₃ | C(CH₃)₂CH₂SCH₃ | CH₃ | H | Cl | |
| 3-2089 | 7-OCH₃ | C(CH₃)₂CH₂SOCH₃ | CH₃ | H | Cl | |
| 3-2090 | 7-OCH₃ | C(CH₃)₂CH₂SO₂CH₃ | CH₃ | H | Cl | |
| 3-2091 | 7-OCH₃ | CH(CH₃)CH₂SCH₃ | CH₃ | H | Cl | |
| 3-2092 | 7-OCH₃ | CH(CH₃)CH₂SOCH₃ | CH₃ | H | Cl | |
| 3-2093 | 7-OCH₃ | CH(CH₃)CH₂SO₂CH₃ | CH₃ | H | Cl | |
| 3-2094 | 7-OCH₃ | CH(CH₃)₂ | H | H | OCF₃ | |
| 3-2095 | 7-OCH₃ | C(CH₃)₂CH₂SCH₃ | H | H | OCF₃ | |
| 3-2096 | 7-OCH₃ | C(CH₃)₂CH₂SOCH₃ | H | H | OCF₃ | |
| 3-2097 | 7-OCH₃ | C(CH₃)₂CH₂SO₂CH₃ | H | H | OCFs | |
| 3-2098 | 7-OCH₃ | CH(CH₃)CH₂SCH₃ | H | H | OCF₃ | |
| 3-2099 | 7-OCH₃ | CH(CH₃)CH₂SOCH₃ | H | H | OCF₃ | |
| 3-2100 | 7-OCH₃ | CH(CH₃)CH₂SO₂CH₃ | H | H | OCF₃ | |
| 3-2101 | 7-OCH₃ | CH(CH₃)₂ | H | H | CF₃ | |
| 3-2102 | 7-OCH₃ | C(CH₃)₂CH₂SCH₃ | H | H | CF₃ | |
| 3-2103 | 7-OCH₃ | C(CH₃)₂CH₂SOCH₃ | H | H | CF₃ | |
| 3-2104 | 7-OCH₃ | C(CH₃)₂CH₂SO₂CH₃ | H | H | CF₃ | |
| 3-2105 | 7-OCH₃ | CH(CH₃)CH₂SCH₃ | H | H | CF₃ | |
| 3-2106 | 7-OCH₃ | CH(CH₃)CH₂SOCH₃ | H | H | CF₃ | |
| 3-2107 | 7-OCH₃ | CH(CH₃)CH₂SO₂CH₃ | H | H | CF₃ | |
| 3-2108 | 7-OCH₃ | CH(CH₃)₂ | H | H | Ph-4-CF₃ | |
| 3-2109 | 7-OCH₃ | C(CH₃)₂CH₂SCH₃ | H | H | Ph-4-CF₃ | |
| 3-2110 | 7-OCH₃ | C(CH₃)₂CH₂SOCH₃ | H | H | Ph-4-CF₃ | |
| 3-2111 | 7-OCH₃ | C(CH₃)₂CH₂SO₂CH₃ | H | H | Ph-4-CF₃ | |
| 3-2112 | 7-OCH₃ | CH(CH₃)CH₂SCH₃ | H | H | Ph-4-CF₃ | |
| 3-2113 | 7-OCH₃ | CH(CH₃)CH₂SOCH₃ | H | H | Ph-4-CF₃ | |
| 3-2114 | 7-OCH₃ | CH(CH₃)CH₂SO₂CH₃ | H | H | Ph-4-CF₃ | |
| 3-2115 | 7-OCH₃ | CH(CH₃)₂ | F | F | CF₃ | |
| 3-2116 | 7-OCH₃ | C(CH₃)₂CH₂SCH₃ | F | F | CF₃ | |
| 3-2117 | 7-OCH₃ | C(CH₃)₂CH₂SOCH₃ | F | F | CF₃ | |
| 3-2118 | 7-OCH₃ | C(CH₃)₂CH₂SO₂CH₃ | F | F | CF₃ | |
| 3-2119 | 7-OCH₃ | CH(CH₃)CH₂SCH₃ | F | F | CF₃ | |
| 3-2120 | 7-OCH₃ | CH(CH₃)CH₂SOCH₃ | F | F | CF₃ | |
| 3-2121 | 7-OCH₃ | CH(CH₃)CH₂SO₂CH₃ | F | F | CF₃ | |
| 3-2122 | 7-OCH₃ | CH(CH₃)₂ | CH₃ | H | COH(CF₃)₂ | |
| 3-2123 | 7-OCH₃ | C(CH₃)₂CH₂SCH₃ | CH₃ | H | COH(CF₃)₂ | |
| 3-2124 | 7-OCH₃ | C(CH₃)₂CH₂SOCH₃ | CH₃ | H | COH(CF₃)₂ | |
| 3-2125 | 7-OCH₃ | C(CH₃)₂CH₂SO₂CH₃ | CH₃ | H | COH(CF₃)₂ | |
| 3-2126 | 7-OCH₃ | CH(CH₃)CH₂SCH₃ | CH₃ | H | COH(CF₃)₂ | |
| 3-2127 | 7-OCH₃ | CH(CH₃)CH₂SOCH₃ | CH₃ | H | COH(CF₃)₂ | |
| 3-2128 | 7-OCH₃ | CH(CH₃)CH₂SO₂CH₃ | CH₃ | H | COH(CF₃)₂ | |
| 3-2129 | 4-SCH₃ | CH(CH₃)₂ | CH₃ | H | CF(CF₃)₂ | |
| 3-2130 | 4-SCH₃ | C(CH₃)₂CH₂SCH₃ | CH₃ | H | CF(CF₃)₂ | |
| 3-2131 | 4-SCH₃ | C(CH₃)₂CH₂SOCH₃ | CH₃ | H | CF(CF₃)₂ | |
| 3-2132 | 4-SCH₃ | C(CH₃)₂CH₂SO₂CH₃ | CH₃ | H | CF(CF₃)₂ | |
| 3-2133 | 4-SCH₃ | CH(CH₃)CH₂SCH₃ | CH₃ | H | CF(CF₃)₂ | |
| 3-2134 | 4-SCH₃ | CH(CH₃)CH₂SOCH₃ | CH₃ | H | CF(CF₃)₂ | |
| 3-2135 | 4-SCH₃ | CH(CH₃)CH₂SO₂CH₃ | CH₃ | H | CF(CF₃)₂ | |
| 3-2136 | 4-SCH₃ | CH(CH₃)₂ | H | H | CF(CF₃)₂ | |
| 3-2137 | 4-SCH₃ | C(CH₃)₂CH₂SCH₃ | H | H | CF(CF₃)₂ | |
| 3-2138 | 4-SCH₃ | C(CH₃)₂CH₂SOCH₃ | H | H | CF(CF₃)₂ | |
| 3-2139 | 4-SCH₃ | C(CH₃)₂CH₂SO₂CH₃ | H | H | CF(CF₃)₂ | |
| 3-2140 | 4-SCH₃ | CH(CH₃)CH₂SCH₃ | H | H | CF(CF₃)₂ | |
| 3-2141 | 4-SCH₃ | CH(CH₃)CH₂SOCH₃ | H | H | CF(CF₃)₂ | |
| 3-2142 | 4-SCH₃ | CH(CH₃)CH₂SO₂CH₃ | H | H | CF(CF₃)₂ | |
| 3-2143 | 4-SCH₃ | CH(CH₃)₂ | Cl | Cl | Cl | |
| 3-2144 | 4-SCH₃ | C(CH₃)₂CH₂SCH₃ | Cl | Cl | Cl | |
| 3-2145 | 4-SCH₃ | C(CH₃)₂CH₂SOCH₃ | Cl | Cl | Cl | |
| 3-2146 | 4-SCH₃ | C(CH₃)₂CH₂SO₂CH₃ | Cl | Cl | Cl | |
| 3-2147 | 4-SCH₃ | CH(CH₃)CH₂SCH₃ | Cl | Cl | Cl | |
| 3-2148 | 4-SCH₃ | CH(CH₃)CH₂SOCH₃ | Cl | Cl | Cl | |
| 3-2149 | 4-SCH₃ | CH(CH₃)CH₂SO₂CH₃ | Cl | Cl | Cl | |
| 3-2150 | 4-SCH₃ | CH(CH₃)₂ | CH₃ | H | OCF₃ | |
| 3-2151 | 4-SCH₃ | C(CH₃)₂CH₂SCH₃ | CH₃ | H | OCF₃ | |
| 3-2152 | 4-SCH₃ | C(CH₃)₂CH₂SOCH₃ | CH₃ | H | OCF₃ | |
| 3-2153 | 4-SCH₃ | C(CH₃)₂CH₂SO₂CH₃ | CH₃ | H | OCF₃ | |
| 3-2154 | 4-SCH₃ | CH(CH₃)CH₂SCH₃ | CH₃ | H | OCF₃ | |
| 3-2155 | 4-SCH₃ | CH(CH₃)CH₂SOCH₃ | CH₃ | H | OCF₃ | |
| 3-2156 | 4-SCH₃ | CH(CH₃)CH₂SO₂CH₃ | CH₃ | H | OCF₃ | |
| 3-2157 | 4-SCH₃ | CH(CH₃)₂ | Cl | H | Cl | |
| 3-2158 | 4-SCH₃ | C(CH₃)₂CH₂SCH₃ | Cl | H | Cl | |
| 3-2159 | 4-SCH₃ | C(CH₃)₂CH₂SOCH₃ | Cl | H | Cl | |
| 3-2160 | 4-SCH₃ | C(CH₃)₂CH₂SO₂CH₃ | Cl | H | Cl | |
| 3-2161 | 4-SCH₃ | CH(CH₃)CH₂SCH₃ | Cl | H | Cl | |
| 3-2162 | 4-SCH₃ | CH(CH₃)CH₂SOCH₃ | Cl | H | Cl | |
| 3-2163 | 4-SCH₃ | CH(CH₃)CH₂SO₂CH₃ | Cl | H | Cl | |
| 3-2164 | 4-SCH₃ | CH(CH₃)₂ | H | Cl | Cl | |
| 3-2165 | 4-SCH₃ | C(CH₃)₂CH₂SCH₃ | H | Cl | Cl | |
| 3-2166 | 4-SCH₃ | C(CH₃)₂CH₂SOCH₃ | H | Cl | Cl | |
| 3-2167 | 4-SCH₃ | C(CH₃)₂CH₂SO₂CH₃ | H | Cl | Cl | |
| 3-2168 | 4-SCH₃ | CH(CH₃)CH₂SCH₃ | H | Cl | Cl | |
| 3-2169 | 4-SCH₃ | CH(CH₃)CH₂SOCH₃ | H | Cl | Cl | |
| 3-2170 | 4-SCH₃ | CH(CH₃)CH₂SO₂CH₃ | H | Cl | Cl | |
| 3-2171 | 4-SCH₃ | CH(CH₃)₂ | Cl | Cl | H | |
| 3-2172 | 4-SCH₃ | C(CH₃)₂CH₂SCH₃ | Cl | Cl | H | |
| 3-2173 | 4-SCH₃ | C(CH₃)₂CH₂SOCH₃ | Cl | Cl | H | |
| 3-2174 | 4-SCH₃ | C(CH₃)₂CH₂SO₂CH₃ | Cl | Cl | H | |
| 3-2175 | 4-SCH₃ | CH(CH₃)CH₂SCH₃ | Cl | Cl | H | |
| 3-2176 | 4-SCH₃ | CH(CH₃)CH₂SOCH₃ | Cl | Cl | H | |
| 3-2177 | 4-SCH₃ | CH(CH₃)CH₂SO₂CH₃ | Cl | Cl | H | |
| 3-2178 | 4-SOCH₃ | CH(CH₃)₂ | Cl | H | CF₃ | |
| 3-2179 | 4-SCH₃ | C(CH₃)₂CH₂SCH₃ | Cl | H | CF₃ | |
| 3-2180 | 4-SCH₃ | C(CH₃)₂CH₂SOCH₃ | Cl | H | CF₃ | |
| 3-2181 | 4-SCH₃ | C(CH₃)₂CH₂SO₂CH₃ | Cl | H | CF₃ | |
| 3-2182 | 4-SCH₃ | CH(CH₃)CH₂SCH₃ | Cl | H | CF₃ | |
| 3-2183 | 4-SCH₃ | CH(CH₃)CH₂SOCH₃ | Cl | H | CF₃ | |
| 3-2184 | 4-SCH₃ | CH(CH₃)CH₂SO₂CH₃ | Cl | H | CF₃ | |
| 3-2185 | 4-SCH₃ | CH(CH₃)₂ | Cl | H | CF₃ | |
| 3-2186 | 4-SCH₃ | C(CH₃)₂CH₂SCH₃ | Cl | H | CF₃ | |
| 3-2187 | 4-SCH₃ | C(CH₃)₂CH₂SOCH₃ | Cl | H | CF₃ | |
| 3-2188 | 4-SCH₃ | C(CH₃)₂CH₂SO₂CH₃ | Cl | H | CF₃ | |
| 3-2189 | 4-SCH₃ | CH(CH₃)CH₂SCH₃ | Cl | H | CF₃ | |
| 3-2190 | 4-SCH₃ | CH(CH₃)CH₂SOCH₃ | Cl | H | CF₃ | |
| 3-2191 | 4-SCH₃ | CH(CH₃)CH₂SO₂CH₃Cl | H | CF₃ | | |
| 3-2192 | 4-SCH₃ | CH(CH₃)₂ | H | H | Cl | |
| 3-2193 | 4-SCH₃ | C(CH₃)₂CH₂SCH₃ | H | H | Cl | |
| 3-2194 | 4-SCH₃ | C(CH₃)₂CH₂SOCH₃ | H | H | Cl | |
| 3-2195 | 4-SCH₃ | C(CH₃)₂CH₂SO₂CH₃ | H | H | Cl | |
| 3-2196 | 4-SCH₃ | CH(CH₃)CH₂SCH₃ | H | H | Cl | |
| 3-2197 | 4-SCH₃ | CH(CH₃)CH₂SOCH₃ | H | H | Cl | |
| 3-2198 | 4-SCH₃ | CH(CH₃)CH₂SO₂CH₃ | H | H | Cl | |
| 3-2199 | 4-SCH₃ | CH(CH₃)₂ | CH₃ | H | Cl | |
| 3-2200 | 4-SCH₃ | C(CH₃)₂CH₂SCH₃ | CH₃ | H | Cl | |
| 3-2201 | 4-SCH₃ | C(CH₃)₂CH₂SOCH₃ | CH₃ | H | Cl | |
| 3-2202 | 4-SCH₃ | C(CH₃)₂CH₂SO₂CH₃ | CH₃ | H | Cl | |
| 3-2203 | 4-SCH₃ | CH(CH₃)CH₂SCH₃ | CH₃ | H | Cl | |
| 3-2204 | 4-SCH₃ | CH(CH₃)CH₂SOCH₃ | CH₃ | H | Cl | |
| 3-2205 | 4-SCH₃ | CH(CH₃)CH₂SO₂CH₃ | CH₃ | H | Cl | |
| 3-2206 | 4-SCH₃ | CH(CH₃)₂ | H | H | OCF₃ | |
| 3-2207 | 4-SCH₃ | C(CH₃)₂CH₂SCH₃ | H | H | OCF₃ | |
| 3-2208 | 4-SCH₃ | C(CH₃)₂CH₂SOCH₃ | H | H | OCF₃ | |
| 3-2209 | 4-SCH₃ | C(CH₃)₂CH₂SO₂CH₃ | H | H | OCF₃ | |
| 3-2210 | 4-SCH₃ | CH(CH₃)CH₂SCH₃ | H | H | OCF₃ | |
| 3-2211 | 4-SCH₃ | CH(CH₃)CH₂SOCH₃ | H | H | OCF₃ | |
| 3-2212 | 4-SCH₃ | CH(CH₃)CH₂SO₂CH₃ | H | H | OCF₃ | |
| 3-2213 | 4-SCH₃ | CH(CH₃)₂ | H | H | CF₃ | |
| 3-2214 | 4-SCH₃ | C(CH₃)₂CH₂SCH₃ | H | H | CF₃ | |
| 3-2215 | 4-SCH₃ | C(CH₃)₂CH₂SOCH₃ | H | H | CF₃ | |
| 3-2216 | 4-SCH₃ | C(CH₃)₂CH₂SO₂CH₃ | H | H | CF₃ | |
| 3-2217 | 4-SCH₃ | CH(CH₃)CH₂SCH₃ | H | H | CF₃ | |
| 3-2218 | 4-SCH₃ | CH(CH₃)CH₂SOCH₃ | H | H | CF₃ | |
| 3-2219 | 4-SCH₃ | CH(CH₃)CH₂SO₂CH₃ | H | H | CF₃ | |
| 3-2220 | 4-SCH₃ | CH(CH₃)₂ | H | H | Ph-4-CF₃ | |
| 3-2221 | 4-SCH₃ | C(CH₃)₂CH₂SCH₃ | H | H | Ph-4-CF₃ | |
| 3-2222 | 4-SCH₃ | C(CH₃)₂CH₂SOCH₃ | H | H | Ph-4-CF₃ | |
| 3-2223 | 4-SCH₃ | C(CH₃)₂CH₂SO₂CH₃ | H | H | Ph-4-CF₃ | |
| 3-2224 | 4-SCH₃ | CH(CH₃)CH₂SCH₃ | H | H | Ph-4-CF₃ | |
| 3-2225 | 4-SCH₃ | CH(CH₃)CH₂SOCH₃ | H | H | Ph-4-CF₃ | |
| 3-2226 | 4-SCH₃ | CH(CH₃)CH₂SO₂CH₃ | H | H | Ph-4-CF₃ | |
| 3-2227 | 4-SCH₃ | CH(CH₃)₂ | F | F | CF₃ | |
| 3-2228 | 4-SCH₃ | C(CH₃)₂CH₂SCH₃ | F | F | CF₃ | |
| 3-2229 | 4-SCH₃ | C(CH₃)₂CH₂SOCH₃ | F | F | CF₃ | |
| 3-2230 | 4-SCH₃ | C(CH₃)₂CH₂SO₂CH₃ | F | F | CF₃ | |
| 3-2231 | 4-SCH₃ | CH(CH₃)CH₂SCH₃ | F | F | CF₃ | |
| 3-2232 | 4-SCH₃ | CH(CH₃)CH₂SOCH₃ | F | F | CF₃ | |
| 3-2233 | 4-SCH₃ | CH(CH₃)CH₂SO₂CH₃ | F | F | CF₃ | |
| 3-2234 | 4-SCH₃ | CH(CH₃)₂ | CH₃ | H | COH(CF₃)₂ | |
| 3-2235 | 4-SCH₃ | C(CH₃)₂CH₂SCH₃ | CH₃ | H | COH(CF₃)₂ | |
| 3-2236 | 4-SCH₃ | C(CH₃)₂CH₂SOCH₃ | CH₃ | H | COH(CF₃)₂ | |
| 3-2237 | 4-SCH₃ | C(CH₃)₂CH₂SO₂CH₃ | CH₃ | H | COH(CF₃)₂ | |
| 3-2238 | 4-SCH₃ | CH(CH₃)CH₂SCH₃ | CH₃ | H | COH(CF₃)₂ | |
| 3-2239 | 4-SCH₃ | CH(CH₃)CH₂SOCH₃ | CH₃ | H | COH(CF₃)₂ | |
| 3-2240 | 4-SCH₃ | CH(CH₃)CH₂SO₂CH₃ | CH₃ | H | COH(CF₃)₂ | |
| 3-2241 | 7-SCH₃ | CH(CH₃)₂ | CH₃ | H | CF(CF₃)₂ | |
| 3-2242 | 7-SCH₃ | C(CH₃)₂CH₂SCH₃ | CH₃ | H | CF(CF₃)₂ | |
| 3-2243 | 7-SCH₃ | C(CH₃)₂CH₂SOCH₃ | CH₃ | H | CF(CF₃)₂ | |
| 3-2244 | 7-SCH₃ | C(CH₃)₂CH₂SO₂CH₃ | CH₃ | H | CF(CF₃)₂ | |
| 3-2245 | 7-SCH₃ | CH(CH₃)CH₂SCH₃ | CH₃ | H | CF(CF₃)₂ | |
| 3-2246 | 7-SCH₃ | CH(CH₃)CH₂SOCH₃ | CH₃ | H | CF(CF₃)₂ | |
| 3-2247 | 7-8CH₃ | CH(CH₃)CH₂SO₂CH₃ | CH₃ | H | CF(CF₃)₂ | |
| 3-2248 | 7-SCH₃ | CH(CH₃)₂ | H | H | CF(CF₃)₂ | |
| 3-2249 | 7-SCH₃ | C(CH₃)₂CH₂SCH₃ | H | H | CF(CF₃)₂ | |
| 3-2250 | 7-SCH₃ | C(CH₃)₂CH₂SOCH₃ | H | H | CF(CF₃)₂ | |
| 3-2251 | 7-SCH₃ | C(CH₃)₂CH₂SO₂CH₃ | H | H | CF(CF₃)₂ | |
| 3-2252 | 7-SCH₃ | CH(CH₃)CH₂SCH₃ | H | H | CF(CF₃)₂ | |
| 3-2253 | 7-SCH₃ | CH(CH₃)CH₂SOCH₃ | H | H | CF(CF₃)₂ | |
| 3-2254 | 7-SCH₃ | CH(CH₃)CH₂SO₂CH₃ | H | H | CF(CF₃)₂ | |
| 3-2255 | 7-SCH₃ | CH(CH₃)₂ | Cl | Cl | Cl | |
| 3-2256 | 7-SCH₃ | C(CH₃)₂CH₂SCH₃ | Cl | Cl | Cl | |
| 3-2257 | 7-SCH₃ | C(CH₃)₂CH₂SOCH₃ | Cl | Cl | Cl | |
| 3-2258 | 7-SCH₃ | C(CH₃)₂CH₂SO₂CH₃ | Cl | Cl | Cl | |
| 3-2259 | 7-SCH₃ | CH(CH₃)CH₂SCH₃ | Cl | Cl | Cl | |
| 3-2260 | 7-SCH₃ | CH(CH₃)CH₂SOCH₃ | Cl | Cl | Cl | |
| 3-2261 | 7-SCH₃ | CH(CH₃)CH₂SO₂CH₃ | Cl | Cl | Cl | |
| 3-2262 | 7-SCH₃ | CH(CH₃)₂ | CH₃ | H | OCF₃ | |
| 3-2263 | 7-SCH₃ | C(CH₃)₂CH₂SCH₃ | CH₃ | H | OCF₃ | |
| 3-2264 | 7-SCH₃ | C(CH₃)₂CH₂SOCH₃ | CH₃ | H | OCF₃ | |
| 3-2265 | 7-SCH₃ | C(CH₃)₂CH₂SO₂CH₃ | CH₃ | H | OCF₃ | |
| 3-2266 | 7-SCH₃ | CH(CH₃)CH₂SCH₃ | CH₃ | H | OCF₃ | |
| 3-2267 | 7-SCH₃ | CH(CH₃)CH₂SOCH₃ | CH₃ | H | OCF₃ | |
| 3-2268 | 7-SCH₃ | CH(CH₃)CH₂SO₂CH₃ | CH₃ | H | OCF₃ | |
| 3-2269 | 7-SCH₃ | CH(CH₃)₂ | C | H | Cl | |
| 3-2270 | 7-SCH₃ | C(CH₃)₂CH₂SCH₃ | Cl | H | Cl | |
| 3-2271 | 7-SCH₃ | C(CH₃)₂CH₂SOCH₃ | Cl | H | Cl | |
| 3-2272 | 7-SCH₃ | C(CH₃)₂CH₂SO₂CH₃ | Cl | H | Cl | |
| 3-2273 | 7-SCH₃ | CH(CH₃)CH₂SCH₃ | Cl | H | Cl | |
| 3-2274 | 7-SCH₃ | CH(CH₃)CH₂SOCH₃ | Cl | H | Cl | |
| 3-2275 | 7-SCH₃ | CH(CH₃)CH₂SO₂CH₃ | Cl | H | Cl | |
| 3-2276 | 7-SCH₃ | CH(CH₃)₂ | H | Cl | Cl | |
| 3-2277 | 7-SCH₃ | C(CH₃)₂CH₂SCH₃ | H | Cl | Cl | |
| 3-2278 | 7-SCH₃ | C(CH₃)₂CH₂SOCH₃ | H | Cl | Cl | |
| 3-2279 | 7-SCH₃ | C(CH₃)₂CH₂SO₂CH₃ | H | Cl | Cl | |
| 3-2280 | 7-SCH₃ | CH(CH₃)CH₂SCH₃ | H | Cl | Cl | |
| 3-2281 | 7-SCH₃ | CH(CH₃)CH₂SOCH₃ | H | Cl | Cl | |
| 3-2282 | 7-SCH₃ | CH(CH₃)CH₂SO₂CH₃ | H | Cl | Cl | |
| 3-2283 | 7-SCH₃ | CH(CH₃)₂ | Cl | Cl | H | |
| 3-2284 | 7-SCH₃ | C(CH₃)₂CH₂SCH₃ | Cl | Cl | H | |
| 3-2285 | 7-SCH₃ | C(CH₃)₂CH₂SOCH₃ | Cl | Cl | H | |
| 3-2286 | 7-SCH₃ | C(CH₃)₂CH₂SO₂CH₃ | Cl | Cl | H | |
| 3-2287 | 7-SCH₃ | CH(CH₃)CH₂SCH₃ | Cl | Cl | H | |
| 3-2288 | 7-SCH₃ | CH(CH₃)CH₂SOCH₃ | Cl | Cl | H | |
| 3-2289 | 7-SCH₃ | CH(CH₃)CH₂SO₂CH₃ | Cl | Cl | H | |
| 3-2290 | 7-SCH₃ | CH(CH₃)₂ | Cl | H | CF₃ | |
| 3-2291 | 7-SCH₃ | C(CH₃)₂CH₂SCH₃ | Cl | H | CF₃ | |
| 3-2292 | 7-SCH₃ | C(CH₃)₂CH₂SOCH₃ | Cl | H | CF₃ | |
| 3-2293 | 7-SCH₃ | C(CH₃)₂CH₂SO₂CH₃ | Cl | H | CF₃ | |
| 3-2294 | 7-SCH₃ | CH(CH₃)CH₂SCH₃ | Cl | H | CF₃ | |
| 3-2295 | 7-SCH₃ | CH(CH₃)CH₂SOCH₃ | Cl | H | CF₃ | |
| 3-2296 | 7-SCH₃ | CH(CH₃)CH₂SO₂CH₃ | Cl | H | CF₃ | |
| 3-2297 | 7-SCH₃ | CH(CH₃)₂ | Cl | H | CF₃ | |
| 3-2298 | 7-SCH₃ | C(CH₃)₂CH₂SCH₃ | Cl | H | CF₃ | |
| 3-2299 | 7-SCH₃ | C(CH₃ | hCH₂SOCH₃ | Cl | H | CF₃ |
| 3-2300 | 7-SCH₃ | C(CH₃)₂CH₂SO₂CH₃ | Cl | H | CF₃ | |
| 3-2301 | 7-SCH₃ | CH(CH₃)CH₂SCH₃ | Cl | H | CF₃ | |
| 3-2302 | 7-SCH₃ | CH(CH₃)CH₂SOCH₃ | Cl | H | CF₃ | |
| 3-2303 | 7-SCH₃ | CH(CH₃)CH₂SO₂CH₃ | Cl | H | CF₃ | |
| 3-2304 | 7-SCH₃ | CH(CH₃)₂ | H | H | Cl | |
| 3-2305 | 7-SCH₃ | C(CH₃)₂CH₂SCH₃ | H | H | Cl | |
| 3-2306 | 7-SCH₃ | C(CH₃)₂CH₂SOCH₃ | H | H | Cl | |
| 3-2307 | 7-SCH₃ | C(CH₃)₂CH₂SO₂CH₃ | H | H | Cl | |
| 3-2308 | 7-SCH₃ | CH(CH₃)CH₂SCH₃ | H | H | Cl | |
| 3-2309 | 7-SCH₃ | CH(CH₃)CH₂SOCH₃ | H | H | Cl | |
| 3-2310 | 7-SCH₃ | CH(CH₃)CH₂SO₂CH₃ | H | H | Cl | |
| 3-2311 | 7-SCH₃ | CH(CH₃)₂ | CH₃ | H | Cl | |
| 3-2312 | 7-SCH₃ | C(CH₃)₂CH₂SCH₃ | CH₃ | H | Cl | |
| 3-2313 | 7-SCH₃ | C(CH₃)₂CH₂SOCH₃ | CH₃ | H | Cl | |
| 3-2314 | 7-SCH₃ | C(CH₃)₂CH₂SO₂CH₃ | CH₃ | H | Cl | |
| 3-2315 | 7-SCH₃ | CH(CH₃)CH₂SCH₃ | CH₃ | H | Cl | |
| 3-2316 | 7-SCH₃ | CH(CH₃)CH₂SOCH₃ | CH₃ | H | Cl | |
| 3-2317 | 7-SCH₃ | CH(CH₃)CH₂SO₂CH₃ | CH₃ | H | Cl | |
| 3-2318 | 7-SCH₃ | CH(CH₃)₂ | H | H | OCF₃ | |
| 3-2319 | 7-SCH₃ | C(CH₃)₂CH₂SCH₃ | H | H | OCF₃ | |
| 3-2320 | 7-SCH₃ | C(CH₃)₂CH₂SOCH₃ | H | H | OCF₃ | |
| 3-2321 | 7-SCH₃ | C(CH₃)₂CH₂SO₂CH₃ | H | OCF₃ | | |
| 3-2322 | 7-SCH₃ | CH(CH₃)CH₂SCH₃ | H | H | OCF₃ | |
| 3-2323 | 7-SCH₃ | CH(CH₃)CH₂SOCH₃ | H | H | OCF₃ | |
| 3-2324 | 7-SCH₃ | CH(CH₃)CH₂SO₂CH₃ | H | H | OCF₃ | |
| 3-2325 | 7-SCH₃ | CH(CH₃)₂ | H | H | CF₃ | |
| 3-2326 | 7-SCH₃ | C(CH₃)₂CH₂SCH₃ | H | H | CF₃ | |
| 3-2327 | 7-SCH₃ | C(CH₃)₂CH₂SOCH₃ | H | H | CF₃ | |
| 3-2328 | 7-SCH₃ | C(CH₃)₂CH₂SO₂CH₃ | H | H | CF₃ | |
| 3-2329 | 7-SCH₃ | CH(CH₃)CH₂SCH₃ | H | H | CF₃ | |
| 3-2330 | 7-SCH₃ | CH(CH₃)CH₂SOCH₃ | H | H | CF₃ | |
| 3-2331 | 7-SCH₃ | CH(CH₃)CH₂SO₂CH₃ | H | H | CF₃ | |
| 3-2332 | 7-SCH₃ | CH(CH₃)₂ | H | H | Ph-4-CF₃ | |
| 3-2333 | 7-SCH₃ | C(CH₃)₂CH₂SCH₃ | H | H | Ph-4-CF₃ | |
| 3-2334 | 7-SCH₃ | C(CH₃)₂CH₂SOCH₃ | H | H | Ph-4-CF₃ | |
| 3-2335 | 7-SCH₃ | C(CH₃)₂CH₂SO₂CH₃ | H | H | Ph-4-CF₃ | |
| 3-2336 | 7-SCH₃ | CH(CH₃)CH₂SCH₃ | H | H | Ph-4-CF₃ | |
| 3-2337 | 7-SCH₃ | CH(CH₃)CH₂SOCH₃ | H | H | Ph-4-CF₃ | |
| 3-2338 | 7-SCH₃ | CH(CH₃)CH₂SO₂CH₃ | H | H | Ph-4-CF₃ | |
| 3-2339 | 7-SCH₃ | CH(CH₃)₂ | F | F | CF₃ | |
| 3-2340 | 7-SCH₃ | C(CH₃)₂CH₂SCH₃ | F | F | CF₃ | |
| 3-2341 | 7-SCH₃ | C(CH₃)₂CH₂SOCH₃ | F | F | CF₃ | |
| 3-2342 | 7-SCH₃ | C(CH₃)₂CH₂SO₂CH₃ | F | F | CF₃ | |
| 3-2343 | 7-SCH₃ | CH(CH₃)CH₂SCH₃ | F | F | CF₃ | |
| 3-2344 | 7-SCH₃ | CH(CH₃)CH₂SOCH₃ | F | F | CF₃ | |
| 3-2345 | 7-SCH₃ | CH(CH₃)CH₂SO₂CH₃ | F | F | CF₃ | |
| 3-2346 | 7-SCH₃ | CH(CH₃)₂ | CH₃ | H | COH(CF₃)₂ | |
| 3-2347 | 7-SCH₃ | C(CH₃)₂CH₂SCH₃ | CH₃ | H | COH(CF₃)₂ | |
| 3-2348 | 7-SCH₃ | C(CH₃)₂CH₂SOCH₃ | CH₃ | H | COH(CF₃)₂ | |
| 3-2349 | 7-SCH₃ | C(CH₃)₂CH₂SO₂CH₃ | CH₃ | H | COH(CF₃)₂ | |
| 3-2350 | 7-SCH₃ | CH(CH₃)CH₂SCH₃ | CH₃ | H | COH(CF₃)₂ | |
| 3-2351 | 7-SCH₃ | CH(CH₃)CH₂SOCH₃ | CH₃ | H | COH(CF₃)₂ | |
| 3-2352 | 7-SCH₃ | CH(CH₃)CH₂SO₂CH₃ | CH₃ | H | COH(CF₃)₂ | |
| 3-2353 | 4-SO₂CH₃ | CH(CH₃)₂ | CH₃ | H | CF(CF₃)₂ | |
| 3-2354 | 4-SO₂CH₃ | C(CH₃)₂CH₂SCH₃ | CH₃ | H | CF(CF₃)₂ | |
| 3-2355 | 4-SO₂CH₃ | C(CH₃)₂CH₂SOCH₃ | CH₃ | H | CF(CF₃)₂ | |
| 3-2356 | 4-SO₂CH₃ | C(CH₃)₂CH₂SO₂CH₃ | CH₃ | H | CF(CF₃)₂ | |
| 3-2357 | 4-SO₂CH₃ | CH(CH₃)CH₂SCH₃ | CH₃ | H | CF(CF₃)₂ | |
| 3-2358 | 4-SO₂CH₃ | CH(CH₃)CH₂SOCH₃ | CH₃ | H | CF(CF₃)₂ | |
| 3-2359 | 4-SO₂CH₃ | CH(CH₃)CH₂SO₂CH₃ | CH₃ | H | CF(CF₃)₂ | |
| 3-2360 | 4-SO₂CH₃ | CH(CH₃)₂ | H | H | CF(CF₃)₂ | |
| 3-2361 | 4-SO₂CH₃ | C(CH₃)₂CH₂SCH₃ | H | H | CF(CF₃)₂ | |
| 3-2362 | 4-SO₂CH₃ | C(CH₃)₂CH₂SOCH₃ | H | H | CF(CF₃)₂ | |
| 3-2363 | 4-SO₂CH₃ | C(CH₃)₂CH₂SO₂CH₃ | H | H | CF(CF₃)₂ | |
| 3-2364 | 4-SO₂CH₃ | CH(CH₃)CH₂SCH₃ | H | H | CF(CF₃)₂ | |
| 3-2365 | 4-SO₂CH₃ | CH(CH₃)CH₂SOCH₃ | H | H | CF(CF₃)₂ | |
| 3-2366 | 4-SO₂CH₃ | CH(CH₃)CH₂SO₂CH₃ | H | H | CF(CF₃)₂ | |
| 3-2367 | 4-SO₂CH₃ | CH(CH₃)₂ | Cl | Cl | Cl | |
| 3-2368 | 4-SO₂CH₃ | C(CH₃)₂CH₂SCH₃ | Cl | Cl | Cl | |
| 3-2369 | 4-SO₂CH₃ | C(CH₃)₂CH₂SOCH₃ | Cl | Cl | Cl | |
| 3-2370 | 4-SO₂CH₃ | C(CH₃)₂CH₂SO₂CH₃ | Cl | Cl | Cl | |
| 3-2371 | 4-SO₂CH₃ | CH(CH₃)CH₂SCH₃ | Cl | Cl | Cl | |
| 3-2372 | 4-SO₂CH₃ | CH(CH₃)CH₂SOCH₃ | Cl | Cl | Cl | |
| 3-2373 | 4-SO₂CH₃ | CH(CH₃)CH₂SO₂CH₃ | Cl | Cl | Cl | |
| 3-2374 | 4-SO₂CH₃ | CH(CH₃)₂ | CH₃ | H | OCF₃ | |
| 3-2375 | 4-SO₂CH₃ | C(CH₃)₂CH₂SCH₃ | CH₃ | H | OCF₃ | |
| 3-2376 | 4-SO₂CH₃ | C(CH₃)₂CH₂SOCH₃ | CH₃ | H | OCF₃ | |
| 3-2377 | 4-SO₂CH₃ | C(CH₃)₂CH₂SO₂CH₃ | CH₃ | H | OCF₃ | |
| 3-2378 | 4-SO₂CH₃ | CH(CH₃)CH₂SCH₃ | CH₃ | H | OCF₃ | |
| 3-2379 | 4-SO₂CH₃ | CH(CH₃)CH₂SOCH₃ | CH₃ | H | OCF₃ | |
| 3-2380 | 4-SO₂CH₃ | CH(CH₃)CH₂SO₂CH₃ | CH₃ | H | OCF₃ | |
| 3-2381 | 4-SO₂CH₃ | CH(CH₃)₂ | Cl | H | Cl | |
| 3-2382 | 4-SO₂CH₃ | C(CH₃)₂CH₂SCH₃ | Cl | H | Cl | |
| 3-2383 | 4-SO₂CH₃ | C(CH₃)₂CH₂SOCH₃ | Cl | H | Cl | |
| 3-2384 | 4-SO₂CH₃ | C(CH₃)₂CH₂SO₂CH₃ | Cl | H | Cl | |
| 3-2385 | 4-SO₂CH₃ | CH(CH₃)CH₂SCH₃ | Cl | H | Cl | |
| 3-2386 | 4-SO₂CH₃ | CH(CH₃)CH₂SOCH₃ | Cl | H | Cl | |
| 3-2387 | 4-SO₂CH₃ | CH(CH₃)CH₂SO₂CH₃ | Cl | H | Cl | |
| 3-2388 | 4-SO₂CH₃ | CH(CH₃)₂ | H | Cl | Cl | |
| 3-2389 | 4-SO₂CH₃ | C(CH₃)₂CH₂SCH₃ | H | Cl | Cl | |
| 3-2390 | 4-SO₂CH₃ | C(CH₃)₂CH₂SOCH₃ | H | Cl | Cl | |
| 3-2391 | 4-SO₂CH₃ | C(CH₃)₂CH₂SO₂CH₃ | H | Cl | Cl | |
| 3-2392 | 4-SO₂CH₃ | CH(CH₃)CH₂SCH₃ | H | Cl | Cl | |
| 3-2393 | 4-SO₂CH₃ | CH(CH₃)CH₂SOCH₃ | H | Cl | Cl | |
| 3-2394 | 4-SO₂CH₃ | CH(CH₃)CH₂SO₂CH₃ | H | Cl | Cl | |
| 3-2395 | 4-SO₂CH₃ | CH(CH₃)₂ | Cl | Cl | H | |
| 3-2396 | 4-SO₂CH₃ | C(CH₃)₂CH₂SCH₃ | Cl | Cl | H | |
| 3-2397 | 4-SO₂CH₃ | C(CH₃)₂CH₂SOCH₃ | Cl | Cl | H | |
| 3-2398 | 4-SO₂CH₃ | C(CH₃)₂CH₂SO₂CH₃ | ClCl | H | | |
| 3-2399 | 4-SO₂CH₃ | CH(CH₃)CH₂SCH₃ | Cl | Cl | H | |
| 3-2400 | 4-SO₂CH₃ | CH(CH₃)CH₂SOCH₃ | Cl | Cl | H | |
| 3-2401 | 4-SO₂CH₃ | CH(CH₃)CH₂SO₂CH₃ | ClCl | H | | |
| 3-2402 | 4-SO₂CH₃ | CH(CH₃)₂ | Cl | H | CF₃ | |
| 3-2403 | 4-SO₂CH₃ | C(CH₃)₂CH₂SCH₃ | Cl | H | CF₃ | |
| 3-2404 | 4-SO₂CH₃ | C(CH₃)₂CH₂SOCH₃ | Cl | H | CF₃ | |
| 3-2405 | 4-SO₂CH₃ | C(CH₃)₂CH₂SO₂CH₃ | Cl | H | CF₃ | |
| 3-2406 | 4-SO₂CH₃ | CH(CH₃)CH₂SCH₃ | Cl | H | CF₃ | |
| 3-2407 | 4-SO₂CH₃ | CH(CH₃)CH₂SOCH₃ | Cl | H | CF₃ | |
| 3-2408 | 4-SO₂CH₃ | CH(CH₃)CH₂SO₂CH₃ | Cl | H | CF₃ | |
| 3-2409 | 4-SO₂CH₃ | CH(CH₃)₂ | Cl | H | CF₃ | |
| 3-2410 | 4-SO₂CH₃ | C(CH₃)₂CH₂SCH₃ | Cl | H | CF₃ | |
| 3-2411 | 4-SO₂CH₃ | C(CH₃)₂CH₂SOCH₃ | Cl | H | CF₃ | |
| 3-2412 | 4-SO₂CH₃ | C(CH₃)₂CH₂SO₂CH₃ | Cl | H | CF₃ | |
| 3-2413 | 4-SO₂CH₃ | CH(CH₃)CH₂SCH₃ | Cl | H | CF₃ | |
| 3-2414 | 4-SO₂CH₃ | CH(CH₃)CH₂SOCH₃ | Cl | H | CF₃ | |
| 3-2415 | 4-SO₂CH₃ | CH(CH₃)CH₂SO₂CH₃ | Cl | H | CF₃ | |
| 3-2416 | 4-SO₂CH₃ | CH(CH₃)₂ | H | H | Cl | |
| 3-2417 | 4-SO₂CH₃ | C(CH₃)₂CH₂SCH₃ | H | H | Cl | |
| 3-2418 | 4-SO₂CH₃ | C(CH₃)₂CH₂SOCH₃ | H | H | Cl | |
| 3-2419 | 4-SO₂CH₃ | C(CH₃)₂CH₂SO₂CH₃ | H | H | Cl | |
| 3-2420 | 4-SO₂CH₃ | CH(CH₃)CH₂SCH₃ | H | H | Cl | |
| 3-2421 | 4-SO₂CH₃ | CH(CH₃)CH₂SOCH₃ | H | H | Cl | |
| 3-2422 | 4-SO₂CH₃ | CH(CH₃)CH₂SO₂CH₃ | H | H | Cl | |
| 3-2423 | 4-SO₂CH₃ | CH(CH₃)₂ | CH₃ | H | Cl | |
| 3-2424 | 4-SO₂CH₃ | C(CH₃)₂CH₂SCH₃ | CH₃ | H | Cl | |
| 3-2425 | 4-SO₂CH₃ | C(CH₃)₂CH₂SOCH₃ | CH₃ | H | Cl | |
| 3-2426 | 4-SO₂CH₃ | C(CH₃)₂CH₂SO₂CH₃ | CH₃ | H | Cl | |
| 3-2427 | 4-SO₂CH₃ | CH(CH₃)CH₂SCH₃ | CH₃ | H | Cl | |
| 3-2428 | 4-SO₂CH₃ | CH(CH₃)CH₂SOCH₃ | CH₃ | H | Cl | |
| 3-2429 | 4-SO₂CH₃ | CH(CH₃)CH₂SO₂CH₃ | CH₃ | H | Cl | |
| 3-2430 | 4-SO₂CH₃ | CH(CH₃)₂ | H | H | OCF₃ | |
| 3-2431 | 4-SO₂CH₃ | C(CH₃)₂CH₂SCH₃ | H | H | OCF₃ | |
| 3-2432 | 4-SO₂CH₃ | C(CH₃)₂CH₂SOCH₃ | H | H | OCF₃ | |
| 3-2433 | 4-SO₂CH₃ | C(CH₃)₂CH₂SO₂CH₃ | H | H | OCF₃ | |
| 3-2434 | 4-SO₂CH₃ | CH(CH₃)CH₂SCH₃ | H | H | OCF₃ | |
| 3-2435 | 4-SO₂CH₃ | CH(CH₃)CH₂SOCH₃ | H | H | OCF₃ | |
| 3-2436 | 4-SO₂CH₃ | CH(CH₃)CH₂SO₂CH₃ | H | H | OCF₃ | |
| 3-2437 | 4-SO₂CH₃ | CH(CH₃)₂ | H | H | CF₃ | |
| 3-2438 | 4-SO₂CH₃ | C(CH₃)₂CH₂SCH₃ | H | H | CF₃ | |
| 3-2439 | 4-SO₂CH₃ | C(CH₃)₂CH₂SOCH₃ | H | H | CF₃ | |
| 3-2440 | 4-SO₂CH₃ | C(CH₃)₂CH₂SO₂CH₃ | H | H | CF₃ | |
| 3-2441 | 4-SO₂CH₃ | CH(CH₃)CH₂SCH₃ | H | H | CF₃ | |
| 3-2442 | 4-SO₂CH₃ | CH(CH₃)CH₂SOCH₃ | H | H | CF₃ | |
| 3-2443 | 4-SO₂CH₃ | CH(CH₃)CH₂SO₂CH₃ | H | H | CF₃ | |
| 3-2444 | 4-SO₂CH₃ | CH(CH₃)₂ | H | H | Ph-4-CF₃ | |
| 3-2445 | 4-SO₂CH₃ | C(CH₃)₂CH₂SCH₃ | H | H | Ph-4-CF₃ | |
| 3-2446 | 4-SO₂CH₃ | C(CH₃)₂CH₂SOCH₃ | H | H | Ph-4-CF₃ | |
| 3-2447 | 4-SO₂CH₃ | C(CH₃)₂CH₂SO₂CH₃ | H | H | Ph-4-CF₃ | |
| 3-2448 | 4-SO₂CH₃ | CH(CH₃)CH₂SCH₃ | H | H | Ph-4-CF₃ | |
| 3-2449 | 4-SO₂CH₃ | CH(CH₃)CH₂SOCH₃ | H | H | Ph-4-CF₃ | |
| 3-2450 | 4-SO₂CH₃ | CH(CH₃)CH₂SO₂CH₃ | H | H | Ph-4-CF₃ | |
| 3-2451 | 4-SO₂CH₃ | CH(CH₃)₂ | F | F | CF₃ | |
| 3-2452 | 4-SO₂CH₃ | C(CH₃)₂CH₂SCH₃ | F | F | CF₃ | |
| 3-2453 | 4-SO₂CH₃ | C(CH₃)₂CH₂SOCH₃ | F | F | CF₃ | |
| 3-2454 | 4-SO₂CH₃ | C(CH₃)₂CH₂SO₂CH₃ | F | F | CF₃ | |
| 3-2455 | 4-SO₂CH₃ | CH(CH₃)CH₂SCH₃ | F | F | CF₃ | |
| 3-2456 | 4-SO₂CH₃ | CH(CH₃)CH₂SOCH₃ | F | F | CF₃ | |
| 3-2457 | 4-SO₂CH₃ | CH(CH₃)CH₂SO₂CH₃ | F | F | CF₃ | |
| 3-2458 | 4-SO₂CH₃ | CH(CH₃)₂ | CH₃ | H | COH(CF₃)₂ | |
| 3-2459 | 4-SO₂CH₃ | C(CH₃)₂CH₂SCH₃ | CH₃ | H | COH(CF₃)₂ | |
| 3-2460 | 4-SO₂CH₃ | C(CH₃)₂CH₂SOCH₃ | CH₃ | H | COH(CF₃)₂ | |
| 3-2461 | 4-SO₂CH₃ | C(CH₃)₂CH₂SO₂CH₃ | CH₃ | H | COH(CF₃)₂ | |
| 3-2462 | 4-SO₂CH₃ | CH(CH₃)CH₂SCH₃ | CH₃ | H | COH(CF₃)₂ | |
| 3-2463 | 4-SO₂CH₃ | CH(CH₃)CH₂SOCH₃ | CH₃ | H | COH(CF₃)₂ | |
| 3-2464 | 4 SO₂CH₃ | CH(CH₃)CH₂SO₂CH₃ | CH₃ | H | COH(CF₃)₂ | |
| 3-2465 | 7-SO₂CH₃ | CH(CH₃)₂ | CH₃ | H | CF(CF₃)₂ | |
| 3-2466 | 7-SO₂CH₃ | C(CH₃)₂CH₂SCH₃ | CH₃ | H | CF(CF₃)₂ | |
| 3-2467 | 7-SO₂CH₃ | C(CH₃)₂CH₂SOCH₃ | CH₃ | H | CF(CF₃)₂ | |
| 3-2468 | 7-SO₂CH₃ | C(CH₃)₂CH₂SO₂CH₃ | CH₃ | H | CF(CF₃)₂ | |
| 3-2469 | 7-SO₂CH₃ | CH(CH₃)CH₂SCH₃ | CH₃ | H | CF(CF₃)₂ | |
| 3-2470 | 7-SO₂CH₃ | CH(CH₃)CH₂SOCH₃ | CH₃ | H | CF(CF₃)₂ | |
| 3-2471 | 7-SO₂CH₃ | CH(CH₃)CH₂SO₂CH₃ | CH₃ | H | CF(CF₃)₂ | |
| 3-2472 | 7-SO₂CH₃ | CH(CH₃)₂ | H | H | CF(CF₃)₂ | |
| 3-2473 | 7-SO₂CH₃ | C(CH₃)₂CH₂SCH₃ | H | H | CF(CF₃)₂ | |
| 3-2474 | 7-SO₂CH₃ | C(CH₃)₂CH₂SOCH₃ | H | H | CF(CF₃)₂ | |
| 3-2475 | 7-SO₂CH₃ | C(CH₃)₂CH₂SO₂CH₃ | H | H | CF(CF₃)₂ | |
| 3-2476 | 7-SO₂CH₃ | CH(CH₃)CH₂SCH₃ | H | H | CF(CF₃)₂ | |
| 3-2477 | 7-SO₂CH₃ | CH(CH₃)CH₂SOCH₃ | H | H | CF(CF₃)₂ | |
| 3-2478 | 7-SO₂CH₃ | CH(CH₃)CH₂SO₂CH₃ | H | H | CF(CF₃)₂ | |
| 3-2479 | 7-SO₂CH₃ | CH(CH₃)₂ | Cl | Cl | Cl | |
| 3-2480 | 7-SO₂CH₃ | C(CH₃)₂CH₂SCH₃ | Cl | Cl | Cl | |
| 3-2481 | 7-SO₂CH₃ | C(CH₃)₂CH₂SOCH₃ | Cl | Cl | Cl | |
| 3-2482 | 7-SO₂CH₃ | C(CH₃)₂CH₂SO₂CH₃ | Cl | Cl | Cl | |
| 3-2483 | 7-SO₂CH₃ | CH(CH₃)CH₂SCH₃ | Cl | Cl | Cl | |
| 3-2484 | 7-SO₂CH₃ | CH(CH₃)CH₂SOCH₃ | Cl | Cl | Cl | |
| 3-2485 | 7-SO₂CH₃ | CH(CH₃)CH₂SO₂CH₃ | Cl | Cl | Cl | |
| 3-2486 | 7-SO₂CH₃ | CH(CH₃)₂ | CH₃ | H | OCF₃ | |
| 3-2487 | 7-SO₂CH₃ | C(CH₃)₂CH₂SCH₃ | CH₃ | H | OCF₃ | |
| 3-2488 | 7-SO₂CH₃ | C(CH₃)₂CH₂SOCH₃ | CH₃ | H | OCF₃ | |
| 3-2489 | 7-SO₂CH₃ | C(CH₃)₂CH₂SO₂CH₃ | CH₃ | H | OCF₃ | |
| 3-2490 | 7-SO₂CH₃ | CH(CH₃)CH₂SCH₃ | CH₃ | H | OCF₃ | |
| 3-2491 | 7-SO₂CH₃ | CH(CH₃)CH₂SOCH₃ | CH₃ | H | OCF₃ | |
| 3-2492 | 7-SO₂CH₃ | CH(CH₃)CH₂SO₂CH₃ | CH₃ | H | OCF₃ | |
| 3-2493 | 7-SO₂CH₃ | CH(CH₃)₂ | Cl | H | Cl | |
| 3-2494 | 7-SO₂CH₃ | C(CH₃)₂CH₂SCH₃ | Cl | H | Cl | |
| 3-2495 | 7-SO₂CH₃ | C(CH₃)₂CH₂SOCH₃ | Cl | H | Cl | |
| 3-2496 | 7-SO₂CH₃ | C(CH₃)₂CH₂SO₂CH₃ | Cl | H | Cl | |
| 3-2497 | 7-SO₂CH₃ | CH(CH₃)CH₂SCH₃ | Cl | H | Cl | |
| 3-2498 | 7-SO₂CH₃ | CH(CH₃)CH₂SOCH₃ | Cl | H | Cl | |
| 3-2499 | 7-SO₂CH₃ | CH(CH₃)CH₂SO₂CH₃ | Cl | H | Cl | |
| 3-2500 | 7-SO₂CH₃ | CH(CH₃)₂ | H | Cl | Cl | |
| 3-2501 | 7-SO₂CH₃ | C(CH₃)₂CH₂SCH₃ | H | Cl | Cl | |
| 3-2502 | 7-SO₂CH₃ | C(CH₃)₂CH₂SOCH₃ | H | Cl | Cl | |
| 3-2503 | 7-SO₂CH₃ | C(CH₃)₂CH₂SO₂CH₃ | H | Cl | Cl | |
| 3-2504 | 7-SO₂CH₃ | CH(CH₃)CH₂SCH₃ | H | Cl | Cl | |
| 3-2505 | 7-SO₂CH₃ | CH(CH₃)CH₂SOCH₃ | H | Cl | Cl | |
| 3-2506 | 7-SO₂CH₃ | CH(CH₃)CH₂SO₂CH₃ | H | Cl | Cl | |
| 3-2507 | 7-SO₂CH₃ | CH(CH₃)₂ | Cl | Cl | H | |
| 3-2508 | 7-SO₂CH₃ | C(CH₃)₂CH₂SCH₃ | Cl | Cl | H | |
| 3-2509 | 7-SO₂CH₃ | C(CH₃)₂CH₂SOCH₃ | Cl | Cl | H | |
| 3-2510 | 7-SO₂CH₃ | C(CH₃)₂CH₂SO₂CH₃ | Cl | Cl | H | |
| 3-2511 | 7-SO₂CH₃ | CH(CH₃)CH₂SCH₃ | Cl | Cl | H | |
| 3-2512 | 7-SO₂CH₃ | CH(CH₃)CH₂SOCH₃ | Cl | Cl | H | |
| 3-2513 | 7-SO₂CH₃ | CH(CH₃)CH₂SO₂CH₃ | Cl | Cl | H | |
| 3-2514 | 7-SO₂CH₃ | CH(CH₃)₂ | Cl | H | CF₃ | |
| 3-2515 | 7-SO₂CH₃ | C(CH₃)₂CH₂SCH₃ | Cl | H | CF₃ | |
| 3-2516 | 7-SO₂CH₃ | C(CH₃)₂CH₂SOCH₃ | Cl | H | CF₃ | |
| 3-2517 | 7-SO₂CH₃ | C(CH₃)₂CH₂SO₂CH₃ | Cl | H | CF₃ | |
| 3-2518 | 7-SO₂CH₃ | CH(CH₃)CH₂SCH₃ | Cl | H | CF₃ | |
| 3-2519 | 7-SO₂CH₃ | CH(CH₃)CH₂SOCH₃ | Cl | H | CF₃ | |
| 3-2520 | 7-SO₂CH₃ | CH(CH₃)CH₂SO₂CH₃ | Cl | H | CF₃ | |
| 3-2521 | 7-SO₂CH₃ | CH(CH₃)₂ | Cl | H | CF₃ | |
| 3-2522 | 7-SO₂CH₃ | C(CH₃)₂CH₂SCH₃ | Cl | H | CF₃ | |
| 3-2523 | 7-SO₂CH₃ | C(CH₃)₂CH₂SOCH₃ | Cl | H | CF₃ | |
| 3-2524 | 7-SO₂CH₃ | C(CH₃)₂CH₂SO₂CH₃ | Cl | H | CF₃ | |
| 3-2525 | 7-SO₂CH₃ | CH(CH₃)CH₂SCH₃ | Cl | H | CF₃ | |
| 3-2526 | 7-SO₂CH₃ | CH(CH₃)CH₂SOCH₃ | Cl | H | CF₃ | |
| 3-2527 | 7-SO₂CH₃ | CH(CH₃)CH₂SO₂CH₃ | Cl | H | CF₃ | |
| 3-2528 | 7-SO₂CH₃ | CH(CH₃)₂ | H | H | Cl | |
| 3-2529 | 7-SO₂CH₃ | C(CH₃)₂CH₂SCH₃ | H | H | Cl | |
| 3-2530 | 7-SO₂CH₃ | C(CH₃)₂CH₂SOCH₃ | H | H | Cl | |
| 3-2531 | 7-SO₂CH₃ | C(CH₃)₂CH₂SO₂CH₃ | H | H | Cl | |
| 3-2532 | 7-SO₂CH₃ | CH(CH₃)CH₂SCH₃ | H | H | Cl | |
| 3-2533 | 7-SO₂CH₃ | CH(CH₃)CH₂SOCH₃ | H | H | Cl | |
| 3-2534 | 7-SO₂CH₃ | CH(CH₃)CH₂SO₂CH₃ | H | H | Cl | |
| 3-2535 | 7-SO₂CH₃ | CH(CH₃)₂ | CH₃ | H | Cl | |
| 3-2536 | 7-SO₂CH₃ | C(CH₃)₂CH₂SCH₃ | CH₃ | H | Cl | |
| 3-2537 | 7-SO₂CH₃ | C(CH₃)₂CH₂SOCH₃ | CH₃ | H | Cl | |
| 3-2538 | 7-SO₂CH₃ | C(CH₃)₂CH₂SO₂CH₃ | CH₃ | H | Cl | |
| 3-2539 | 7-SO₂CH₃ | CH(CH₃)CH₂SCH₃ | CH₃ | H | Cl | |
| 3-2540 | 7-SO₂CH₃ | CH(CH₃)CH₂SOCH₃ | CH₃ | H | Cl | |
| 3-2541 | 7-SO₂CH₃ | CH(CH₃)CH₂SO₂CH₃ | CH₃ | H | Cl | |
| 3-2542 | 7-SO₂CH₃ | CH(CH₃)₂ | H | H | OCF₃ | |
| 3-2543 | 7-SO₂CH₃ | C(CH₃)₂CH₂SCH₃ | H | H | OCF₃ | |
| 3-2544 | 7-SO₂CH₃ | C(CH₃)₂CH₂SOCH₃ | H | H | OCF₃ | |
| 3-2545 | 7-SO₂CH₃ | C(CH₃)₂CH₂SO₂CH₃ | H | H | OCF₃ | |
| 3-2546 | 7-SO₂CH₃ | CH(CH₃)CH₂SCH₃ | H | H | OCF₃ | |
| 3-2547 | 7-SO₂CH₃ | CH(CH₃)CH₂SOCH₃ | H | H | OCF₃ | |
| 3-2548 | 7-SO₂CH₃ | CH(CH₃)CH₂SO₂CH₃ | H | H | OCF₃ | |
| 3-2549 | 7-SO₂CH₃ | CH(CH₃)₂ | H | H | CF₃ | |
| 3-2550 | 7-SO₂CH₃ | C(CH₃)₂CH₂SCH₃ | H | H | CF₃ | |
| 3-2551 | 7-SO₂CH₃ | C(CH₃)₂CH₂SOCH₃ | H | H | CF₃ | |
| 3-2552 | 7-SO₂CH₃ | C(CH₃)₂CH₂SO₂CH₃ | H | H | CF₃ | |
| 3-2553 | 7-SO₂CH₃ | CH(CH₃)CH₂SCH₃ | H | H | CF₃ | |
| 3-2554 | 7-SO₂CH₃ | CH(CH₃)CH₂SOCH₃ | H | H | CF₃ | |
| 3-2555 | 7-SO₂CH₃ | CH(CH₃)CH₂SO₂CH₃ | H | H | CF₃ | |
| 3-2556 | 7-SO₂CH₃ | CH(CH₃)₂ | H | H | Ph-4-CF₃ | |
| 3-2557 | 7-SO₂CH₃ | C(CH₃)₂CH₂SCH₃ | H | H | Ph-4-CF₃ | |
| 3-2558 | 7-SO₂CH₃ | C(CH₃)₂CH₂SOCH₃ | H | H | Ph-4-CF₃ | |
| 3-2559 | 7-SO₂CH₃ | C(CH₃)₂CH₂SO₂CH₃ | H | H | Ph-4-CF₃ | |
| 3-2560 | 7-SO₂CH₃ | CH(CH₃)CH₂SCH₃ | H | H | Ph-4-CF₃ | |
| 3-2561 | 7-SO₂CH₃ | CH(CH₃)CH₂SOCH₃ | H | H | Ph-4-CF₃ | |
| 3-2562 | 7-SO₂CH₃ | CH(CH₃)CH₂SO₂CH₃ | H | H | Ph-4-CF₃ | |
| 3-2563 | 7-SO₂CH₃ | CH(CH₃)₂ | F | CF₃ | | |
| 3-2564 | 7-SO₂CH₃ | C(CH₃)₂CH₂SCH₃ | F | F | CF₃ | |
| 3-2565 | 7-SO₂CH₃ | C(CH₃)₂CH₂SOCH₃ | F | F | CF₃ | |
| 3-2566 | 7-SO₂CH₃ | C(CH₃)₂CH₂SO₂CH₃ | F | F | CF₃ | |
| 3-2567 | 7-SO₂CH₃ | CH(CH₃)CH₂SCH₃ | F | F | CF₃ | |
| 3-2568 | 7-SO₂CH₃ | CH(CH₃)CH₂SOCH₃ | F | F | CF₃ | |
| 3-2569 | 7-SO₂CH₃ | CH(CH₃)CH₂SO₂CH₃ | F | F | CF₃ | |
| 3-2570 | 7-SO₂CH₃ | CH(CH₃)₂ | CH₃ | H | COH(CF₃)₂ | |
| 3-2571 | 7-SO₂CH₃ | C(CH₃)₂CH₂SCH₃ | CH₃ | H | COH(CF₃)₂ | |
| 3-2572 | 7-SO₂CH₃ | C(CH₃)₂CH₂SOCH₃ | CH₃ | H | COH(CF₃)₂ | |
| 3-2573 | 7-SO₂CH₃ | C(CH₃)₂CH₂SO₂CH₃ | CH₃ | H | COH(CF₃)₂ | |
| 3-2574 | 7-SO₂CH₃ | CH(CH₃)CH₂SCH₃ | CH₃ | H | COH(CF₃)₂ | |
| 3-2575 | 7-SO₂CH₃ | CH(CH₃)CH₂SOCH₃ | CH₃ | H | COH(CF₃)₂ | |
| 3-2576 | 7-SO₂CH₃ | CH(CH₃)CH₂SO₂CH₃ | CH₃ | H | COH(CF₃)₂ | |
| 3-2577 | 4-OSO₂CH₃ | CH(CH₃)₂ | CH₃ | H | CF(CF₃)₂ | |
| 3-2578 | 4-OSO₂CH₃ | C(CH₃)₂CH₂SCH₃ | CH₃ | H | CF(CF₃)₂ | |
| 3-2579 | 4-OSO₂CH₃ | C(CH₃)₂CH₂SOCH₃ | CH₃ | H | CF(CF₃)₂ | |
| 3-2580 | 4-OSO₂CH₃ | C(CH₃)₂CH₂SO₂CH₃ | CH₃ | H | CF(CF₃)₂ | |
| 3-2581 | 4-OSO₂CH₃ | CH(CH₃)CH₂SCH₃ | CH₃ | H | CF(CF₃)₂ | |
| 3-2582 | 4-OSO₂CH₃ | CH(CH₃)CH₂SOCH₃ | CH₃ | H | CF(CF₃)₂ | |
| 3-2583 | 4-OSO₂CH₃ | CH(CH₃)CH₂SO₂CH₃ | CH₃ | H | CF(CF₃)₂ | |
| 3-2584 | 4-OSO₂CH₃ | CH(CH₃)₂ | H | H | CF(CF₃)₂ | |
| 3-2585 | 4-OSO₂CH₃ | C(CH₃)₂CH₂SCH₃ | H | H | CF(CF₃)₂ | |
| 3-2586 | 4-OSO₂CH₃ | C(CH₃)₂CH₂SOCH₃ | H | H | CF(CF₃)₂ | |
| 3-2587 | 4-OSO₂CH₃ | C(CH₃)₂CH₂SO₂CH₃ | H | H | CF(CF₃)₂ | |
| 3-2588 | 4-OSO₂CH₃ | CH(CH₃)CH₂SCH₃ | H | H | CF(CF₃)₂ | |
| 3-2589 | 4-OSO₂CH₃ | CH(CH₃)CH₂SOCH₃ | H | H | CF(CF₃)₂ | |
| 3-2590 | 4-OSO₂CH₃ | CH(CH₃)CH₂SO₂CH₃ | H | H | CF(CF₃)₂ | |
| 3-2591 | 4-OSO₂CH₃ | CH(CH₃)₂ | Cl | Cl | Cl | |
| 3-2592 | 4-OSO₂CH₃ | C(CH₃)₂CH₂SCH₃ | Cl | Cl | Cl | |
| 3-2593 | 4-OSO₂CH₃ | C(CH₃)₂CH₂SOCH₃ | Cl | Cl | Cl | |
| 3-2594 | 4-OSO₂CH₃ | C(CH₃)₂CH₂SO₂CH₃ | Cl | Cl | Cl | |
| 3-2595 | 4-OSO₂CH₃ | CH(CH₃)CH₂SCH₃ | Cl | Cl | Cl | |
| 3-2596 | 4-OSO₂CH₃ | CH(CH₃)CH₂SOCH₃ | Cl | Cl | Cl | |
| 3-2597 | 4-OSO₂CH₃ | CH(CH₃)CH₂SO₂CH₃ | Cl | Cl | Cl | |
| 3-2598 | 4-OSO₂CH₃ | CH(CH₃)₂ | CH₃ | H | OCF₃ | |
| 3-2599 | 4-OSO₂CH₃ | C(CH₃)₂CH₂SCH₃ | CH₃ | H | OCF₃ | |
| 3-2600 | 4-OSO₂CH₃ | C(CH₃)₂CH₂SOCH₃ | CH₃ | H | OCF₃ | |
| 3-2601 | 4-OSO₂CH₃ | C(CH₃)₂CH₂SO₂CH₃ | CH₃ | H | OCF₃ | |
| 3-2602 | 4-OSO₂CH₃ | CH(CH₃)CH₂SCH₃ | CH₃ | H | OCF₃ | |
| 3-2603 | 4-OSO₂CH₃ | CH(CH₃)CH₂SOCH₃ | CH₃ | H | OCF₃ | |
| 3-2604 | 4-OSO₂CH₃ | CH(CH₃)CH₂SO₂CH₃ | CH₃ | H | OCF₃ | |
| 3-2605 | 4-OSO₂CH₃ | CH(CH₃)₂ | Cl | H | Cl | |
| 3-2606 | 4-OSO₂CH₃ | C(CH₃)₂CH₂SCH₃ | Cl | H | Cl | |
| 3-2607 | 4-OSO₂CH₃ | C(CH₃)₂CH₂SOCH₃ | Cl | H | Cl | |
| 3-2608 | 4-OSO₂CH₃ | C(CH₃)₂CH₂SO₂CH₃ | Cl | H | Cl | |
| 3-2609 | 4-OSO₂CH₃ | CH(CH₃)CH₂SCH₃ | Cl | H | Cl | |
| 3-2610 | 4-OSO₂CH₃ | CH(CH₃)CH₂SOCH₃ | Cl | H | Cl | |
| 3-2611 | 4-OSO₂CH₃ | CH(CH₃)CH₂SO₂CH₃ | Cl | H | Cl | |
| 3-2612 | 4-OSO₂CH₃ | CH(CH₃)₂ | H | Cl | Cl | |
| 3-2613 | 4-OSO₂CH₃ | C(CH₃)₂CH₂SCH₃ | H | Cl | Cl | |
| 3-2614 | 4-OSO₂CH₃ | C(CH₃)₂CH₂SOCH₃ | H | Cl | Cl | |
| 3-2615 | 4-OSO₂CH₃ | C(CH₃)₂CH₂SO₂CH₃ | H | Cl | Cl | |
| 3-2616 | 4-OSO₂CH₃ | CH(CH₃)CH₂SCH₃ | H | Cl | Cl | |
| 3-2617 | 4-OSO₂CH₃ | CH(CH₃)CH₂SOCH₃ | H | Cl | Cl | |
| 3-2618 | 4-OSO₂CH₃ | CH(CH₃)CH₂SO₂CH₃ | H | Cl | Cl | |
| 3-2619 | 4-OSO₂CH₃ | CH(CH₃)₂ | Cl | Cl | H | |
| 3-2620 | 4-QSO₂CH₃ | C(CH₃)₂CH₂SCH₃ | Cl | Cl | H | |
| 3-2621 | 4-OSO₂CH₃ | C(CH₃)₂CH₂SOCH₃ | Cl | Cl | H | |
| 3-2622 | 4-OSO₂CH₃ | C(CH₃ | hCH₂SO₂CH₃Cl | Cl | H | |
| 3-2623 | 4-OSO₂CH₃ | CH(CH₃)CH₂SCH₃ | Cl | Cl | H | |
| 3-2624 | 4-OSO₂CH₃ | CH(CH₃)CH₂SOCH₃ | Cl | Cl | H | |
| 3-2625 | 4-OSO₂CH₃ | CH(CH₃)CH₂SO₂CH₃ | Cl | Cl | H | |
| 3-2626 | 4-OSO₂CH₃ | CH(CH₃)₂ | Cl | H | CF₃ | |
| 3-2627 | 4-OSO₂CH₃ | C(CH₃)₂CH₂SCH₃ | Cl | H | CF₃ | |
| 3-2628 | 4-OSO₂CH₃ | C(CH₃)₂CH₂SOCH₃ | Cl | H | CF₃ | |
| 3-2629 | 4-OSO₂CH₃ | C(CH₃)₂CH₂SO₂CH₃ | Cl | H | CF₃ | |
| 3-2630 | 4-OSO₂CH₃ | CH(CH₃)CH₂SCH₃ | Cl | H | CF₃ | |
| 3-2631 | 4-OSO₂CH₃ | CH(CH₃)CH₂SOCH₃ | Cl | H | CF₃ | |
| 3-2632 | 4-OSO₂CH₃ | CH(CH₃)CH₂SO₂CH₃ | Cl | H | CF₃ | |
| 3-2633 | 4-OSO₂CH₃ | CH(CH₃)₂ | Cl | H | CF₃ | |
| 3-2634 | 4-OSO₂CH₃ | C(CH₃)₂CH₂SCH₃ | Cl | H | CF₃ | |
| 3-2635 | 4-OSO₂CH₃ | C(CH₃)₂CH₂SOCH₃ | Cl | H | CF₃ | |
| 3-2636 | 4-OSO₂CH₃ | C(CH₃)₂CH₂SO₂CH₃ | Cl | H | CF₃ | |
| 3-2637 | 4-OSO₂CH₃ | CH(CH₃)CH₂SCH₃ | Cl | H | CF₃ | |
| 3-2638 | 4-OSO₂CH₃ | CH(CH₃)CH₂SOCH₃ | Cl | H | CF₃ | |
| 3-2639 | 4-OSO₂CH₃ | CH(CH₃)CH₂SO₂CH₃ | Cl | H | CF₃ | |
| 3-2640 | 4-OSO₂CH₃ | CH(CH₃)₂ | H | H | Cl | |
| 3-2641 | 4-OSO₂CH₃ | C(CH₃)₂CH₂SCH₃ | H | H | Cl | |
| 3-2642 | 4-OSO₂CH₃ | C(CH₃)₂CH₂SOCH₃ | H | H | Cl | |
| 3-2643 | 4-OSO₂CH₃ | C(CH₃)₂CH₂SO₂CH₃ | H | H | Cl | |
| 3-2644 | 4-OSO₂CH₃ | CH(CH₃)CH₂SCH₃ | H | H | Cl | |
| 3-2645 | 4-OSO₂CH₃ | CH(CH₃)CH₂SOCH₃ | H | H | Cl | |
| 3-2646 | 4-OSO₂CH₃ | CH(CH₃)CH₂SO₂CH₃ | H | H | Cl | |
| 3-2647 | 4-OSO₂CH₃ | CH(CH₃)₂ | CH₃ | H | Cl | |
| 3-2648 | 4-OSO₂CH₃ | C(CH₃)₂CH₂SCH₃ | CH₃ | H | Cl | |
| 3-2649 | 4-OSO₂CH₃ | C(CH₃)₂CH₂SOCH₃ | CH₃ | H | Cl | |
| 3-2650 | 4-OSO₂CH₃ | C(CH₃)₂CH₂SO₂CH₃ | CH₃ | H | Cl | |
| 3-2651 | 4-OSO₂CH₃ | CH(CH₃)CH₂SCH₃ | CH₃ | H | Cl | |
| 3-2652 | 4-OSO₂CH₃ | CH(CH₃)CH₂SOCH₃ | CH₃ | H | Cl | |
| 3-2653 | 4-OSO₂CH₃ | CH(CH₃)CH₂SO₂CH₃ | CH₃ | H | Cl | |
| 3-2654 | 4-OSO₂CH₃ | CH(CH₃)₂ | H | H | OCF₃ | |
| 3-2655 | 4-OSO₂CH₃ | C(CH₃)₂CH₂SCH₃ | H | H | OCF₃ | |
| 3-2656 | 4-OSO₂CH₃ | C(CH₃)₂CH₂SOCH₃ | H | H | OCF₃ | |
| 3-2657 | 4-OSO₂CH₃ | C(CH₃)₂CH₂SO₂CH₃ | H | H | OCF₃ | |
| 3-2658 | 4-OSO₂CH₃ | CH(CH₃)CH₂SCH₃ | H | H | OCF₃ | |
| 3-2659 | 4-CSO₂CH₃ | CH(CH₃)CH₂SOCH₃ | H | H | OCF₃ | |
| 3-2660 | 4-OSO₂CH₃ | CH(CH₃)CH₂SO₂CH₃ | H | H | OCF₃ | |
| 3-2661 | 4-OSO₂CH₃ | CH(CH₃)₂ | H | H | | |
| 3-2662 | 4-OSO₂CH₃ | C(CH₃)₂CH₂SCH₃ | H | H | CF₃ | |
| 3-2663 | 4-OSO₂CH₃ | C(CH₃)₂CH₂SOCH₃ | H | H | CF₃ | |
| 3-2664 | 4-OSO₂CH₃ | C(CH₃)₂CH₂SO₂CH₃ | H | H | CF₃ | |
| 3-2665 | 4-OSO₂CH₃ | CH(CH₃)CH₂SCH₃ | H | H | CF₃ | |
| 3-2666 | 4-OSO₂CH₃ | CH(CH₃)CH₂SOCH₃ | H | H | CF₃ | |
| 3-2667 | 4-OSO₂CH₃ | CH(CH₃)CH₂SO₂CH₃ | H | H | CF₃ | |
| 3-2668 | 4-OSO₂CH₃ | CH(CH₃)₂ | H | H | Ph-4-CF₃ | |
| 3-2669 | 4-OSO₂CH₃ | C(CH₃)₂CH₂SCH₃ | H | H | Ph-4-CF₃ | |
| 3-2670 | 4-OSO₂CH₃ | C(CH₃)₂CH₂SOCH₃ | H | H | Ph-4-CF₃ | |
| 3-2671 | 4-OSO₂CH₃ | C(CH₃)₂CH₂SO₂CH₃ | H | H | Ph-4-CF₃ | |
| 3-2672 | 4-OSO₂CH₃ | CH(CH₃)CH₂SCH₃ | H | H | Ph-4-CF₃ | |
| 3-2673 | 4-OSO₂CH₃ | CH(CH₃)CH₂SOCH₃ | H | H | Ph-4-CF₃ | |
| 3-2674 | 4-OSO₂CH₃ | CH(CH₃)CH₂SO₂CH₃ | H | H | Ph-4-CF₃ | |
| 3-2675 | 4-OSO₂CH₃ | CH(CH₃)₂ | F | F | CF₃ | |
| 3-2676 | 4-OSO₂CH₃ | C(CH₃)₂CH₂SCH₃ | F | F | CF₃ | |
| 3-2677 | 4-OSO₂CH₃ | C(CH₃)₂CH₂SOCH₃ | F | F | CF₃ | |
| 3-2678 | 4-OSO₂CH₃ | C(CH₃)₂CH₂SO₂CH₃ | F | F | CF₃ | |
| 3-2679 | 4-OSO₂CH₃ | CH(CH₃)CH₂SCH₃ | F | F | CF₃ | |
| 3-2680 | 4-OSO₂CH₃ | CH(CH₃)CH₂SOCH₃ | F | F | CF₃ | |
| 3-2681 | 4-OSO₂CH₃ | CH(CH₃)CH₂SO₂CH₃ | F | F | CF₃ | |
| 3-2682 | 4-OSO₂CH₃ | CH(CH₃)₂ | CH₃ | H | COH(CF₃)₂ | |
| 3-2683 | 4-OSO₂CH₃ | C(CH₃)₂CH₂SCH₃ | CH₃ | H | COH(CF₃)₂ | |
| 3-2684 | 4-OSO₂CH₃ | C(CH₃)₂CH₂SOCH₃ | CH₃ | H | COH(CF₃)₂ | |
| 3-2685 | 4-OSO₂CH₃ | C(CH₃)₂CH₂SO₂CH₃ | CH₃ | H | COH(CF₃)₂ | |
| 3-2686 | 4-OSO₂CH₃ | CH(CH₃)CH₂SCH₃ | CH₃ | H | COH(CF₃)₂ | |
| 3-2687 | 4-OSO₂CH₃ | CH(CH₃)CH₂SOCH₃ | CH₃ | H | COH(CF₃)₂ | |
| 3-2688 | 4-OSO₂CH₃ | CH(CH₃)CH₂SO₂CH₃ | CH₃ | H | COH(CF₃)₂ | |
| 3-2689 | 7-OSO₂CH₃ | CH(CH₃)₂ | CH₃ | H | CF(CF₃)₂ | |
| 3-2690 | 7-OSO₂CH₃ | C(CH₃)₂CH₂SCH₃ | CH₃ | H | CF(CF₃)₂ | |
| 3-2691 | 7-OSO₂CH₃ | C(CH₃)₂CH₂SOCH₃ | CH₃ | H | CF(CF₃)₂ | |
| 3-2692 | 7-OSO₂CH₃ | C(CH₃)₂CH₂SO₂CH₃ | CH₃ | H | CF(CF₃)₂ | |
| 3-2693 | 7-OSO₂CH₃ | CH(CH₃)CH₂SCH₃ | CH₃ | H | CF(CF₃)₂ | |
| 3-2694 | 7-OSO₂CH₃ | CH(CH₃)CH₂SOCH₃ | CH₃ | H | CF(CF₃)₂ | |
| 3-2695 | 7-OSO₂CH₃ | CH(CH₃)CH₂SO₂CH₃ | CH₃ | H | CF(CF₃)₂ | |
| 3-2696 | 7-OSO₂CH₃ | CH(CH₃)₂ | H | H | CF(CF₃)₂ | |
| 3-2697 | 7-OSO₂CH₃ | C(CH₃)₂CH₂SCH₃ | H | H | CF(CF₃)₂ | |
| 3-2698 | 7-OSO₂CH₃ | C(CH₃)₂CH₂SOCH₃ | H | H | CF(CF₃)₂ | |
| 3-2699 | 7-OSO₂CH₃ | C(CH₃)₂CH₂SO₂CH₃ | H | H | CF(CF₃)₂ | |
| 3-2700 | 7-OSO₂CH₃ | CH(CH₃)CH₂SCH₃ | H | H | CF(CF₃)₂ | |
| 3-2701 | 7-OSO₂CH₃ | CH(CH₃)CH₂SOCH₃ | H | H | CF(CF₃)₂ | |
| 3-2702 | 7-OSO₂CH₃ | CH(CH₃)CH₂SO₂CH₃ | H | H | CF(CF₃)₂ | |
| 3-2703 | 7-OSO₂CH₃ | CH(CH₃)₂ | Cl | Cl | Cl | |
| 3-2704 | 7-OSO₂CH₃ | C(CH₃)₂CH₂SCH₃ | Cl | Cl | Cl | |
| 3-2705 | 7-OSO₂CH₃ | C(CH₃)₂CH₂SOCH₃ | Cl | Cl | Cl | |
| 3-2706 | 7-OSO₂CH₃ | C(CH₃)₂CH₂SO₃CH₃ | Cl | Cl | Cl | |
| 3-2707 | 7-OSO₂CH₃ | CH(CH₃)CH₂SCH₃ | Cl | Cl | Cl | |
| 3-2708 | 7-OSO₂CH₃ | CH(CH₃)CH₂SOCH₃ | Cl | Cl | Cl | |
| 3-2709 | 7-OSO₂CH₃ | CH(CH₃)CH₂SO₂CH₃ | Cl | Cl | Cl | |
| 3-2710 | 7-OSO₂CH₃ | CH(CH₃)₂ | CH₃ | H | OCF₃ | |
| 3-2711 | 7-OSO₂CH₃ | C(CH₃)₂CH₂SCH₃ | CH₃ | H | OCF₃ | |
| 3-2712 | 7-OSO₂CH₃ | C(CH₃)₂CH₂SOCH₃ | CH₃ | H | OCF₃ | |
| 3-2713 | 7-OSO₂CH₃ | C(CH₃)₂CH₂SO₂CH₃ | CH₃ | H | OCF₃ | |
| 3-2714 | 7-OSO₂CH₃ | CH(CH₃)CH₂SCH₃ | CH₃ | H | OCF₃ | |
| 3-2715 | 7-OSO₂CH₃ | CH(CH₃)CH₂SOCH₃ | CH₃ | H | OCF₃ | |
| 3-2716 | 7-OSO₂CH₃ | CH(CH₃)CH₂SO₂CH₃ | CH₃ | H | OCF₃ | |
| 3-2717 | 7-OSO₂CH₃ | CH(CH₃)₂ | Cl | H | Cl | |
| 3-2718 | 7-OSO₂CH₃ | C(CH₃)₂CH₂SCH₃ | Cl | H | Cl | |
| 3-2719 | 7-OSO₂CH₃ | C(CH₃)₂CH₂SOCH₃ | Cl | H | Cl | |
| 3-2720 | 7-OSO₂CH₃ | C(CH₃)₂CH₂SO₂CH₃ | Cl | H | Cl | |
| 3-2721 | 7-OSO₂CH₃ | CH(CH₃)CH₂SCH₃ | Cl | H | Cl | |
| 3-2722 | 7-OSO₂CH₃ | CH(CH₃)CH₂SOCH₃ | Cl | H | Cl | |
| 3-2723 | 7-OSO₂CH₃ | CH(CH₃)CH₂SO₂CH₃ | Cl | H | Cl | |
| 3-2724 | 7-OSO₂CH₃ | CH(CH₃)₂ | H | Cl | Cl | |
| 3-2725 | 7-OSO₂CH₃ | C(CH₃)₂CH₂SCH₃ | H | Cl | Cl | |
| 3-2726 | 7-OSO₂CH₃ | C(CH₃)₂CH₂SOCH₃ | H | Cl | Cl | |
| 3-2727 | 7-OSO₂CH₃ | C(CH₃)₂CH₂SO₂CH₃ | H | Cl | Cl | |
| 3-2728 | 7-OSO₂CH₃ | CH(CH₃)CH₂SCH₃ | H | Cl | Cl | |
| 3-2729 | 7-OSO₂CH₃ | CH(CH₃)CH₂SOCH₃ | H | Cl | Cl | |
| 3-2730 | 7-OSO₂CH₃ | CH(CH₃)CH₂SO₂CH₃ | H | Cl | Cl | |
| 3-2731 | 7-OSO₂CH₃ | CH(CH₃)₂ | Cl | Cl | H | |
| 3-2732 | 7-OSO₂CH₃ | C(CH₃)₂CH₂SCH₃ | Cl | Cl | H | |
| 3-2733 | 7-OSO₂CH₃ | C(CH₃)₂CH₂SOCH₃ | Cl | Cl | H | |
| 3-2734 | 7-OSO₂CH₃ | C(CH₃)₂CH₂SO₂CH₃ | Cl | Cl | H | |
| 3-2735 | 7-OSO₂CH₃ | CH(CH₃)CH₂SCH₃ | Cl | Cl | H | |
| 3-2736 | 7-OSO₂CH₃ | CH(CH₃)CH₂SOCH₃ | Cl | Cl | H | |
| 3-2737 | 7-OSO₂CH₃ | CH(CH₃)CH₂SO₂CH₃ | Cl | Cl | H | |
| 3-2738 | 7-OSO₂CH₃ | CH(CH₃)₂ | Cl | H | CF₃ | |
| 3-2739 | 7-OSO₂CH₃ | C(CH₃)₂CH₂SCH₃ | Cl | H | CF₃ | |
| 3-2740 | 7-OSO₂CH₃ | C(CH₃)₂CH₂SOCH₃ | Cl | H | CF₃ | |
| 3-2741 | 7-OSO₂CH₃ | C(CH₃)₂CH₂SO₂CH₃ | Cl | H | CF₃ | |
| 3-2742 | 7-OSO₂CH₃ | CH(CH₃)CH₂SCH₃ | Cl | H | CF₃ | |
| 3-2743 | 7-OSO₂CH₃ | CH(CH₃)CH₂SOCH₃ | Cl | H | CF₃ | |
| 3-2744 | 7-OSO₂CH₃ | CH(CH₃)CH₂SO₂CH₃ | Cl | H | CF₃ | |
| 3-2745 | 7-OSO₂CH₃ | CH(CH₃)₂ | Cl | H | CF₃ | |
| 3-2746 | 7-OSO₂CH₃ | C(CH₃)₂CH₂SCH₃ | Cl | H | CF₃ | |
| 3-2747 | 7-OSO₂CH₃ | C(CH₃)₂CH₂SOCH₃ | Cl | H | CF₃ | |
| 3-2748 | 7-OSO₂CH₃ | C(CH₃)₂CH₂SO₂CH₃ | Cl | H | CF₃ | |
| 3-2749 | 7-OSO₂CH₃ | CH(CH₃)CH₂SCH₃ | Cl | H | CF₃ | |
| 3-2750 | 7-OSO₂CH₃ | CH(CH₃)CH₂SOCH₃ | Cl | H | CF₃ | |
| 3-2751 | 7-OSO₂CH₃ | CH(CH₃)CH₂SO₂CH₃ | Cl | H | CF₃ | |
| 3-2752 | 7-OSO₂CH₃ | CH(CH₃)₂ | H | H | Cl | |
| 3-2753 | 7-OSO₂CH₃ | C(CH₃)₂CH₂SCH₃ | H | H | Cl | |
| 3-2754 | 7-OSO₂CH₃ | C(CH₃)₂CH₂SOCH₃ | H | H | Cl | |
| 3-2755 | 7-OSO₂CH₃ | C(CH₃)₂CH₂SO₂CH₃ | H | H | Cl | |
| 3-2756 | 7-OSO₂CH₃ | CH(CH₃)CH₂SCH₃ | H | H | Cl | |
| 3-2757 | 7-OSO₂CH₃ | CH(CH₃)CH₂SOCH₃ | H | H | Cl | |
| 3-2758 | 7-OSO₂CH₃ | CH(CH₃)CH₂SO₂CH₃ | H | H | Cl | |
| 3-2759 | 7-OSO₂CH₃ | CH(CH₃)₂ | CH₃ | H | Cl | |
| 3-2760 | 7-OSO₂CH₃ | C(CH₃)₂CH₂SCH₃ | CH₃ | H | Cl | |
| 3-2761 | 7-OSO₂CH₃ | C(CH₃)₂CH₂SOCH₃ | CH₃ | H | Cl | |
| 3-2762 | 7-OSO₂CH₃ | C(CH₃)₂CH₂SO₂CH₃ | CH₃ | H | Cl | |
| 3-2763 | 7-OSO₂CH₃ | CH(CH₃)CH₂SCH₃ | CH₃ | H | Cl | |
| 3-2764 | 7-OSO₂CH₃ | CH(CH₃)CH₂SOCH₃ | CH₃ | H | Cl | |
| 3-2765 | 7-OSO₂CH₃ | CH(CH₃)CH₂SO₂CH₃ | CH₃ | H | Cl | |
| 3-2766 | 7-OSO₂CH₃ | CH(CH₃)₂ | H | H | OCF₃ | |
| 3-2767 | 7-OSO₂CH₃ | C(CH₃)₂CH₂SCH₃ | H | H | OCF₃ | |
| 3-2768 | 7-OSO₂CH₃ | C(CH₃)₂CH₂SOCH₃ | H | H | OCF₃ | |
| 3-2769 | 7-OSO₂CH₃ | C(CH₃)₂CH₂SO₂CH₃ | H | H | OCF₃ | |
| 3-2770 | 7-OSO₂CH₃ | CH(CH₃)CH₂SCH₃ | H | H | OCF₃ | |
| 3-2771 | 7-OSO₂CH₃ | CH(CH₃)CH₂SOCH₃ | H | H | OCF₃ | |
| 3-2772 | 7-OSO₂CH₃ | CH(CH₃)CH₂SO₂CH₃ | H | H | OCF₃ | |
| 3-2773 | 7-OSO₂CH₃ | CH(CH₃)₂ | H | H | CF₃ | |
| 3-2774 | 7-OSO₂CH₃ | C(CH₃)₂CH₂SCH₃ | H | H | CF₃ | |
| 3-2775 | 7-OSO₂CH₃ | C(CH₃)₂CH SOCH₃ | H | H | CF₃ | |
| 3-2776 | 7-OSO₂CH₃ | C(CH₃)₂CH₂SO₂CH₃ | H | H | CF₃ | |
| 3-2777 | 7-OSO₂CH₃ | CH(CH₃)CH₂SCH₃ | H | H | CF₃ | |
| 3-2778 | 7-OSO₂CH₃ | CH(CH₃)CH₂SOCH₃ | H | H | CF₃ | |
| 3-2779 | 7-OSO₂CH₃ | CH(CH₃)CH₂SO₂CH₃ | H | H | CF₃ | |
| 3-2780 | 7-OSO₂CH₃ | CH(CH₃)₂ | H | H | Ph-4-CF₃ | |
| 3-2781 | 7-OSO₂CH₃ | C(CH₃)₂CH₂SCH₃ | H | H | Ph-4-CF₃ | |
| 3-2782 | 7-OSO₂CH₃ | C(CH₃)₂CH₂SOCH₃ | H | H | Ph-4-CF₃ | |
| 3-2783 | 7-OSO₂CH₃ | C(CH₃)₂CH₂SO₂CH₃ | H | H | Ph-4-CF₃ | |
| 3-2784 | 7-OSO₂CH₃ | CH(CH₃)CH₂SCH₃ | H | H | Ph-4-CF₃ | |
| 3-2785 | 7-OSO₂CH₃ | CH(CH₃)CH₂SOCH₃ | H | H | Ph-4-CF₃ | |
| 3-2786 | 7-OSO₂CH₃ | CH(CH₃)CH₂SO₂CH₃ | H | H | Ph-4-CF₃ | |
| 3-2787 | 7-OSO₂CH₃ | CH(CH₃)₂ | F | F | CF₃ | |
| 3-2788 | 7-OSO₂CH₃ | C(CH₃)₂CH₂SCH₃ | F | F | CF₃ | |
| 3-2789 | 7-OSO₂CH₃ | C(CH₃)₂CH₂SOCH₃ | F | F | CF₃ | |
| 3-2790 | 7-OSO₂CH₃ | C(CH₃)₂CH₂SO₂CH₃ | F | F | CF₃ | |
| 3-2791 | 7-OSO₂CH₃ | CH(CH₃)CH₂SCH₃ | F | F | CF₃ | |
| 3-2792 | 7-OSO₂CH₃ | CH(CH₃)CH₂SOCH₃ | F | F | CF₃ | |
| 3-2793 | 7-OSO₂CH₃ | CH(CH₃)CH₂SO₂CH₃ | F | F | CF₃ | |
| 3-2794 | 7-OSO₂CH₃ | CH(CH₃)₂ | CH₃ | H | COH(CF₃)₂ | |
| 3-2795 | 7-OSO₂CH₃ | C(CH₃)₂CH₂SCH₃ | CH₃ | H | COH(CF₃)₂ | |
| 3-2796 | 7-OSO₂CH₃ | C(CH₃)₂CH₂SOCH₃ | CH₃ | H | COH(CF₃)₂ | |
| 3-2797 | 7-OSO₂CH₃ | C(CH₃)₂CH₂SO₂CH₃ | CH₃ | H | COH(CF₃)₂ | |
| 3-2798 | 7-OSO₂CH₃ | CH(CH₃)CH₂SCH₃ | CH₃ | H | COH(CF₃)₂ | |
| 3-2799 | 7-OSO₂CH₃ | CH(CH₃)CH₂SOCH₃ | CH₃ | H | COH(CF₃)₂ | |
| 3-2800 | 7-OSO₂CH₃ | CH(CH₃)CH₂SO₂CH₃ | CH₃ | H | COH(CF₃)₂ | |

TABLE 4

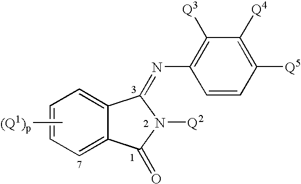

| | | | | | | mp |
|---|---|---|---|---|---|---|
| Comp. | | | | | | (° C.) |
| No. | (Q¹)ₚ | Q² | Q³ | Q⁴ | Q⁵ | or n_{D}²⁰ |
| 4-1 | 7-Cl | CH(CH₃)₂ | CH₃ | H | CF(CF₃)₂ | 91-93 |
| 4-2 | 7-Cl | CH(CH₃)CH₂SO₂CH₃ | CH₃ | H | CF(CF₃)₂ | 82-85 |

TABLE 5

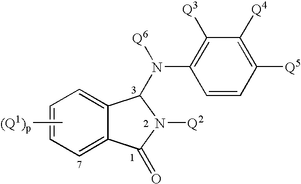

| Comp. No. | (Q¹)ₚ | Q² | Q³ | Q⁴ | Q⁵ | Q⁶ | mp (° C.) or n_{D}²⁰ |
|---|---|---|---|---|---|---|---|
| 5-1 | 7-Cl | CH(CH₃)CH₂SCH₃ | CH₃ | H | CF(CF₃)₂ | CH₃ | |
| 5-2 | 7-Cl | CH(CH₃)CH₂SO₂CH₃ | CH₃ | H | CF(CF₃)₂ | CH₃ | |
| 5-3 | 7-Cl | CH(CH₃)CH₂SCH₃ | CH₃ | H | CF(CF₃)₂ | CH₂CH₃ | 57-61 |
| 5-4 | 7-Cl | CH(CH₃)CH₂SO₂CH₃ | CH₃ | H | CF(CF₃)₂ | CH₂CH₃ | 160-166 |

### SYNTHESIS EXAMPLE 7

### Preparation of Intermediate

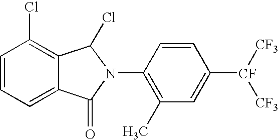

4-Chloro-3-[2-methyl-4-(1,2,2,2-tetrafluoro-1-trifluoromethylethyl)phenylamino]-3H-isobenzofuran-1-one (1.9 g) was refluxed in the presence of thionyl chloride (10 g) for 3 hours. After naturally cooling the reaction mixture, the excess of thionyl chloride was distilled off under reduced pressure, and further, the operation of adding toluene and distilling off under reduced pressure was repeated three times to obtain 3,4-dichloro-2-[2-methyl-4-(1,2,2,2-tetrafluoro-1-trifluoromethylethyl)phenyl]-2,3-dihydroisoindol-1-one (2.0 g). It was used for the next reaction without further purification.

### SYNTHESIS EXAMPLE 8

### Preparation of Intermediate

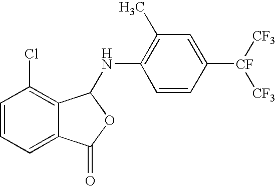

A methanol solution of 4-chloro-3-hydroxy-3H-isobenzofuran-1-one (1.0 g) and 2-methyl-4-(1,2,2,2-tetrafluoro-1-trifluoromethylethyl)phenylamine (1.6 g) was refluxed for 16 hours. After naturally cooling the reaction mixture to room temperature, the solvent was distilled off under reduced pressure. The residue was filtered off while washing with a mixed solvent of hexane and ether to obtain 4-chloro-3-[2-methyl-4-(1,2,2,2-tetrafluoro-1-trifluoromethylethyl)phenylamino]-3H-isobenzofuran-1-one (1.9 g, mp 229-231° C.).

### SYNTHESIS EXAMPLE 9

### Preparation of Intermediate

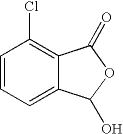

A tetrahydrofuran solution of 2-(3-chlorophenyl)-[1,3]dioxolane (17 g) was cooled to −78° C. and tetrahydrofuran solution of sec-butyl lithium (1 mol/l in THF, 96 ml) was added thereto dropwise. The reaction solution was added to a tetrahydrofuran solution filled with dry ice and the mixture was stirred until it warmed up to room temperature. After finishing the reaction the solvent was distilled off. After addition of 6N aqueous solution of hydrochloric acid, the reaction solution was stirred at room temperature for 8 hours and at 80° C. for 1 hour. The reaction solution was extracted with ethyl acetate, washed with water and then with saturated aqueous solution of sodium chloride, and dried with anhydrous sodium sulfate. After the solvent was distilled off, the residue was purified by silica gel column chromatography (hexane:ethyl acetate=2:1→1:1) to obtain 7-chloro-3-hydroxy-3H-isobenzofuran-1-one (3.6 g, mp 140-145° C.).

### SYNTHESIS EXAMPLE 10

### Preparation of Intermediate

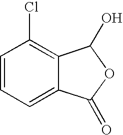

A tetrahydrofuran solution of 3-chloro-N,N-diethylbenzamide (5.0 g) and N,N,N′,N′-tetramethyl-ethylenediamine (3.0 g) was cooled to −78° C. and tetrahydrofuran solution of sec-butyl lithium (1 mol/l in THF, 26 ml) was added thereto dropwise. After stirring the reaction solution at −78° C. for 1 hour, a tetrahydrofuran solution of N,N-dimethylformamide (7.4 g) was added and stirred until it warmed up to room temperature. After finishing the reaction, the reaction solution was, after addition of 1N aqueous solution of hydrochloric acid, extracted with ethyl acetate and the solvent was distilled off to obtain 4-chloro-3-hydroxy-3H-isobenzofuran-1-one (2.8 g, mp. 120-122° C.).

### SYNTHESIS EXAMPLE 11

### Preparation of Intermediate

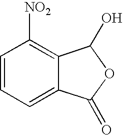

3-Methoxy-4nitro-3H-isobenzofuran-1-one (3.1 g) was suspended in 6N aqueous solution of hydrochloric acid and refluxed for 3 hours. After cooling to room temperature and diluted with water, the reaction mixture was extracted with ethyl acetate. After the solvent was distilled off, the residue was purified by silica gel column chromatography (hexane:ethyl acetate=2:1→1:1) to obtain 3-hydroxy-4-nitro-3H-isobenzofuran-1-one (2.0 g, mp. 153-156° C.).

### SYNTHESIS EXAMPLE 12

### Preparation of Intermediate

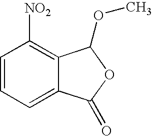

To an anhydrous methanol solution of methyl 2-bromomethyl-3-nitrobenzoate (13.5 g) and 2-nitropropane (4.6 g) an anhydrous methanol solution of sodium methoxide (9.5 g) was added and refluxed for 4 hours. After cooling the reaction mixture to room temperature, the solvent was distilled off under reduced pressure. The residue was washed with water and filtered off. The obtained precipitation was dried to obtain 3-methoxy-4-nitro-3H-isobenzofuran-1-one (10 g, mp. 115-118° C.).

### SYNTHESIS EXAMPLE 13

### Preparation of Intermediate

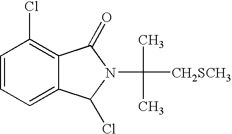

7-Chloro-2-(1,1-dimethyl-2-methylthioethyl)-3-hydroxy-2,3-dihydroindol-1-one (0.8 g) and thionyl chloride (1.7 g) were refluxed in ethyl acetate for 3 hours. After finishing the reaction, the solvent was distilled off to obtain 3,7-dichloro-2-(1,1-dimethyl-2-methylthioethyl)-2,3-dihydroindol-1-one (0.9 g). It was used for the next reaction without further purification.

### SYNTHESIS EXAMPLE 14

### Preparation of Intermediate

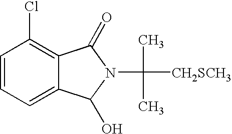

2-Chloro-N-(1,1-dimethyl-2-methylthioethyl)benzamide (1.8 g) and N,N,N′,N′-tetramethylethylenediamine (1.8 g) were dissolved in anhydrous THF and 1 mol tetrahydrofuran solution of sec-butyl lithium (15 ml) was added thereto dropwise at −78° C. and the reaction solution was stirred for 1 hour at the same temperature. After addition of N,N-dimethylformamide (1.1 g) the reaction solution was warmed up to room temperature while stirring. After finishing the reaction, the reaction solution was, after addition of 1N aqueous solution of hydrochloric acid, extracted with ethyl acetate. The organic layer was washed with water and then with saturated aqueous solution of sodium chloride and dried with anhydrous sodium sulfate. After the solvent was distilled off, the obtained residue was purified by silica gel column chromatography (eluted with hexane, ethyl acetate) to obtain 7-chloro-2-1,1-dimethyl-2-methylthioethyl)-3-hydroxy-2,3-dihydroindol-1-one (1.5 g, mp. 141-142° C.).

### SYNTHESIS EXAMPLE 15

### Preparation of Intermediate

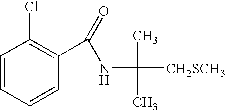

2-Chlorobenzoyl chloride (3.0 g) and 1,1-dimethyl-2-methylthioethyl-amine (2.0 g) were stirred at room temperature for 4 hours in dichloromethane in the presence of triethylamine (2.6 g). After finishing the reaction, the organic layer was washed with water and then with saturated aqueous solution of sodium chloride and dried with anhydrous sodium sulfate. After the solvent was distilled off, the obtained residue was purified by silica gel column chromatography (eluted with hexane, ethyl acetate) to obtain 2-chloro-N-(1,1-dimethyl-2-methylthioethyl)benzamide (4.0 g, mp. 83-86° C.).#

### SYNTHESIS EXAMPLE 16

### Preparation of Intermediate

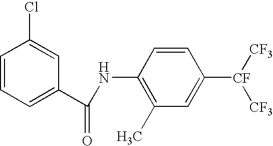

3-Chlorobenzoic acid (1.0 g), 2-methyl-4-(1,2,2,2-tetrafluoro-1-trifluoromethylethyl)aniline (1.8 g) and 4-dimethylaminopyridine (0.2 g) were stirred at room temperature for 2 days in dichloroethane in the presence of N-(3-dimethylaminopropyl)-N′-ethylcarbodiimide hydrochloride (1.8 g). After finishing the reaction, the organic layer was washed with water and then with saturated aqueous solution of sodium chloride and dried with anhydrous sodium sulfate. After the solvent was distilled off, the obtained residue was purified by silica gel column chromatography (eluted with hexane, ethyl acetate) to obtain 3-chloro-N-[2-methyl-4-1,2,2,2-tetrafluoro-1-trifluoromethylethyl)phenyl]-benzamide (2.5 g, mp. 74-76° C.).

### SYNTHESIS EXAMPLE 17

### Preparation of Intermediate

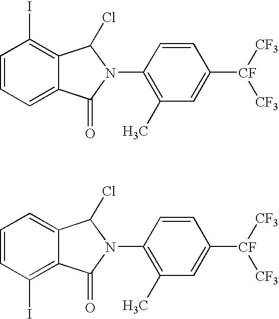

A one-to-one mixture of 3-hydroxy-4-iodo-2-[2-methyl-4-(1,2,2,2-tetrafluoro-1-trifluoromethylethyl)phenyl]-2,3-dihydro-isoindol-1-one and 3-hydroxy-7-iodo-2-[2-methyl-4-(1,2,2,2-tetrafluoro-1-trifluoromethylethyl)-phenyl]-2,3-dihydroisoindol-1-one (5.5 g) and thionyl chloride (2.5 g) was refluxed for 3 hours in dichloroethane in the presence of a catalytic amount of N,N-dimethylformamide. After finishing the reaction, the solvent was distilled off to obtain a mixture of 3-chloro-4-iodo-2-[2-methyl-4-(1,2,2,2-tetrafluoro-1-trifluoromethylethyl)phenyl]-2,3-dihydroisoindol-1-one and 3-chloro-7-iodo-2-[2-methyl-4-(1,2,2,2-tetrafluoro-1-trifluoromethylethyl)phenyl]-2,3-dihydro-isoindol-1-one (5.6 g). The mixture was used for the next reaction without further purification.

### SYNTHESIS EXAMPLE 18

### Preparation of Intermediate

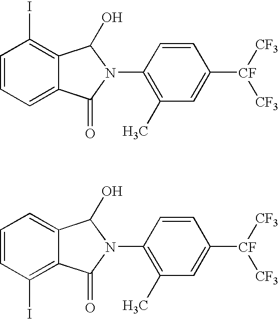

4-Iodo-2-[2-methyl-4-(1,2,2,2-tetrafluoro-1-trifluoromethylethyl)-phenyl]isoindol-1,3-dione (5.4 g) was stirred in methanol (150 ml) at 0° C. and sodium borohydride (0.2 g) was slowly added thereto. After stirring the reaction solution at room temperature for 8 hours, the reaction was finished by addition of water. The solvent was distilled off under reduced pressure and the obtained residue was dissolved in ethyl acetate. The organic layer was washed with water and then with saturated aqueous solution of sodium chloride and dried with anhydrous sodium sulfate, and the solvent was distilled off to obtain a mixture of 3-hydroxy-4-iodo-2-[2-methyl-4-(1,2,2,2-tetrafluoro-1-trifluoromethyl-ethyl)-phenyl]-2,3-dihydroisoindol-1-one and 3-hydroxy-7-iodo-2-[2-methyl-4-(1,2,2,2-tetrafluoro-1-trifluoromethylethyl)-phenyl]-2,3-dihydroisoindol-1-one (5.1 g). The mixture was used for the next reaction without further separation and purification.

### BIOLOGICAL TEST EXAMPLE 1

### Test Against Larva of Spodoptera litura

Preparation of Test Solution:

Solvent: Dimethylformamide 3 parts by weight

Emulsifier: Polyoxyethylene alkyl phenyl ether 1 part by weight

In order to make an appropriate formulation of an active compound, 1 part by weight of the active compound was mixed with the above-mentioned amount of solvent containing the above-mentioned amount of emulsifier and the mixture was diluted with water to a prescribed concentration.

Test Method:

Leaves of sweet potato were soaked in the test solution diluted to a prescribed concentration with water, dried in the air and put in a dish of 9 cm diameter. 10 larvae of Spodoptera litura at the third instar were placed on the leaves and kept in a room at the constant temperature of 25° C. After 2 and 4 days further leaves of sweet potato were added and after 7 days the number of dead larvae was counted and the rate of death was calculated.

In this test the results of 2 dishes at 1 section were averaged.

Test Results

As specific examples the compounds of the compound no. 1-34, 1-35, 1-36, 1-50, 1-55, 1-57, 2-29, 2-32, 2-35, 2-141, 2-144, 2-172, 3-119, 3-225, 3-226, 3-228, 3-229, 3-231, 3-677 and 3-679 showed 100% of rate of death at 20 ppm concentration of the effective component.

### FORMULATION EXAMPLE 1

### Granule

To a mixture of 10 parts of the compound of the present invention (1-34), 30 parts of bentonite (montmorillonite), 58 parts of talc and 2 parts of ligninsulfonate salt, 25 parts of water are added, well kneaded, made into granules of 10 to 40 mesh by an extrusion granulator and dried at 40 to 50° C. to obtain granules.

### FORMULATION EXAMPLE 2

### Granules

95 Parts of clay mineral particles having particle diameter distribution in the range of 0.2-2 mm are put in a rotary mixer. While rotating it, 5 parts of the compound of the present invention (1-34) are sprayed together with a liquid diluent, wetted uniformly and dried at 40 to 50° C. to obtain granules.

### FORMULATION EXAMPLE 3

### Emulsifiable Concentrate

30 Parts of the compound of the present invention (1-34), 55 parts of xylene, 8 parts of polyoxyethylene alkyl phenyl ether and 7 parts of calcium alkylbenzenesulfonate are mixed and stirred to obtain an emulsifiable concentrate.

### FORMULATION EXAMPLE 4

### Wettable Powder

15 Parts of the compound of the present invention (1-34), 80 parts of a mixture of white carbon (hydrous amorphous silicon oxide fine powders) and powder clay (1:5), 2 parts of sodium alkylbenzenesulfonate and 3 parts of sodium alkylnaphthalenesulfonate-formalin-condensate are crushed and mixed to make a wettable powder.

### FORMULATION EXAMPLE 5

### Water Dispersible Granule

20 Parts of the compound of the present invention (1-34), 30 parts of sodium ligninsulfonate, 15 parts of bentonite and 35 parts of calcined diatomaceous earth powder are well mixed, added with water, extruded with 0.3 mm screen and dried to obtain water dispersible granules.

1-10. (canceled)

11. A method for combating insects comprising allowing to act on insects and/or their habitat an isoindolinone of formula (I) 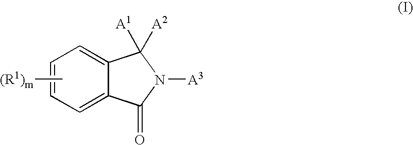
wherein
A¹ represents hydrogen, and
A² represents one of the groups 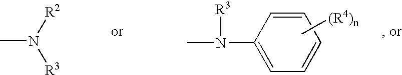
A¹ and A² together form one of the groups 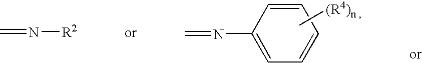
A³ represents —R² or the group 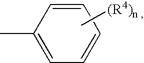
R¹ represents halogen, alkyl, alkoxy, alkylthio, alkylsulfonyl, alkylsulfonyloxy, haloalkyl, haloalkoxy, or nitro,
m represents 0, 1, 2, 3, or 4, with the proviso that R¹ may be identical or different when m represents 2, 3, or 4,
R² represents alkyl that is optionally substituted by alkylthio, alkylsulfinyl, or alkylsulfonyl,
R³ represents hydrogen or alkyl,
R⁴ represents halogen, alkyl, haloalkyl that is optionally substituted by hydroxy, haloalkoxy, or phenyl that is optionally substituted by haloalkyl, and
n represents 0, 1, 2, 3, or 4, with the proviso that R⁴ may be identical or different when n represents 2, 3, or 4.

12. An isoindolinone of formula (IA) 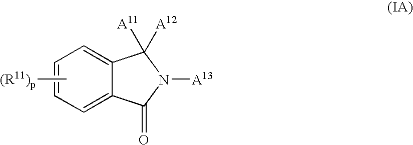
wherein
A¹¹ represents hydrogen, and
A¹² represents one of the groups 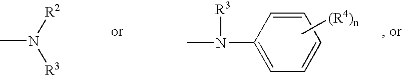
A^{11 and A}¹² together form one of the groups 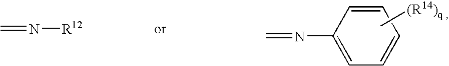
A¹³ represents —R¹² or the group 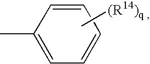
R¹¹ represents halogen, alkyl, alkoxy, alkylthio, alkylsulfonyl, alkylsulfonyloxy, haloalkyl, haloalkoxy, or nitro,
p represents 0, 1, 2, 3, or 4, with the proviso that R¹¹ may be identical or different when p represents 2, 3, or 4,
R¹² represents alkyl that is optionally substituted by alkylthio, alkylsulfinyl, or alkylsulfonyl,
R¹³ represents hydrogen or alkyl,
R¹⁴ represents halogen, alkyl, haloalkyl that is optionally substituted by hydroxy, haloalkoxy, or phenyl that is optionally substituted by haloalkyl,
q represents 0, 1, 2, 3, or 4, with the proviso that R¹⁴ may be identical or different when q represents 2, 3, or 4,
with the exception of the isoindolinones of formula (IA) in which
(E-1) A¹¹ represents hydrogen,
A¹² represents anilino,
A¹³ represents tert-butyl, and
p represents 0,
(E-2) A¹¹ represents hydrogen,
A¹² represents 2-fluoro-4-methylanilino or 3-trifluoromethylanilino, and
A¹³ represents n-butyl or 3-methylbutyl,
(E-3) A¹¹ represents hydrogen,
A¹² represents the group —NH—R¹²,
A¹³ represents —R¹²,
R¹² represents at the same time ethyl, iso-propyl, n-butyl, 1-methyl-n-hexyl, or n-dodecyl, and
p represents 0,
(E-4) A¹¹ represents hydrogen,
A¹² represents tert-butylamino or diethylamino,
A¹³ represents methyl, and
p represents 0,
(E-5) A¹¹ represents hydrogen,
A¹² represents anilino or 2-methylanilino,
A¹³ represents phenyl, and
p represents 0,
(E-6) A¹¹ and A¹² together form methylimino or ethylimino,
A¹³ represents 2,6-di(isopropyl)phenyl, and
p represents 0,
(E-7) A¹¹ and A¹² together form the group ═N-alkyl,
A¹³ represents 2,6-diethylphenyl, and
p represents 0 or p represents 1 and R¹¹ represents lower alkyl,
(E-8) A¹¹ and A¹² together form phenylimino,
A¹³ represents methyl or n-propyl, and
p represents 0,
(E-9) A¹¹ and A¹² together represent the group ═N—R¹²,
A¹³ represents —R¹²,
R¹² represents at the same time C₁₋₅-alkyl, and
p represents 0,
(E-10) A¹¹ and A¹² together form 4-methylanilino,
A¹³ represents anilino or 4-methylanilino, and
p represents 0, or
(E-1 1) A¹¹ and A¹² together form the group 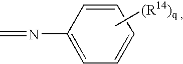
A¹³ represents the group 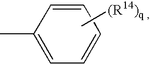
R¹⁴ each independently represents methyl or chloro,
q represents 0 or 1, and
p represents 1 and R¹¹ represents chloro or bromo.

13. An isoindolinone of formula (IA) according to claim 12
in which
A¹¹ represents hydrogen, and
A¹² represents one of the following groups 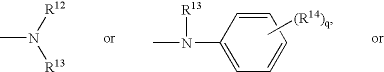
A¹¹ and A¹² together form one of the following groups 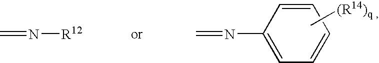
A¹³ represents —R¹² or the group 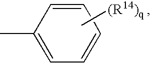
R¹¹ represents fluoro, chloro, bromo, iodo, C₁₋₄-alkyl, C₁₋₄-alkoxy, C₁₋₄-alkylthio, C₁₋₄-alkylsulfonyl, C₁₋₄-alkylsulfonyloxy, C₁₋₄-haloalkyl, C₁₋₄-haloalkoxy, or nitro,
p represents 0, 1, 2, 3, or 4, with the proviso that R¹¹ may be identical or different when p represents 2, 3, or 4,
R¹² represents C₁₋₆-alkyl which is optionally substituted by C₁₋₄-alkylthio, C₁₋₄-alkylsulfinyl, or C₁₋₄-alkylsulfonyl,
R¹³ represents hydrogen or C₁₋₆-alkyl,
R¹⁴ represents fluoro, chloro, C₁₋₄-alkyl, C₁₋₄-haloalkyl that is optionally substituted by hydroxy, C₁₋₄-haloalkoxy, or phenyl that is optionally substituted by C₁₋₄-haloalkyl,
q represents 0, 1, 2, 3, or 4, with the proviso that R¹⁴ may be identical or different when q represents 2, 3, or 4,
with the exception of the isoindolinones of formula (IA) in which
(E-1) A¹¹ represents hydrogen,
A¹² represents anilino,
A¹³ represents tert-butyl, and
p represents 0,
(E-2) A¹¹ represents hydrogen,
A¹² represents 2-fluoro-4-methylanilino or 3-trifluoromethylanilino, and
A¹³ represents n-butyl or 3-methylbutyl,
(E-3) A¹¹ represents hydrogen,
A¹² represents the group —NH—R¹²,
A¹³ represents —R¹²,
R¹² represents at the same time ethyl, iso-propyl, or n-butyl, and
p represents 0,
(E-4) A¹¹ represents hydrogen,
A¹² represents tert-butylamino or diethylamino,
A¹³ represents methyl, and
p represents 0,
(E-5) A¹¹ represents hydrogen,
A¹² represents anilino or 2-methylanilino,
A¹³ represents phenyl, and
p represents 0,
(E-6) A¹¹ and A¹² together form methylimino or ethylimino,
A¹³ represents 2,6-di(isopropyl)phenyl, and
p represents 0,
(E-7) A¹¹ and A¹² together represent group ═N—C₁₋₆-alkyl,
A¹³ represents 2,6-diethylphenyl, and
p represents 0 or p represents 1 and R¹¹ represents C₁₋₄-alkyl,
(E-8) A¹¹ and A¹² together form phenylimino,
A¹³ represents methyl or n-propyl, and
p represents 0,
(E-9) A¹¹ and A¹² together represent the group ═N—R¹²,
A¹³ represents —R¹²,
R¹² represents at the same time C₁₋₅-alkyl, and
p represents 0,
(E-10) A¹¹ and A¹² together form 4-methylanilino,
A¹³ represents anilino or 4-methylanilino, and
p represents 0, or
(E-11) A¹¹ and A¹² together form the group 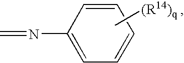
A¹³ represents the group 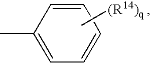
R¹⁴ each independently represents methyl or chloro,
q represents 0 or 1, and
p represents 1 and R¹¹ represents chloro or bromo.

14. An isoindolinone of formula (IA) according to claim 12
in which
A¹¹ represents hydrogen, and
A¹² represents one of the groups 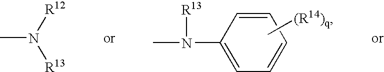
A¹¹ and A¹² together form one of the groups 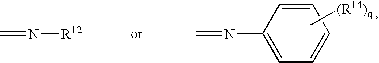
A¹³ represents —R¹² or the group 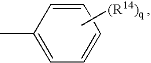
R¹¹ represents fluoro, chloro, bromo, iodo, methyl, methoxy, methylthio, methylsulfonyl, methylsulfonyloxy, trifluoromethyl, trifluoromethoxy, or nitro,
p represents 0, 1, or 2, with the proviso that R¹¹ may be identical or different when p represents 2,
R¹² represents iso-propyl, 1-methyl-2-(methylthio)ethyl, 1,1-dimethyl-2-(methyl-thio)ethyl, 1-methyl-2-(methylsulfinyl)ethyl, 1,1-dimethyl-2-(methylsulfinyl)-ethyl, 1-methyl-2-(methylsulfonyl)ethyl, 1,1-dimethyl-2-(methylsulfonyl)ethyl,
R¹³ represents hydrogen or methyl,
R¹⁴ represents fluoro, chloro, methyl, trifluoromethyl, perfluoroisopropyl, or trifluoromethoxy,
q represents 0, 1, 2, or 3, with the proviso that R¹⁴ may be identical or different when q represents 2 or 3,
with the exception of the isoindolinones of formula (IA) in which
(E-3) A¹¹ represents hydrogen,
A¹² represents the group —NH—R¹²,
A¹³ represents —R¹²,
R¹² represents at the same time iso-propyl, and
p represents 0,
(E-5) All represents hydrogen,
A¹² represents anilino or 2-methylanilino,
A¹³ represents phenyl, and
p represents 0,
(E-9) A¹¹ and A¹² together represent the group ═N—R¹²,
A¹³ represents —R¹²,
R¹² represents at the same time iso-propyl, and
p represents 0,
(E-10) A¹¹ and A¹² together form 4-methylanilino,
A¹³ represents anilino or 4-methylanilino, and
p represents 0, or
(E-11) A¹¹ and A¹² together form the group 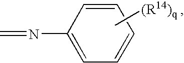
A¹³ represents the group 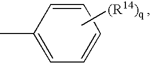
R¹⁴ each independently represents methyl or chloro,
q represents 0 or 1, and
p represents 1 and R¹¹ represents chloro or bromo.

15. A process for the preparation of isoindolinones of formula (IA) according to claim 12 comprising
(A) for isoindolinones of formula (IA) in which
A¹¹ represents hydrogen atom,
A¹² represents one of the groups 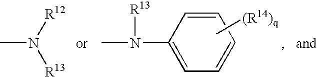
R¹², R¹³, R¹⁴, and q have the same definitions as for formula (IA) in claim 12, reacting a compound of formula (II) 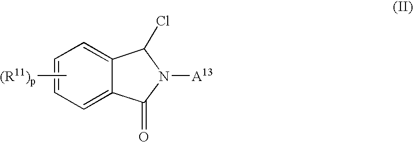
wherein
A¹³ represents —R¹² or the group 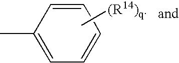
R¹¹, R¹², R¹⁴, p, and q have the same definitions as for formula (IA) in claim 12,
with a compound of formula (Ill)
H—R^{12a} (III)
wherein
A^{12a} represents one of the groups 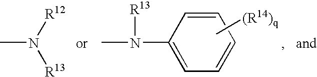
R¹², R¹³, R¹⁴, and q have the same definitions as for formula (IA) in claim 12,
in the presence of inert solvents, and optionally in the presence of an acid binder,
or
(B) for isoindolinones of formula (IA) in which
R¹¹ represents halogen, alkyl, alkoxy, alkylsulfonyl, alkylsulfonyloxy, haloalkyl, haloalkoxy, or nitro, and
R¹² represents alkyl that is substituted by alkylsulfinyl or alkylsulfonyl: reacting a compound of formula (IAb) 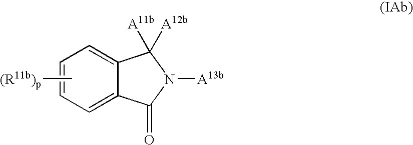
wherein
A^{11b} represents hydrogen atom, and
A^{12b} represents one of the groups 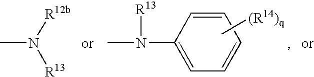
A^{11b} and A^{12b} together form one of the groups 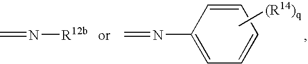
A^{13b} represents —R^{12b} or the group 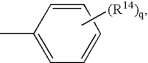
R^{11b} represents halogen, alkyl, alkoxy, alkylsulfonyl, alkylsulfonyloxy, haloalkyl, haloalkoxy, or nitro,
R^{12b} represents alkyl that is substituted by alkylthio, and
R¹³, R¹⁴, p, and q have the same definitions as for formula (IA) in claim 12,
with a peroxy acid in the presence of inert solvents,
or
(C) for isoindolinones of formula (IA) in which
A¹¹ and A¹² together form one of the groups 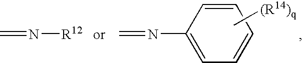
A¹³ represents —R¹² or the group 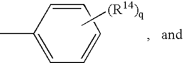
R¹², R¹³, R¹⁴, and q have the same definitions as for formula (IA) in claim 12, reacting a compound of formula (IAc) 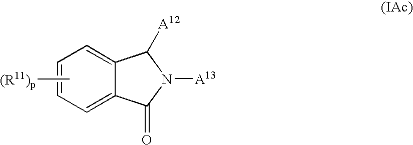
wherein
A¹² represents one of the groups 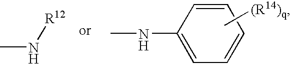
A¹³ represents —R¹² or the group 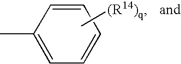
R¹¹, R¹², R¹⁴, p, and q have the same definitions as for formula (IA) in claim 12,
with a cyanide in the presence of inert solvents,
or
(D) for isoindolinones of formula (IA) in which
A¹¹ and A¹² together form one of the groups 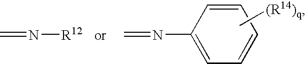
A¹³ represents —R¹² or the group 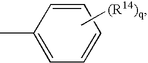
R¹¹ represents halogen, alkyl, alkoxy, alkylsulfonyl, alkylsulfonyloxy, haloalkyl, haloalkoxy, or nitro, and
R¹² represents alkyl that is substituted with alkylsulfonyl:
reacting a compound of formula (IAd) 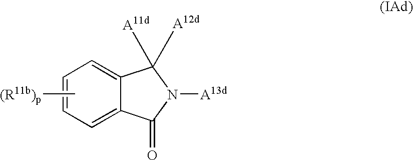
wherein
A^{11d} represents hydrogen, and
A^{12d} represents one of the groups 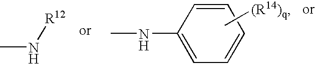
A^{11d} and A^{12d} together form one of the groups 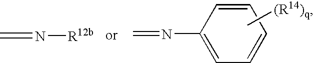
A^{13d} represents —R^{12b} or the group 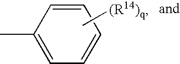
R^{11b}, R¹², R^{12b}, R¹⁴, p and q have the same definitions as for formula (IA) in claim 12,
with an oxidizing agent in the presence of inert solvents.

16. A pesticide comprising one or more isoindolinones of formula (I) according to claim 11 and one or more extenders and/or surfactants.

17. A pesticide comprising one or more isoindolinones of formula (IA) according to claim 12 and one or more extenders and/or surfactants.

18. A method for combating insects comprising allowing an effective amount of an isoindolinone of formula (IA) according to claim 12 to act on insects and/or their habitat.

19. A process for the preparation of an insecticidal composition comprising mixing one or more compounds of formula (I) according to claim 11 with one or more extenders and/or surface act agents.
